(19) United States
(12) Patent Application Publication
(10) Pub. No.: US 2026/0127170 A1
(43) Pub. Date: May 7, 2026

(54) Database System Including Query Operations Having a Tree Structure

(71) Applicant: Ocient Holdings LLC, Chicago, IL (US)

(72) Inventors: Ellis Mihalko Saupe, University City, MO (US); Syed Muhammad Arsam Hassan Naqvi, Elgin, IL (US); Anson Tiong, Lakeville, MN (US)

(73) Assignee: Ocient Holdings LLC, Chicago, IL (US)

(21) Appl. No.: 19/439,140

(22) Filed: Jan. 2, 2026

Related U.S. Application Data
(63) Continuation of application No. 18/634,450, filed on Apr. 12, 2024.

(51) Int. Cl. G06F 16/2453

(52) U.S. Cl. CPC G06F 16/24537; G06F 16/24542

(57) ABSTRACT

A set of processing core resources of a database system is operable to receive a query regarding a dataset. The query includes query operations organized in a tree structure. A section of the tree includes a set of branches having a common connection point. The set is operable to, for the section, set a first execution indicator to a pause mode value. The set is operable to set a second execution indicator to an execution mode value. The set is operable to execute the second set of query operations to produce a second partial query resultant. The set is operable to, when the second branch is substantially completes, send an end of file signal to the third set of query operations. The set is operable to, in response to the end of file signal, change the first execution indicator to the execution mode value and execute the first set of query operations to produce a first partial query resultant.

### CROSS-REFERENCE TO RELATED APPLICATIONS

The present U.S. Utility Patent Application claims priority pursuant to 35 U.S.C. § 120 as a continuation of U.S. Utility application Ser. No. 18/634,450, entitled, “EXECUTING MULTI-CHILD OPERATORS DURING QUERY EXECUTION VIA APPLYING A PIECEWISE SCHEDULING STRATEGY”, filed on Apr. 12, 2024, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networking and more particularly to database system and operation.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system in accordance with various embodiments;

FIG. 1A is a schematic block diagram of an embodiment of a database system in accordance with various embodiments;

FIG. 2 is a schematic block diagram of an embodiment of an administrative sub-system in accordance with various embodiments;

FIG. 3 is a schematic block diagram of an embodiment of a configuration sub-system in accordance with various embodiments;

FIG. 4 is a schematic block diagram of an embodiment of a parallelized data input sub-system in accordance with various embodiments;

FIG. 5 is a schematic block diagram of an embodiment of a parallelized query and response (Q&R) sub-system in accordance with various embodiments;

FIG. 6 is a schematic block diagram of an embodiment of a parallelized data store, retrieve, and/or process (IO& P) sub-system in accordance with various embodiments;

FIG. 7 is a schematic block diagram of an embodiment of a computing device in accordance with various embodiments;

FIG. 8 is a schematic block diagram of another embodiment of a computing device in accordance with various embodiments;

FIG. 9 is a schematic block diagram of another embodiment of a computing device in accordance with various embodiments;

FIG. 10 is a schematic block diagram of an embodiment of a node of a computing device in accordance with various embodiments;

FIG. 11 is a schematic block diagram of an embodiment of a node of a computing device in accordance with various embodiments;

FIG. 12 is a schematic block diagram of an embodiment of a node of a computing device in accordance with various embodiments;

FIG. 13 is a schematic block diagram of an embodiment of a node of a computing device in accordance with various embodiments;

FIG. 14 is a schematic block diagram of an embodiment of operating systems of a computing device in accordance with various embodiments;

FIGS. 15-23 are schematic block diagrams of an example of processing a table or data set for storage in the database system in accordance with various embodiments;

FIG. 24A is a schematic block diagram of a query execution plan implemented via a plurality of nodes in accordance with various embodiments;

FIGS. 24B-24D are schematic block diagrams of embodiments of a node that implements a query processing module in accordance with various embodiments;

FIG. 24E is an embodiment is schematic block diagrams illustrating a plurality of nodes that communicate via shuffle networks in accordance with various embodiments;

FIG. 24F is a schematic block diagram of a database system communicating with an external requesting entity in accordance with various embodiments;

FIG. 24G is a schematic block diagram of a query processing system in accordance with various embodiments;

FIG. 24H is a schematic block diagram of a query operator execution flow in accordance with various embodiments;

FIG. 24I is a schematic block diagram of a plurality of nodes that utilize query operator execution flows in accordance with various embodiments;

FIG. 24J is a schematic block diagram of a query execution module that executes a query operator execution flow via a plurality of corresponding operator execution modules in accordance with various embodiments;

FIG. 24K illustrates an example embodiment of a plurality of database tables stored in database storage in accordance with various embodiments;

FIG. 24L illustrates an example embodiment of a dataset stored in database storage that includes at least one array field in accordance with various embodiments;

FIG. 24M is a schematic block diagram of a query execution module that implements a plurality of column data streams in accordance with various embodiments;

FIG. 24N illustrates example data blocks of a column data stream in accordance with various embodiments;

FIG. 24O is a schematic block diagram of a query execution module illustrating writing and processing of data blocks by operator execution modules in accordance with various embodiments;

FIG. 24P is a schematic block diagram of a database system that implements a segment generator that generates segments from a plurality of records in accordance with various embodiments;

FIG. 24Q is a schematic block diagram of a segment generator that implements a cluster key-based grouping module, a columnar rotation module, and a metadata generator module in accordance with various embodiments;

FIG. 24R is a schematic block diagram of a query processing system that generates and executes a plurality of IO pipelines to generate filtered records sets from a plurality of segments in conjunction with executing a query in accordance with various embodiments;

FIG. 24S is a schematic block diagram of a query processing system that generates an IO pipeline for accessing a corresponding segment based on predicates of a query in accordance with various embodiments;

FIG. 24T is a schematic block diagram of a database system that includes a plurality of storage clusters that each mediate cluster state data via a plurality of nodes in accordance with a consensus protocol in accordance with various embodiments;

FIG. 24U is a schematic block diagram of a database system that implements a compressed column filter conversion module based on accessing a dictionary structure in accordance with various embodiments;

FIG. 24V is a schematic block diagram of a query execution module that implements a Global Dictionary Compression join via access to a dictionary structure in accordance with various embodiments;

FIG. 25A is a schematic block diagram of a database system executing a join process based on a join expression of a query request in accordance with various embodiments;

FIG. 25B is a schematic block diagram of a query execution module executing a join process via multiple parallel processes in accordance with various embodiments;

FIG. 25C is a schematic block diagram of a query execution module executing a join operator based on utilizing a hasp map generated from right input rows in accordance with various embodiments;

FIGS. 26A-26C are schematic block diagrams of example query operator execution flows executed by a query execution module in accordance with various embodiments;

FIG. 26D is a schematic block diagram of a query execution module that executes a query operator execution flow in accordance with a right-to-left piecewise scheduling strategy dictated by an operator scheduling module in accordance with various embodiments;

FIG. 26E is a schematic block diagram illustrating right-to-left piecewise operator execution of an example query operator execution flow in accordance with various embodiments;

FIG. 26F is a schematic block diagram of a pre-execution compiling module that instantiates a plurality of atomic integers for a plurality of leaf operators of a query operator execution flow in accordance with various embodiments;

FIG. 26G is a schematic block diagram of an operator execution module that updates an atomic integer for a leaf operator to initiate execution of the leaf operator in accordance with various embodiments;

FIG. 26H is a schematic block diagram illustrating execution of a union all operator by a query execution module via left-to-right piecewise operator execution of a plurality of parallelized processes in accordance with various embodiments;

FIG. 26I is a schematic block diagram of an operator flow generator module that implements a flow optimizer module to transform an example query operator execution flow to include a plurality of grouped aggregation operators and a union all operator for execution via left-to-right piecewise operator execution in accordance with various embodiments;

FIG. 26J is a schematic block diagram of an operator flow generator module that implements a flow optimizer module to transform an example query operator execution flow to include a plurality blocking operators for execution via left-to-right piecewise operator execution in accordance with various embodiments;

FIG. 26K is a logic diagram illustrating a method for execution in accordance with various embodiments;

FIG. 27A is a schematic block diagram of a query execution module executing a join operator via access to a hash map that includes a plurality of bucket structures in accordance with various embodiments;

FIG. 27B illustrates an embodiment of a hash map that includes a bucket structure indicating a value set stored via a plurality of chunks via a pointer to a first chunk in accordance with various embodiments;

FIG. 27C is a logic diagram illustrating a method for execution in accordance with various embodiments;

FIG. 28A is a schematic block diagram of a hash map generator module that implements a hash map resizing process in accordance with various embodiments;

FIG. 28B is a schematic block diagram of a hash map generator module that implements a hash map resizing module to apply a slot rehashing module to a fixed-size hash table in accordance with various embodiments;

FIGS. 28C and 28D illustrate execution of linear probing processes via a slot rehashing module in accordance with various embodiments;

FIG. 28E is a logic diagram illustrating a method for execution in accordance with various embodiments;

FIG. 29A is a schematic block diagram of a database system that executes a query request indicating a limit sort operation via execution of a query operator execution flow that includes a hierarchical plurality of heap sort operations in accordance with various embodiments;

FIG. 29B is a schematic block diagram of an operator flow generator module of a database system that implements a hierarchical limit sort condition detection module to determine whether to apply a hierarchical limit sort strategy in generating a query operator execution flow in accordance with various embodiments;

FIG. 29C is a schematic block diagram of an operator flow generator module of a database system that implements a multiplexer copy-free limit sort condition detection module to determine whether to apply a multiplexer copy-free limit sort strategy in generating a query operator execution flow in accordance with various embodiments;

FIG. 29D is a logic diagram illustrating a method for execution in accordance with various embodiments;

FIG. 30A is a schematic block diagram of a node that implements a plurality of processing core resources that each implement a data spill signaling module in accordance with various embodiments;

FIG. 30B is a logic diagram illustrating a method for execution in accordance with various embodiments;

FIG. 31A is a schematic block diagram of a database system that executes a query request indicating a plurality of join operations via execution of a query operator execution flow that includes a multi-join operator implementing a multi-join topology in accordance with various embodiments;

FIG. 31B illustrates a join map structure that includes a plurality of array structures that each include a plurality of bucket structures in accordance with various embodiments;

FIG. 31C a schematic block diagram of a stream row processing module implemented via execution of a multi-join operator to access a join map structure based on applying a traversal-based match determination process to a multi-join topology-based binary tree structure in accordance with various embodiments;

FIGS. 31D-31F illustrate embodiments of a query execution module executing multi-join operators implementing example multi-join topologies in accordance with various embodiments;

FIG. 31G is a schematic block diagram of an operator flow generator module that generates a query operator execution flow via implementing a flow optimizer module in accordance with various embodiments;

FIG. 31H is a schematic block diagram of flow optimizer module that implements a join merge module to generate a multi-join topology of a multi-join operator in accordance with various embodiments;

FIG. 31I is a logic diagram illustrating a method for execution in accordance with various embodiments;

FIG. 32A is a schematic block diagram of a query execution module that executes a multi-join operator implementing a join map generator module operable to access child branch dependency information in accordance with various embodiments;

FIG. 32B illustrates execution of a multi-join operator via implementing a join map generator module to process one child branch at a first time and to process another child branch at a second time based on child branch dependency information in accordance with various embodiments;

FIG. 32C illustrates a join map generator module that implements a child branch dependency information generator module to generate child branch dependency information based on applying a traversal-based dependency generation process to a multi-join topology-based binary tree structure in accordance with various embodiments;

FIGS. 32D-32E illustrate a child branch dependency information generator module that generates example child branch dependency information based on processing example multi-join topologies in accordance with various embodiments; and

FIG. 32F is a logic diagram illustrating a method for execution in accordance with various embodiments.

### DETAILED DESCRIPTION OF THE INVENTION

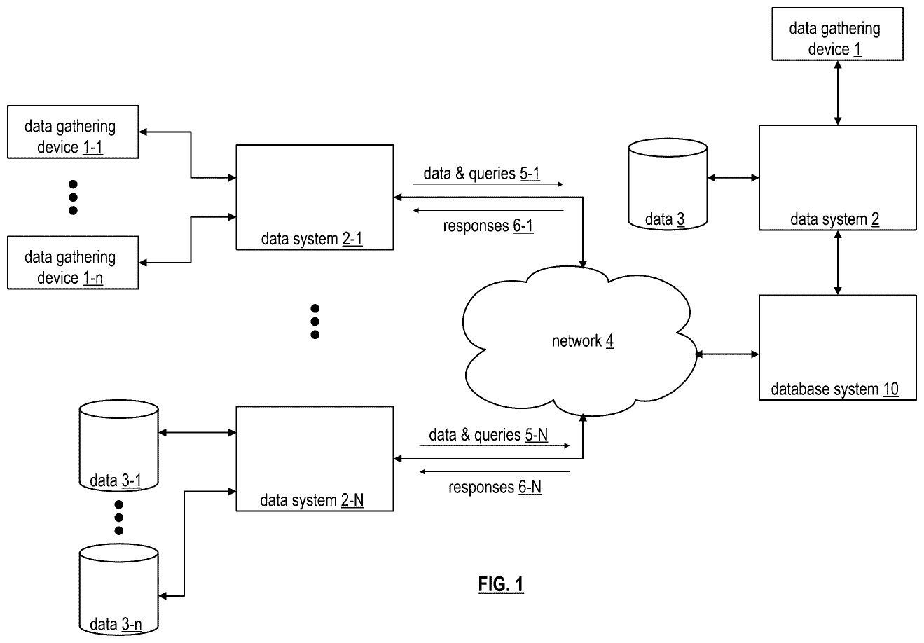

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of: wide area network (WAN) connections, local area network (LAN) connections, wireless connections, wireline connections, etc. to couple the sub-systems 11, 12, 13, 15, and 16 together.

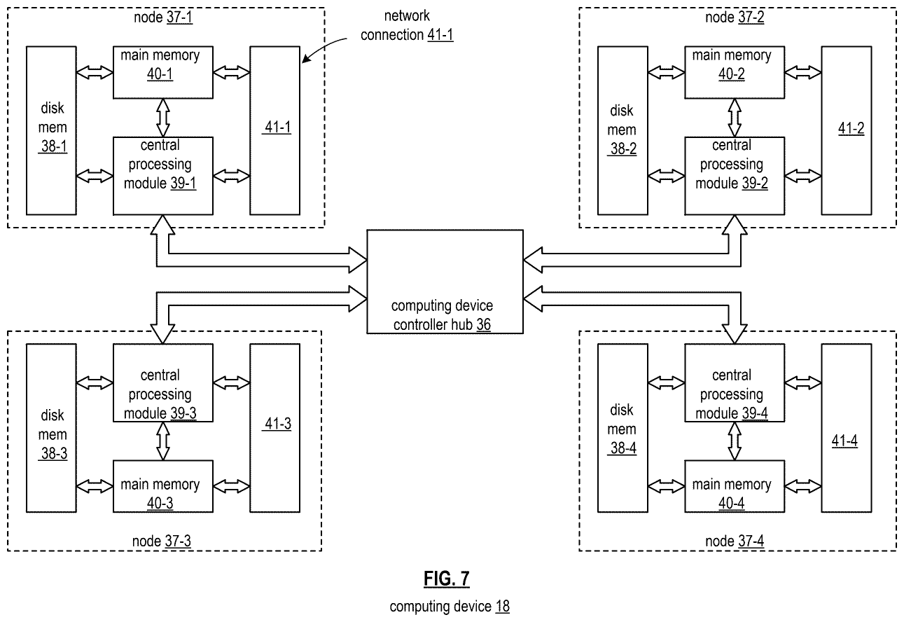

Each of the sub-systems 11, 12, 13, 15, and 16 include a plurality of computing devices; an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

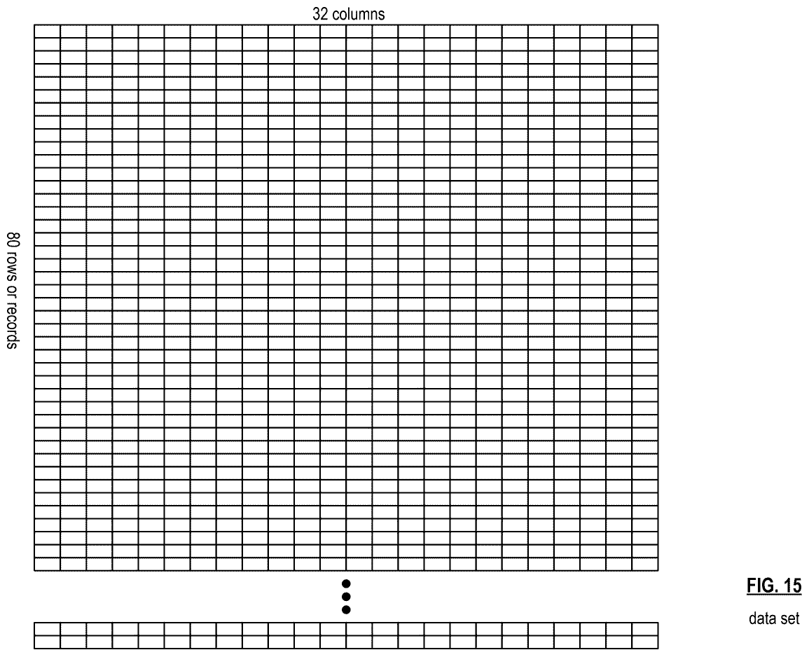

As is further discussed with reference to FIG. 15, the data source organizes its records of the data set into a table that includes rows and columns. The columns represent data fields of data for the rows. Each row corresponds to a record of data. For example, a table include payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches of dividing a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

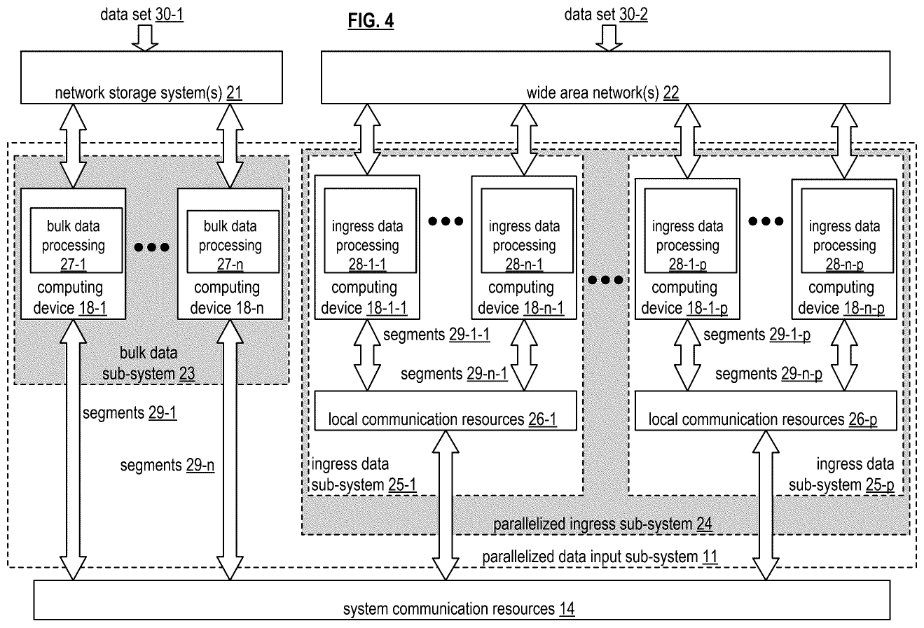

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of: a naming scheme, a request to store, a memory resource requirement, a processing resource requirement, an expected access frequency level, an expected storage duration, a required maximum access latency time, and other requirements associated with storage, processing, and retrieval of data.

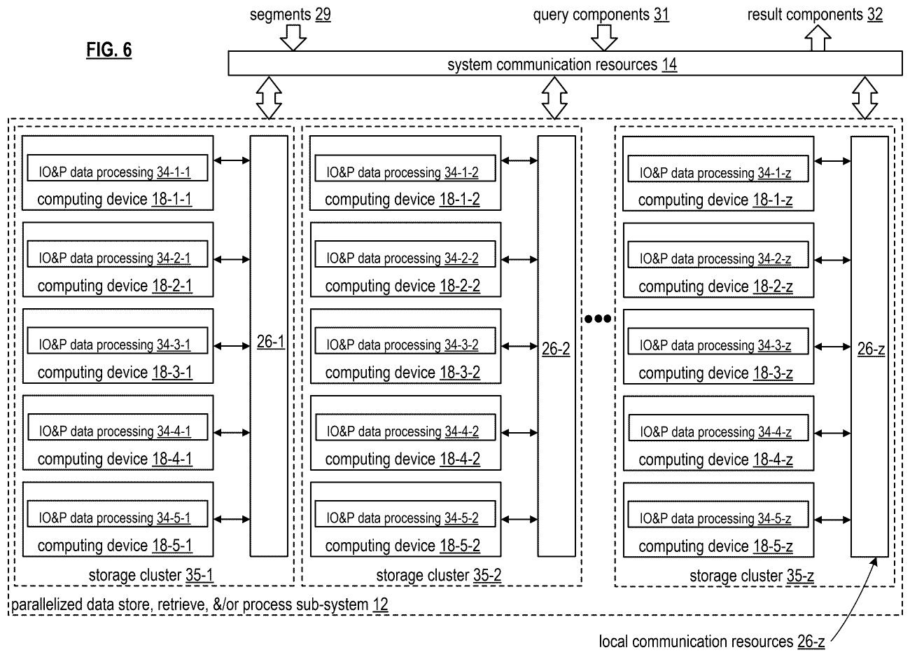

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates a SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

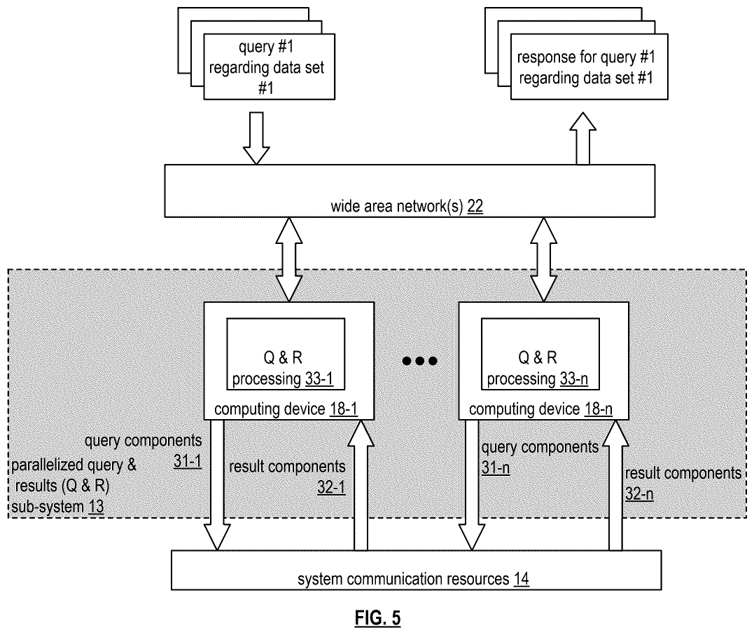

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

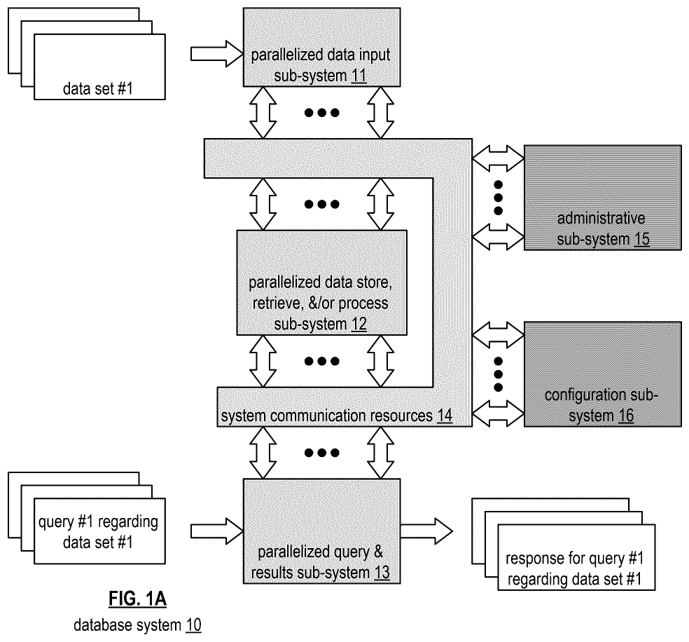

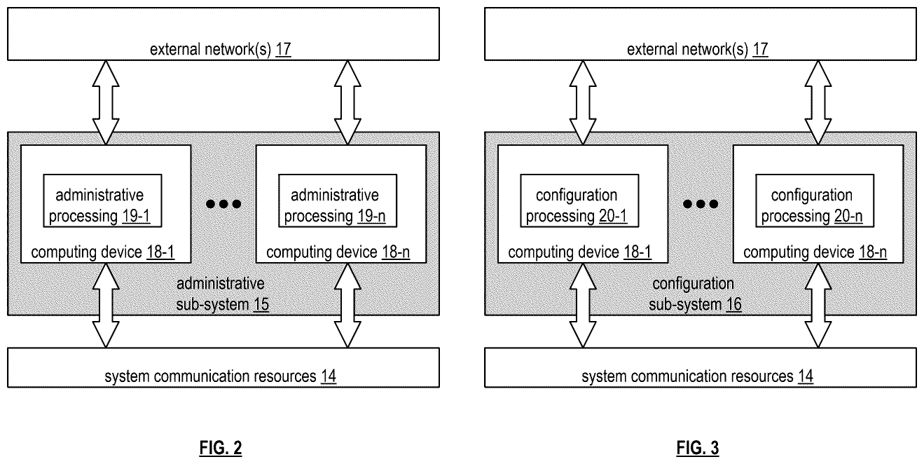

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub-system 12.

Processing resources of the parallelized data store, retrieve, &/or process sub-system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

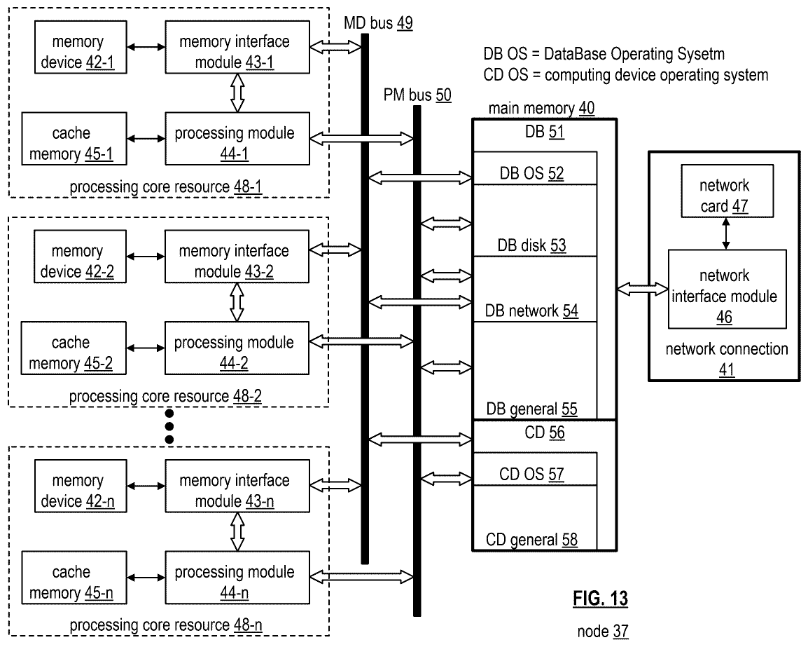

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (10 &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

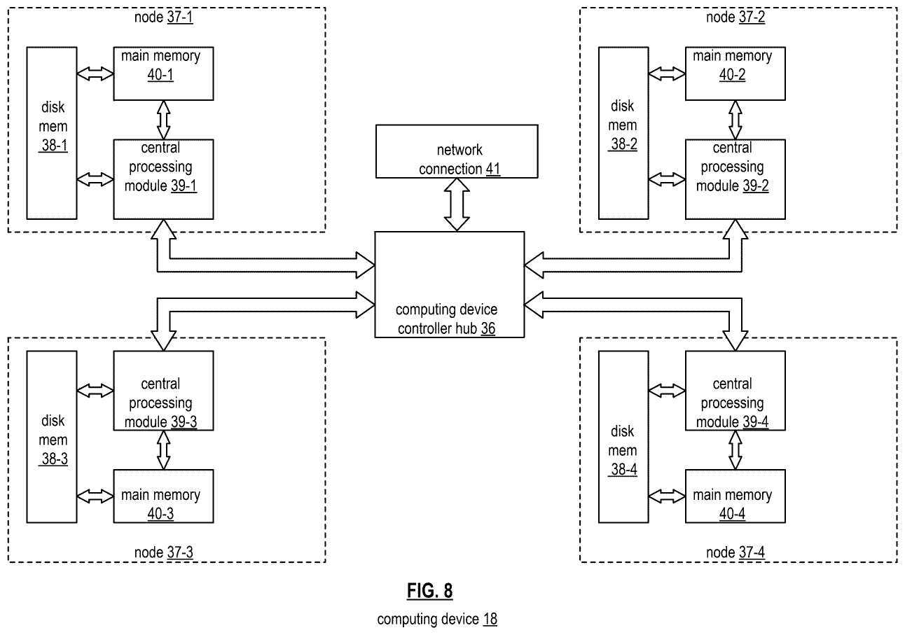

FIG. 8 is a schematic block diagram of another embodiment of a computing device similar to the computing device of FIG. 7 with an exception that it includes a single network connection 41, which is coupled to the computing device controller hub 36. As such, each node coordinates with the computing device controller hub to transmit or receive data via the network connection.

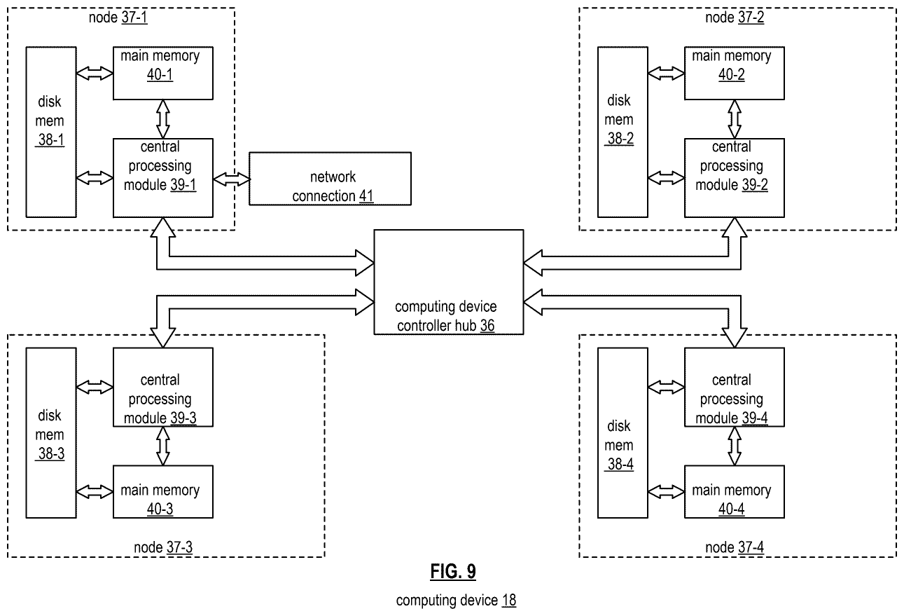

FIG. 9 is a schematic block diagram of another embodiment of a computing device is similar to the computing device of FIG. 7 with an exception that it includes a single network connection 41, which is coupled to a central processing module of a node (e.g., to central processing module 39-1 of node 37-1). As such, each node coordinates with the central processing module via the computing device controller hub 36 to transmit or receive data via the network connection.

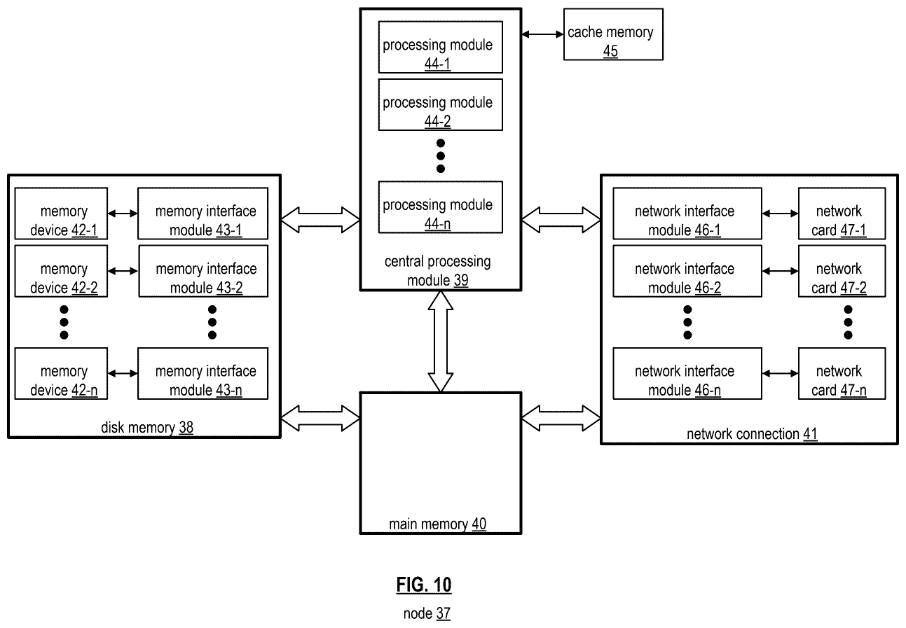

FIG. 10 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11 n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

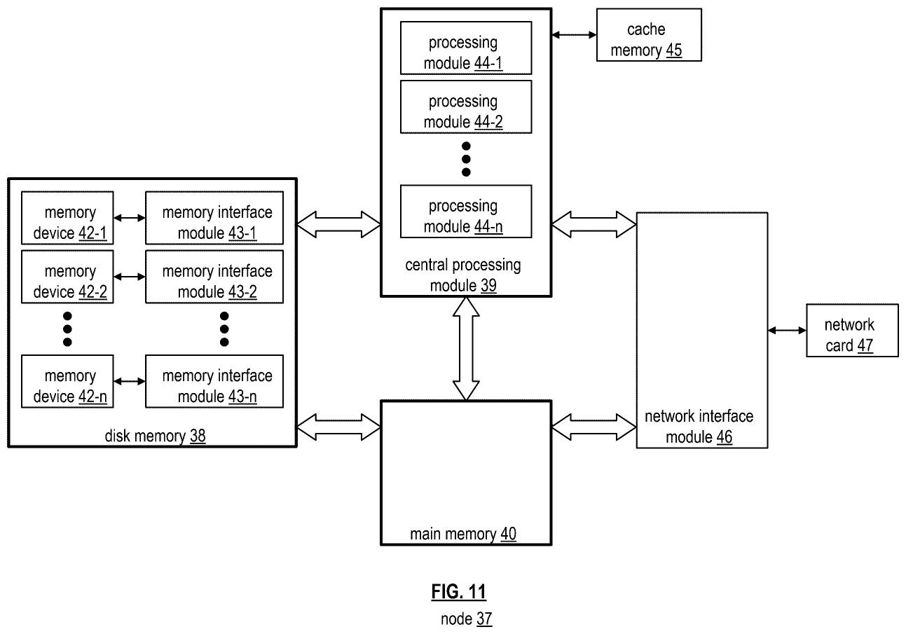

FIG. 11 is a schematic block diagram of an embodiment of a node 37 of a computing device 18 that is similar to the node of FIG. 10, with a difference in the network connection. In this embodiment, the node 37 includes a single network interface module 46 and a corresponding network card 47 configuration.

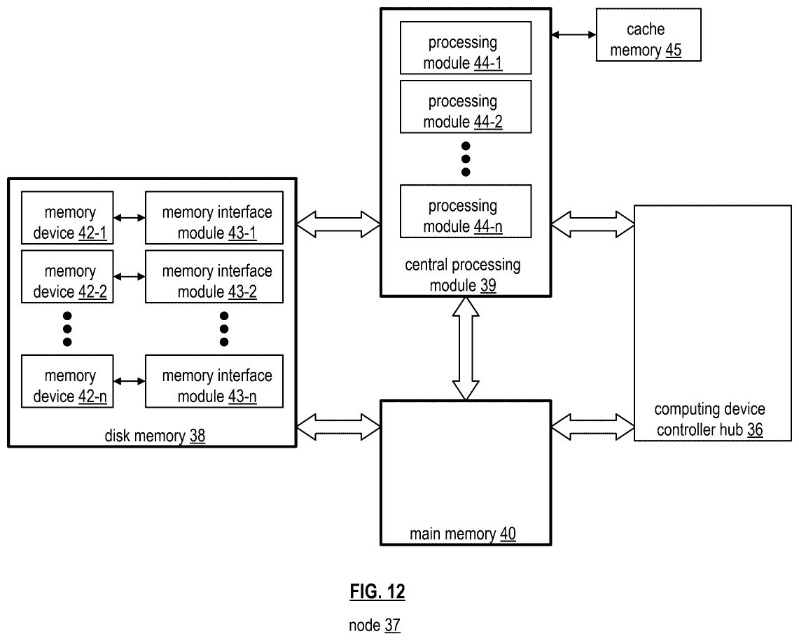

FIG. 12 is a schematic block diagram of an embodiment of a node 37 of a computing device 18 that is similar to the node of FIG. 10, with a difference in the network connection. In this embodiment, the node 37 connects to a network connection via the computing device controller hub 36.

FIG. 13 is a schematic block diagram of another embodiment of a node 37 of computing device 18 that includes processing core resources 48-1 through 48-n, a memory device (MD) bus 49, a processing module (PM) bus 50, a main memory 40 and a network connection 41. The network connection 41 includes the network card 47 and the network interface module 46 of FIG. 10. Each processing core resource 48 includes a corresponding processing module 44-1 through 44-n, a corresponding memory interface module 43-1 through 43-n, a corresponding memory device 42-1 through 42-n, and a corresponding cache memory 45-1 through 45-n. In this configuration, each processing core resource can operate independently of the other processing core resources. This further supports increased parallel operation of database functions to further reduce execution time.

The main memory 40 is divided into a computing device (CD) 56 section and a database (DB) 51 section. The database section includes a database operating system (OS) area 52, a disk area 53, a network area 54, and a general area 55. The computing device section includes a computing device operating system (OS) area 57 and a general area 58. Note that each section could include more or less allocated areas for various tasks being executed by the database system.

In general, the database OS 52 allocates main memory for database operations. Once allocated, the computing device OS 57 cannot access that portion of the main memory 40. This supports lock free and independent parallel execution of one or more operations.

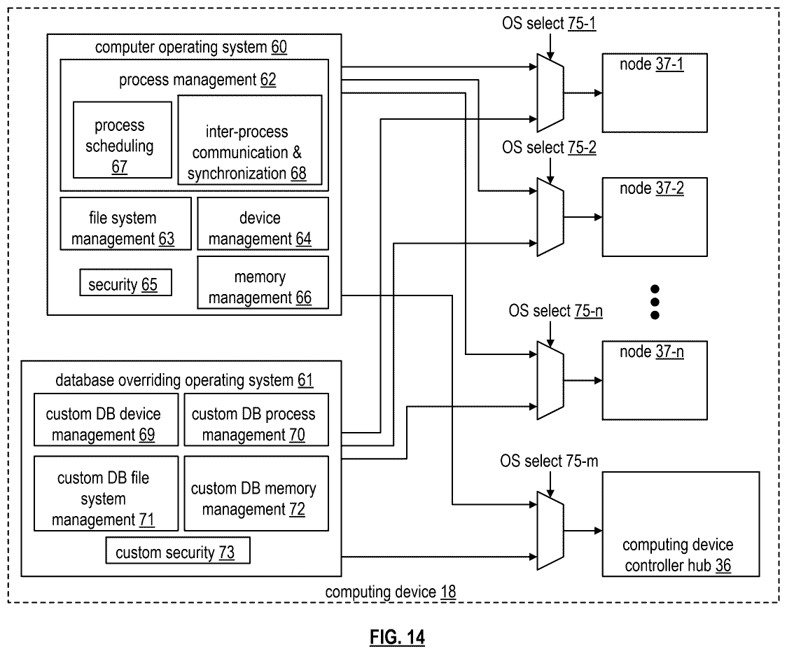

FIG. 14 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

FIGS. 15-23 are schematic block diagrams of an example of processing a table or data set for storage in the database system 10. FIG. 15 illustrates an example of a data set or table that includes 32 columns and 80 rows, or records, that is received by the parallelized data input-subsystem. This is a very small table, but is sufficient for illustrating one or more concepts regarding one or more aspects of a database system. The table is representative of a variety of data ranging from insurance data, to financial data, to employee data, to medical data, and so on.

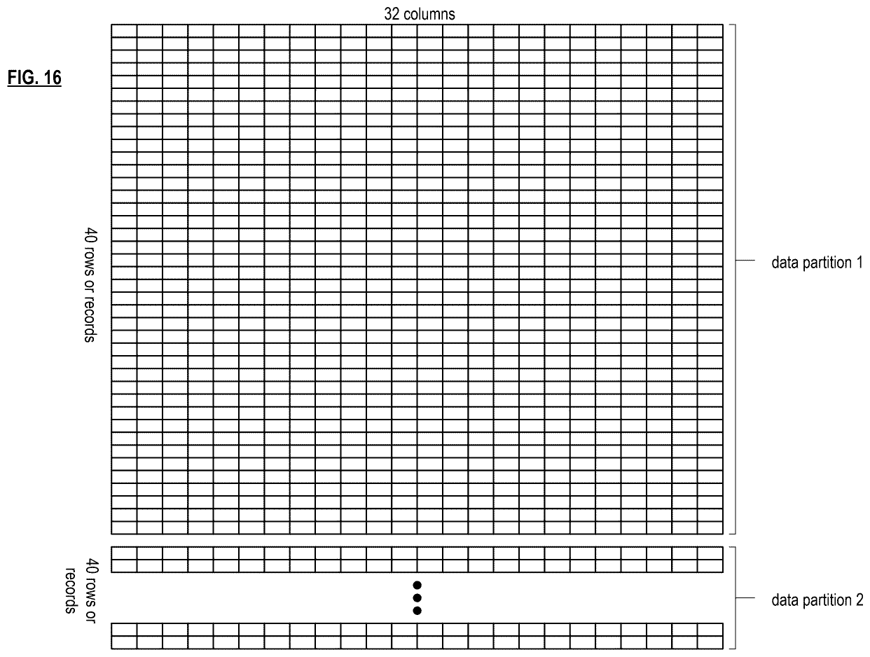

FIG. 16 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

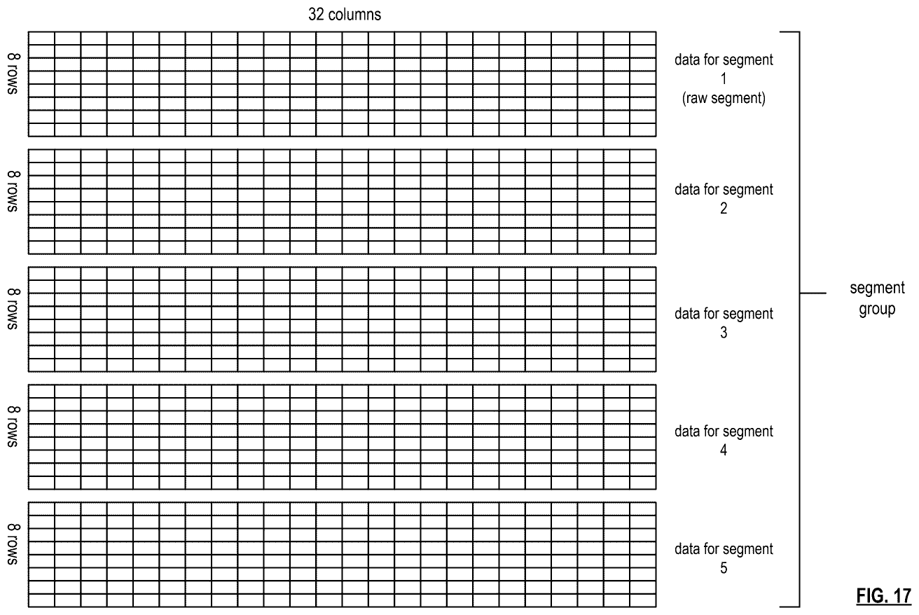

FIG. 17 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces; thus, eight segments are created.

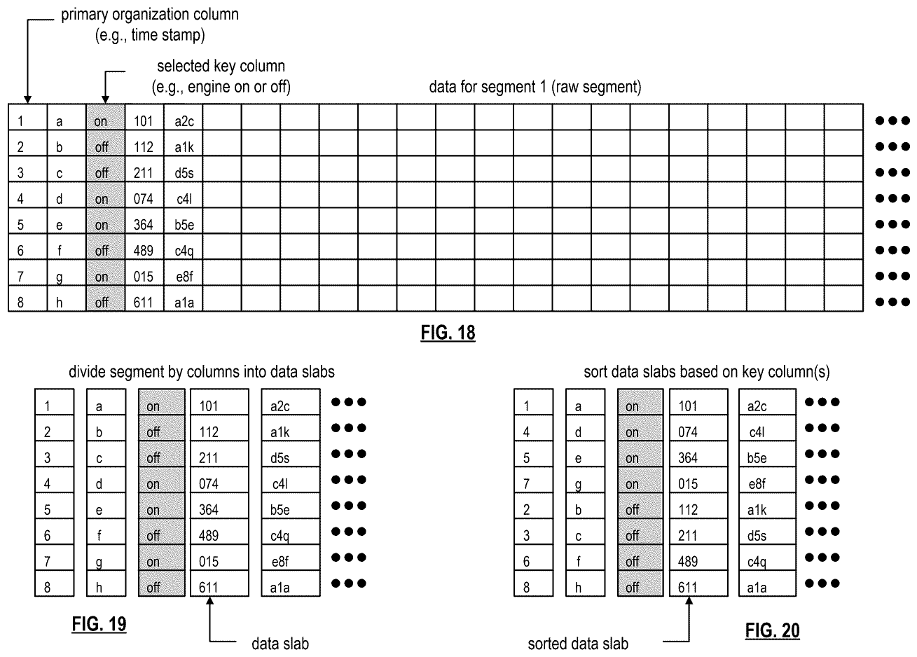

FIG. 18 illustrates an example of data for segment 1 of the segments of FIG. 17. The segment is in a raw form since it has not yet been key column sorted. As shown, segment 1 includes 8 rows and 32 columns. The third column is selected as the key column and the other columns store various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

FIG. 19 illustrates an example of the parallelized data input-subsystem dividing segment 1 of FIG. 18 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

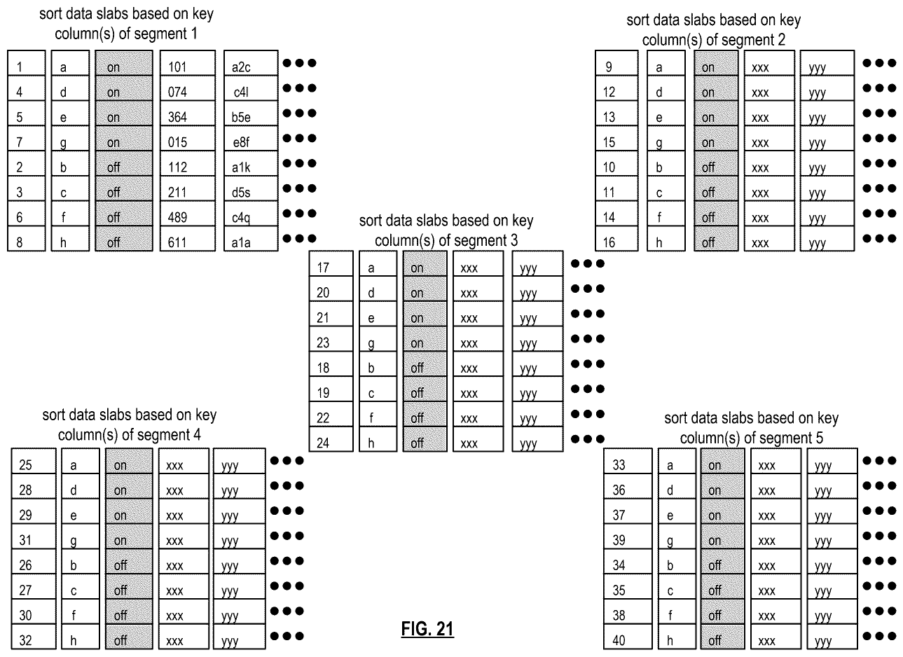

FIG. 20 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

FIG. 21 illustrates an example of each segment of the segment group sorted into sorted data slabs. The similarity of data from segment to segment is for the convenience of illustration. Note that each segment has its own data, which may or may not be similar to the data in the other sections.

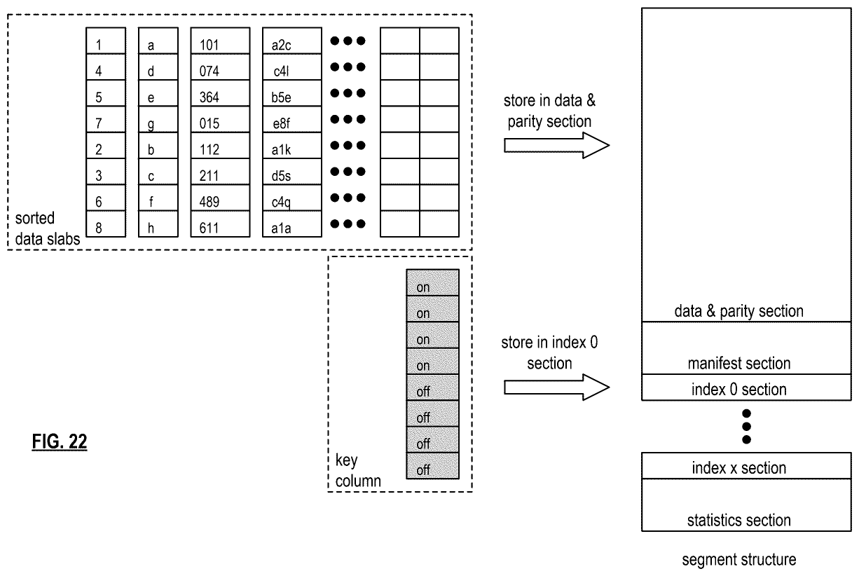

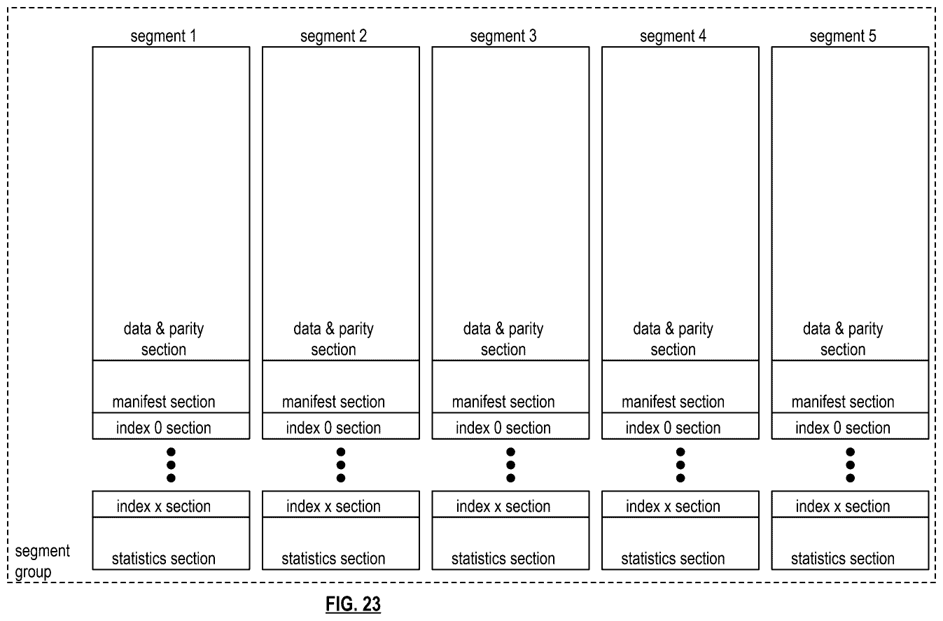

FIG. 22 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 KiloBytes).

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). As another example, the redundancy encoding utilizes an erasure coding scheme.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

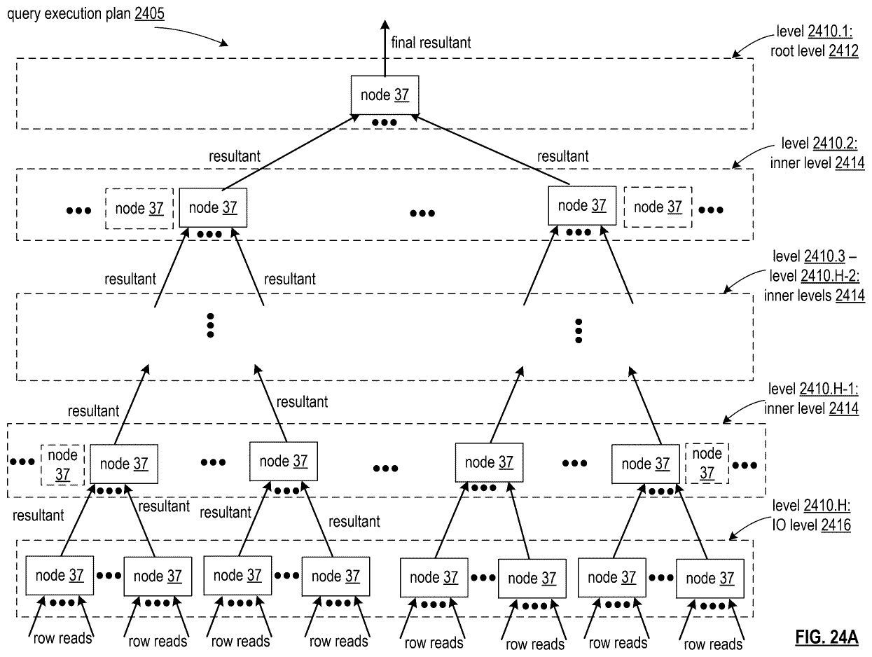

FIG. 23 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

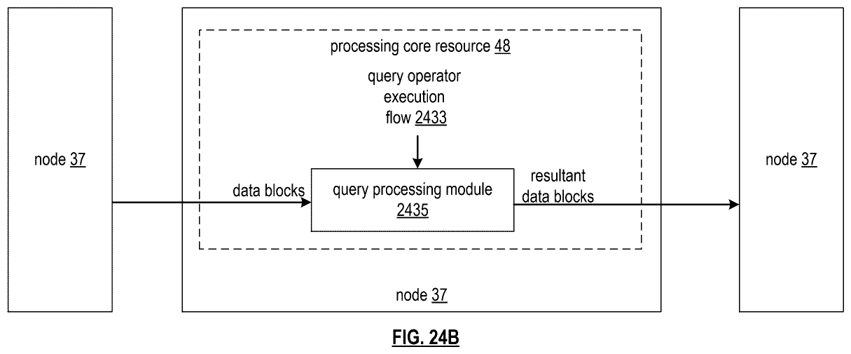

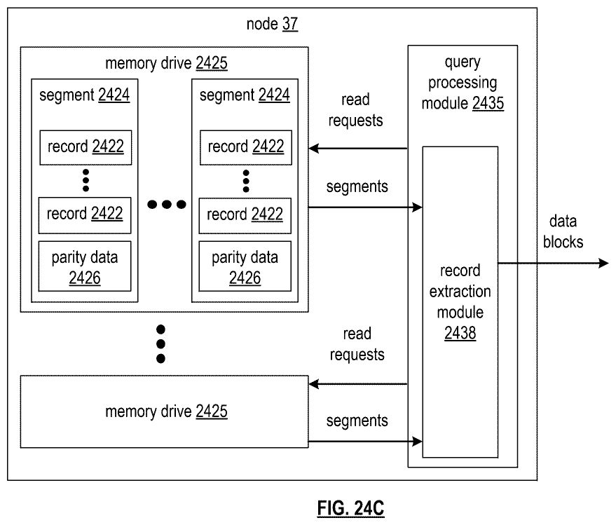

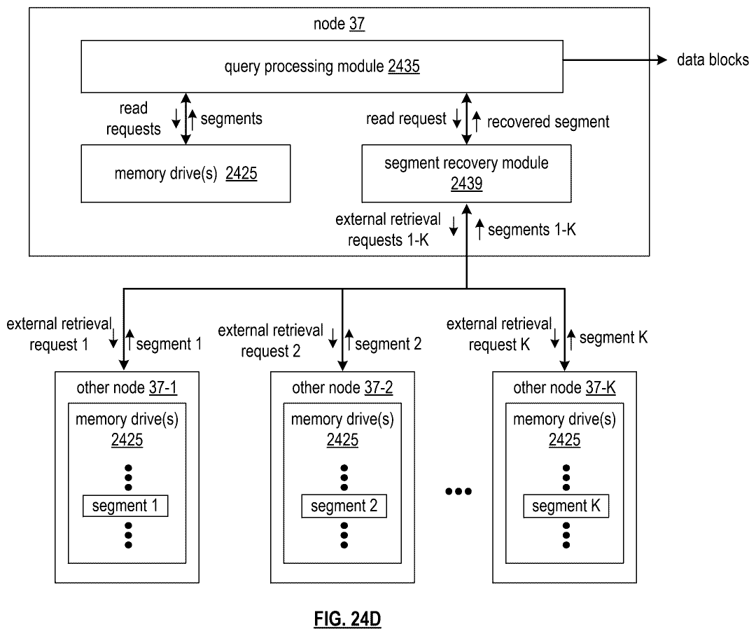

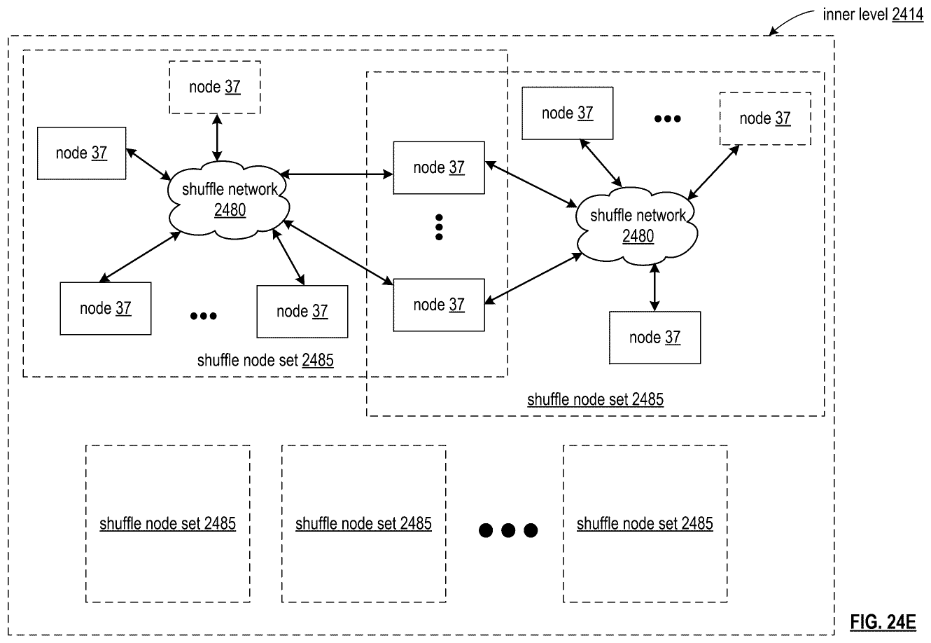

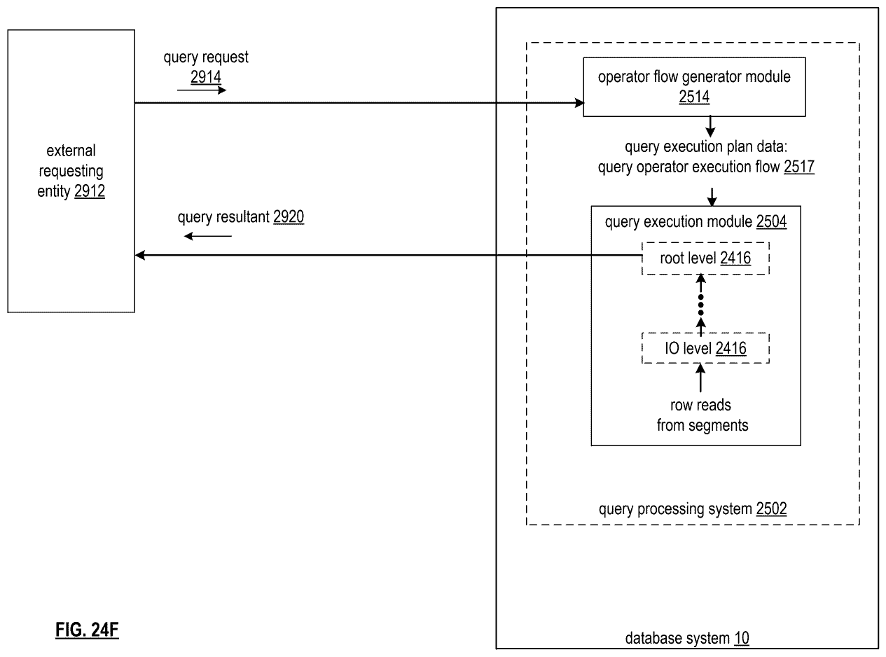

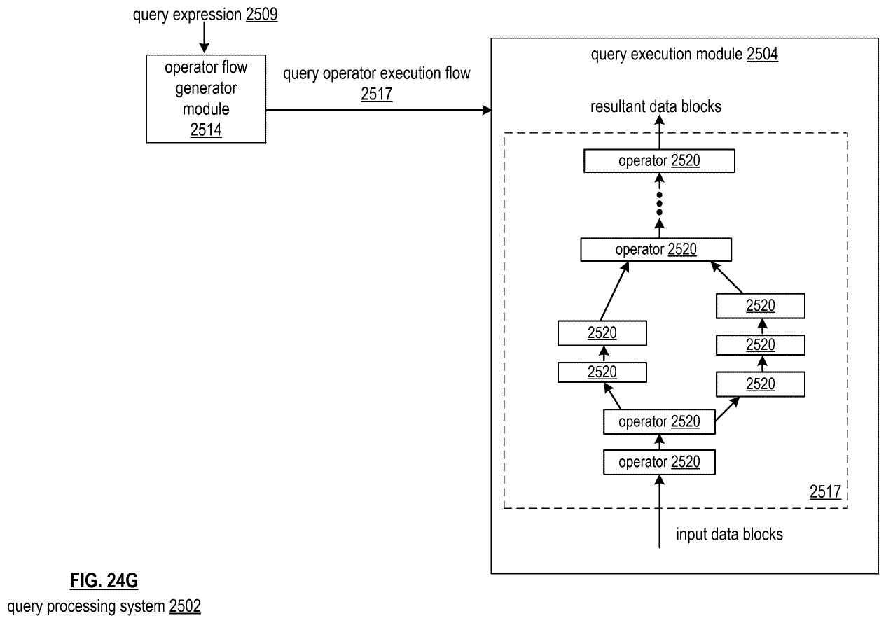

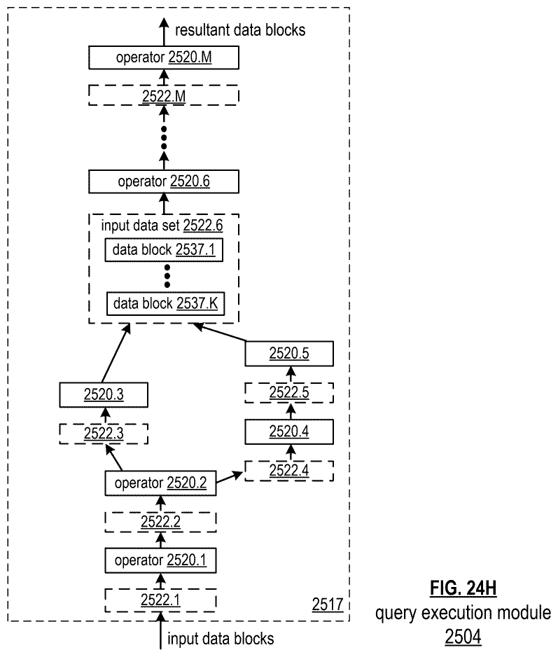

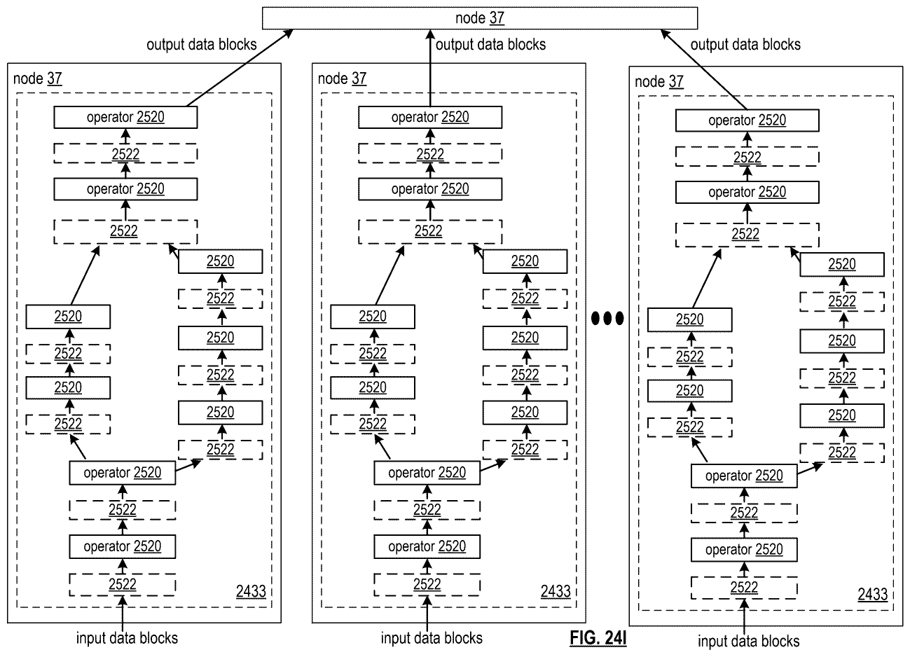

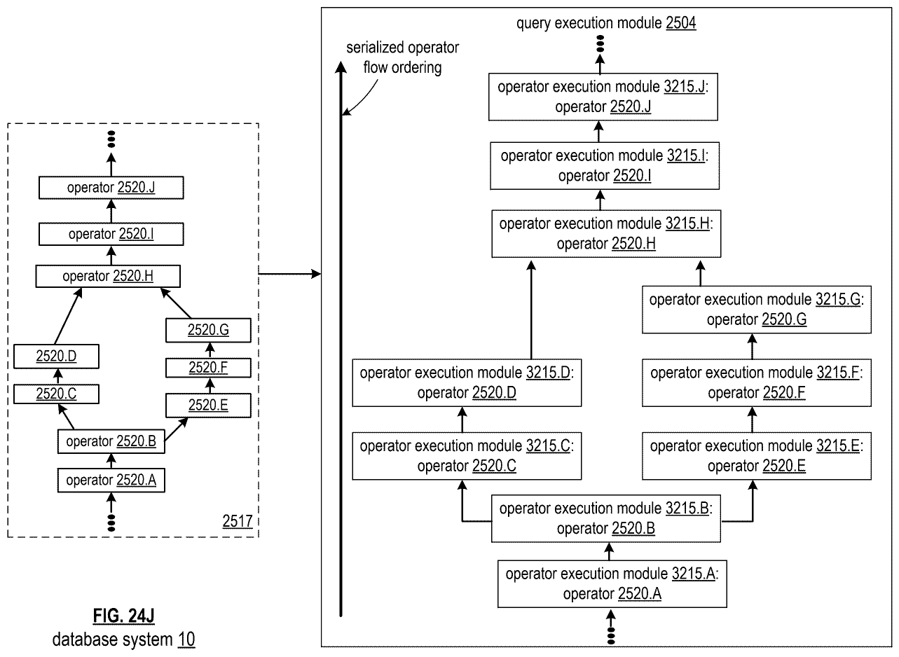

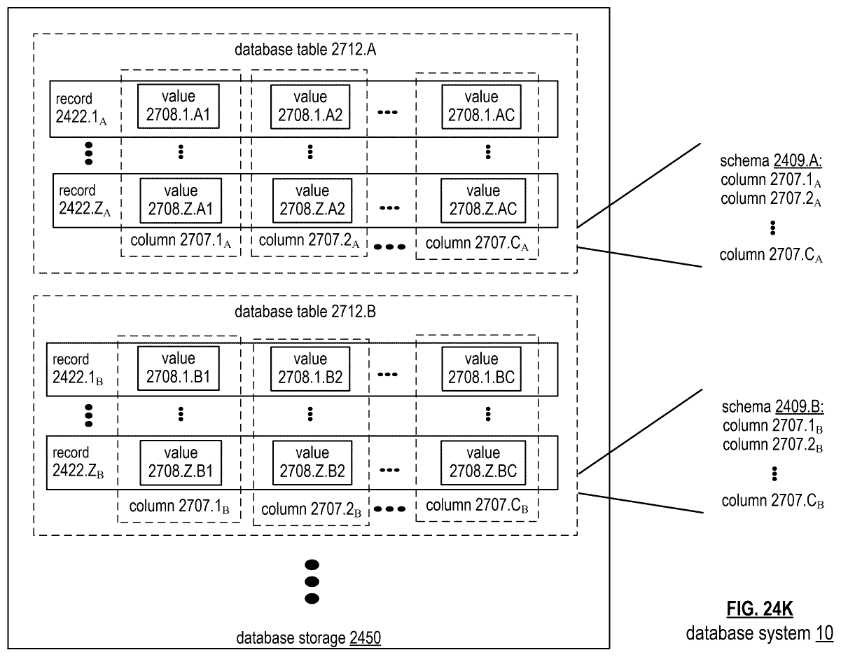

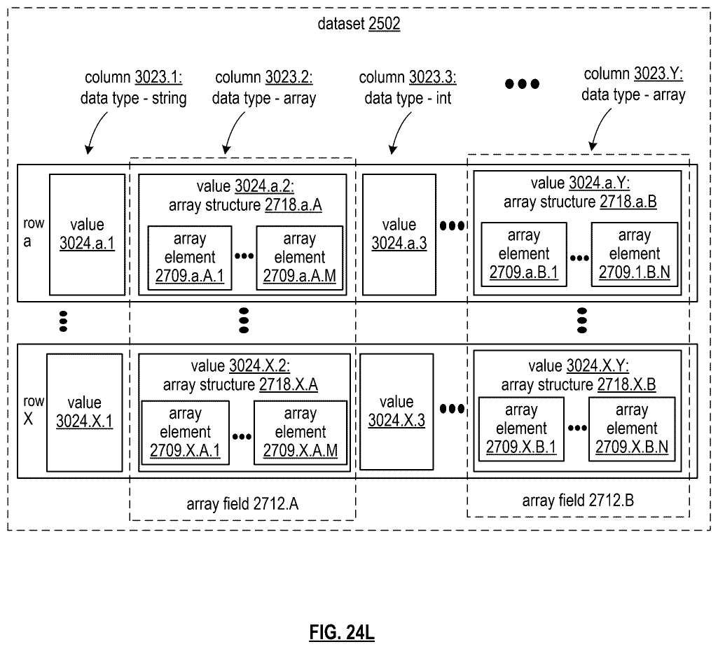

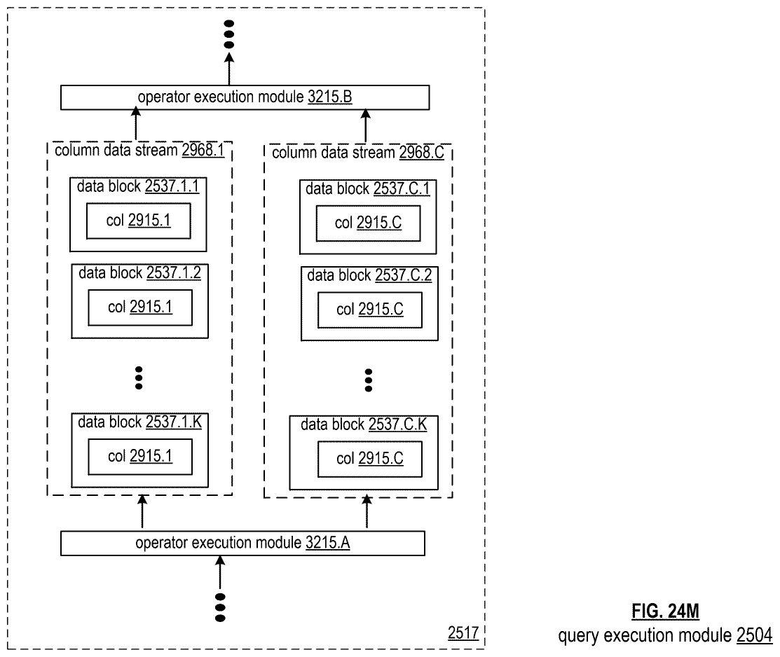

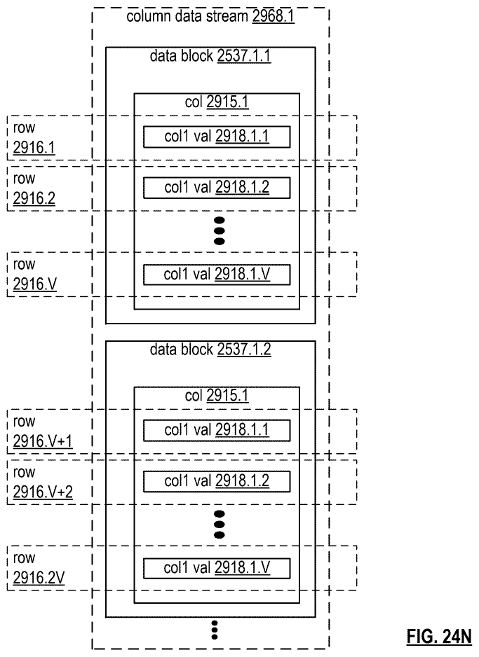

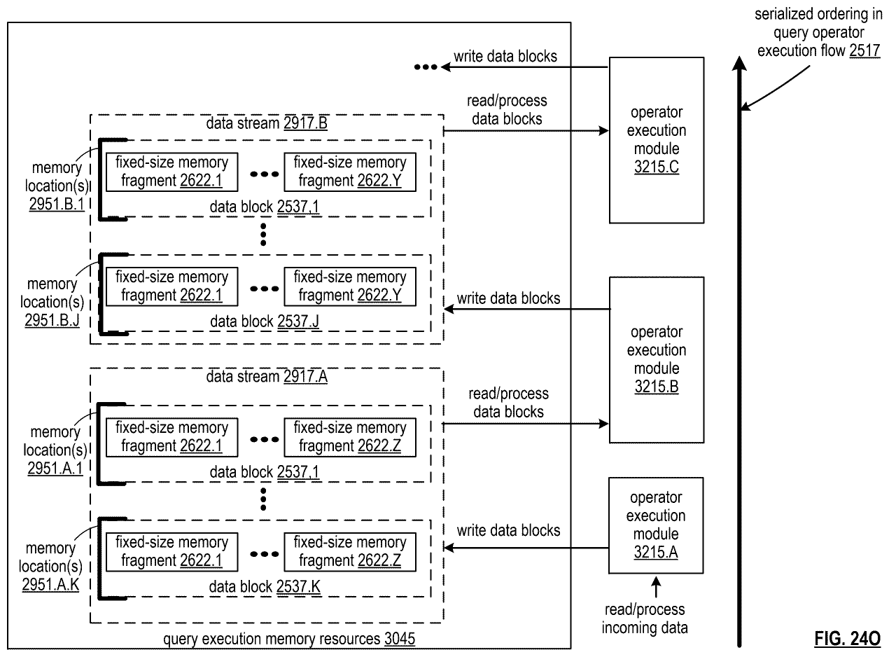

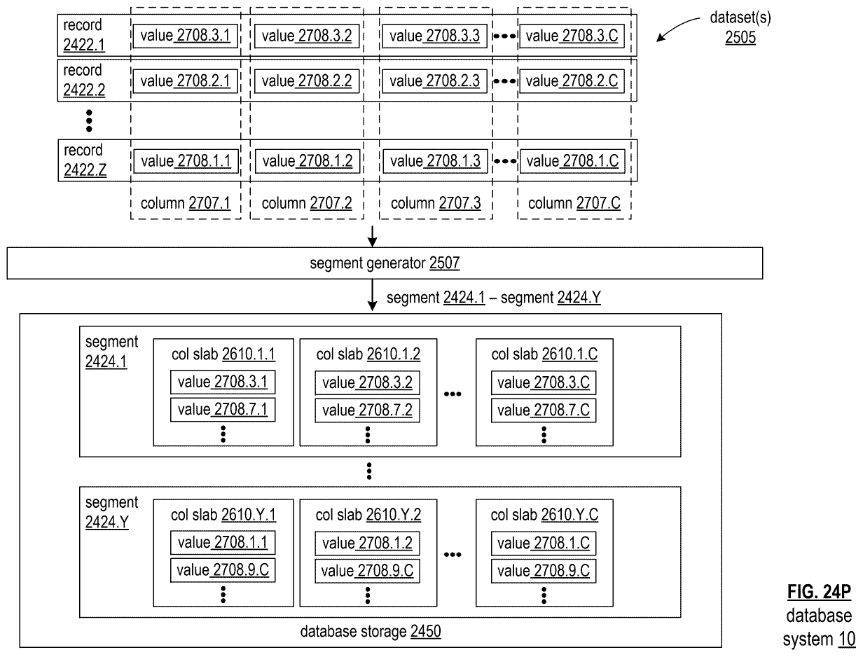

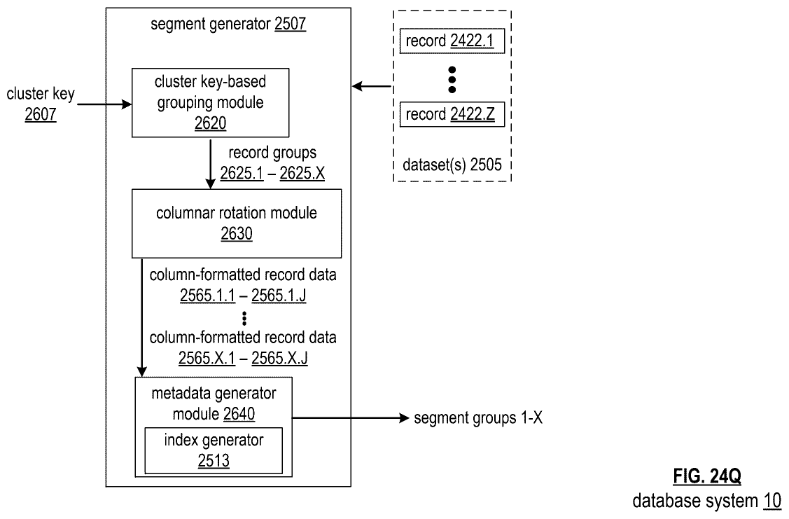

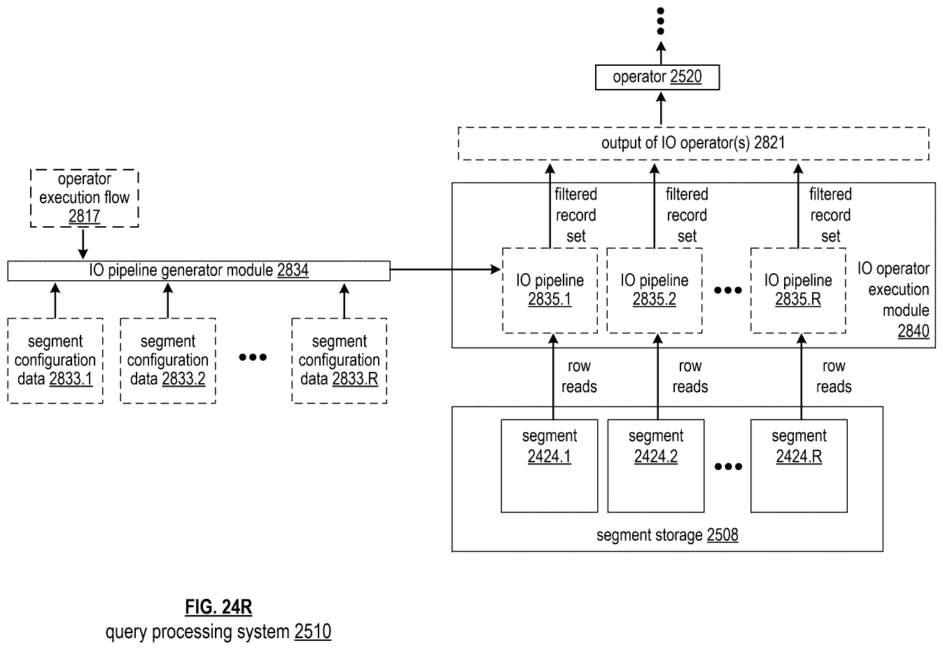

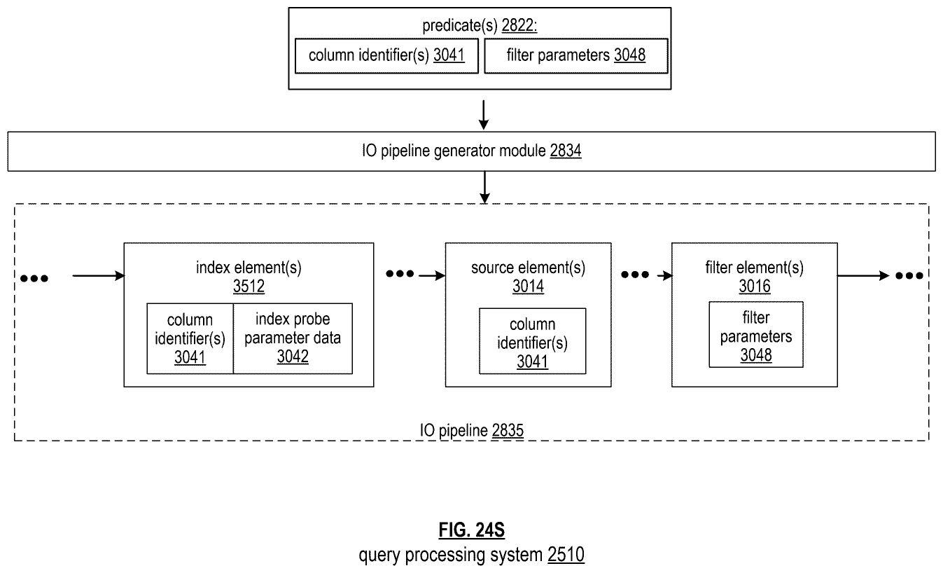

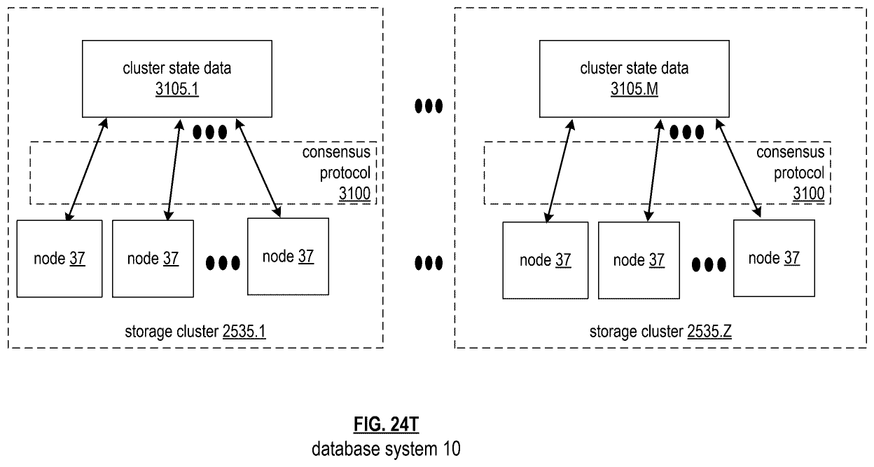

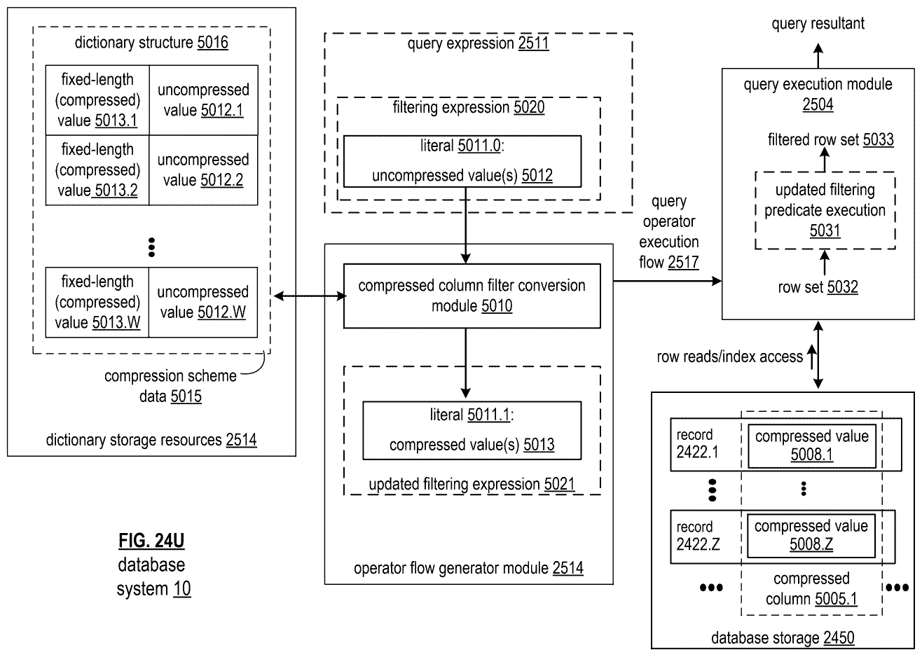

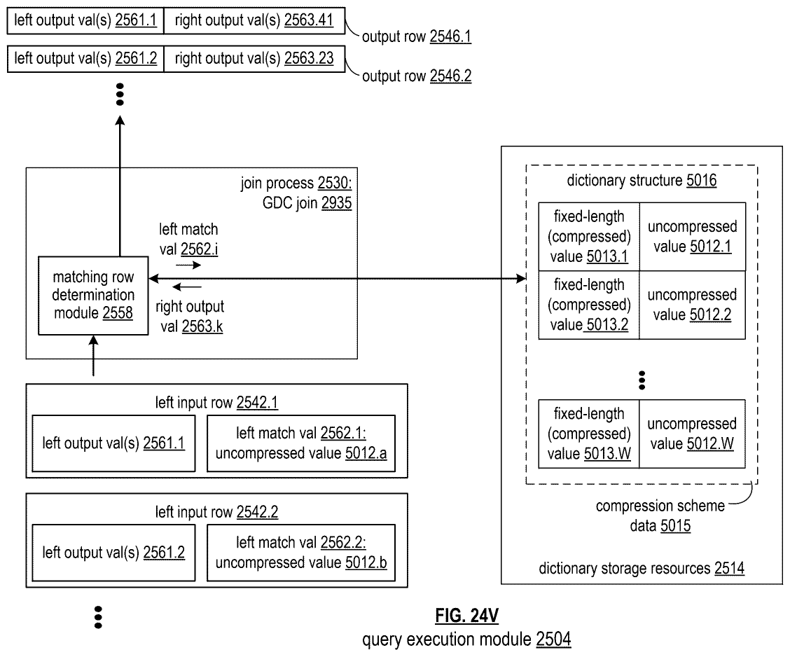

FIG. 24A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412; a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H−1, and there are no other inner levels 2410.3-2410.H−2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query, but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all of the rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set. In some cases, nodes 37 that do not store segments included in segment sets, that do not have access to stored segments, and/or that are not operable to perform row reads are not included at the IO level, but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H−1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined, and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 24A, resultants are sent by nodes upstream with respect to the tree structure of the query execution plan as they are generated, where the root node generates a final resultant of the query. While not depicted in FIG. 24A, nodes at a same level can share data and/or send resultants to each other, for example, in accordance with operators of the query at this same level dictating that data is sent between nodes.

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H−1 includes at least one node from the IO level 2416 in the possible set of nodes. In such cases, while each selected node in level 2410.H−1 is depicted to process resultants sent from other nodes 37 in FIG. 24A, each selected node in level 2410.H−1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

Some or all features and/or functionality of FIG. 24A can be performed via at least one node 37 in conjunction with system metadata applied across a plurality of nodes 37, for example, where at least one node 37 participates in some or all features and/or functionality of FIG. 24A based on receiving and storing the system metadata in local memory of the at least one node 37 as configuration data and/or based on further accessing and/or executing this configuration data to participate in a query execution plan of FIG. 24A as part of its database functionality accordingly. Performance of some or all features and/or functionality of FIG. 24A can optionally change and/or be updated over time, and/or a set of nodes participating in executing some or all features and/or functionality of FIG. 24A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24B illustrates an embodiment of a node 37 executing a query in accordance with the query execution plan 2405 by implementing a query processing module 2435. The query processing module 2435 can be operable to execute a query operator execution flow 2433 determined by the node 37, where the query operator execution flow 2433 corresponds to the entirety of processing of the query upon incoming data assigned to the corresponding node 37 in accordance with its role in the query execution plan 2405. This embodiment of node 37 that utilizes a query processing module 2435 can be utilized to implement some or all of the plurality of nodes 37 of some or all computing devices 18-1-18-n, for example, of the of the parallelized data store, retrieve, and/or process sub-system 12, and/or of the parallelized query and results sub-system 13.

As used herein, execution of a particular query by a particular node 37 can correspond to the execution of the portion of the particular query assigned to the particular node in accordance with full execution of the query by the plurality of nodes involved in the query execution plan 2405. This portion of the particular query assigned to a particular node can correspond to execution plurality of operators indicated by a query operator execution flow 2433. In particular, the execution of the query for a node 37 at an inner level 2414 and/or root level 2412 corresponds to generating a resultant by processing all incoming resultants received from nodes at a lower level of the query execution plan 2405 that send their own resultants to the node 37. The execution of the query for a node 37 at the IO level corresponds to generating all resultant data blocks by retrieving and/or recovering all segments assigned to the node 37.

Thus, as used herein, a node 37's full execution of a given query corresponds to only a portion of the query's execution across all nodes in the query execution plan 2405. In particular, a resultant generated by an inner level node 37's execution of a given query may correspond to only a portion of the entire query result, such as a subset of rows in a final result set, where other nodes generate their own resultants to generate other portions of the full resultant of the query. In such embodiments, a plurality of nodes at this inner level can fully execute queries on different portions of the query domain independently in parallel by utilizing the same query operator execution flow 2433. Resultants generated by each of the plurality of nodes at this inner level 2414 can be gathered into a final result of the query, for example, by the node 37 at root level 2412 if this inner level is the top-most inner level 2414 or the only inner level 2414. As another example, resultants generated by each of the plurality of nodes at this inner level 2414 can be further processed via additional operators of a query operator execution flow 2433 being implemented by another node at a consecutively higher inner level 2414 of the query execution plan 2405, where all nodes at this consecutively higher inner level 2414 all execute their own same query operator execution flow 2433.

As discussed in further detail herein, the resultant generated by a node 37 can include a plurality of resultant data blocks generated via a plurality of partial query executions. As used herein, a partial query execution performed by a node corresponds to generating a resultant based on only a subset of the query input received by the node 37. In particular, the query input corresponds to all resultants generated by one or more nodes at a lower level of the query execution plan that send their resultants to the node. However, this query input can correspond to a plurality of input data blocks received over time, for example, in conjunction with the one or more nodes at the lower level processing their own input data blocks received over time to generate their resultant data blocks sent to the node over time. Thus, the resultant generated by a node's full execution of a query can include a plurality of resultant data blocks, where each resultant data block is generated by processing a subset of all input data blocks as a partial query execution upon the subset of all data blocks via the query operator execution flow 2433.

As illustrated in FIG. 24B, the query processing module 2435 can be implemented by a single processing core resource 48 of the node 37. In such embodiments, each one of the processing core resources 48-1-48-n of a same node 37 can be executing at least one query concurrently via their own query processing module 2435, where a single node 37 implements each of set of operator processing modules 2435-1-2435-n via a corresponding one of the set of processing core resources 48-1-48-n. A plurality of queries can be concurrently executed by the node 37, where each of its processing core resources 48 can each independently execute at least one query within a same temporal period by utilizing a corresponding at least one query operator execution flow 2433 to generate at least one query resultant corresponding to the at least one query.

Some or all features and/or functionality of FIG. 24B can be performed via a corresponding node 37 in conjunction with system metadata applied across a plurality of nodes 37 that includes the given node, for example, where the given node 37 participates in some or all features and/or functionality of FIG. 24B based on receiving and storing the system metadata in local memory of given node 37 as configuration data and/or based on further accessing and/or executing this configuration data to process data blocks via a query processing module as part of its database functionality accordingly. Performance of some or all features and/or functionality of FIG. 24B can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24C illustrates a particular example of a node 37 at the IO level 2416 of the query execution plan 2405 of FIG. 24A. A node 37 can utilize its own memory resources, such as some or all of its disk memory 38 and/or some or all of its main memory 40 to implement at least one memory drive 2425 that stores a plurality of segments 2424. Memory drives 2425 of a node 37 can be implemented, for example, by utilizing disk memory 38 and/or main memory 40. In particular, a plurality of distinct memory drives 2425 of a node 37 can be implemented via the plurality of memory devices 42-1-42-n of the node 37's disk memory 38.

Each segment 2424 stored in memory drive 2425 can be generated as discussed previously in conjunction with FIGS. 15-23. A plurality of records 2422 can be included in and/or extractable from the segment, for example, where the plurality of records 2422 of a segment 2424 correspond to a plurality of rows designated for the particular segment 2424 prior to applying the redundancy storage coding scheme as illustrated in FIG. 17. The records 2422 can be included in data of segment 2424, for example, in accordance with a column-format and/or other structured format. Each segments 2424 can further include parity data 2426 as discussed previously to enable other segments 2424 in the same segment group to be recovered via applying a decoding function associated with the redundancy storage coding scheme, such as a RAID scheme and/or erasure coding scheme, that was utilized to generate the set of segments of a segment group.

Thus, in addition to performing the first stage of query execution by being responsible for row reads, nodes 37 can be utilized for database storage, and can each locally store a set of segments in its own memory drives 2425. In some cases, a node 37 can be responsible for retrieval of only the records stored in its own one or more memory drives 2425 as one or more segments 2424. Executions of queries corresponding to retrieval of records stored by a particular node 37 can be assigned to that particular node 37. In other embodiments, a node 37 does not use its own resources to store segments. A node 37 can access its assigned records for retrieval via memory resources of another node 37 and/or via other access to memory drives 2425, for example, by utilizing system communication resources 14.

The query processing module 2435 of the node 37 can be utilized to read the assigned by first retrieving or otherwise accessing the corresponding redundancy-coded segments 2424 that include the assigned records its one or more memory drives 2425. Query processing module 2435 can include a record extraction module 2438 that is then utilized to extract or otherwise read some or all records from these segments 2424 accessed in memory drives 2425, for example, where record data of the segment is segregated from other information such as parity data included in the segment and/or where this data containing the records is converted into row-formatted records from the column-formatted row data stored by the segment. Once the necessary records of a query are read by the node 37, the node can further utilize query processing module 2435 to send the retrieved records all at once, or in a stream as they are retrieved from memory drives 2425, as data blocks to the next node 37 in the query execution plan 2405 via system communication resources 14 or other communication channels.

Some or all features and/or functionality of FIG. 24C can be performed via a corresponding node 37 in conjunction with system metadata applied across a plurality of nodes 37 that includes the given node, for example, where the given node 37 participates in some or all features and/or functionality of FIG. 24C based on receiving and storing the system metadata in local memory of given node 37 as configuration data and/or based on further accessing and/or executing this configuration data to read segments and/or extract rows from segments via a query processing module as part of its database functionality accordingly. Performance of some or all features and/or functionality of FIG. 24C can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24D illustrates an embodiment of a node 37 that implements a segment recovery module 2439 to recover some or all segments that are assigned to the node for retrieval, in accordance with processing one or more queries, that are unavailable. Some or all features of the node 37 of FIG. 24D can be utilized to implement the node 37 of FIGS. 24B and 24C, and/or can be utilized to implement one or more nodes 37 of the query execution plan 2405 of FIG. 24A, such as nodes 37 at the IO level 2416. A node 37 may store segments on one of its own memory drives 2425 that becomes unavailable, or otherwise determines that a segment assigned to the node for execution of a query is unavailable for access via a memory drive the node 37 accesses via system communication resources 14. The segment recovery module 2439 can be implemented via at least one processing module of the node 37, such as resources of central processing module 39. The segment recovery module 2439 can retrieve the necessary number of segments 1-K in the same segment group as an unavailable segment from other nodes 37, such as a set of other nodes 37-1-37-K that store segments in the same storage cluster 35. Using system communication resources 14 or other communication channels, a set of external retrieval requests 1-K for this set of segments 1-K can be sent to the set of other nodes 37-1-37-K, and the set of segments can be received in response. This set of K segments can be processed, for example, where a decoding function is applied based on the redundancy storage coding scheme utilized to generate the set of segments in the segment group and/or parity data of this set of K segments is otherwise utilized to regenerate the unavailable segment. The necessary records can then be extracted from the unavailable segment, for example, via the record extraction module 2438, and can be sent as data blocks to another node 37 for processing in conjunction with other records extracted from available segments retrieved by the node 37 from its own memory drives 2425.

Note that the embodiments of node 37 discussed herein can be configured to execute multiple queries concurrently by communicating with nodes 37 in the same or different tree configuration of corresponding query execution plans and/or by performing query operations upon data blocks and/or read records for different queries. In particular, incoming data blocks can be received from other nodes for multiple different queries in any interleaving order, and a plurality of operator executions upon incoming data blocks for multiple different queries can be performed in any order, where output data blocks are generated and sent to the same or different next node for multiple different queries in any interleaving order. IO level nodes can access records for the same or different queries any interleaving order. Thus, at a given point in time, a node 37 can have already begun its execution of at least two queries, where the node 37 has also not yet completed its execution of the at least two queries.

A query execution plan 2405 can guarantee query correctness based on assignment data sent to or otherwise communicated to all nodes at the IO level ensuring that the set of required records in query domain data of a query, such as one or more tables required to be accessed by a query, are accessed exactly one time: if a particular record is accessed multiple times in the same query and/or is not accessed, the query resultant cannot be guaranteed to be correct. Assignment data indicating segment read and/or record read assignments to each of the set of nodes 37 at the IO level can be generated, for example, based on being mutually agreed upon by all nodes 37 at the IO level via a consensus protocol executed between all nodes at the IO level and/or distinct groups of nodes 37 such as individual storage clusters 35. The assignment data can be generated such that every record in the database system and/or in query domain of a particular query is assigned to be read by exactly one node 37. Note that the assignment data may indicate that a node 37 is assigned to read some segments directly from memory as illustrated in FIG. 24C and is assigned to recover some segments via retrieval of segments in the same segment group from other nodes 37 and via applying the decoding function of the redundancy storage coding scheme as illustrated in FIG. 24D.

Assuming all nodes 37 read all required records and send their required records to exactly one next node 37 as designated in the query execution plan 2405 for the given query, the use of exactly one instance of each record can be guaranteed. Assuming all inner level nodes 37 process all the required records received from the corresponding set of nodes 37 in the IO level 2416, via applying one or more query operators assigned to the node in accordance with their query operator execution flow 2433, correctness of their respective partial resultants can be guaranteed. This correctness can further require that nodes 37 at the same level intercommunicate by exchanging records in accordance with JOIN operations as necessary, as records received by other nodes may be required to achieve the appropriate result of a JOIN operation. Finally, assuming the root level node receives all correctly generated partial resultants as data blocks from its respective set of nodes at the penultimate, highest inner level 2414 as designated in the query execution plan 2405, and further assuming the root level node appropriately generates its own final resultant, the correctness of the final resultant can be guaranteed.

In some embodiments, each node 37 in the query execution plan can monitor whether it has received all necessary data blocks to fulfill its necessary role in completely generating its own resultant to be sent to the next node 37 in the query execution plan. A node 37 can determine receipt of a complete set of data blocks that was sent from a particular node 37 at an immediately lower level, for example, based on being numbered and/or have an indicated ordering in transmission from the particular node 37 at the immediately lower level, and/or based on a final data block of the set of data blocks being tagged in transmission from the particular node 37 at the immediately lower level to indicate it is a final data block being sent. A node 37 can determine the required set of lower level nodes from which it is to receive data blocks based on its knowledge of the query execution plan 2405 of the query. A node 37 can thus conclude when a complete set of data blocks has been received each designated lower level node in the designated set as indicated by the query execution plan 2405. This node 37 can therefore determine itself that all required data blocks have been processed into data blocks sent by this node 37 to the next node 37 and/or as a final resultant if this node 37 is the root node. This can be indicated via tagging of its own last data block, corresponding to the final portion of the resultant generated by the node, where it is guaranteed that all appropriate data was received and processed into the set of data blocks sent by this node 37 in accordance with applying its own query operator execution flow 2433.

In some embodiments, if any node 37 determines it did not receive all of its required data blocks, the node 37 itself cannot fulfill generation of its own set of required data blocks. For example, the node 37 will not transmit a final data block tagged as the “last” data block in the set of outputted data blocks to the next node 37, and the next node 37 will thus conclude there was an error and will not generate a full set of data blocks itself. The root node, and/or these intermediate nodes that never received all their data and/or never fulfilled their generation of all required data blocks, can independently determine the query was unsuccessful. In some cases, the root node, upon determining the query was unsuccessful, can initiate re-execution of the query by re-establishing the same or different query execution plan 2405 in a downward fashion as described previously, where the nodes 37 in this re-established query execution plan 2405 execute the query accordingly as though it were a new query. For example, in the case of a node failure that caused the previous query to fail, the new query execution plan 2405 can be generated to include only available nodes where the node that failed is not included in the new query execution plan 2405.

Some or all features and/or functionality of FIG. 24D can be performed via a corresponding node 37 in conjunction with system metadata applied across a plurality of nodes 37 that includes the given node, for example, where the given node 37 participates in some or all features and/or functionality of FIG. 24D based on receiving and storing the system metadata in local memory of given node 37 as configuration data and/or based on further accessing and/or executing this configuration data to recover segments via external retrieval requests and performing a rebuilding process upon corresponding segments as part of its database functionality accordingly. Performance of some or all features and/or functionality of FIG. 24D can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24E illustrates an embodiment of an inner level 2414 that includes at least one shuffle node set 2485 of the plurality of nodes assigned to the corresponding inner level. A shuffle node set 2485 can include some or all of a plurality of nodes assigned to the corresponding inner level, where all nodes in the shuffle node set 2485 are assigned to the same inner level. In some cases, a shuffle node set 2485 can include nodes assigned to different levels 2410 of a query execution plan. A shuffle node set 2485 at a given time can include some nodes that are assigned to the given level, but are not participating in a query at that given time, as denoted with dashed outlines and as discussed in conjunction with FIG. 24A. For example, while a given one or more queries are being executed by nodes in the database system 10, a shuffle node set 2485 can be static, regardless of whether all of its members are participating in a given query at that time. In other cases, shuffle node set 2485 only includes nodes assigned to participate in a corresponding query, where different queries that are concurrently executing and/or executing in distinct time periods have different shuffle node sets 2485 based on which nodes are assigned to participate in the corresponding query execution plan. While FIG. 24E depicts multiple shuffle node sets 2485 of an inner level 2414, in some cases, an inner level can include exactly one shuffle node set, for example, that includes all possible nodes of the corresponding inner level 2414 and/or all participating nodes of the of the corresponding inner level 2414 in a given query execution plan.

While FIG. 24E depicts that different shuffle node sets 2485 can have overlapping nodes 37, in some cases, each shuffle node set 2485 includes a distinct set of nodes, for example, where the shuffle node sets 2485 are mutually exclusive. In some cases, the shuffle node sets 2485 are collectively exhaustive with respect to the corresponding inner level 2414, where all possible nodes of the inner level 2414, or all participating nodes of a given query execution plan at the inner level 2414, are included in at least one shuffle node set 2485 of the inner level 2414. If the query execution plan has multiple inner levels 2414, each inner level can include one or more shuffle node sets 2485. In some cases, a shuffle node set 2485 can include nodes from different inner levels 2414, or from exactly one inner level 2414. In some cases, the root level 2412 and/or the IO level 2416 have nodes included in shuffle node sets 2485. In some cases, the query execution plan 2405 includes and/or indicates assignment of nodes to corresponding shuffle node sets 2485 in addition to assigning nodes to levels 2410, where nodes 37 determine their participation in a given query as participating in one or more levels 2410 and/or as participating in one or more shuffle node sets 2485, for example, via downward propagation of this information from the root node to initiate the query execution plan 2405 as discussed previously.

The shuffle node sets 2485 can be utilized to enable transfer of information between nodes, for example, in accordance with performing particular operations in a given query that cannot be performed in isolation. For example, some queries require that nodes 37 receive data blocks from its children nodes in the query execution plan for processing, and that the nodes 37 additionally receive data blocks from other nodes at the same level 2410. In particular, query operations such as JOIN operations of a SQL query expression may necessitate that some or all additional records that were access in accordance with the query be processed in tandem to guarantee a correct resultant, where a node processing only the records retrieved from memory by its child IO nodes is not sufficient.

In some cases, a given node 37 participating in a given inner level 2414 of a query execution plan may send data blocks to some or all other nodes participating in the given inner level 2414, where these other nodes utilize these data blocks received from the given node to process the query via their query processing module 2435 by applying some or all operators of their query operator execution flow 2433 to the data blocks received from the given node. In some cases, a given node 37 participating in a given inner level 2414 of a query execution plan may receive data blocks to some or all other nodes participating in the given inner level 2414, where the given node utilizes these data blocks received from the other nodes to process the query via their query processing module 2435 by applying some or all operators of their query operator execution flow 2433 to the received data blocks.

This transfer of data blocks can be facilitated via a shuffle network 2480 of a corresponding shuffle node set 2485. Nodes in a shuffle node set 2485 can exchange data blocks in accordance with executing queries, for example, for execution of particular operators such as JOIN operators of their query operator execution flow 2433 by utilizing a corresponding shuffle network 2480. The shuffle network 2480 can correspond to any wired and/or wireless communication network that enables bidirectional communication between any nodes 37 communicating with the shuffle network 2480. In some cases, the nodes in a same shuffle node set 2485 are operable to communicate with some or all other nodes in the same shuffle node set 2485 via a direct communication link of shuffle network 2480, for example, where data blocks can be routed between some or all nodes in a shuffle network 2480 without necessitating any relay nodes 37 for routing the data blocks. In some cases, the nodes in a same shuffle set can broadcast data blocks.

In some cases, some nodes in a same shuffle node set 2485 do not have direct links via shuffle network 2480 and/or cannot send or receive broadcasts via shuffle network 2480 to some or all other nodes 37. For example, at least one pair of nodes in the same shuffle node set cannot communicate directly. In some cases, some pairs of nodes in a same shuffle node set can only communicate by routing their data via at least one relay node 37. For example, two nodes in a same shuffle node set do not have a direct communication link and/or cannot communicate via broadcasting their data blocks. However, if these two nodes in a same shuffle node set can each communicate with a same third node via corresponding direct communication links and/or via broadcast, this third node can serve as a relay node to facilitate communication between the two nodes. Nodes that are “further apart” in the shuffle network 2480 may require multiple relay nodes.

Thus, the shuffle network 2480 can facilitate communication between all nodes 37 in the corresponding shuffle node set 2485 by utilizing some or all nodes 37 in the corresponding shuffle node set 2485 as relay nodes, where the shuffle network 2480 is implemented by utilizing some or all nodes in the nodes shuffle node set 2485 and a corresponding set of direct communication links between pairs of nodes in the shuffle node set 2485 to facilitate data transfer between any pair of nodes in the shuffle node set 2485. Note that these relay nodes facilitating data blocks for execution of a given query within a shuffle node sets 2485 to implement shuffle network 2480 can be nodes participating in the query execution plan of the given query and/or can be nodes that are not participating in the query execution plan of the given query. In some cases, these relay nodes facilitating data blocks for execution of a given query within a shuffle node sets 2485 are strictly nodes participating in the query execution plan of the given query. In some cases, these relay nodes facilitating data blocks for execution of a given query within a shuffle node sets 2485 are strictly nodes that are not participating in the query execution plan of the given query.

Different shuffle node sets 2485 can have different shuffle networks 2480. These different shuffle networks 2480 can be isolated, where nodes only communicate with other nodes in the same shuffle node sets 2485 and/or where shuffle node sets 2485 are mutually exclusive. For example, data block exchange for facilitating query execution can be localized within a particular shuffle node set 2485, where nodes of a particular shuffle node set 2485 only send and receive data from other nodes in the same shuffle node set 2485, and where nodes in different shuffle node sets 2485 do not communicate directly and/or do not exchange data blocks at all. In some cases, where the inner level includes exactly one shuffle network, all nodes 37 in the inner level can and/or must exchange data blocks with all other nodes in the inner level via the shuffle node set via a single corresponding shuffle network 2480.

Alternatively, some or all of the different shuffle networks 2480 can be interconnected, where nodes can and/or must communicate with other nodes in different shuffle node sets 2485 via connectivity between their respective different shuffle networks 2480 to facilitate query execution. As a particular example, in cases where two shuffle node sets 2485 have at least one overlapping node 37, the interconnectivity can be facilitated by the at least one overlapping node 37, for example, where this overlapping node 37 serves as a relay node to relay communications from at least one first node in a first shuffle node sets 2485 to at least one second node in a second first shuffle node set 2485. In some cases, all nodes 37 in a shuffle node set 2485 can communicate with any other node in the same shuffle node set 2485 via a direct link enabled via shuffle network 2480 and/or by otherwise not necessitating any intermediate relay nodes. However, these nodes may still require one or more relay nodes, such as nodes included in multiple shuffle node sets 2485, to communicate with nodes in other shuffle node sets 2485, where communication is facilitated across multiple shuffle node sets 2485 via direct communication links between nodes within each shuffle node set 2485.

Note that these relay nodes facilitating data blocks for execution of a given query across multiple shuffle node sets 2485 can be nodes participating in the query execution plan of the given query and/or can be nodes that are not participating in the query execution plan of the given query. In some cases, these relay nodes facilitating data blocks for execution of a given query across multiple shuffle node sets 2485 are strictly nodes participating in the query execution plan of the given query. In some cases, these relay nodes facilitating data blocks for execution of a given query across multiple shuffle node sets 2485 are strictly nodes that are not participating in the query execution plan of the given query.

In some cases, a node 37 has direct communication links with its child node and/or parent node, where no relay nodes are required to facilitate sending data to parent and/or child nodes of the query execution plan 2405 of FIG. 24A. In other cases, at least one relay node may be required to facilitate communication across levels, such as between a parent node and child node as dictated by the query execution plan. Such relay nodes can be nodes within a and/or different same shuffle network as the parent node and child node, and can be nodes participating in the query execution plan of the given query and/or can be nodes that are not participating in the query execution plan of the given query.

Some or all features and/or functionality of FIG. 24E can be performed via at least one node 37 in conjunction with system metadata applied across a plurality of nodes 37, for example, where at least one node 37 participates in some or all features and/or functionality of FIG. 24E based on receiving and storing the system metadata in local memory of the at least one node 37 as configuration data and/or based on further accessing and/or executing this configuration data to participate in one or more shuffle node sets of FIG. 24E as part of its database functionality accordingly. Performance of some or all features and/or functionality of FIG. 24E can optionally change and/or be updated over time, and/or a set of nodes participating in executing some or all features and/or functionality of FIG. 24E can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24F illustrates an embodiment of a database system that receives some or all query requests from one or more external requesting entities 2912. The external requesting entities 2912 can be implemented as a client device such as a personal computer and/or device, a server system, or other external system that generates and/or transmits query requests 2914. A query resultant 2920 can optionally be transmitted back to the same or different external requesting entity 2912. Some or all query requests processed by database system 10 as described herein can be received from external requesting entities 2912 and/or some or all query resultants generated via query executions described herein can be transmitted to external requesting entities 2912.

For example, a user types or otherwise indicates a query for execution via interaction with a computing device associated with and/or communicating with an external requesting entity. The computing device generates and transmits a corresponding query request 2914 for execution via the database system 10, where the corresponding query resultant 2920 is transmitted back to the computing device, for example, for storage by the computing device and/or for display to the corresponding user via a display device.

As another example, a query is automatically generated for execution via processing resources via a computing device and/or via communication with an external requesting entity implemented via at least one computing device. For example, the query is automatically generated and/or modified from a request generated via user input and/or received from a requesting entity in conjunction with implementing a query generator system, a query optimizer, generative artificial intelligence (AI), and/or other artificial intelligence and/or machine learning techniques. The computing device generates and transmits a corresponding query request 2914 for execution via the database system 10, where the corresponding query resultant 2920 is transmitted back to the computing device, for example, for storage by the computing device, transmission to another system, and/or for display to at least one corresponding user via a display device.

Some or all features and/or functionality of FIG. 24F can be performed via at least one node 37 in conjunction with system metadata applied across a plurality of nodes 37, for example, where at least one node 37 participates in some or all features and/or functionality of FIG. 24F based on receiving and storing the system metadata in local memory of the at least one node 37 as configuration data, and/or based on further accessing and/or executing this configuration data to generate query execution plan data from query requests by implementing some or all of the operator flow generator module 2514 as part of its database functionality accordingly, and/or to participate in one or more query execution plans of a query execution module 2504 as part of its database functionality accordingly. Performance of some or all features and/or functionality of FIG. 24F can optionally change and/or be updated over time, and/or a set of nodes participating in executing some or all features and/or functionality of FIG. 24F can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24G illustrates an embodiment of a query processing system 2502 that generates a query operator execution flow 2517 from a query expression 2509 for execution via a query execution module 2504. The query processing system 2502 can be implemented utilizing, for example, the parallelized query and/or response sub-system 13 and/or the parallelized data store, retrieve, and/or process subsystem 12. The query processing system 2502 can be implemented by utilizing at least one computing device 18, for example, by utilizing at least one central processing module 39 of at least one node 37 utilized to implement the query processing system 2502. The query processing system 2502 can be implemented utilizing any processing module and/or memory of the database system 10, for example, communicating with the database system 10 via system communication resources 14.

As illustrated in FIG. 24G, an operator flow generator module 2514 of the query processing system 2502 can be utilized to generate a query operator execution flow 2517 for the query indicated in a query expression 2509. This can be generated based on a plurality of query operators indicated in the query expression and their respective sequential, parallelized, and/or nested ordering in the query expression, and/or based on optimizing the execution of the plurality of operators of the query expression. This query operator execution flow 2517 can include and/or be utilized to determine the query operator execution flow 2433 assigned to nodes 37 at one or more particular levels of the query execution plan 2405 and/or can include the operator execution flow to be implemented across a plurality of nodes 37, for example, based on a query expression indicated in the query request and/or based on optimizing the execution of the query expression.

In some cases, the operator flow generator module 2514 implements an optimizer to select the query operator execution flow 2517 based on determining the query operator execution flow 2517 is a most efficient and/or otherwise most optimal one of a set of query operator execution flow options and/or that arranges the operators in the query operator execution flow 2517 such that the query operator execution flow 2517 compares favorably to a predetermined efficiency threshold. For example, the operator flow generator module 2514 selects and/or arranges the plurality of operators of the query operator execution flow 2517 to implement the query expression in accordance with performing optimizer functionality, for example, by perform a deterministic function upon the query expression to select and/or arrange the plurality of operators in accordance with the optimizer functionality. This can be based on known and/or estimated processing times of different types of operators. This can be based on known and/or estimated levels of record filtering that will be applied by particular filtering parameters of the query. This can be based on selecting and/or deterministically utilizing a conjunctive normal form and/or a disjunctive normal form to build the query operator execution flow 2517 from the query expression. This can be based on selecting a determining a first possible serial ordering of a plurality of operators to implement the query expression based on determining the first possible serial ordering of the plurality of operators is known to be or expected to be more efficient than at least one second possible serial ordering of the same or different plurality of operators that implements the query expression. This can be based on ordering a first operator before a second operator in the query operator execution flow 2517 based on determining executing the first operator before the second operator results in more efficient execution than executing the second operator before the first operator. For example, the first operator is known to filter the set of records upon which the second operator would be performed to improve the efficiency of performing the second operator due to being executed upon a smaller set of records than if performed before the first operator. This can be based on other optimizer functionality that otherwise selects and/or arranges the plurality of operators of the query operator execution flow 2517 based on other known, estimated, and/or otherwise determined criteria.

A query execution module 2504 of the query processing system 2502 can execute the query expression via execution of the query operator execution flow 2517 to generate a query resultant. For example, the query execution module 2504 can be implemented via a plurality of nodes 37 that execute the query operator execution flow 2517. In particular, the plurality of nodes 37 of a query execution plan 2405 of FIG. 24A can collectively execute the query operator execution flow 2517. In such cases, nodes 37 of the query execution module 2504 can each execute their assigned portion of the query to produce data blocks as discussed previously, starting from IO level nodes propagating their data blocks upwards until the root level node processes incoming data blocks to generate the query resultant, where inner level nodes execute their respective query operator execution flow 2433 upon incoming data blocks to generate their output data blocks. The query execution module 2504 can be utilized to implement the parallelized query and results sub-system 13 and/or the parallelized data store, receive and/or process sub-system 12.

Some or all features and/or functionality of FIG. 24G can be performed via at least one node 37 in conjunction with system metadata applied across a plurality of nodes 37, for example, where at least one node 37 participates in some or all features and/or functionality of FIG. 24G based on receiving and storing the system metadata in local memory of the at least one node 37 as configuration data and/or based on further accessing and/or executing this configuration data to generate query execution plan data from query requests by executing some or all operators of a query operator flow 2517 as part of its database functionality accordingly. Performance of some or all features and/or functionality of FIG. 24G can optionally change and/or be updated over time, and/or a set of nodes participating in executing some or all features and/or functionality of FIG. 24G can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24H presents an example embodiment of a query execution module 2504 that executes query operator execution flow 2517. Some or all features and/or functionality of the query execution module 2504 of FIG. 24H can implement the query execution module 2504 of FIG. 24G and/or any other embodiment of the query execution module 2504 discussed herein. Some or all features and/or functionality of the query execution module 2504 of FIG. 24H can optionally be utilized to implement the query processing module 2435 of node 37 in FIG. 24B and/or to implement some or all nodes 37 at inner levels 2414 of a query execution plan 2405 of FIG. 24A.

The query execution module 2504 can execute the determined query operator execution flow 2517 by performing a plurality of operator executions of operators 2520 of the query operator execution flow 2517 in a corresponding plurality of sequential operator execution steps. Each operator execution step of the plurality of sequential operator execution steps can correspond to execution of a particular operator 2520 of a plurality of operators 2520-1-2520-M of a query operator execution flow 2433.

In some embodiments, a single node 37 executes the query operator execution flow 2517 as illustrated in FIG. 24H as their operator execution flow 2433 of FIG. 24B, where some or all nodes 37 such as some or all inner level nodes 37 utilize the query processing module 2435 as discussed in conjunction with FIG. 24B to generate output data blocks to be sent to other nodes 37 and/or to generate the final resultant by applying the query operator execution flow 2517 to input data blocks received from other nodes and/or retrieved from memory as read and/or recovered records. In such cases, the entire query operator execution flow 2517 determined for the query as a whole can be segregated into multiple query operator execution sub-flows 2433 that are each assigned to the nodes of each of a corresponding set of inner levels 2414 of the query execution plan 2405, where all nodes at the same level execute the same query operator execution flows 2433 upon different received input data blocks. In some cases, the query operator execution flows 2433 applied by each node 37 includes the entire query operator execution flow 2517, for example, when the query execution plan includes exactly one inner level 2414. In other embodiments, the query processing module 2435 is otherwise implemented by at least one processing module the query execution module 2504 to execute a corresponding query, for example, to perform the entire query operator execution flow 2517 of the query as a whole.

A single operator execution by the query execution module 2504, such as via a particular node 37 executing its own query operator execution flows 2433, by executing one of the plurality of operators of the query operator execution flow 2433. As used herein, an operator execution corresponds to executing one operator 2520 of the query operator execution flow 2433 on one or more pending data blocks 2537 in an operator input data set 2522 of the operator 2520. The operator input data set 2522 of a particular operator 2520 includes data blocks that were outputted by execution of one or more other operators 2520 that are immediately below the particular operator in a serial ordering of the plurality of operators of the query operator execution flow 2433. In particular, the pending data blocks 2537 in the operator input data set 2522 were outputted by the one or more other operators 2520 that are immediately below the particular operator via one or more corresponding operator executions of one or more previous operator execution steps in the plurality of sequential operator execution steps. Pending data blocks 2537 of an operator input data set 2522 can be ordered, for example as an ordered queue, based on an ordering in which the pending data blocks 2537 are received by the operator input data set 2522. Alternatively, an operator input data set 2522 is implemented as an unordered set of pending data blocks 2537.

If the particular operator 2520 is executed for a given one of the plurality of sequential operator execution steps, some or all of the pending data blocks 2537 in this particular operator 2520's operator input data set 2522 are processed by the particular operator 2520 via execution of the operator to generate one or more output data blocks. For example, the input data blocks can indicate a plurality of rows, and the operation can be a SELECT operator indicating a simple predicate. The output data blocks can include only proper subset of the plurality of rows that meet the condition specified by the simple predicate.

Once a particular operator 2520 has performed an execution upon a given data block 2537 to generate one or more output data blocks, this data block is removed from the operator's operator input data set 2522. In some cases, an operator selected for execution is automatically executed upon all pending data blocks 2537 in its operator input data set 2522 for the corresponding operator execution step. In this case, an operator input data set 2522 of a particular operator 2520 is therefore empty immediately after the particular operator 2520 is executed. The data blocks outputted by the executed data block are appended to an operator input data set 2522 of an immediately next operator 2520 in the serial ordering of the plurality of operators of the query operator execution flow 2433, where this immediately next operator 2520 will be executed upon its data blocks once selected for execution in a subsequent one of the plurality of sequential operator execution steps.

Operator 2520.1 can correspond to a bottom-most operator 2520 in the serial ordering of the plurality of operators 2520.1-2520.M. As depicted in FIG. 24G, operator 2520.1 has an operator input data set 2522.1 that is populated by data blocks received from another node as discussed in conjunction with FIG. 24B, such as a node at the IO level of the query execution plan 2405. Alternatively these input data blocks can be read by the same node 37 from storage, such as one or more memory devices that store segments that include the rows required for execution of the query. In some cases, the input data blocks are received as a stream over time, where the operator input data set 2522.1 may only include a proper subset of the full set of input data blocks required for execution of the query at a particular time due to not all of the input data blocks having been read and/or received, and/or due to some data blocks having already been processed via execution of operator 2520.1. In other cases, these input data blocks are read and/or retrieved by performing a read operator or other retrieval operation indicated by operator 2520.

Note that in the plurality of sequential operator execution steps utilized to execute a particular query, some or all operators will be executed multiple times, in multiple corresponding ones of the plurality of sequential operator execution steps. In particular, each of the multiple times a particular operator 2520 is executed, this operator is executed on set of pending data blocks 2537 that are currently in their operator input data set 2522, where different ones of the multiple executions correspond to execution of the particular operator upon different sets of data blocks that are currently in their operator queue at corresponding different times.

As a result of this mechanism of processing data blocks via operator executions performed over time, at a given time during the query's execution by the node 37, at least one of the plurality of operators 2520 has an operator input data set 2522 that includes at least one data block 2537. At this given time, one more other ones of the plurality of operators 2520 can have input data sets 2522 that are empty. For example, a given operator's operator input data set 2522 can be empty as a result of one or more immediately prior operators 2520 in the serial ordering not having been executed yet, and/or as a result of the one or more immediately prior operators 2520 not having been executed since a most recent execution of the given operator.

Some types of operators 2520, such as JOIN operators or aggregating operators such as SUM, AVERAGE, MAXIMIUIM, or MINIMUM operators, require knowledge of the full set of rows that will be received as output from previous operators to correctly generate their output. As used herein, such operators 2520 that must be performed on a particular number of data blocks, such as all data blocks that will be outputted by one or more immediately prior operators in the serial ordering of operators in the query operator execution flow 2517 to execute the query, are denoted as “blocking operators.” Blocking operators are only executed in one of the plurality of sequential execution steps if their corresponding operator queue includes all of the required data blocks to be executed. For example, some or all blocking operators can be executed only if all prior operators in the serial ordering of the plurality of operators in the query operator execution flow 2433 have had all of their necessary executions completed for execution of the query, where none of these prior operators will be further executed in accordance with executing the query.

Some operator output generated via execution of an operator 2520, alternatively or in addition to being added to the input data set 2522 of a next sequential operator in the sequential ordering of the plurality of operators of the query operator execution flow 2433, can be sent to one or more other nodes 37 in a same shuffle node set as input data blocks to be added to the input data set 2522 of one or more of their respective operators 2520. In particular, the output generated via a node's execution of an operator 2520 that is serially before the last operator 2520.M of the node's query operator execution flow 2433 can be sent to one or more other nodes 37 in a same shuffle node set as input data blocks to be added to the input data set 2522 of a respective operators 2520 that is serially after the last operator 2520.1 of the query operator execution flow 2433 of the one or more other nodes 37.

As a particular example, the node 37 and the one or more other nodes 37 in a shuffle node set all execute queries in accordance with the same, common query operator execution flow 2433, for example, based on being assigned to a same inner level 2414 of the query execution plan 2405. The output generated via a node's execution of a particular operator 2520.i this common query operator execution flow 2433 can be sent to the one or more other nodes 37 in a same shuffle node set as input data blocks to be added to the input data set 2522 the next operator 2520.i+1, with respect to the serialized ordering of the query of this common query operator execution flow 2433 of the one or more other nodes 37. For example, the output generated via a node's execution of a particular operator 2520.i is added input data set 2522 the next operator 2520.i+1 of the same node's query operator execution flow 2433 based on being serially next in the sequential ordering and/or is alternatively or additionally added to the input data set 2522 of the next operator 2520.i+1 of the common query operator execution flow 2433 of the one or more other nodes in a same shuffle node set based on being serially next in the sequential ordering.

In some cases, in addition to a particular node sending this output generated via a node's execution of a particular operator 2520.i to one or more other nodes to be input data set 2522 the next operator 2520.i+1 in the common query operator execution flow 2433 of the one or more other nodes 37, the particular node also receives output generated via some or all of these one or more other nodes' execution of this particular operator 2520.i in their own query operator execution flow 2433 upon their own corresponding input data set 2522 for this particular operator. The particular node adds this received output of execution of operator 2520.i by the one or more other nodes to the be input data set 2522 of its own next operator 2520.i+1.

This mechanism of sharing data can be utilized to implement operators that require knowledge of all records of a particular table and/or of a particular set of records that may go beyond the input records retrieved by children or other descendants of the corresponding node. For example, JOIN operators can be implemented in this fashion, where the operator 2520.i+1 corresponds to and/or is utilized to implement JOIN operator and/or a custom-join operator of the query operator execution flow 2517, and where the operator 2520.i+1 thus utilizes input received from many different nodes in the shuffle node set in accordance with their performing of all of the operators serially before operator 2520.i+1 to generate the input to operator 2520.i+1.

Some or all features and/or functionality of FIG. 24H can be performed via at least one node 37 in conjunction with system metadata applied across a plurality of nodes 37, for example, where at least one node 37 participates in some or all features and/or functionality of FIG. 24H based on receiving and storing the system metadata in local memory of the at least one node 37 as configuration data and/or based on further accessing and/or executing this configuration data execute some or all operators of a query operator flow 2517 as part of its database functionality accordingly. Performance of some or all features and/or functionality of FIG. 24H can optionally change and/or be updated over time, and/or a set of nodes participating in executing some or all features and/or functionality of FIG. 24H can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24I illustrates an example embodiment of multiple nodes 37 that execute a query operator execution flow 2433. For example, these nodes 37 are at a same level 2410 of a query execution plan 2405, and receive and perform an identical query operator execution flow 2433 in conjunction with decentralized execution of a corresponding query. Each node 37 can determine this query operator execution flow 2433 based on receiving the query execution plan data for the corresponding query that indicates the query operator execution flow 2433 to be performed by these nodes 37 in accordance with their participation at a corresponding inner level 2414 of the corresponding query execution plan 2405 as discussed in conjunction with FIG. 24G. This query operator execution flow 2433 utilized by the multiple nodes can be the full query operator execution flow 2517 generated by the operator flow generator module 2514 of FIG. 24G. This query operator execution flow 2433 can alternatively include a sequential proper subset of operators from the query operator execution flow 2517 generated by the operator flow generator module 2514 of FIG. 24G, where one or more other sequential proper subsets of the query operator execution flow 2517 are performed by nodes at different levels of the query execution plan.

Each node 37 can utilize a corresponding query processing module 2435 to perform a plurality of operator executions for operators of the query operator execution flow 2433 as discussed in conjunction with FIG. 24H. This can include performing an operator execution upon input data sets 2522 of a corresponding operator 2520, where the output of the operator execution is added to an input data set 2522 of a sequentially next operator 2520 in the operator execution flow, as discussed in conjunction with FIG. 24H, where the operators 2520 of the query operator execution flow 2433 are implemented as operators 2520 of FIG. 24H. Some or operators 2520 can correspond to blocking operators that must have all required input data blocks generated via one or more previous operators before execution. Each query processing module can receive, store in local memory, and/or otherwise access and/or determine necessary operator instruction data for operators 2520 indicating how to execute the corresponding operators 2520.

Some or all features and/or functionality of FIG. 24I can be performed via at least one node 37 in conjunction with system metadata applied across a plurality of nodes 37, for example, where at least one node 37 participates in some or all features and/or functionality of FIG. 24I based on receiving and storing the system metadata in local memory of the at least one node 37 as configuration data and/or based on further accessing and/or executing this configuration data to execute some or all operators of a query operator flow 2517 in parallel with other nodes, send data blocks to a parent node, and/or process data blocks from child nodes as part of its database functionality accordingly. Performance of some or all features and/or functionality of FIG. 24I can optionally change and/or be updated over time, and/or a set of nodes participating in executing some or all features and/or functionality of FIG. 24I can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24J illustrates an embodiment of a query execution module 2504 that executes each of a plurality of operators of a given operator execution flow 2517 via a corresponding one of a plurality of operator execution modules 3215. The operator execution modules 3215 of FIG. 24J can be implemented to execute any operators 2520 being executed by a query execution module 2504 for a given query as described herein.

In some embodiments, a given node 37 can optionally execute one or more operators, for example, when participating in a corresponding query execution plan 2405 for a given query, by implementing some or all features and/or functionality of the operator execution module 3215, for example, by implementing its operator processing module 2435 to execute one or more operator execution modules 3215 for one or more operators 2520 being processed by the given node 37. For example, a plurality of nodes of a query execution plan 2405 for a given query execute their operators based on implementing corresponding query processing modules 2435 accordingly.

FIG. 24K illustrates an embodiment of database storage 2450 operable to store a plurality of database tables 2712, such as relational database tables or other database tables as described previously herein. Database storage 2450 can be implemented via the parallelized data store, retrieve, and/or process sub-system 12, via memory drives 2425 of one or more nodes 37 implementing the database storage 2450, and/or via other memory and/or storage resources of database system 10. The database tables 2712 can be stored as segments as discussed in conjunction with FIGS. 15-23 and/or FIGS. 24B-24D. A database table 2712 can be implemented as one or more datasets and/or a portion of a given dataset, such as the dataset of FIG. 15.

A given database table 2712 can be stored based on being received for storage, for example, via the parallelized ingress sub-system 24 and/or via other data ingress. Alternatively or in addition, a given database table 2712 can be generated and/or modified by the database system 10 itself based on being generated as output of a query executed by query execution module 2504, such as a Create Table As Select (CTAS) query or Insert query.

A given database table 2712 can be in accordance with a schema 2409 defining columns of the database table, where records 2422 correspond to rows having values 2708 for some or all of these columns. Different database tables can have different numbers of columns and/or different datatypes for values stored in different columns. For example, the set of columns 2707.1_{A}-2707.C_{A} of schema 2709.A for database table 2712.A can have a different number of columns than and/or can have different datatypes for some or all columns of the set of columns 2707.1_{B}-2707.C_{B} of schema 2709.B for database table 2712.B. The schema 2409 for a given n database table 2712 can denote same or different datatypes for some or all of its set of columns. For example, some columns are variable-length and other columns are fixed-length. As another example, some columns are integers, other columns are binary values, other columns are Strings, and/or other columns are char types.

Row reads performed during query execution, such as row reads performed at the IO level of a query execution plan 2405, can be performed by reading values 2708 for one or more specified columns 2707 of the given query for some or all rows of one or more specified database tables, as denoted by the query expression defining the query to be performed. Filtering, join operations, and/or values included in the query resultant can be further dictated by operations to be performed upon the read values 2708 of these one or more specified columns 2707.

FIG. 24L illustrates an embodiment of a dataset 2502 having one or more columns 3023 implemented as array fields 2712. Some or all features and/or functionality of the dataset 2502 of FIG. 24L can be utilized to implement one or more of the database tables 2712 of FIG. 24K and/or any embodiment of any database table and/or dataset received, stored, and processed via the database system 10 as described herein.

Columns 3023 implemented as array fields 2712 can include array structures 2718 as values 3024 for some or all rows. A given array structure 2718 can have a set of elements 2709.1-2709.M. The value of M can be fixed for a given array field 2712, or can be different for different array structures 2718 of a given array field 2712. In embodiments where the number of elements is fixed, different array fields 2712 can have different fixed numbers of array elements 2709, for example, where a first array field 2712.A has array structures having M elements, and where a second array field 2712.B has array structures having N elements.

Note that a given array structure 2718 of a given array field can optionally have zero elements, where such array structures are considered as empty arrays satisfying the empty array condition. An empty array structure 2718 is distinct from a null value 3852, as it is a defined structure as an array 2718, despite not being populated with any values. For example, consider an example where an array field for rows corresponding to people is implemented to note a list of spouse names for all marriages of each person. An empty array for this array field for a first given row denotes a first corresponding person was never married, while a null value for this array field for a second given row denotes that it is unknown as to whether the second corresponding person was ever married, or who they were married to.

Array elements 2709 of a given array structure can have the same or different data type. In some embodiments, data types of array elements 2709 can be fixed for a given array field (e.g., all array elements 2709 of all array structures 2718 of array field 2712.A are string values, and all array elements 2709 of all array structures 2718 of array field 2712.B are integer values). In other embodiments, data types of array elements 2709 can be different for a given array field and/or a given array structure.

Some array structures 2718 that are non-empty can have one or more array elements having the null value 3852, where the corresponding value 3024 thus meets the null-inclusive array condition. This is distinct from the null value condition 3842, as the value 3024 itself is not null, but is instead an array structure 2718 having some or all of its array elements 2709 with values of null. Continuing example where an array field for rows corresponding to people is implemented to note a list of spouse names for all marriages of each person, a null value for this array field for the second given row denotes that it is unknown as to whether the second corresponding person was ever married or who they were married to, while a null value within an array structure for a third given row denotes that the name of the spouse for a corresponding one of a set of marriages of the person is unknown.

Some array structures 2718 that are non-empty can have all non-null values for its array elements 2709, where all corresponding array elements 2709 were populated and/or defined. Some array structures 2718 that are non-empty can have values for some of its array elements 2709 that are null, and values for others of its array elements 2709 that are non-null values.

Some array structures 2718 that are non-empty can have values for all of its array elements 2709 that are null. This is still distinct from the case where the value 3024 denotes a value of null with no array structure 2718. Continuing example where an array field for rows corresponding to people is implemented to note a list of spouse names for all marriages of each person, a null value for this array field for the second given row denotes that it is unknown as to whether the second corresponding person was ever married, how many times they were married or who they were married to, while the array structure for the third given row denotes a set of three null values and non-null values, denoting that the person was married three times, but the names of the spouses for all three marriages are unknown.

FIGS. 24M-24N illustrates an example embodiment of a query execution module 2504 of a database system 10 that executes queries via generation, storage, and/or communication of a plurality of column data streams 2968 corresponding to a plurality of columns. Some or all features and/or functionality of query execution module 2504 of FIGS. 24M-24N can implement any embodiment of query execution module 2504 described herein and/or any performance of query execution described herein. Some or all features and/or functionality of column data streams 2968 of FIGS. 24M-24N can implement any embodiment of data blocks 2537 and/or other communication of data between operators 2520 of a query operator execution flow 2517 when executed by a query execution module 2504, for example, via a corresponding plurality of operator execution modules 3215.

As illustrated in FIG. 24M, in some embodiments, data values of each given column 2915 are included in data blocks of their own respective column data stream 2968. Each column data stream 2968 can correspond to one given column 2915, where each given column 2915 is included in one data stream included in and/or referenced by output data blocks generated via execution of one or more operator execution module 3215, for example, to be utilized as input by one or more other operator execution modules 3215. Different columns can be designated for inclusion in different data streams. For example, different column streams are written do different portions of memory, such as different sets of memory fragments of query execution memory resources.

As illustrated in FIG. 24N, each data block 2537 of a given column data stream 2968 can include values 2918 for the respective column for one or more corresponding rows 2916. In the example of FIG. 24N, each data block includes values for V corresponding rows, where different data blocks in the column data stream include different respective sets of V rows, for example, that are each a subset of a total set of rows to be processed. In other embodiments, different data blocks can have different numbers of rows. The subsets of rows across a plurality of data blocks 2537 of a given column data stream 2968 can be mutually exclusive and collectively exhaustive with respect to the full output set of rows, for example, emitted by a corresponding operator execution module 3215 as output.

Values 2918 of a given row utilized in query execution are thus dispersed across different A given column 2915 can be implemented as a column 2707 having corresponding values 2918 implemented as values 2708 read from database table 2712 read from database storage 2450, for example, via execution of corresponding IO operators. Alternatively or in addition, a given column 2915 can be implemented as a column 2707 having new and/or modified values generated during query execution, for example, via execution of an extend expression and/or other operation. Alternatively or in addition, a given column 2915 can be implemented as a new column generated during query execution having new values generated accordingly, for example, via execution of an extend expression and/or other operation. The set of column data streams 2968 generated and/or emitted between operators in query execution can correspond to some or all columns of one or more tables 2712 and/or new columns of an existing table and/or of a new table generated during query execution.

Additional column streams emitted by the given operator execution module can have their respective values for the same full set of output rows across for other respective columns. For example, the values across all column streams are in accordance with a consistent ordering, where a first row's values 2918.1.1-2918.1.C for columns 2915.1-2915.C are included first in every respective column data stream, where a second row's values 2918.2.1-2918.2.C for columns 2915.1-2915.C are included second in every respective column data stream, and so on. In other embodiments, rows are optionally ordered differently in different column streams. Rows can be identified across column streams based on consistent ordering of values, based on being mapped to and/or indicating row identifiers, or other means.

As a particular example, for every fixed-length column, a huge block can be allocated to initialize a fixed length column stream, which can be implemented via mutable memory as a mutable memory column stream, and/or for every variable-length column, another huge block can be allocated to initialize a binary stream, which can be implemented via mutable memory as a mutable memory binary stream. A given column data stream 2968 can be continuously appended with fixed length values to data runs of contiguous memory and/or may grow the underlying huge page memory region to acquire more contiguous runs and/or fragments of memory.

In other embodiments, rather than emitting data blocks with values 2918 for different columns in different column streams, values 2918 for a set of multiple column can be emitted in a same multi-column data stream.

FIG. 24O illustrates an example of operator execution modules 3215.C that each write their output memory blocks to one or more memory fragments 2622 of query execution memory resources 3045 and/or that each read/process input data blocks based on accessing the one or more memory fragments 2622 Some or all features and/or functionality of the operator execution modules 3215 of FIG. 24O can implement the operator execution modules of FIG. 24J and/or can implement any query execution described herein. The data blocks 2537 can implement the data blocks of column streams of FIGS. 24M and/or 24N, and/or any operator 2520's input data blocks and/or output data blocks described herein.

A given operator execution module 3215.A for an operator that is a child operator of the operator executed by operator execution module 3215.B can emit its output data blocks for processing by operator execution module 3215.B based on writing each of a stream of data blocks 2537.1-2537.K of data stream 2917.A to contiguous or non-contiguous memory fragments 2622 at one or more corresponding memory locations 2951 of query execution memory resources 3045.

Operator execution module 3215.A can generate these data blocks 2537.1-2537.K of data stream 2917.A in conjunction with execution of the respective operator on incoming data. This incoming data can correspond to one or more other streams of data blocks 2537 of another data stream 2917 accessed in memory resources 3045 based on being written by one or more child operator execution modules corresponding to child operators of the operator executed by operator execution module 3215.A. Alternatively or in addition, the incoming data is read from database storage 2450 and/or is read from one or more segments stored on memory drives, for example, based on the operator executed by operator execution module 3215.A being implemented as an IO operator.

The parent operator execution module 3215.B of operator execution module 3215.A can generate its own output data blocks 2537.1-2537.J of data stream 2917.B based on execution of the respective operator upon data blocks 2537.1-2537.K of data stream 2917.A. Executing the operator can include reading the values from and/or performing operations toy filter, aggregate, manipulate, generate new column values from, and/or otherwise determine values that are written to data blocks 2537.1-2537.J.

In other embodiments, the operator execution module 3215.B does not read the values from these data blocks, and instead forwards these data blocks, for example, where data blocks 2537.1-2537.J include memory reference data for the data blocks 2537.1-2537.K to enable one or more parent operator modules, such as operator execution module 3215.C, to access and read the values from forwarded streams.

In the case where operator execution module 3215.A has multiple parents, the data blocks 2537.1-2537.K of data stream 2917.A can be read, forwarded, and/or otherwise processed by each parent operator execution module 3215 independently in a same or similar fashion. Alternatively or in addition, in the case where operator execution module 3215.B has multiple children, each child's emitted set of data blocks 2537 of a respective data stream 2917 can be read, forwarded, and/or otherwise processed by operator execution module 3215.B in a same or similar fashion.

The parent operator execution module 3215.C of operator execution module 3215.B can similarly read, forward, and/or otherwise process data blocks 2537.1-2537.J of data stream 2917.B based on execution of the respective operator to render generation and emitting of its own data blocks in a similar fashion. Executing the operator can include reading the values from and/or performing operations to filter, aggregate, manipulate, generate new column values from, and/or otherwise process data blocks 2537.1-2537.J to determine values that are written to its own output data. For example, the operator execution module 3215.C reads data blocks 2537.1-2537.K of data stream 2917.A and/or the operator execution module 3215.B writes data blocks 2537.1-2537.J of data stream 2917.B. As another example, the operator execution module 3215.C reads data blocks 2537.1-2537.K of data stream 2917.A, or data blocks of another descendent, based on having been forwarded, where corresponding memory reference information denoting the location of these data blocks is read and processed from the received data blocks data blocks 2537.1-2537.J of data stream 2917.B enable accessing the values from data blocks 2537.1-2537.K of data stream 2917.A. As another example, the operator execution module 3215.B does not read the values from these data blocks, and instead forwards these data blocks, for example, where data blocks 2537.1-2537.J include memory reference data for the data blocks 2537.1-2537.J to enable one or more parent operator modules to read these forwarded streams.

This pattern of reading and/or processing input data blocks from one or more children for use in generating output data blocks for one or more parents can continue until ultimately a final operator, such as an operator executed by a root level node, generates a query resultant, which can itself be stored as data blocks in this fashion in query execution memory resources and/or can be transmitted to a requesting entity for display and/or storage.

For example, rather than accessing this large data for some or all potential records prior to filtering in a query execution, for example, via IO level 2416 of a corresponding query execution plan 2405 as illustrated in FIGS. 24A and 24C, and/or rather than passing this large data to other nodes 37 for processing, for example, from IO level nodes 37 to inner level nodes 37 and/or between any nodes 37 as illustrated in FIGS. 24A, 24B, and 24C, this large data is not accessed until a final stage of a query. As a particular example, this large data of the projected field is simply joined at the end of the query for the corresponding outputted rows that meet query predicates of the query. This ensures that, rather than accessing and/or passing the large data of these fields for some or all possible records that may be projected in the resultant, only the large data of these fields for final, filtered set of records that meet the query predicates are accessed and projected.

FIG. 24P illustrates an embodiment of a database system 10 that implements a segment generator 2507 to generate segments 2424. Some or all features and/or functionality of the database system 10 of FIG. 24P can implement any embodiment of the database system 10 described herein. Some or all features and/or functionality of segments 2424 of FIG. 24P can implement any embodiment of segment 2424 described herein.

A plurality of records 2422.1-2422.Z of one or more datasets 2505 to be converted into segments can be processed to generate a corresponding plurality of segments 2424.1-2424.Y. Each segment can include a plurality of column slabs 2610.1-2610.C corresponding to some or all of the C columns of the set of records.

In some embodiments, the dataset 2505 can correspond to a given database table 2712. In some embodiments, the dataset 2505 can correspond to only portion of a given database table 2712 (e.g., the most recently received set of records of a stream of records received for the table over time), where other datasets 2505 are later processed to generate new segments as more records are received over time. In some embodiments, the dataset 2505 can correspond to multiple database tables. The dataset 2505 optionally includes non-relational records and/or any records/files/data that is received from/generated by a given data source multiple different data sources.

Each record 2422 of the incoming dataset 2505 can be assigned to be included in exactly one segment 2424. In this example, segment 2424.1 includes at least records 2422.3 and 2422.7, while segment 2424 includes at least records 2422.1 and 2422.9. All of the Z records can be guaranteed to be included in exactly one segment by segment generator 2507. Rows are optionally grouped into segments based on a cluster-key based grouping or other grouping by same or similar column values of one or more columns. Alternatively, rows are optionally grouped randomly, in accordance with a round robin fashion, or by any other means.

A given row 2422 can thus have all of its column values 2708.1-2708.C included in exactly one given segment 2424, where these column values are dispersed across different column slabs 2610 based on which columns each column value corresponds. This division of column values into different column slabs can implement the columnar-format of segments described herein. The generation of column slabs can optionally include further processing of each set of column values assigned to each column slab. For example, some or all column slabs are optionally compressed and stored as compressed column slabs.

The database storage 2450 can thus store one or more datasets as segments 2424, for example, where these segments 2424 are accessed during query execution to identify/read values of rows of interest as specified in query predicates, where these identified rows/the respective values are further filtered/processed/etc., for example, via operators 2520 of a corresponding query operator execution flow 2517, or otherwise accordance with the query to render generation of the query resultant.

FIG. 24Q illustrates an example embodiment of a segment generator 2507 of database system 10. Some or all features and/or functionality of the database system 10 of FIG. 24Q can implement any embodiment of the database system 10 described herein. Some or all features and/or functionality of the segment generator 2507 of FIG. 24Q can implement the segment generator 2507 of FIG. 24P and/or any embodiment of the segment generator 2507 described herein.

The segment generator 2507 can implement a cluster key-based grouping module 2620 to group records of a dataset 2505 by a predetermined cluster key 2607, which can correspond to one or more columns. The cluster key can be received, accessed in memory, configured via user input, automatically selected based on an optimization, or otherwise determined. This grouping by cluster key can render generation of a plurality of record groups 2625.1-2625.X.

The segment generator 2507 can implement a columnar rotation module 2630 to generate a plurality of column formatted record data (e.g., column slabs 2610 to be included in respective segments 2424). Each record group 2625 can have a corresponding set of J column-formatted record data 2565.1-2565.J generated, for example, corresponding to J segments in a given segment group.

A metadata generator module 2640 can further generate parity data, index data, statistical data, and/or other metadata to be included in segments in conjunction with the column-formatted record data. A set of X segment groups corresponding to the X record groups can be generated and stored in database storage 2450. For example, each segment group includes J segments, where parity data of a proper subset of segments in the segment group can be utilized to rebuild column-formatted record data of other segments in the same segment group as discussed previously.

In some embodiments, the segment generator 2507 implements some or all features and/or functionality of the segment generator disclosed by: U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility Patent Application for all purposes; U.S. Utility application Ser. No. 16/985,957 entitled “PARALLELIZED SEGMENT GENERATION VIA KEY-BASED SUBDIVISION IN DATABASE SYSTEMS”, filed Aug. 5, 2020, which is hereby incorporated herein by reference in its entirety and made part of the present U.S. Utility Patent Application for all purposes; and/or U.S. Utility application Ser. No. 16/985,930, entitled “RECORD DEDUPLICATION IN DATABASE SYSTEMS”, filed Aug. 5, 2020, issued as U.S. Pat. No. 11,321,288 on May 3, 2022, which is hereby incorporated herein by reference in its entirety and made part of the present U.S. Utility Patent Application for all purposes. For example, the database system 10 implements some or all features and/or functionality of record processing and storage system of U.S. Utility application Ser. No. 16/985,723, U.S. Utility application Ser. No. 16/985,957, and/or U.S. Utility application Ser. No. 16/985,930.

FIG. 24R illustrates an embodiment of a query processing system 2510 that implements an IO pipeline generator module 2834 to generate a plurality of IO pipelines 2835.1-2835.R for a corresponding plurality of segments 2424.1-2424.R, where these IO pipelines 2835.1-2835.R are each executed by an IO operator execution module 2840 to facilitate generation of a filtered record set by accessing the corresponding segment. Some or all features and/or functionality of the query processing system 2510 of FIG. 24R can implement any embodiment of query processing system 2510, any embodiment of query execution module 2504, and/or any embodiment of executing a query described herein.

Each IO pipeline 2835 can be generated based on corresponding segment configuration data 2833 for the corresponding segment 2424, such as secondary indexing data for the segment, statistical data/cardinality data for the segment, compression schemes applied to the column slabs of the segment, or other information denoting how the segment is configured. For example, different segments 2424 have different IO pipelines 2835 generated for a given query based on having different secondary indexing schemes, different statistical data/cardinality data for its values, different compression schemes applied for some of all of the columns of its records, or other differences.

An IO operator execution module 2840 can execute each respective IO pipeline 2835. For example, the IO operator execution module 2840 is implemented by nodes 37 at the IO level of a corresponding query execution plan 2405, where a node 37 storing a given segment 2424 is responsible for accessing the segment as described previously, and thus executes the IO pipeline for the given segment.

This execution of IO pipelines 2835 by IO operator execution module 2840 correspond to executing IO operators 2421 of a query operator execution flow 2517. The output of IO operators 2421 can correspond to output of IO operators 2421 and/or output of IO level. This output can correspond to data blocks that are further processed via additional operators 2520, for example, by nodes at inner levels and/or the root level of a corresponding query execution plan.

Each IO pipeline 2835 can be generated based on pushing some or all filtering down to the IO level, where query predicates are applied via the IO pipeline based on accessing index structures, sourcing values, filtering rows, etc. Each IO pipeline 2835 can be generated to render semantically equivalent application of query predicates, despite differences in how the IO pipeline is arranged/executed for the given segment. For example, an index structure of a first segment is used to identify a set of rows meeting a condition for a corresponding column in a first corresponding IO pipeline while a second segment has its row values sourced and compared to a value to identify which rows meet the condition, for example, based on the first segment having the corresponding column indexed and the second segment not having the corresponding column indexed. As another example, the IO pipeline for a first segment applies a compressed column slab processing element to identify where rows are stored in a compressed column slab and to further facilitate decompression of the rows, while a second segment accesses this column slab directly for the corresponding column based on this column being compressed in the first segment and being uncompressed for the second segment.

FIG. 24S illustrates an example embodiment of an IO pipeline 2835 that is generated to include one or more index elements 3512, one or more source elements 3014, and/or one or more filter elements 3016. These elements can be arranged in a serialized ordering that includes one or more parallelized paths. These elements can implement sourcing and/or filtering of rows based on query predicates 2822 applied to one or more columns, identified by corresponding column identifiers 3041 and corresponding filter parameters 3048. Some or all features and/or functionality of the IO pipeline 2835 and/or IO pipeline generator module 2834 of FIG. 24S can implement the IO pipeline 2835 and/or IO pipeline generator module 2834 of FIG. 24R, and/or any embodiment of IO pipeline 2835, of IO pipeline generator module 2834, or of any query execution via accessing segments described herein.

In some embodiments, the IO pipeline generator module 2834, IO pipeline 2835, IO operator execution module 2840, and/or any embodiment of IO pipeline generation and/or IO pipeline execution described herein, implements some or all features and/or functionality of the IO pipeline generator module 2834, IO pipeline 2835, IO operator execution module 2840, and/or pushing of filtering and/or other operations to the IO level as disclosed by: U.S. Utility application Ser. No. 17/303,437, entitled “QUERY EXECUTION UTILIZING PROBABILISTIC INDEXING” and filed May 28, 2021; U.S. Utility application Ser. No. 17/450,109, entitled “MISSING DATA-BASED INDEXING IN DATABASE SYSTEMS” and filed Oct. 6, 2021; U.S. Utility application Ser. No. 18/310,177, entitled “OPTIMIZING AN OPERATOR FLOW FOR PERFORMING AGGREGATION VIA A DATABASE SYSTEM” and filed May 1, 2023; U.S. Utility application Ser. No. 18/355,505, entitled “STRUCTURING GEOSPATIAL INDEX DATA FOR ACCESS DURING QUERY EXECUTION VIA A DATABASE SYSTEM” and filed Jul. 20, 2023; and/or U.S. Utility application Ser. No. 18/485,861, entitled “QUERY PROCESSING IN A DATABASE SYSTEM BASED ON APPLYING A DISJUNCTION OF CONJUNCTIVE NORMAL FORM PREDICATES” and filed Oct. 12, 2023; all of which hereby incorporated herein by reference in its entirety and made part of the present U.S. Utility Patent Application for all purposes.

FIG. 24T presents an embodiment of a database system 10 that includes a plurality of storage clusters 2535. Storage clusters 2535.1-2535.Z of FIG. 24T can implement some or all features and/or functionality of storage clusters 35-1-35-Z described herein, and/or can implement some or all features and/or functionality of any embodiment of a storage cluster described herein. Some or all features and/or functionality of database system 10 of FIG. 24T can implement any embodiment of database system 10 described herein.

Each storage cluster 2535 can be implemented via a corresponding plurality of nodes 37. In some embodiments, a given node 37 of database system 10 is optionally included in exactly one storage cluster. In some embodiments, one or more nodes 37 of database system 10 are optionally included in no storage clusters (e.g., aren't configured to store segments). In some embodiments, one or more nodes 37 of database system 10 can be included in multiple storage clusters.

In some embodiments, some or all nodes 37 in a storage cluster 2535 participate at the IO level 2416 in query execution plans based on storing segments 2424 in corresponding memory drives 2425, and based on accessing these segments 2424 during query execution. This can include executing corresponding IO operators, for example, via executing an IO pipeline 2835 (and/or multiple IO pipelines 2835, where each IO pipeline is configured for each respective segment 2424). All segments in a given same segment group (e.g., a set of segments collectively storing parity data and/or replicated parts enabling any given segment in the segment group to be rebuilt/accessed as a virtual segment during query execution via access to some or all other segments in the same segment group as described previously) are optionally guaranteed to be stored in a same storage cluster 2535, where segment rebuilds and/or virtual segment use in query execution can thus be facilitated via communication between nodes in a given storage cluster 2535 accordingly, for example, in response to a node failing and/or a segment becoming unavailable.

Each storage cluster 2535 can further mediate cluster state data 3105 in accordance with a consensus protocol mediated via the plurality of nodes 37 of the given storage cluster. Cluster state data 3105 can implement any embodiment of state data and/or system metadata described herein. In some embodiments, cluster state data 3105 can indicate data ownership information indicating ownership of each segments stored by the cluster by exactly one node (e.g., as a physical segment or a virtual segment) to ensure queries are executed correctly via processing rows in each segment (e.g., of a given dataset against which the query is executed) exactly once.

Consensus protocol 3100 can be implemented via the raft consensus protocol and/or any other consensus protocol. Consensus protocol 3100 can be implemented be based on distributing a state machine across a plurality of nodes, ensuring that each node in the cluster agrees upon the same series of state transitions and/or ensuring that each node operates in accordance with the currently agreed upon state transition. Consensus protocol 3100 can implement any embodiment of consensus protocol described herein.

Coordination across different storage clusters 2535 can be minimal and/or non-existent, for example, based on each storage cluster coordinating state data and/or corresponding query execution separately. For example, state data 3105 across different storage clusters is optionally unrelated.

Each storage cluster's nodes 37 can perform various database tasks (e.g., participate in query execution) based on accessing/utilizing the state data 3105 of its given storage cluster, for example, without knowledge of state data of other storage clusters. This can include nodes syncing state data 3105 and/or otherwise utilizing the most recent version of state data 3105, for example, based on receiving updates from a leader node in the cluster, triggering a sync process in response to determining to perform a corresponding task requiring most recent state data, accessing/updating a locally stored copy of the state data, and/or otherwise determining updated state data.

In some embodiments, updating of state data (such as configuration data, system metadata, data shared via a consensus protocol, and/or any other state data described herein), for example, utilized by nodes to perform respective functionality over time, can be performed in conjunction with an event driven model. In some embodiments, such updating of state data over time can be performed in a same or similar fashion as updating of configuration data as disclosed by: U.S. Utility application Ser. No. 18/321,212, entitled COMMUNICATING UPDATES TO SYSTEM METADATA VIA A DATABASE SYSTEM, filed May 22, 2023; and/or U.S. Utility application Ser. No. 18/310,262, entitled “GENERATING A SEGMENT REBUILD PLAN VIA A NODE OF A DATABASE”, filed May 1, 2023; which are hereby incorporated herein by reference in their entirety and made part of the present U.S. Utility Patent Application for all purposes.

In some embodiments, system metadata can be generated and/or updated over time with different corresponding metadata sequence numbers (MSNs). For example, such generation/updating of metadata over time can be implemented via any features and/or functionality of the generation of data ownership information over time with corresponding OSNs as disclosed by U.S. Utility application Ser. No. 16/778,194, entitled “SERVICING CONCURRENT QUERIES VIA VIRTUAL SEGMENT RECOVERY”, filed Jan. 31, 2020, and issued as U.S. Pat. No. 11,061,910 on Jul. 13, 2021, which is hereby incorporated herein by reference in its entirety and made part of the present U.S. Utility Patent Application for all purposes. In some embodiments, the system metadata management system 2702 and/or a corresponding metadata system protocol can be implemented via a consensus protocols mediated via a plurality of nodes, for example, to update system metadata 2710, in a via any features and/or functionality of the execution of consensus protocols mediated via a plurality of nodes as disclosed by this U.S. Utility application Ser. No. 16/778,194. In some embodiments, each version of system metadata 2710 can assign nodes to different tasks and/or functionality via any features and/or functionality of assigning nodes to different segments for access in query execution in different versions of data ownership information as disclosed by this U.S. Utility application Ser. No. 16/778,194. In some embodiments, system metadata indicates a current version of data ownership information, where nodes utilize system metadata and corresponding system configuration data to determine their own ownership of segments for use in query execution accordingly, and/or to execute queries utilizing correct sets of segments accordingly, based on processing the denoted data ownership information as U.S. Utility application Ser. No. 16/778,194.

FIGS. 24U and 24V illustrate embodiments of a database system 10 that utilizes a dictionary structure to store compressed columns. Some or all features and/or functionality of the dictionary structure 5016 of FIGS. 24U and/or 24V can implement any compression scheme data and/or means of generating and/or accessing compressed columns described herein. Any other features and/or functionality of database system 10 of FIG. 24U and/or 24V can implement any other embodiment of database system 10 described herein.

In some embodiments, columns are compressed as compressed columns 5005 based on a globally maintained dictionary (e.g., dictionary structure 5016), for example, in conjunction with applying Global Dictionary Compression (GDC). Applying Global Dictionary Compression can include replaces variable length column values with fixed length integers on disk (e.g., in database storage 2450), where the globally maintained dictionary is stored elsewhere, for example, via different (e.g., slower/less efficient) memory resources of a different type/in a different location from the database storage 2450 that stores the compressed columns 5005 accessed during query execution.

The dictionary structure can store a plurality of fixed-length, compressed values 5013 (e.g., integers) each mapped to a single uncompressed value 5012 (e.g., variable-length values, such as strings). The mapping of compressed values 5013 to uncompressed values 5012 can be in accordance with a one-to-one mapping. The mapping of compressed values 5013 to uncompressed values 5012 can be based on utilizing the fixed-length values 5013 as keys of a corresponding map and/or dictionary data structure, and/or can be based on utilizing the uncompressed values 5012 as keys of a corresponding map and/or dictionary data structure.

A given uncompressed value 5012 that is included in many rows of one or more tables can be replaced (i.e., “compressed”) via a same corresponding compressed value 5013 mapped to this uncompressed value 5012 as the compressed value 5008 for these rows in compressed column 5005 in database storage. As new rows are received for storage over time, their column values for one or more compressed columns 5005 can be replaced via corresponding compressed values 5008 based on accessing the dictionary structure and determining whether the uncompressed value 5012 of this column is stored in the dictionary structure 5016. If yes, the compressed value 5013 mapped to the uncompressed value 5012 in this existing entry is stored as compressed value 5008 in the compressed column 5005 in the database storage 2450. If no, the dictionary structure 5016 can be updated to include a new entry that includes the uncompressed value 5012 and a new compressed value 5013 (e.g., different from all existing compressed values in the structure) generated for this uncompressed value 5012, where this new compressed value 5013 is stored as is applied as compressed value 5008 in the database storage 2450.

The dictionary structure 5016 can be stored in dictionary storage resources 2514, which can be different types of resources from and/or can be stored in a different location from the database storage 2450 storing the compressed columns for query execution. In some embodiments, the dictionary storage resources 2514 storing dictionary structure 5016 can be considered a portion/type of memory as of database storage 2450 that are accessed during query execution as necessary for decompressing column values. In some embodiments, the dictionary storage resources 2514 storing dictionary structure 5016 can be implemented as metadata storage resources, for example, implemented by a metadata consensus state mediated via a metadata storage cluster of nodes maintaining system metadata such as GDCs of the database system 10.

The dictionary structure 5016 can correspond to a given column 5005, where different columns optionally have their own dictionary structure 5016 build and maintained. Alternatively, a common dictionary structure 5016 can optionally be maintained for multiple columns of a same table/same dataset, and/or for multiple columns across different tables/different datasets. For example, a given uncompressed value 5012 appearing in different columns 5005 of the same or different table is compressed via the same fixed-length value 5013 as dictated by the dictionary structure 5016.

This dictionary structure 5016 can be globally maintained (e.g., across some or all nodes, indicating fixed length values mapped across one or more segments stored in conjunction with storing one or more relational database tables) and can be updated overtime (e.g., as more data is added with new variable length values requiring mapping to fixed length values). For example, the dictionary structure 5016 is maintained/stored in state data that is mediated/accessible by some or all nodes 37 of the database system 10 via the dictionary structure 5016 being included in any embodiment of state data described herein.

In some embodiments, dictionary compression via dictionary structure 5016 can implement the compression scheme utilized to generate (e.g., compress/decompress the values of) compressed columns 5005 of FIG. 24U based on implementing some or all features and/or functionality of the compression of data during ingress via a dictionary as disclosed by U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility Patent Application for all purposes.

In some embodiments, dictionary compression via dictionary structure 5016 can implement the compression scheme utilized to generate (e.g., compress/decompress the values of) compressed columns 5005 of FIG. 24U based on implementing some or all features and/or functionality of global dictionary compression as disclosed by U.S. Utility application Ser. No. 16/220,454, entitled “DATA SET COMPRESSION WITHIN A DATABASE SYSTEM”, filed Dec. 14, 2018, issued as U.S. Pat. No. 11,256,696 on Feb. 22, 2022, which is hereby incorporated herein by reference in its entirety and made part of the present U.S. Utility Patent Application for all purposes.

In some embodiments, dictionary compression via dictionary structure 5016 can be utilized in performing GDC join processes during query execution to enable recovery of uncompressed values during query execution, for example, based on implementing some or all features and/or functionality of GDC joins as disclosed by U.S. Utility application Ser. No. 18/226,525, entitled “SWITCHING MODES OF OPERATION OF A ROW DISPERSAL OPERATION DURING QUERY EXECUTION”, filed Jul. 26, 2023, which is hereby incorporated herein by reference in its entirety and made part of the present U.S. Utility Patent Application for all purposes.

FIG. 24U illustrates an embodiment of database system 10 where a compressed column filter conversion module 5010 accesses a dictionary structure 5016 to generate an updated filtering expression 5021 in conjunction with query execution.

The compressed column filter conversion module 5010 can generate updated filtering expression 5021 based on updating one or more literals 5011.1 from corresponding literals 5011.0 based on replacing uncompressed values 5012 with compressed values 5013 mapped to these compressed values based on accessing dictionary structure 5016 and determining which fixed-length compressed value 5013 is mapped to each given uncompressed value 5012. Such functionality can be implemented for one or more queries executed by database system 10 to reduce access to the dictionary structure during query execution in conjunction with performing one or more optimizations of the query operator execution flow to improve query performance.

FIG. 24V illustrates an embodiment of executing a join process 2530 that is implemented as a global dictionary compression (GDC) join. This can include applying a matching row determination module 2558 via access to a dictionary structure 5016.

In some embodiments, unlike hash maps generated during query execution for access in conjunction with executing other types of JOIN operations (e.g., as described in U.S. Utility application Ser. No. 18/266,525), the dictionary structure 5016 can optionally be accessed during GDC join processes based on being globally maintained, and thus being generated prior to execution of the corresponding query. In particular, the dictionary structure 5016 can be implemented in conjunction with compressing one or more columns, such as a variable length values stored in one or more variable length columns, by mapping these variable length, uncompressed values (e.g., strings, other large values of a given column) to corresponding fixed-length, compressed values 5013 (e.g., integers or other fixed length values).

For example, segments can store the fixed length values to improve storage efficiency and/or queries can access and process these fixed length values, where the uncompressed variable length values are only required via access to dictionary structure 5016 to emit an uncompressed value 5012 for a given fixed-length value 5013 of a given input row. This functionality can be achieved via performing a corresponding join as described herein, where the matching condition 2519 is implemented for a compressed column and indicates matching by the value of the compressed column, such as simply emitting the uncompressed value mapped to the compressed column as the right output value 2563 for a given input row, implemented as a left input row 2542 of a join operation.

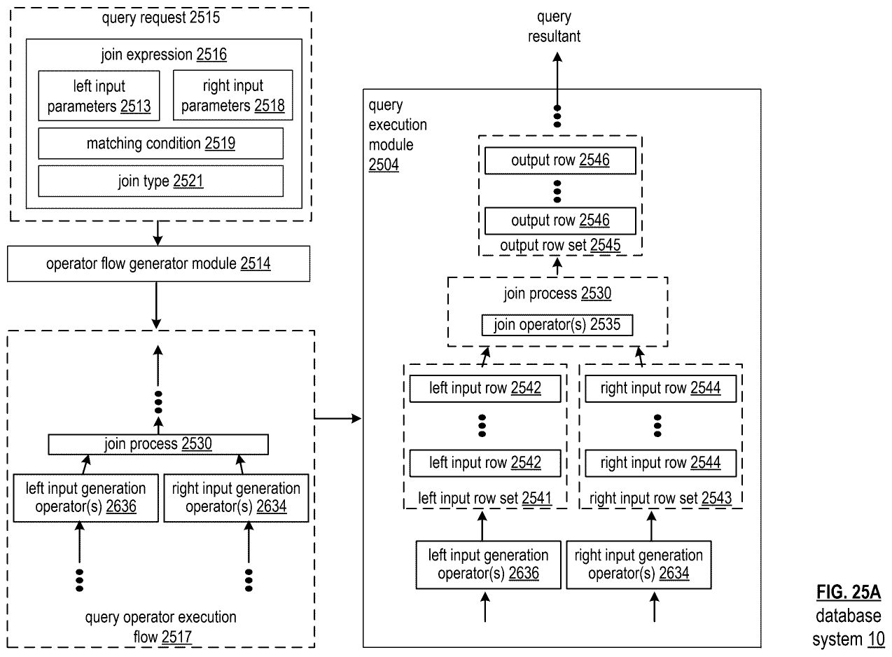

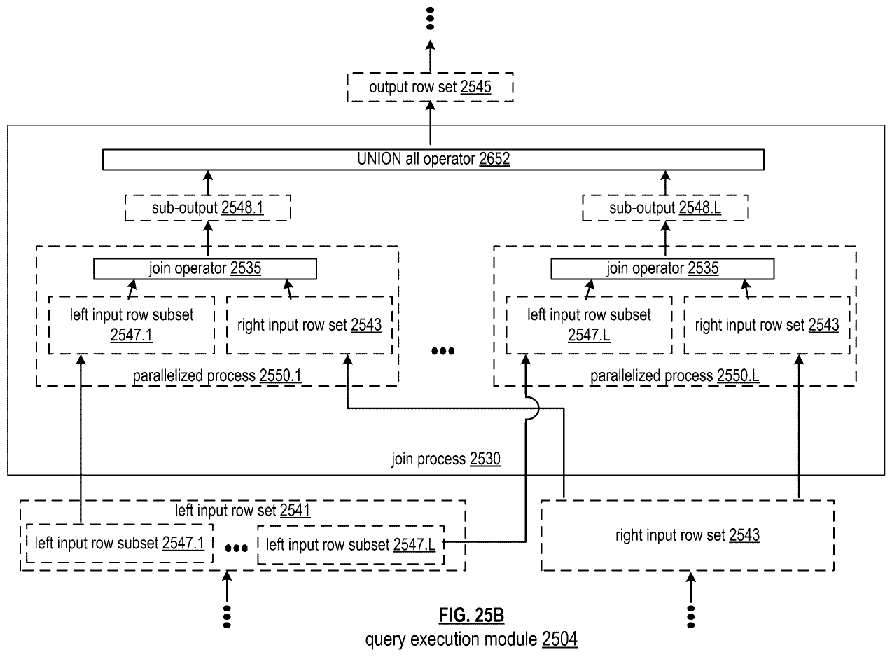

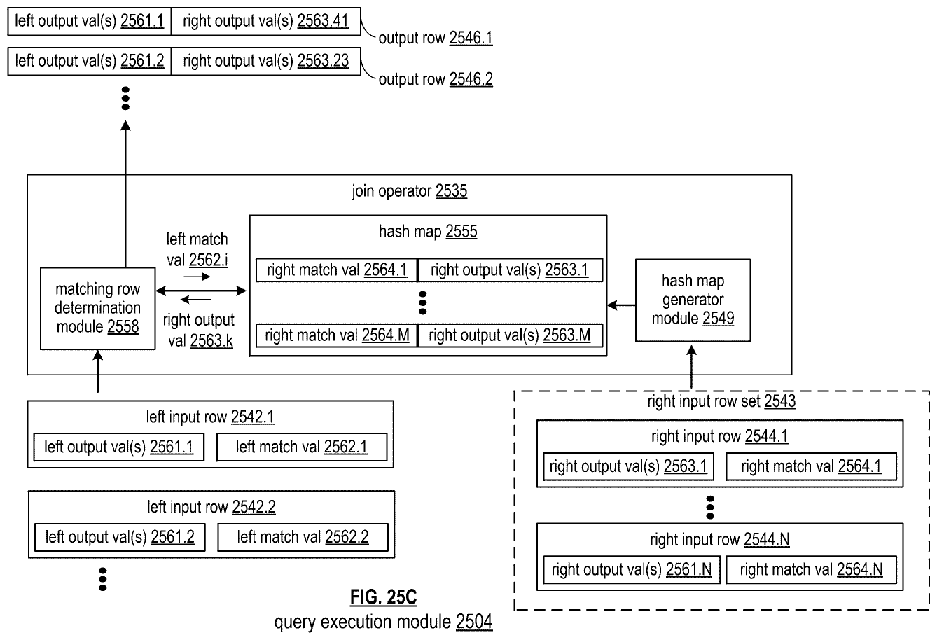

FIGS. 25A-25C illustrate embodiments of a database system 10 operable to execute queries indicating join expressions based on implementing corresponding join processes via one or more join operators. Some or all features and/or functionality of FIGS. 25A-25C can be utilized to implement the database system 10 when executing queries indicating join expressions. Some or all features and/or functionality of FIGS. 25A-25C can be utilized to implement any embodiment of the database system 10 described herein.

FIG. 25A illustrates an example of processing a query request 2515 that indicates a join expression 2516. The join expression 2516 can indicate that columns from one or more tables, for example, indicated by left input parameters 2513 and/or right input parameters 2518, be combined into a new table based on particular criteria, such as matching condition 2519 and/or a join type 2521 of the join operation. For example, the join expression 2516 can be implemented as a SQL JOIN clause, or any other type of join operation in any query language.

The join expression 2516 can indicate left input parameters 2513 and/or right input parameters 2518, denoting how the left input rows and/or right input rows be selected and/or generated for processing, such as which columns of which tables be selected. The left input and right input are optionally not distinguished as left and right, for example, where the join expression 2516 simply denotes input values for two input row sets. The join expression can optionally indicate performance of a join across three or more sets of rows, and/or multiple join expressions can be indicated to denote performance of joins across three or more sets of rows. In the case of a self-join, the join expression can optionally indicate performance of a join across a single set of input rows.

The join expression 2516 can indicate a matching condition 2519 denoting what condition constitutes a left input row being matched with a right input row in generating output of the join operation, which can be based on characteristics of the left input row and/or the right input row, such as a function of values of one or more columns of the left input row and/or the right input row. For example, the matching condition 2519 requires equality between a value of a first column value of the left input rows and a second column value of the right input rows. The matching condition 2519 can indicate any conditional expression between values of the left input rows and right input rows, which can require equality between values, inequality between values, one value being less than another value, one value being greater than another value, one value being less than or equal to another value, one value being greater than or equal to another value, one value being a substring of another value, one value being an array element of an array, or other criteria. In some embodiments, the matching condition 2519 indicates all left input rows be matched with all right input rows.

The join expression 2516 can indicate a join type 2521 indicating the type of join to be performed to produce the output rows. For example, the join type 2521 can indicate the join be performed as a one of: a full outer join, a left outer join, a right outer join, an inner join, a cross join, a cartesian product, a self-join, an equi-join, a natural join, a hash join, or any other type of join, such as any SQL join type and/or any relational algebra join operation.

The query request 2515 can further indicate other portions of a corresponding query expression indicating performance of other operators, for example, to define the left input rows and/or the right input rows, and/or to further process output of the join expression.

The operator flow generator module 2514 can generate the query operator execution flow 2517 to indicate performance of a join process 2530 via one or more corresponding operators. The operators of the join process 2530 can be configured based on the matching condition 2519 and/or the join type 2521. The join process can be implemented via one or more serialized operators and/or multiple parallelized branches of operators 2520 configured to execute the corresponding join expression.

The operator flow generator module 2514 can generate the query operator execution flow 2517 to indicate performance of the join process 2530 upon output data blocks generated via one or more left input generation operators 2636 and one or more right input generation operators 2634. For example, the left input generation operators 2636 include one or more serialized operators and/or multiple parallelized branches of operators 2520 utilized to retrieve a set of rows from memory, for example, to perform IO operations, to filter the set of rows, to manipulate and/or transform values of the set of rows to generate new values of a new set of rows for performing the join, or otherwise retrieve and/or generate the left input rows, in accordance with the left input parameters 2513. Similarly, the right input generation operators 2634 include one or more serialized operators and/or multiple parallelized branches of operators utilized to retrieve a set of rows from memory, for example, via IO operators, to filter the set of rows, to manipulate and/or transform values of the set of rows to generate new values of a new set of rows for performing the join, or otherwise retrieve and/or generate the right input rows, in accordance with the right input parameters 2518. The left input generation operators 2636 and right input generation operators 2634 can optionally be distinct and performed in parallel to generate respective left and right input row sets separately. Alternatively, one or more of the left input generation operators 2636 and right input generation operators 2634 can optionally be shared operators between left input generation operators 2636 and right input generation operators 2634 to aid in generating both the left and right input row sets.

The query execution module 2504 can be implemented to execute the query operator execution flow 2517 to facilitate performance of the corresponding join expression 2516. This can include executing the left input generation operators 2636 to generate a left input row set 2541 that includes a plurality of left input rows 2542 determined in accordance with the left input parameters 2513, and/or executing the right input generation operators 2634 to generate a right input row set 2543 that includes a plurality of right input rows 2544 determined in accordance with the right input parameters 2518. The plurality of left input rows 2542 of the left input row set 2541 can be generated via the left input generation operators 2636 as a stream of data blocks sent to the join process 2530 for processing, and/or the plurality of right input rows 2544 of the right input row set 2543 can be generated via the right input generation operators 2634 as a stream of data blocks sent to the join process 2530 for processing.

The join process 2530 can implement one or more join operators 2535 to process the left input row set 2541 and the right input row set 2543 to generate an output row set 2545 that includes a plurality of output rows 2546. The one or more join operators 2535 can be implemented as one or more operators 2520 configured to execute some or all of the corresponding join process. The output rows 2546 of the output row set 2545 can be generated via the join process 2530 as a stream of data blocks emitted as a query resultant of the query request 2515 and/or sent to other operators serially after the join process 2530 for further processing.

Each output rows 2546 can be generated based on matching a given left input row 2542 with a given right input row 2544 based on the matching condition 2519 and/or the join type 2521, where one or more particular columns of this left input row are combined with one or more particular columns of this given right input row 2544 as specified in the left input parameters 2513 and/or the right input parameters 2518 of the join expression 2516. A given left input row 2542 can be included in no output rows based on matching with no right input rows 2544. A given left input row 2542 can be included in one or more output rows based on matching with one or more right input rows 2544 and/or being padded with null values as the right column values. A given right input row 2544 can be included in no output rows based on matching with no left input rows 2542. A given right input row 2544 can be included in one or more output rows based on matching with one or more left input rows 2542 and/or being padded with null values as the left column values.

The query execution module 2504 can execute the query operator execution flow 2517 via a plurality of nodes 37 of a query execution plan 2405, for example, in accordance with nodes 37 participating across different levels of the plan. For example, the left input generation operators 2636 and/or the right input generation operators 2634 are implemented via nodes at a first one or more levels of the query execution plan 2405, such as an IO level and/or one or more inner levels directly above the IO level.

The left input generation operators 2636 and the right input generation operators 2634 can be implemented via a common set of nodes at these one or more levels. Alternatively some or all of the left input generation operators 2636 are processed via a first set of nodes of these one or more levels, and the right input generation operators 2634 are processed via a second set of nodes that have a non-null difference with and/or that are mutually exclusive with the first set of nodes.

The join process 2530 can be implemented via a nodes at a second one or more levels of the query execution plan 2405, such as one or more inner levels directly above the first one or more levels, and/or the root level. For example, one or more nodes at the second one or more levels implementing the join process 2530 receive left input rows 2542 and/or right input rows 2544 for processing from child nodes implementing the left input generation operators 2636 and/or child nodes implementing the right input generation operators 2634. The one or more nodes implementing the join process 2530 at the second one or more levels can optionally belong to a same shuffle node set 2485, and can laterally exchange left input rows and/or right input rows with each other via one or more shuffle operators and/or broadcast operators via a corresponding shuffle network 2480.

FIG. 25B illustrates an embodiment of a query execution module 2504 executing a join process 2530 via a plurality of parallelized processes 2550.1-2550.L. Some or all features and/or functionality of the query execution module 2504 can be utilized to implement the query execution module 2504 of FIG. 25A, and/or any other embodiment of the query execution module 2504 described herein. In other embodiments, the query execution module 2504 of FIG. 25A implements the join process 2530 via a single join operator of a single processes rather than the plurality of parallelized processes 2550.

In some embodiments, the plurality of parallelized processes 2550.1-2550.L are implemented via a corresponding plurality of nodes 37.1-37.L of a same level, such as a given inner level, of a query execution plan 2405 executing the given query. The plurality of parallelized processes 2550.1-2550.L can be implemented via any other set of parallelized and/or distinct memory and/or processing resources.

Each parallelized process 2550 can be responsible for generating its own sub-output 2548 based on processing a corresponding left input row subset 2547 of the left input row set 2541, and by further processing all of the right input row set. The full output row set 2545 can be generated by applying a UNION all operator 2652 implementing a union across all L sets of sub-output 2548, where all output rows 2546 of all sub-outputs 2548 are thus included in the output row set 2545. The output rows 2546 of a given sub-output 2548 can be generated via the join operator 2535 of the corresponding parallelized process 2555 as a stream of data blocks sent to the UNION all operator 2652.

In some embodiments, L different nodes and/or L different subsets of nodes that each include multiple nodes generate a corresponding left input row subset 2547 at a corresponding level of the query execution plan at a level below the level of nodes implementing the plurality of parallelized processes 2550.1-2550.L. For example, each parallelized process 2550 only receives the left input rows 2542 generated by its own one or more child nodes, where each of these child nodes only sends its output data blocks to one parent. The left input row set 2541 can otherwise be segregated into the set of left input row subsets 2547.1-2547.L, each designated for a corresponding one of the set of parallelized processes 2550.1-2550.L. The plurality of left input row subsets 2547.1-2547.L can be mutually exclusive and collectively exhaustive with respect to the left input row set 2541, where each left input row 2542 is received and processed by exactly one parallelized process 2550.

In some embodiments, the right input row set 2543 is generated via another set of nodes that is the same as, overlapping with, and/or distinct from the set of nodes that generate the left input row subsets 2547.1-2547.L. For example, similar to the nodes generating left input row subsets 2547, L different nodes and/or L different subsets of nodes that each include multiple nodes generate a corresponding subset of right input rows, where these subsets are mutually exclusive and collectively exhaustive with respect to the right input row set 2543. Unlike the left input rows, all right input rows 2544 can be received by all parallelized processes 2550.1, for example, based on each node of this other set of nodes sending its output data blocks to all L nodes implementing the L parallelized processes 2550, rather than a single parent. Alternatively, the right input rows 2544 generated by a given node can be sent by the node to one parent implementing a corresponding one of the plurality of parallelized processes 2550.1-2550.L, where the L nodes perform a shuffle and/or broadcast process to share received rows of the right input row set 2543 with one another via a shuffle network 2480 to facilitate all L nodes receiving all of the right input rows 2544. Each right input row 2544 is otherwise received and processed by every parallelized process 2550.

This mechanism can be employed for correctly implementing inner joins and/or left outer joins. In some embodiments, further adaptation of this join process 2530 is required to facilitate performance of full outer joins and/or right outer joins, as a given parallel process cannot ascertain whether a given right row matches with a left row of some or the left input row subset, or should be padded with nulls based on not matching with any left rows.

In some embodiments, to implement a right outer join, the right and left input rows of a right outer join are designated in reverse, enabling the right outer join to be correctly generated based on instead segregating the right input rows of the right outer join across all parallelized processes 2550, and instead processing all left input rows of the right outer join by all parallelized processes 2550.

The left input row set that is segregated across all parallelized processes 2550 vs. the right input row set processed via every parallelized processes 2550 can be selected, for example, based on an optimization process performed when generating the query operator execution flow 2517. For example, for a join specified as being performed upon two sets of input rows, while the input row set segregated amongst different parallelized processes 2550 and the input row set processed via every parallelized processes 2550 could be interchangeably selected, an intelligent selection is employed to optimize processing via the parallelized processes. For example, the input row set that is estimated and/or known to require smaller memory space due to column value types and/or number of input rows meeting the respective parameters is optionally designated as the right input row set 2543, and the larger input row set that is estimated and/or known to require larger memory space is designated as the left input row set 2541, for example, to reduce the full set of right input rows required to be processed by a given parallelized process. In some cases, this optimization is performed even in the case of a left outer join or right outer join, where, if the right hand side designated in the query expression is in fact estimated to be larger than the left hand side, the “left” input row set 2541 that is segregated across all parallelized processes 2550 is selected to instead correspond to the right hand side designated by the query expression, and the “right” input row set 2543 that is segregated across all parallelized processes 2550 is selected to instead correspond to the left hand side designated by the query expression. In other embodiments, the vice versa scenario is applied, where the larger row set is designated as the right input row set 2543 processed by every parallelized process, and where the smaller row set is designated as the left input row set 2541 segregated into subsets each for processing by only one parallelized process.

FIG. 25C illustrates an embodiment of a query execution module 2504 executing a join operator 2535. The embodiment of implementing the join operator 2535 of FIG. 25C can be utilized to implement the join process 2530 of FIG. 25A and/or can be utilized to implement the join operator 2535 executed via each of a set of parallelized processes 2550 of FIG. 25B.

The join operator can process all right input rows 2544.1-2544.N of a right input row set 2543, and can process some or all left input rows 2542, such as only left input rows of a corresponding left input row subset 2547. The right input rows 2544 and/or left input rows can be received as one or more streams of data blocks.

A plurality of left input rows 2542 can have a respective plurality of columns each having its own column value. One or more of these column values can be implemented as left output values 2561, designated for output in output rows 2546, where these left output values 2561, if outputted, are padded with nulls or combined with corresponding right rows when matching condition 2519 is met. One or more of these column values can be implemented as left match values 2562, designated for use in determining whether the given row matches with one or more right input rows. These left match values 2562 can be distinct columns from the columns that include left output values 2561, where these columns are utilized to identify matches only as required by the matching condition 2519, but are not to be emitted as output in output rows 2546. Alternatively, some or all of these left match values 2562 can same columns as one or more columns that include left output values 2561, where these columns are utilized to not only identify matches as required by the matching condition 2519, but are further emitted as output in output rows 2546.

In some cases, the left input rows 2542 utilize a single column whose values implement both the left output values 2561 and the left match values 2562. In other cases, the left input rows 2542 can utilize multiple columns, where a first subset of these columns implement one or more left output values 2561, where a second subset of these columns implement one or more left match values 2562, and where the first subset and the second subset are optionally equivalent, optionally have a non-null intersection and/or a non-null difference, and/or optionally are mutually exclusive. Different columns of the left input rows can optionally be received and processed in different column streams, for example, via a distinct set of processes operating in parallel with or without coordination.

Similarly to the left input rows, the plurality of right input rows 2544 can have a respective plurality of columns each having its own column value. One or more of these column values can be implemented as right output values 2563, designated for output in output rows 2546, where these left output values 2561, if outputted, are padded with nulls or combined with corresponding left rows when matching condition 2519 is met. One or more of these column values can be implemented as left match values 2564, designated for use in determining whether the given row matches with one or more left input rows. These right match values 2564 can be distinct columns from the columns that include right output values 2563, where these columns are utilized to identify matches only as required by the matching condition 2519, but are not to be emitted as output in output rows 2546. Alternatively, some or all of these right match values 2564 can be implemented via same columns as one or more columns that include left output values 2561, where these columns are utilized to not only identify matches as required by the matching condition 2519, but are further emitted as output in output rows 2546.

In some cases, the right input rows 2544 utilize a single column whose values implement both the left output values 2561 and the left match values 2564. In other cases, the right input rows 2544 can utilize multiple columns, where a first subset of these columns implement one or more right output values 2563, where a second subset of these columns implement one or more right match values 2564, and where the first subset and the second subset are optionally equivalent, optionally have a non-null intersection and/or a non-null difference, and/or optionally are mutually exclusive. Different columns of the right input rows can optionally be received and processed in different column streams, for example, via a distinct set of processes operating in parallel with or without coordination.

Some or all of the set of columns of the left input rows can be the same as or distinct from some or all of the set of columns of the right input rows. For example, the left input rows and right input rows come from different tables, and include different columns of different tables. As another example, the left input rows and right input rows come from different tables each having a column with shared information, such as a particular type of data relating the different tables, where this column in a first table from which the left input rows are retrieved is used as the left match value 2562, and where this column in a second table from which the right input rows are retrieved is used as the right match value 2564. As another example, the left input rows and right input rows come from a same table, for example, where the left input row set 2541 and right input row set 2543 are optionally equivalent sets of rows upon which a self-join is performed.

The join operator 2535 can utilize a hash map 2555 generated from the right input row set 2543, mapping right match values 2564 to respective right output values 2536. For example, the raw right match values 2564 and/or other values generated from, hashed from, and/or determined based on the raw right match values 2564, are stored as keys of the hash map. In the case where the right match value 2564 for a given right input row includes multiple values of multiple columns, the key can optionally be generated from and/or can otherwise denote the given set of values.

In some embodiments, the join operator 2535 be implemented as a hash join, and/or the join operator 2535 can utilize the hash map 2555 generated from the right input row set 2543 based on being implemented as a hash join.

The number of entries M of the hash map 2555 is optionally strictly less than the number of right input rows N based on one or more right input rows 2544 having a same right match value 2564 and/or otherwise mapping to the same key generated from their right match values. These right match values 2564 can thus be mapped to multiple corresponding right output values 2563 of multiple corresponding right input rows 2544. The number of entries M of the hash map 2555 is optionally equal to N in other cases based on no pairs of right input rows 2544 sharing a same right match value 2564 and/or otherwise not mapping to the same key generated from their right match values.

The join operator 2535 can generate this hash map 2555 from the right input row set 2543 via a hash map generator module 2549. Alternatively, the join operator can receive this hash map and/or access this hash map in memory. In embodiments where multiple parallelized processes 2550 are employed, each parallelized processes 2550 optionally generates its own hash map 2555 from the full set of right input rows 2544 of right input row set 2543. Alternatively, as the hash map 2555 is equivalent for all parallelized processes 2550, the hash map 2555 is generated once, and is then sent to all parallelized processes and/or is then stored in memory accessible by all parallelized processes.

The join operator 2535 can implement a matching row determination module 2558 to utilize this hash map 2555 to determine whether a given left input row 2542 matches with a given right input row 2543 as defined by matching condition 2519. For example, the matching condition 2519 requires equality of the column that includes left match values 2562 with the column that includes right match values 2564, or indicates another required relation between one or more columns that includes one or more corresponding left match values 2562 with one or more columns that include one or more right match values 2564. For a given incoming left input row 2542.i, the matching row determination module 2558 can access hash map 2555 to determine whether this given left input row's left match value 2562 matches with any of the right match values 2564, for example, based on the left match value being equal to and/or hashing to a given key and/or otherwise being determined to match with this key as required by matching condition 2519. In the case where a match is identified as a right input row 2544k, the right output value 2563 is retrieved and/or otherwise determined based on the hash map 2555, and the respective output row 2546 is generated to include the a new row generated to include both the one or more left output values 2561.i of the left input row 2542.i, as well as the right output values 2563.k of the identified matching right input row 2544k.

In this example, a first output value includes left output value 2561.1 and right output value 2563.41 based on the left match value 2562.1 of left input row 2542.1 being determined to be equal to, or otherwise match with as defined by the matching condition 2519, the right match value 2564.41 of the right input row 2542.41. Similarly, a second output value includes left output value 2561.2 and right output value 2563.23 based on the left match value 2562.2 of left input row 2542.2 being determined to be equal to, or otherwise match with as defined by the matching condition 2519, the right match value 2564.23 of the right input row 2542.23.

While not illustrated, in some cases, one or left match values 2562 of one or more left input rows 2542 are determined match with no right match values 2564 of any right input rows 2544, for example, based on matching row determination module 2558 searching the hash map for these raw and/or processed left match values 2562 and determining no key is included in the hash map, or otherwise determining no right match value 2564 is equal to, or otherwise matches with as defined by the matching condition 2519, the given left match value 2562. The respective left output values of these left input rows 2542 can be padded with null values in output rows 2546, for example, in the case where the join type is a full outer join or a left outer join. Alternatively, the respective left output values of these left input rows 2542 are not emitted in respective output rows 2546, for example, in the case where the join type is an inner join or a right outer join.

While not illustrated, in some cases, one or left match values 2562 of one or more left input rows 2542 are determined match with right match values 2564 of multiple right input rows 2544, for example, based on matching row determination module 2558 searching the hash map for these raw and/or processed left match values 2562 and determining a key is included in the hash map 2555 that maps to multiple right output values 2563 of multiple right input rows 2544. The respective left output values of these left input rows 2542 can be emitted in multiple corresponding output rows 2546, where each of these multiple corresponding output rows 2546 includes the right output values 2563 of a given one of the multiple right input rows 2544. For example, if the left match values 2562 of a given left input rows 2542 matches with right match values 2564 of three right input rows 2544, the left match values 2562 is emitted in three output rows 2546, each including the respective one or more right output values of a given one of the three right input rows 2544.

While not illustrated, in some cases, after processing the left input rows, one or more or right match values 2562 of one or more right input rows 2544 are determined not to have matched with any left match values 2562 of any of the received left input rows 2542, for example, based on matching row determination module 2558 never accessing these entries having these keys in the hash map when identifying matches for the left input rows. For example, execution of the join operator 2535 implementing a full outer join or a right join includes tracking the right input rows 2544 having matches, and all other remaining rows of the hash map are determined to not have had matches, and thus never had their output values 2563 emitted. In the case of a full outer join or a right join, the output values 2563 of these remaining, unmatched rows can be emitted as output rows 2546 padded with null values.

In some embodiments, any performance of join operations and/or execution/optimization of query operator execution flows that include join operators described herein can be implemented via some or all features and/or functionality of performing join operations and/or implementing join operators as disclosed by: U.S. Utility application Ser. No. 18/321,906, entitled “PROCESSING LEFT JOIN OPERATIONS VIA A DATABASE SYSTEM BASED ON FORWARDING INPUT”, filed May 23, 2023; U.S. Utility application Ser. No. 18/494,230, entitled “GENERATING EXECUTION TRACKING ROWS DURING QUERY EXECUTION VIA A DATABASE SYSTEM”, filed Oct. 25, 2023; and/or U.S. Utility application Ser. No. 18/326,305, entitled “HANDLING NULL VALUES IN PROCESSING JOIN OPERATIONS DURING QUERY EXECUTION”, filed May 31, 2023, which are all hereby incorporated herein by reference in its entirety and made part of the present U.S. Utility Patent Application for all purposes.

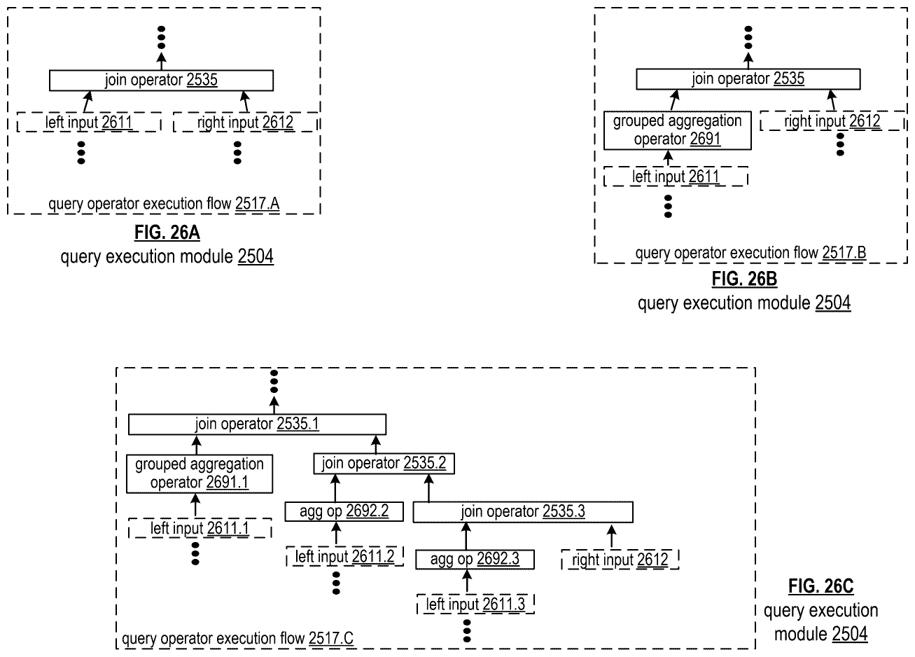

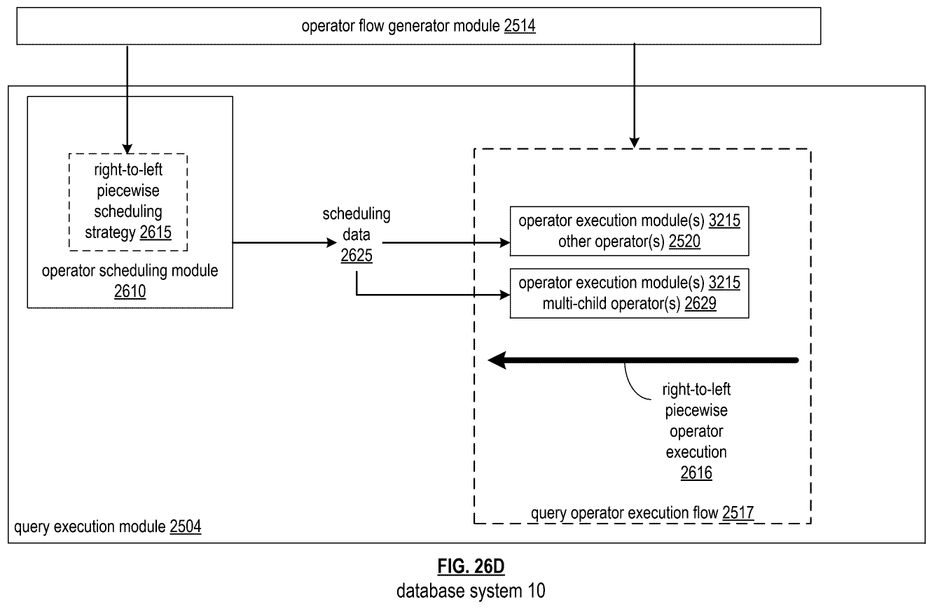

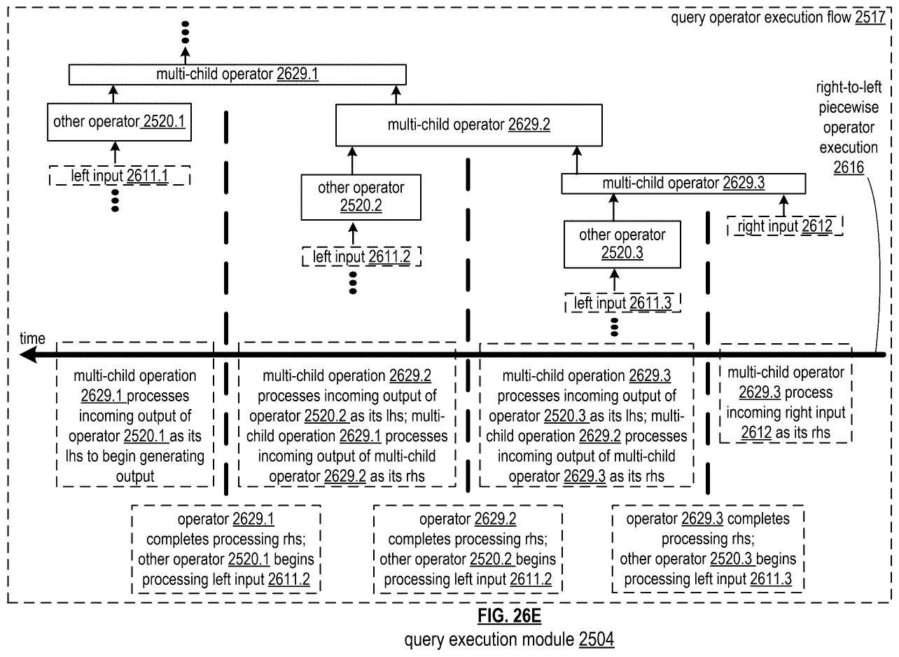

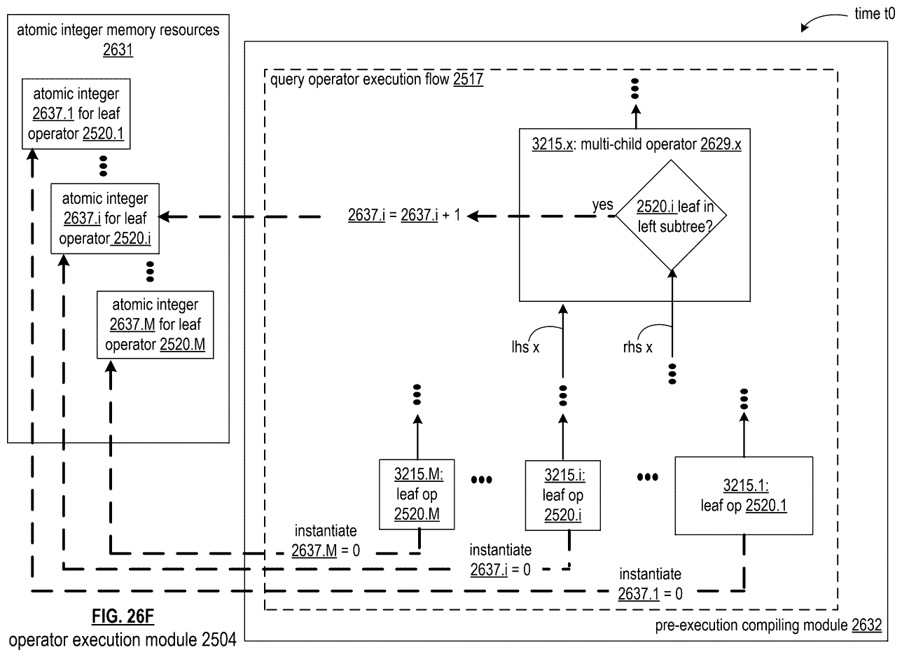

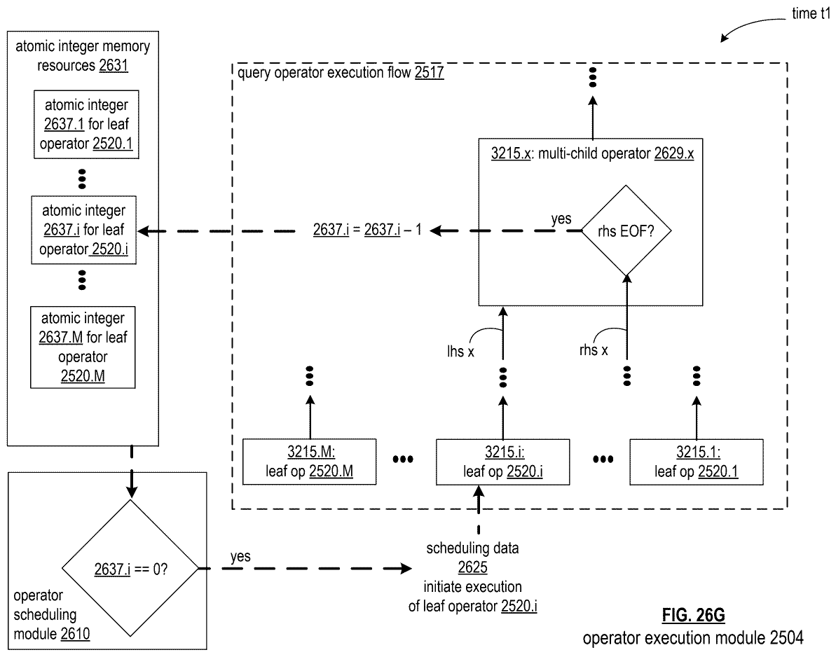

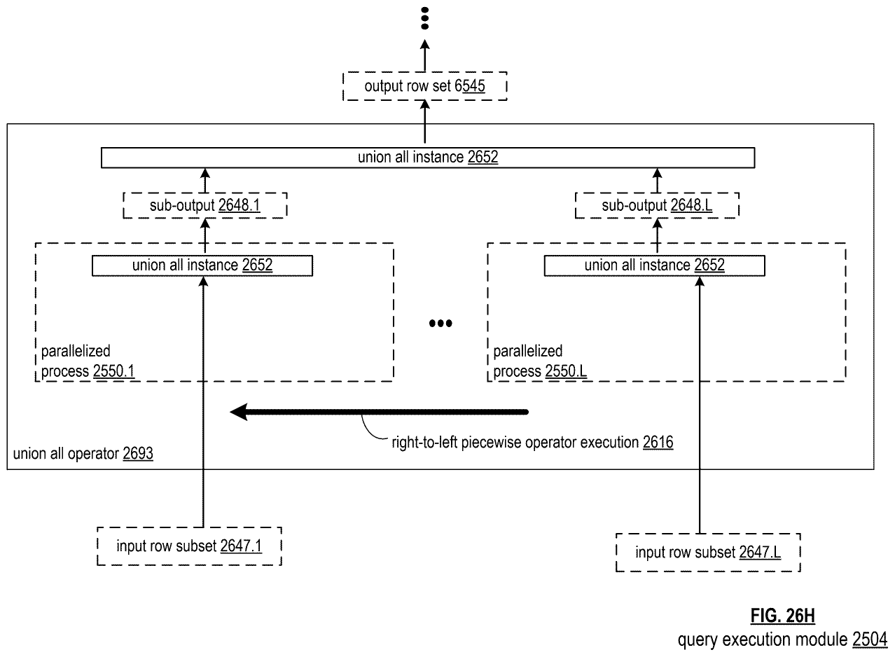

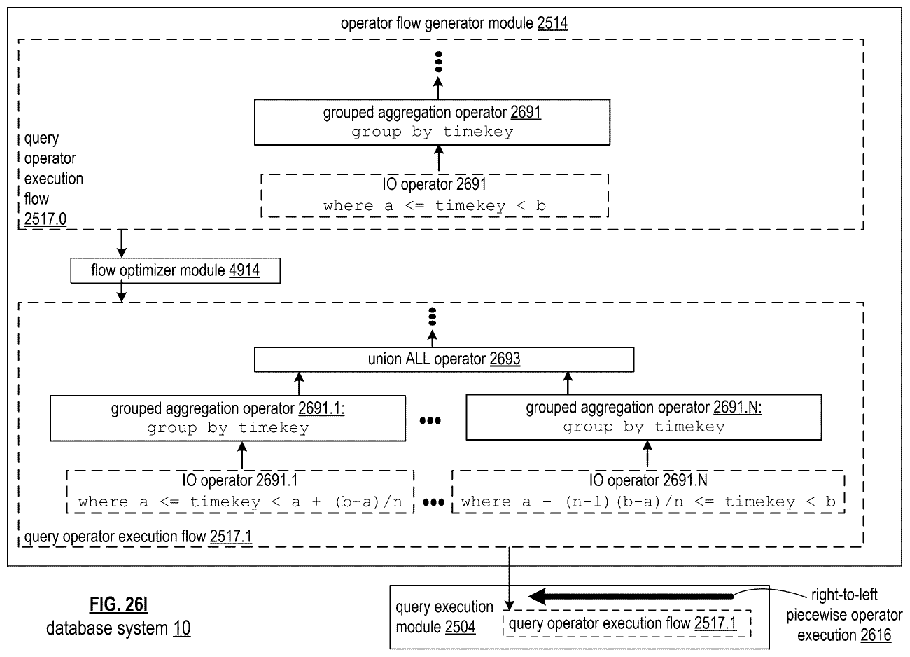

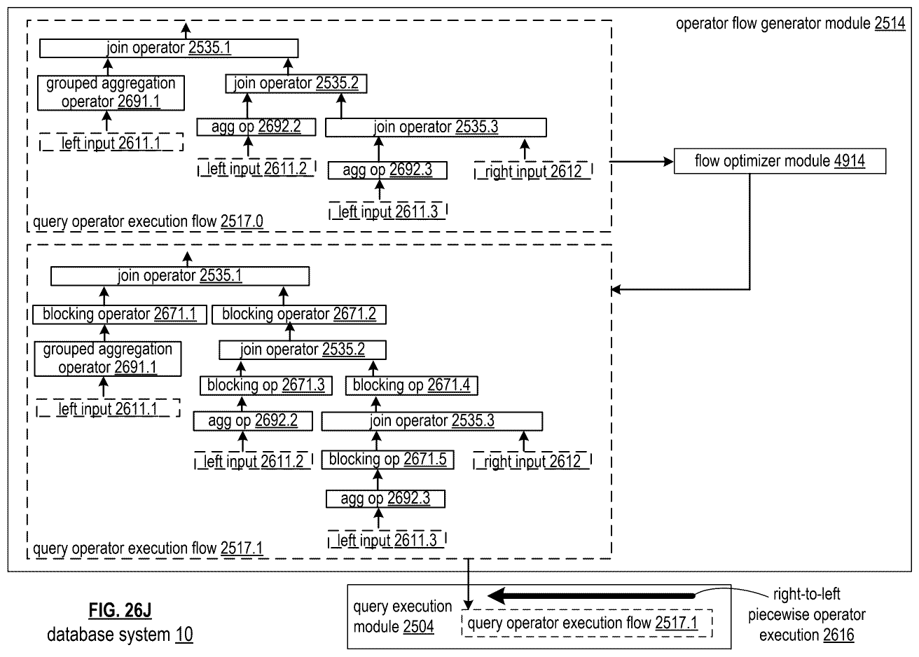

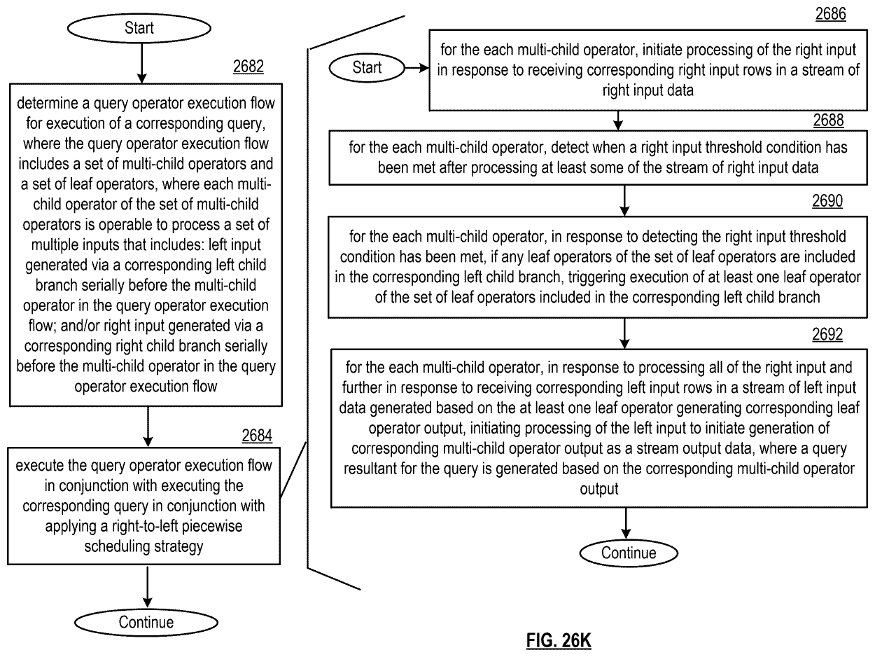

FIGS. 26A-26J illustrate embodiments where a query execution module performs right-to-left piecewise operator execution in executing query operator execution flows that include at least one multi-child operator. The embodiments illustrated in 26A-26J can be utilized to implement one or more nodes 37 of one or more computing devices 18 implementing database system 10. Some or all features and/or functionality of FIGS. 26A-26J can be utilized to implement any embodiment of executing queries and/or corresponding query operator execution flows 2517 and/or 2433 described herein. Some or all features and/or functionality of FIGS. 26A-26J can implement any embodiment of implementing join expressions and/or performing corresponding join processes via join operators via implementing some or all features and/or functionality of FIGS. 25A-25C, and/or can implement any join expressions/join processes/join operations/join operators described herein. Some or all features and/or functionality of FIGS. 26A-26J can be utilized to implement any embodiment of database system 10 described herein.

In some embodiments, it can be an invariant on database plans that a child 0 (e.g., the left hand side “lhs”) of a join operator is streamed, and all other children are loaded entirely into memory either as hash maps, or cursors for nested loop joins.

In some embodiments, a greedy scheduling algorithm that simply runs whatever plan operator is capable of doing work can be utilized to cause the lhs of a join to accumulate memory before the right hand side “rhs” has finished being processed into memory. In such cases, the lhs stream cannot be processed further until the entire rhs is loaded.

In some embodiments, the lhs can be prevented from accumulating large amounts of memory based on join operators (and/or set operators) maintain a child index to run variable (e.g., childlndexToRun) that was updated as they received eofs (e.g., end of file notifications) from children (e.g., child operator execution modules 3215). In such embodiments, multiplexers directly below these joins can be implemented to consider the current runnable index, and can be configured to avoid processing data on the connected child. In such embodiments, this implementation mostly has no direct intervention from the scheduler.

FIG. 26A illustrates a first example operator execution flow 2517.A for executing a join process. In considering a case where this example operator execution flow 2517.A is executed in embodiments implementing the functionality discussed above, as soon as some configurable number of data blocks N reach the join multiplexer from the lhs, in some embodiments, they sit unprocessed and the scheduler's standard backpressure system will prevent the lhs from materializing more data. This system can fail or not execute properly when there is a blocking operator on the left hand side.

FIG. 26B illustrates a second example operator execution flow for executing a join process. In considering a case where this example operator execution flow 2517.B is executed in embodiments implementing the functionality discussed above, all memory from the lhs io operator will be materialized and sit in the distinct operator's map before the rhs can eof because no data can reach the lhs multiplexer of the join until the distinct has received an eof. In some cases, there will be no meaningful backpressure here. In some cases, this is not impactful because the rhs join map must reside in memory at the same time as the full agg map anyways.

Grouped aggregation process 2691 can be implemented via any grouped aggregation operation (e.g., in accordance with SQL) and/or any aggregation described herein. In some embodiments, any implementing of grouped aggregation can be implemented via some or all features and/or functionality of implementing of grouped aggregation as disclosed by U.S. Utility application Ser. No. 18/226,525, entitled “SWITCHING MODES OF OPERATION OF A ROW DISPERSAL OPERATION DURING QUERY EXECUTION”, filed Jul. 26, 2023, which is hereby incorporated herein by reference in its entirety and made part of the present U.S. Utility Patent Application for all purposes.

This problem arising in the example of FIG. 26B can compound in larger series of joins, such as in considering the example illustrated in FIG. 26C. FIG. 26C illustrates a third example operator execution flow for executing a join process, implementing a right-deep join tree. In considering a case where this example operator execution flow 2517.C is executed in embodiments implementing the functionality discussed above, nothing will prevent any of the lhs children from running, and all 3 grouped agg maps can be in memory at the same time as the rhs join map for each join. In some embodiments, to minimize concurrent memory requirements, only the join map of the current rightmost join, the agg map of its left child, and the in-progress join map being built from the output of that join are strictly needed.

Consideration of these examples of FIGS. 26A-26C can motivate a need to prevent lhs subtrees from accumulating memory on blocking operators based on configuring the scheduler and/or each join to have more global info about the current plan. This improvement can be rendered based on a corresponding scheduler (e.g., implemented via query execution module 2504) recording an id for every leaf of the lhs subtree of a join, then directly blocking the leaves from running until the rhs of every parallel join operator has received an eof signal.

FIGS. 26D-26J present embodiments of implementing such functionality to introduce corresponding improvements to query efficiency in executing join processes. Such implementation can be based on, when operators (e.g., join operators) are constructed (e.g., implemented in a corresponding query operator execution flow), every leaf operator instantiates a shared pointer to an atomic integer. Before allowing any leaf operator to do work, the scheduler can poll this atomic and prevent the work cycle if the atomic is nonzero. When compiling a multi-child plan operator, it can record the shared pointer for each leaf operator in the subtrees that it may block. Every multi-child operator (e.g., optionally excluding union all) can be directly connected to every parallel stream of every plan child through a multiplexer. Each multi-child operator can increment the shared leaf atomics from any subtree they do not wish to run. For example, each join will immediately increment the atomic for every leaf in the left subtree, then decrement the flag as soon as it processes an eof on its rhs. Once the last parallel join operator processes an eof on its rhs, the atomic will be 0 and the left subtree leaves can thus be able (e.g., triggered) to run.

Union all operator instances may not be directly connected to each plan child, but they can be aware of which plan children instances they are directly connected to and how many total plan children they have. For example, to implement right→left scheduling of a union all, a union all instance connected only to child 4 can increment the atomics to block children 0 through 3 even though it is not connected to them. Once this union all receives an eof, it can vote to unblock all children. The union alls connected only to child 3 will then be runnable, and they will be blocking subtrees [0, 2] so we still produce piecewise behavior.

Outside of union alls, database system 10 implementing such functionality can support the weak piecewise logic that will not prevent blocking operators from running, but will prevent data from accumulating directly on the join lhs. This can be implemented simply by waiting until N blocks are received on a given child to block other children rather than immediately incrementing the flags for undesired children.

Configuration for piecewise scheduling per-plan can be delegated to the optimizer (e.g., operator flow generator module 2514). Stronger piecewise guarantees can reduce memory usage, but the naive/greedy scheduling approach of concurrently running whatever is available to run can be certainly more CPU-efficient because nothing is ever waiting to run. In some embodiments, the optimizer does not attempt to make any complex choices about this configuration, where every multi-child operator other than union all is configured to weakly run from right to left, meaning that no subtree will be blocked from running until a certain amount of data reaches a join operator. In other embodiments, the tradeoff between CPU-efficiency of executing operators once data blocks are available vs. the memory efficiency of executing operators in the piecewise fashion can be evaluated in determining how corresponding scheduling of query execution be applied (e.g., before initiating query execution, or dynamically during query execution).

In some embodiments, such implementations of piecewise scheduling optionally does not pass across network boundaries.

For example, a join on level 1 may block the level 1 network operator from running on its lhs as that is a “leaf” within that level's subplan, but memory may still accumulate below that gather on lower vm levels. Similarly, in some embodiments, no attempt is made to block leafs across shuffle boundaries, for example, because no eof signal can be delivered for a join rhs on one node significantly before another node because the rhs shuffle guarantees global-eofs. In some embodiments, extreme skew could still result in the remaining data on a single node/core taking longer to be processed. During this time, other nodes may have processed their rhs eofs and unblocked their lhs subtree leaves. Blocks will traverse the lhs shuffle and may back up on the node that has not yet processed its rhs eof. In some embodiments, this is avoided by using a message passing system to block/unblock leaves rather than directly blocking leaves with a shared atomic. In some embodiments, implementations of piecewise scheduling is configured to pass across network boundaries (e.g., between nodes at same or different levels of the query plan).

In some embodiments, given a simple self-join serially after a tee, the lhs will accumulate memory (e.g., this is not prevented via piecewise scheduling strategies). In some embodiments, leaves below tees can still be blocked for cases, for example, where a lhs branch of a join includes a union serially after a tee. In some embodiments, categorically blocking of subtrees containing tees are not blocked from this scheduling approach. In some embodiments, the optimizer considers if every one of a tee's parents are contained in a subtree before blocking anything below that tee in that subtree in determining the scheduling strategy to be applied.

FIG. 26D illustrates a query execution module that implements query execution modules 3215 to execute operators 2520 of a query operator execution flow 2517 via right-to-left piecewise operator execution 2616 based on scheduling data generated via an operator scheduling module 2610 in accordance with applying a right-to-left piecewise scheduling strategy. This can include scheduling execution of a set of one or more multi-child operators 2629 of the flow 2517 and/or a set of one or more other operators 2520 of the flow 2517, which can include one or more leaf operators (e.g., operators serially before other operators in the flow, such as IO operators and/or operators immediately after IO operators). Some or all features and/or functionality of the database system 10 of FIG. 26A can be utilized to implement any embodiment of database system 10 described herein.

In some embodiments, the one or more multi-child operators 2629 are implemented via any type of operator that processes multiple child branches (e.g., multiple independent input sets of rows). Some or all multi-child operators 2629 of a given query operator execution flow can be implemented via: one or more join operators 2535 (e.g., implementing corresponding join processes 2530); one or more union all operators; one or more union distinct operators; one or more other set operators (e.g., set intersection, set difference, etc.); and/or other types of operators (e.g., in accordance with SQL or any query language). Some or all other operators 2520 (e.g., leaf operators or other operators serially after leaf operators) of a given query operator execution flow can be implemented via any other type of operator (e.g., non multi-child operators that process a single incoming branch, such as grouped aggregation operators 2692, other types of aggregation operators, sliding window operators, tee operators, blocking operators, other operators in accordance with SQL in accordance with any language, and/or other types of operators).

In some embodiments, the operator scheduling module 2610 applying right-to-left piecewise scheduling process 2615 in conjunction with executing the query as a whole (e.g., across some or all levels of a hierarchical query execution plan 2405). In some embodiments, the operator scheduling module 2610 applying right-to-left piecewise scheduling process 2615 is implemented by a given node 37 executing its own query operator execution flow 2433 (e.g., its own subplan of the query operator execution flow 2517 assigned to the corresponding level of the plan), where some or all different nodes 37 at a same level or across different levels similarly implement their own operator scheduling module 2610 (e.g., independently, in parallel, and/or without coordination) to render right-to-left piecewise operator execution 2616 when processing their own incoming data blocks to generate their own partial resultants accordingly in conjunction with participation in query execution plan 2405.

FIG. 26E illustrates example execution of an example query operator execution flow 2504 via right-to-left piecewise operator execution 2616. Some or all features and/or functionality of FIG. 26E can implement the query operator execution flow 2517 and/or corresponding right-to-left piecewise operator execution 2616 of FIG. 26D and/or any other embodiment of embodiment of query operator execution flow 2517 and/or corresponding right-to-left piecewise operator execution 2616 described herein. Some or all features and/or functionality of the operator execution flow 2517 of FIG. 26E can implement the example query operator execution flow 2517.C of FIG. 26C (e.g., where multi-child operators 2629.1, 2629.2, and/or 2629.3, are implemented as join operators 2535.1, 2535.2, and/or 2535.3; and/or where other operators 2520.1, 2520.2, and/or 2520.3 are implemented as grouped aggregation operators 2691.1, 2691.2, and/or 2692.3), where FIG. 26E illustrates example execution of the query operator execution flow 2517.C of FIG. 26C when implementing right-to-left piecewise operator execution 2616.

Based on implementing right-to-left piecewise operator execution, during a first temporal period, multi-child operator 2629.3 processes incoming right input 2612 (e.g., as a stream of input blocks that include a plurality of input rows) received via its right child branch as its right hand side. For example multi-child operator 2629.3 populates a hash map based on right input 2612 in conjunction with implementing some or all features and/or functionality of FIG. 25C.

At a first time ending the first temporal period, operator 2629.3 completes its processing of the right input 2612 (or receives an EOF in right input 2612 indicating receipt of all rows in right input 2612, or optionally reaches another threshold amount of processing/receipt of right input 2612 denoted by right-to-left piecewise scheduling strategy), and the other operator 2520.3 begins processing left input 2611.3 (e.g., as a stream of input blocks that include a plurality of input rows). For example, the other operator 2520.3 begins processing left input 2611.3 based on being triggered to initiate processing in response to operator 2629.3 completing its processing of the right input 2612, due to other operator 2520.3 being a leaf operator in the left child branch of multi-child operator 2629.3. As another example, the other operator 2520.3 begins processing left input 2611.3 based on receiving output generated by lower operators in the left child branch of the multi-child operator 2629.3 and based on a leaf operator serially before other operator 2520.3 being triggered to initiate processing in response to operator 2629.3 completing its processing of the right input 2612 due to this leaf operator being a leaf operator in the left child branch of multi-child operator 2629.3.

During a second temporal period strictly after the first temporal period, multi-child operator 2629.3 processes incoming output of operator 2520.3 as its lhs, and multi-child operator 2629.2 processes incoming output of multi-child operator 2629.3 as its rhs. For example, multi-child operator 2629.3 processes incoming output of operator 2520.3 based on the operator 2520.3 being included in the left child branch of multi-child operator 2629.3. This can be based on multi-child operator 2629.3 accessing the hash map generated from the right input 2612 to process each row received from other operator 2520.3, for example, in conjunction with implementing some or all features and/or functionality of FIG. 25C. Processing of incoming output of operator 2520.3 (e.g., a stream of incoming rows/data blocks or multiple rows) by multi-child operator 2629.3 can render multi-child operator 2629.3 emitting of corresponding output, for example, as a stream of output as rows/data blocks of multiple rows for processing by multi-child operator 2629.2 as rhs input based on multi-child operator 2629.3 being in the right child branch of multi-child operator 2629.2. For example multi-child operator 2629.2 populates a hash map based on the output generated by multi-child operator 2629.3 in conjunction with implementing some or all features and/or functionality of FIG. 25C.

At a second time ending the second temporal period, operator 2629.2 completes its processing of its rhs received from operator 2629.3 (or receives an EOF in its rhs received from operator 2629.3 indicating receipt of all rows in its rhs received from operator 2629.3, or optionally reaches another threshold amount of processing/receipt of rows in its rhs received from operator 2629.3 denoted by right-to-left piecewise scheduling strategy), and the other operator 2520.2 begins processing left input 2611.2 (e.g., as a stream of input blocks that include a plurality of input rows). For example, the other operator 2520.2 begins processing left input 2611.2 based on being triggered to initiate processing in response to operator 2629.2 completing its processing of its rhs, due to other operator 2520.2 being a leaf operator in the left child branch of multi-child operator 2629.2. As another example, the other operator 2520.2 begins processing left input 2611.2 based on receiving output generated by lower operators in the left child branch of the multi-child operator 2629.2 and based on a leaf operator serially before other operator 2520.2 being triggered to initiate processing in response to operator 2629.2 completing its processing of its rhs, due to this leaf operator being a leaf operator in the left child branch of multi-child operator 2629.2.

During a third temporal period strictly after the second temporal period, multi-child operator 2629.2 processes incoming output of operator 2520.2 as its lhs, and multi-child operator 2629.1 processes incoming output of multi-child operator 2629.2 as its rhs. For example, multi-child operator 2629.2 processes incoming output of operator 2520.2 based on the operator 2520.2 being included in the left child branch of multi-child operator 2629.2. This can be based on multi-child operator 2629.2 accessing its hash map generated from the rhs to process each row received from other operator 2520.2, for example, in conjunction with implementing some or all features and/or functionality of FIG. 25C. Processing of incoming output of operator 2520.2 (e.g., a stream of incoming rows/data blocks or multiple rows) by multi-child operator 2629.2 can render multi-child operator 2629.2 emitting of corresponding output, for example, as a stream of output as rows/data blocks of multiple rows for processing by multi-child operator 2629.1 as rhs input based on multi-child operator 2629.2 being in the right child branch of multi-child operator 2629.1. For example multi-child operator 2629.1 populates a hash map based on the output generated by multi-child operator 2629.2 in conjunction with implementing some or all features and/or functionality of FIG. 25C.

At a third time ending the third temporal period, operator 2629.1 completes its processing of its rhs received from operator 2629.2 (or receives an EOF in its rhs received from operator 2629.2 indicating receipt of all rows in its rhs received from operator 2629.2, or optionally reaches another threshold amount of processing/receipt of rows in its rhs received from operator 2629.2 denoted by right-to-left piecewise scheduling strategy), and the other operator 2520.1 begins processing left input 2611.1 (e.g., as a stream of input blocks that include a plurality of input rows). For example, the other operator 2520.1 begins processing left input 2611.1 based on being triggered to initiate processing in response to operator 2629.1 completing its processing of its rhs, due to other operator 2520.1 being a leaf operator in the left child branch of multi-child operator 2629.1. As another example, the other operator 2520.1 begins processing left input 2611.1 based on receiving output generated by lower operators in the left child branch of the multi-child operator 2629.1 and based on a leaf operator serially before other operator 2520.1 being triggered to initiate processing in response to operator 2629.1 completing its processing of its rhs, due to this leaf operator being a leaf operator in the left child branch of multi-child operator 2629.1.

During a fourth temporal period strictly after the third temporal period, multi-child operator 2629.1 processes incoming output of operator 2520.1 as its lhs. For example, multi-child operator 2629.1 processes incoming output of operator 2520.1 based on the operator 2520.1 being included in the left child branch of multi-child operator 2629.1. This can be based on multi-child operator 2629.1 accessing the hash map generated from its rhs to process each row received from other operator 2520.1, for example, in conjunction with implementing some or all features and/or functionality of FIG. 25C. Processing of incoming output of operator 2520.1 (e.g., a stream of incoming rows/data blocks or multiple rows) by multi-child operator 2629.1 can render multi-child operator 2629.1 emitting of corresponding output, for example, as a stream of output as rows/data blocks of multiple rows for processing by multi-child operator 2629.1. This output can be processed by a subsequent operator serially after multi-child operator 2629.1 to ultimately render generation of a query resultant, and/or this output can be included in query resultant of the query based on multi-child operator 2629.1 being a root operator of the plan.

FIGS. 26F and 26G present embodiments of a query operator execution module 2504 that triggers execution of one or more leaf operators of a left child branch of a given multi-child operator 2520.x upon determining a threshold amount receipt/processing of rows in its rhs has been met (e.g., triggered by determining an EOF has been received in the rhs). Some or all features and/pr functionality of FIGS. 26F and 26G can implement right-to-left piecewise operator execution 2618 and/or can implement query execution module 2504 of FIG. 25E and/or 25D.

As illustrated in FIG. 26F, during a first time t0, the operator execution module 2504 implements a pre-execution compiling module 2632 to compile corresponding operators of the flow. For example, such compiling is performed by a corresponding node 37 and/or on an operator by operator basis via corresponding operator execution modules 3215.

For leaf operators 2520, compiling can include instantiating a corresponding atomic integer 2537. Thus, a set of leaf operators 2520.1-2520.M have a corresponding set of atomic integers 2637.1-2637.M stored in atomic integer memory resources 2631. Their instantiated value can correspond to a value of zero. These initial values can be incremented (e.g., by a value of 1) prior to query execution in compilation of corresponding multi-child operators 2629, where a given multi-child operator 2629.x increments any atomic integers 2637.i for any leaf operators 2520.i included in its own left child branch. Some atomic integers 2637 for some leaf operators 2520 may be incremented multiple times based on being included in the left child branch of multiple multi-child operators 2629 (e.g., a given leaf operator 2520 is included in the left child branch of a first multi-child operator 2629, and this first multi-child operator 2629 is included in the left child branch of a second multi-child operator 2629, rendering this given leaf operator also being included in the left child branch of this second multi-child operator 2629).

As illustrated in FIG. 26G, during a first time t1 after execution of the operator execution flow begins, operator scheduling module 2610 can schedule execution of leaf operators only once their corresponding atomic integers 2637 reach the value of zero (or other initial value to which they were set upon instantiation in compilation of the leaf operator). Thus, execution of a given leaf operator 2520.i is triggered once all multi-child operators 2629 having the leaf operator in its left child branch meet their respective threshold condition of receiving/processing their rhs received from their right child branch (e.g., once all multi-child operators 2629 having the leaf operator in its left child branch receive EOF in their rhs and/or complete processing of their rhs) based on each of these multi-child operators 2629 decrementing the corresponding atomic integers 2637 of their leaf operators 2520 belonging in their left child branch (e.g., by a value of 1, or other value matching the value by which incrementing occurred in compilation), where the atomic integer 2637.i of a given leaf operator 2520.i ultimately reaches the value of zero once all multi-child operators 2629 having the leaf operator in its left child branch, which originally had incremented this atomic integer 2637.i during compilation, decrement the atomic integer respectfully.

Note that in the case where a given multi-child operator 2629 is implemented via a join process 2530 of FIG. 25B that includes a plurality of parallelized processes 2550.1-2550.L each executing their own instance of the join operator 2535, each of the parallelized processes 2550.1-2550.L can optionally increment and decrement the atomic integer 2637 for any left child branch leaf operators of the respective multi-child operator 2629 implementing the join process 2530 (e.g., the atomic variable is thus incremented by L prior to execution, and will only be again decremented by L once each parallelized processes 2550.1 independently completes its own processing of right input row set 2543), thus requiring that every parallelized process completes its respective rhs processing/receipt of rhs rows/other threshold processing/receipt of the rhs prior to such leaf operators included in the left child branch of this multi-child operator 2629 implementing the join process 2530.

FIG. 26H illustrates how principles of right-to-left piecewise operator execution 2616 is adapted for a union all operator implemented via a plurality of union all operator instances. In particular, each of a plurality of parallelized processes 2550.1-2550.L can each process their respective input row subsets 2647 corresponding input to the union all instance (e.g., each received from a corresponding child branch of the union all or otherwise being included in input to the union all).

Applying the right-to-left piecewise operator execution 2616 can include performing one union all instance 2652 at a time. For example, first, right-most union all instance 2652 of parallelized process 2550.L is executed upon input row subset 2647.L to generate sub-output 2648.L. Next, once input row subset 2647.L EOFs, second right-most union all instance 2652 of parallelized process 2550.L−1 is executed upon input row subset 2647.L to generate sub-output 2648.L−1, and so on, until ultimately once input row subset 2647.2 EOFs, left-most union all instance 2652 of parallelized process 2550.1 is executed upon input row subset 2647.1 to generate sub-output 2648.1.

Implementing such piecewise execution can be based on implementing same or similar functionality of updating atomic integers 2637 for each parallelized process 2550, where atomic integer 2637.1 is incremented to the value L−1 during compilation due to each of the parallelized processes 2550.2-2550.L incrementing atomic integer 2637.1 due to being right of parallelized process 2550.1; where atomic integer 2637.2 is incremented to L−2 during compilation, due to each of the parallelized processes 2550.3-2550.L incrementing atomic integer 2637.2 due to being right of parallelized process 2550.2; and where atomic integer 2637.L is not incremented and starts with a value of zero, initiating execution of this parallelized process first, due to no other parallelized processes being right of parallelized process 2550.L. As each parallelized process completes execution of its respective union all instance, it can decrement all atomic values for processes to its left respectively (e.g., atomic integers 2637.1-2637.L−1 are decremented by parallelized process 2550.L once input row subset 2647.L EOFs rendering atomic integer 2637.L−1 having a value of zero and triggering its execution and rendering other atomic integers 2637.1-2637.L−2 still having values greater than zero until more parallelized processes complete from right to left.

FIGS. 26I-26J illustrate embodiments where a flow optimizer module 4914 transforms the query operator execution flow for execution from an initial flow 2517.0 to an updated flow 2517.1, for example, in conjunction with an optimization process. In particular, transforms can be applied to leverage the memory usage reduction in applying the right-to-left piecewise scheduling strategy 2615 and/or can further improve memory usage reduction rendered in applying the right-to-left piecewise scheduling strategy 2615. Some or all features and/or functionality of flows 2517.1 generated via optimization can implement any embodiment of query operator execution flow 2517 described herein.

FIG. 26I illustrates an embodiment where right-to-left piecewise scheduling strategy 2615 is leveraged in implementing time bucket plan partitioning. For example, consider an initial plan 2517.0. This plan can be transformed to the plan of 2517.1, exclusive partitions of the time key filter of IO operator 2691 are generated as IO operators 2691.1-2691.N implementing separate, contiguous portions of the original filter, generated for processing by for N parallel grouped aggregation operators 2691.1-2691.N, where the grouped aggregation of grouped aggregation operator 2691 of the flow 2517.0 are calculated separately over each partition. If the union all operator is configured to strongly-piecewise schedule its children, for example, as discussed in conjunction with FIG. 26H, the aggregation map is only required to be materialized for a single partition of the time key at any given time. In some embodiments, cost of this additional partitioning has minimal computational overhead beyond added plan complexity. In some embodiments, time key filters (at least bucket aligned time key filters) require no per-row logic and can immediately exclude entire tkt segments (e.g., segments 2424) during operator compilation. In some embodiments, the optimizer can choose to only generate bucket aligned partitions of the time key to ensure the filtering is inexpensive. Although the computational overhead can be very low, this partitioned plan can have higher latency in practice because many threads may be idly waiting for each previous partition to complete its processing.

If there is no explicit time filter on the time key, the optimizer may still attempt to generate time bucket partitions like this for a query based on table statistics similar to how sort partition points are currently estimated.

This could similarly be applied to partition any plan operator with a time key included in some equality key: grouped aggs, set operators (other than union all), equijoins, or partitioned sliding window aggs. This can similarly be applied to other types of keys.

FIG. 26I illustrates an embodiment where right-to-left piecewise scheduling strategy 2615 is leveraged in implementing spill-aware piecewise scheduling. Consider the right-deep join of FIG. 26C. With the strongest possible piecewise scheduling enabled on each join, multiple large hash maps can still be required in memory at a given time. For example, while evaluating join 2535.3, the entire rhs join map is still required to be accessible in memory, and streaming the lhs makes no practical difference because no memory can be released from grouped aggregation operation 2692.3 until all groups are emitted. Additionally, while emitting rows from join 2535.3, they will be processed into join 2535.2's map. No memory will be released from join 2535.3, until all rows have been emitted, the entire contents of all three of these maps are required to be concurrently maintained in memory.

Spilling a join or agg map can be is very expensive; for example, the contents of the map must be copied out and multiplexed based on their hash keys to be further partitioned as on disk blocks, where a large amount of temp disk io is required, and/or then the agg/join operators will switch to a much more expensive, further partitioned “external” algorithm to finish evaluating the operator which can introduce further inefficiency.

Most of this additional cost can be avoided in cases when a stream of data blocks can be spilled directly to disk rather than partitioning and copying out from a large hash table. Data blocks can require very little serialization overhead (e.g., unless compressed spill is enabled), so the most significant cost of spilling a stream of blocks is likely disk io.

If a fully blocking operator 2671 is added the plan that does nothing other than collect data blocks and emit them all once its input partitions are eof, faster spilling and streaming can be guaranteed, for example, even if concurrent memory requirements are too high. The flow optimizer module 2419 can thus transform flow 2517.0 to flow 2517.1 via insertion of such blocking operators.

For example, approximately the same concurrent mem requirements would be required to evaluate join 2535.3 in this case, but there would be much more capable of efficiently spilling. If the rhs from is prevented running (or blocking operator 2617.6 is added to join 2535.3's rhs and is prevented from running) until blocking operator 2617.5 receives an eof, needing the entire join 2535.3 map in memory while processing the agg 2692.3 map can be avoided. If the query execution module runs out of memory while building join 2535.3's rhs map, all of blocking operator 2617.5's data can be spilled to temp disk (e.g., relatively inexpensively), and then later blocks can be streamed through join 2535.3, for example, without requiring significant memory beyond the single join map for 2535.3's rhs. Similarly, if the materialized results of the join cause out of memory conditions, it can be relatively inexpensive to spill blocking operator 2617.4's data without needing to transition any joins or agg to the more expensive external execution.

Adding the additional blocking operators below multi-child operators with memory intensive children in their subtree can be simple for the flow optimizer module 4914. The right-to-left piecewise scheduling strategy 2615 can be adapted in this case to render scheduling to enable eofs reaching each blocking operator rather than directly reaching the join. Each blocking operator can also be required to be prevented from emitting data until the blocking operators on each sibling subtree receive eofs. This can be implemented, for example, by registering a shared atomic for each blocking operator in a same or similar fashion as they are assigned to leaf operators as discussed in conjunction with FIGS. 26F-26G.

In some embodiments, implementing scheme involves a great deal of waiting, and can be significantly slower for executing many queries. However, it can be significantly faster for queries that would normally be forced to spill and transition joins to external. The flow optimizer module 4914 can be configured to structure a flow like this under certain conditions, for example, where this insertion of blocking operators is enabled when a user-provided hint is present and/or when a disk spill is expected in maintaining the multiple maps during execution (e.g., based on number of rows to be processed, expected size of the hash maps due to cardinality of rows, current memory availability, etc.)

FIG. 26K illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 26K, for example, based on participating in execution of a query being executed by the database system 10. Some or all of the method of FIG. 26K can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 26K based on implementing a corresponding plurality of processing core resources 48.1-48.W. Some or all of the steps of FIG. 26K can optionally be performed by any other one or more processing modules of the database system 10. Some or all of the steps of FIG. 26K can be performed to implement some or all of the functionality of the database system 10 as described in conjunction with FIGS. 26A-26J, for example, by implementing some or all of the functionality of query execution module 2504, operator flow generator module 2514, operator scheduling module 2610, right-to-left piecewise scheduling strategy 2615, right-to-left piecewise operator execution 2616, and/or multi-child operator 2629. Some or all steps of FIG. 26K can be performed by database system 10 in accordance with other embodiments of the database system 10 and/or nodes 37 discussed herein. Some or all of the steps of FIG. 26K can be performed in conjunction with performing some or all steps of any other method described herein.

Step 2682 includes determining a query operator execution flow for execution of a corresponding query, wherein the query operator execution flow includes a set of multi-child operators and a set of leaf operators. In various examples, each multi-child operator of the set of multi-child operators is operable to process a set of multiple inputs that includes: left input generated via a corresponding left child branch serially before the multi-child operator in the query operator execution flow; and/or right input generated via a corresponding right child branch serially before the multi-child operator in the query operator execution flow.

Step 2684 includes executing the query operator execution flow in conjunction with executing the corresponding query in conjunction with applying a right-to-left piecewise scheduling strategy.

Performing step 2684 can include performing some or all of steps 2686, 2688, 2690, and/or 2692. In various examples, performing step 2684 can include executing each multi-child operator based on performing some or all of steps 2686, 2688, 2690, and/or 2692 for the each multi-child operator. Step 2686 includes initiating processing of the right input in response to receiving corresponding right input rows in a stream of right input data. Step 2688 includes detecting when a right input threshold condition has been met after processing at least some of the stream of right input data. Step 2690 includes, in response to detecting the right input threshold condition has been met, if any leaf operators of the set of leaf operators are included in the corresponding left child branch, triggering execution of at least one leaf operator of the set of leaf operators included in the corresponding left child branch. Step 2692 includes, in response to processing all of the right input and further in response to receiving corresponding left input rows in a stream of left input data generated based on the at least one leaf operator generating corresponding leaf operator output, initiating processing of the left input to initiate generation of corresponding multi-child operator output as a stream output data.

In various examples, a query resultant for the query is generated based on the corresponding multi-child operator output.

In various examples, the set of multi-child operators includes exactly one multi-child operator. In various examples, the set of multi-child operators includes multiple multi-child operators.

In various examples, the set of leaf operators includes exactly one leaf operator. In various examples, the set of leaf operators includes multiple leaf operators.

In various examples, the right input threshold condition corresponds to receipt of all of the right input. In various examples, detecting the right input threshold condition has been met is based on determining all right input rows in the stream of right input rows have been received.

In various examples, the stream of right input rows are generated as right child output of via a right child operator serially after all other operators in the corresponding right child branch. In various examples, determining the all right input rows in the stream of right input rows have been received is based on receiving an end of file (EOF) indication generated by the right child operator based on the right child operator sending all rows of the right child output.

In various examples, processing of the right input includes generating a hash map for storage via query execution memory resources. In various examples, processing of the left input includes accessing the hash map to generate the corresponding multi-child operator output.

In various examples, the set of multi-child operators includes at least one join operator. In various examples, the set of leaf operators includes at least one grouped aggregation operator.

In various examples, the set of multi-child operators includes an operator executed via a plurality of parallelized instances of the operator. In various examples, detecting the right input threshold condition has been met for the operator is based on determining the right input threshold condition has been met for all of the plurality of parallelized instances of the operator.

In various examples, the set of multi-child operators includes multiple multi-child operators. In various examples, a first multi-child operator of the set of multi-child operators is included in the right child branch of a second multi-child operator. In various examples, a third multi-child operator of the set of multi-child operators is included in the left child branch of the second multi-child operator.

In various examples, the first multi-child operator of the set of multi-child operators is included in the right child branch of the second multi-child operator. In various examples, a first leaf operator of the set of leaf operators is included in a first left child branch of the first multi-child operator. In various examples, a second leaf operator of the set of leaf operators is included in a second left child branch of the second multi-child operator. In various examples, the first leaf operator initiates execution in a first timeframe in response to the first multi-child operator detecting the right input threshold condition has been met at a first corresponding time. In various examples, the second leaf operator initiates execution in a second timeframe in response to the second multi-child operator detecting the right input threshold condition has been met at a second corresponding time. In various examples, the second timeframe is strictly after the first timeframe. In various examples, the second time is strictly after the first time based on applying the right-to-left piecewise scheduling strategy.

In various examples, executing each leaf operator of the set of leaf operators is based on initiating execution of the each leaf operator in response to determining a corresponding atomic integer stored for the leaf operator has a value equal to zero. In various examples, executing the each multi-child operator is based on, in response to detecting the right input threshold condition has been met and if any leaf operators of the set of leaf operators are included in the corresponding left child branch, decrementing the value of all corresponding atomic integers for all leaf operators of the set of leaf operators included in the corresponding left child branch. In various examples, triggering execution of the at least one leaf operator included in the corresponding left child branch is based on at least one corresponding atomic integer having the value equal to zero in response to the decrementing of the value of all corresponding atomic integers for all leaf operators of the set of leaf operators included in the corresponding left child branch by the each multi-child operator.

In various examples, executing the query operator execution flow is further based on: compiling the each leaf operator prior to execution of the each leaf operator based on instantiating the corresponding atomic integer with the value of zero; and/or compiling the each multi-child operator based on decrementing the value of the all corresponding atomic integers for the all leaf operators of the set of leaf operators included in the corresponding left child branch.

In various examples, the each multi-child operator decrements each atomic integer of the all corresponding atomic integers for the all leaf operators of the set of leaf operators included in the corresponding left child branch based on applying a corresponding shared pointer for the each atomic integer. In various examples, a corresponding value of an atomic integer of one of the set of leaf operators reaches the value of zero after being decremented multiple times via multiple different multi-child operators of the set of multi-child operators based on being included in corresponding left child branches for all of the multiple different multi-child operators. In various examples, the multiple different multi-child operators each decrement the corresponding value of the atomic integer based on each applying a same shared pointer for the atomic integer.

In various examples, the set of multiple inputs for at least one multi-child operator of the set of multi-child operators includes at least three inputs that includes the right input, the left input, and at least one further left input. In various examples, applying the right-to-left piecewise scheduling strategy is based on processing the at least three inputs one at a time, starting with the right input, continuing with the left input, and further continuing with the at least one further left input.

In various examples, the set of multi-child operators includes a union all operator. In various examples, executing the union all operator includes executing a plurality of parallelized operator instances of the union all operator that includes a first union all instance operator to process the right input and a second union all instance operable to process the left input based on: initiating processing of the right input via the second union all operator instance in response to receiving the corresponding right input rows in the stream of right input data; detecting when the right input threshold condition has been met after processing the at least some of the stream of right input data; in response to detecting the right input threshold condition has been met, if any leaf operators of the set of leaf operators are included in the corresponding left child branch, triggering execution of the at least one leaf operator of the set of leaf operators included in the corresponding left child branch; and/or in response to receiving corresponding left input rows in a stream of left input data generated based on the at least one leaf operator generating corresponding leaf operator output, initiating processing of the left input via the second union all operator instance.

In various examples, determining the query operator execution flow for execution of the corresponding query is based on: determining an initial query operator execution flow for the corresponding query; and/or generating the query operator execution flow based on transforming the initial query operator execution flow to include the set of multi-child operators for execution in accordance with applying the right-to-left piecewise scheduling strategy.

In various examples, the initial query operator execution flow for the corresponding query includes a key-based operator that utilizes a corresponding key for performance upon input rows filtered to include only rows having the corresponding key falling within a corresponding range. In various examples, the query operator execution flow transforms the key-based operator into a plurality of parallelized key-based operators serially before a union all operator based on plurality of parallelized key-based operators are each performed upon corresponding subset of rows filtered to include only rows having the corresponding key falling within a corresponding one of a plurality of contiguous subranges that collectively render the range. In various examples, the set of multi-child operators includes the union all operator. In various examples, the set of leaf operators includes the plurality of parallelized key-based operators, and wherein the plurality of parallelized key-based operators are executed one at a time applying the right-to-left piecewise scheduling strategy.

In various examples, transforming the initial query operator execution flow includes inserting a blocking operator serially after the each multi-child operator. In various examples, a first multi-child operator of the set of multi-child operators is included in the right child branch of a second multi-child operator serially before a corresponding blocking operator included in the right child branch of the second multi-child operator. In various examples, a first leaf operator of the set of leaf operators is included in a first left child branch of the first multi-child operator. In various examples, a second leaf operator of the set of leaf operators is included in a second left child branch of the second multi-child operator. In various examples, execution of the second multi-child operator is initiated strictly after execution of the first multi-child operator is complete based on the second multi-child operator beginning to receive right input rows generated as multi-child output of the first multi-child operator only once the first multi-child operator completes generation of all of its corresponding multi-child operator output based on execution of the corresponding blocking operator.

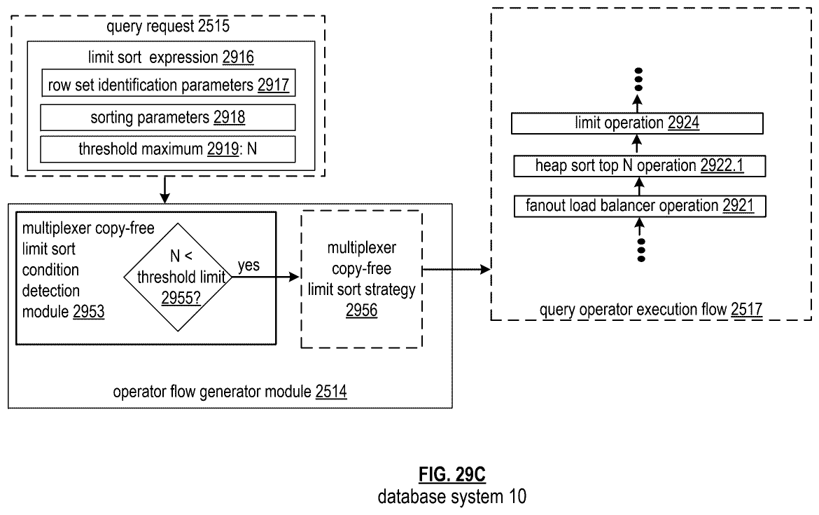

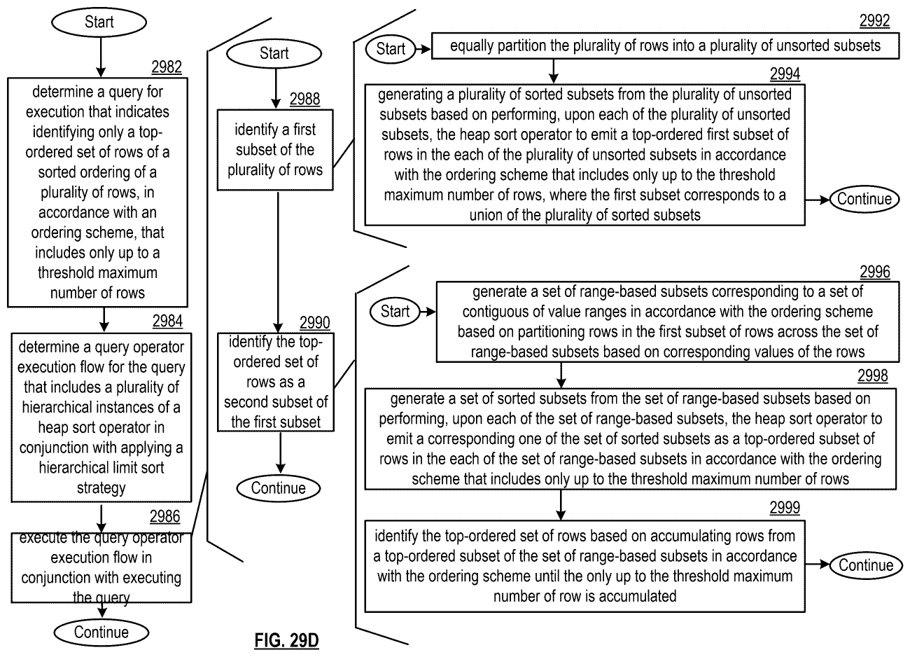

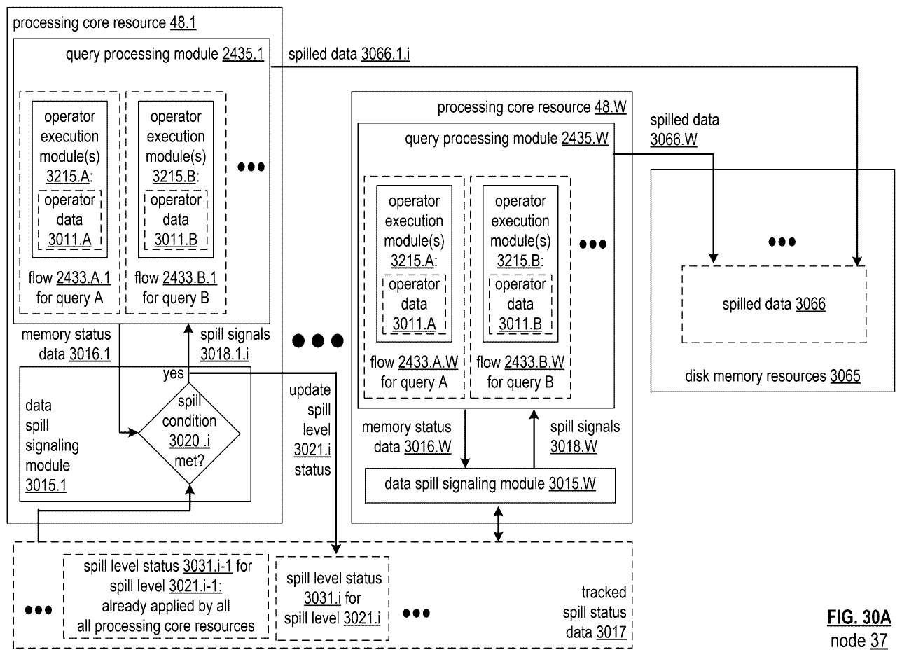

In various examples, the query operator execution flow further includes a plurality of hierarchical instances of a heap sort operator in conjunction with applying a hierarchical limit sort strategy. In various examples, executing the query operator execution flow in conjunction with executing the query is further based on: identifying a first subset of a plurality of rows based on generating a plurality of sorted subsets from a plurality of unsorted subsets based on performing a first parallelized plurality of instances of the heap sort operator; and/or identifying a top-ordered set of rows as a second subset of the first subset based on generating a set of sorted subsets from a set of range-based subsets of the first subset of the plurality of rows based on performing a second parallelized plurality of instances of the heap sort operator. For example, the query operator execution flow is generated and/or executed in conjunction with implementing some or all features and/or functionality of FIGS. 29A-29D.

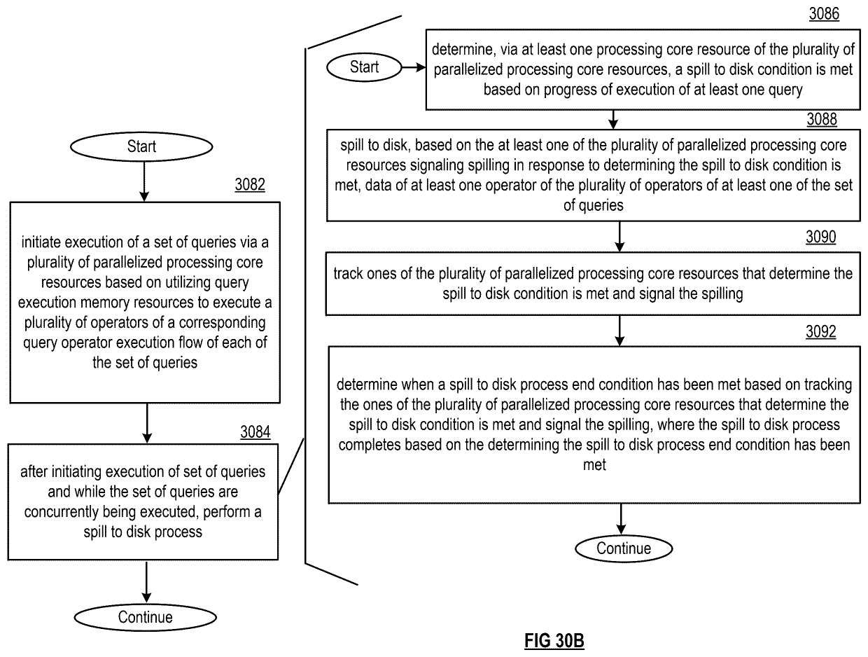

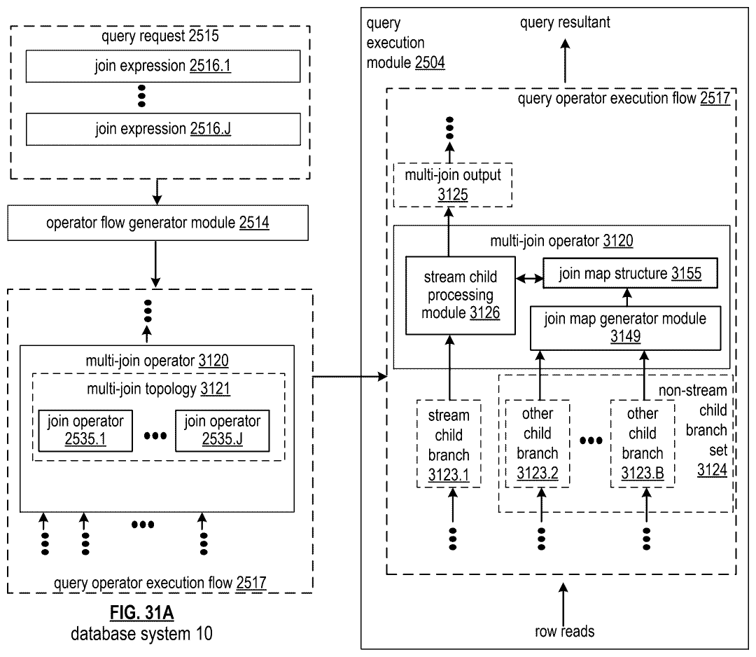

In various examples, the query is one of a set of queries. In various examples, execution of the set of queries is initiated via a plurality of parallelized processing core resources. In various examples, the method further includes, after initiating execution of set of queries and while the set of queries are concurrently being executed, performing a spill to disk process based on: spilling to disk, based on at least one of the plurality of parallelized processing core resources signaling spilling in response to determining a spill to disk condition is met, data of at least one operator the query; and/or determining when a spill to disk process end condition has been met based on tracking the ones of the plurality of parallelized processing core resources that determine the spill to disk condition is met and signal the spilling. In various examples, the spill to disk process completes based on the determining the spill to disk process end condition has been met. For example, the query executed and/or spilled to disk in conjunction with implementing some or all features and/or functionality of FIGS. 30A-30B.

In various embodiments, any one of more of the various examples listed above are implemented in conjunction with performing some or all steps of FIG. 26K. In various embodiments, any set of the various examples listed above can be implemented in tandem, for example, in conjunction with performing some or all steps of FIG. 26K, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 26K described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 26K, for example, in conjunction with further implementing any one or more of the various examples described above.

In various embodiments, the operational instructions, when executed by the at least one processor, cause the database system to: determine, for execution of a corresponding query, a query operator execution flow that includes a set of multi-child operators and a set of leaf operators, where each multi-child operator of the set of multi-child operators is operable to process a set of multiple inputs that includes: left input generated via a corresponding left child branch serially before the multi-child operator in the query operator execution flow; and right input generated via a corresponding right child branch serially before the multi-child operator in the query operator execution flow. In various embodiments, the operational instructions, when executed by the at least one processor, further cause the database system to: execute the query operator execution flow in conjunction with executing the corresponding query in conjunction with applying a right-to-left piecewise scheduling strategy. In various embodiments, executing the query operator execution flow in conjunction with executing the corresponding query in conjunction with applying a right-to-left piecewise scheduling strategy includes executing the each multi-child operator based on: initiating processing of the right input in response to receiving corresponding right input rows in a stream of right input data; detecting when a right input threshold condition has been met after processing at least some of the stream of right input data; in response to detecting the right input threshold condition has been met, if any leaf operators of the set of leaf operators are included in the corresponding left child branch, triggering execution of at least one leaf operator of the set of leaf operators included in the corresponding left child branch; and in response to processing all of the right input and further in response to receiving corresponding left input rows in a stream of left input data generated based on the at least one leaf operator generating corresponding leaf operator output, initiating processing of the left input to initiate generation of corresponding multi-child operator output as a stream output data, wherein a query resultant for the query is generated based on the corresponding multi-child operator output.

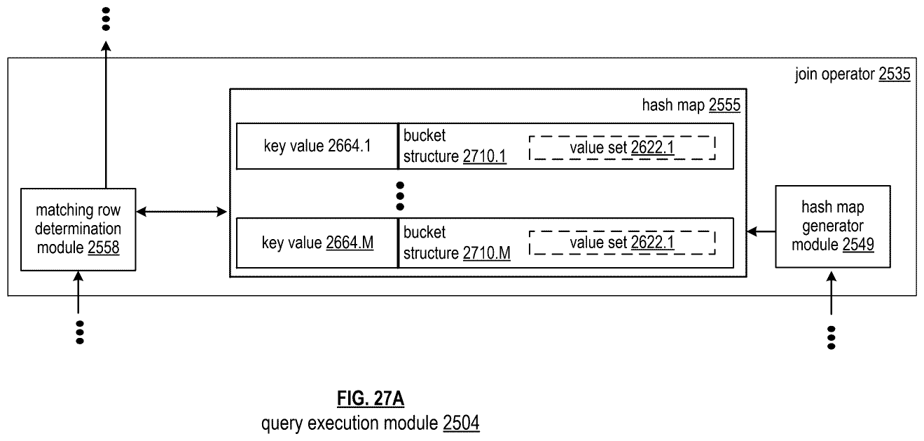

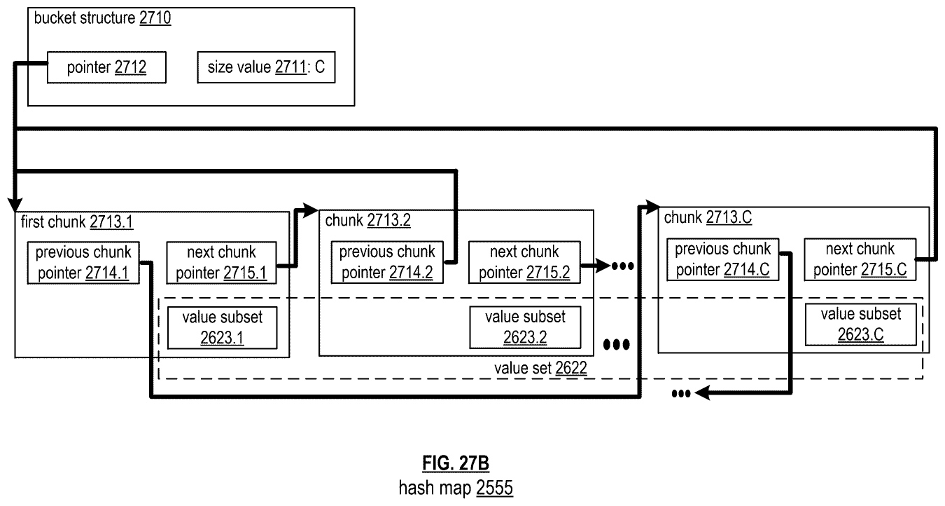

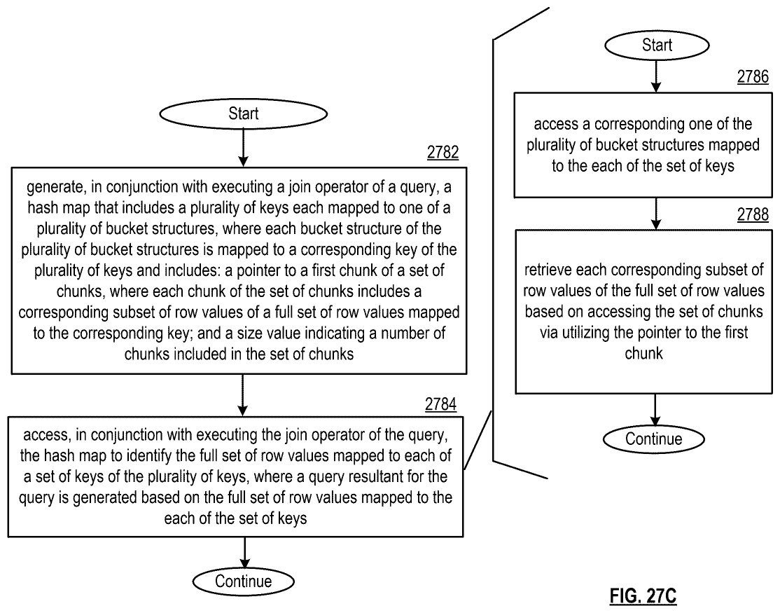

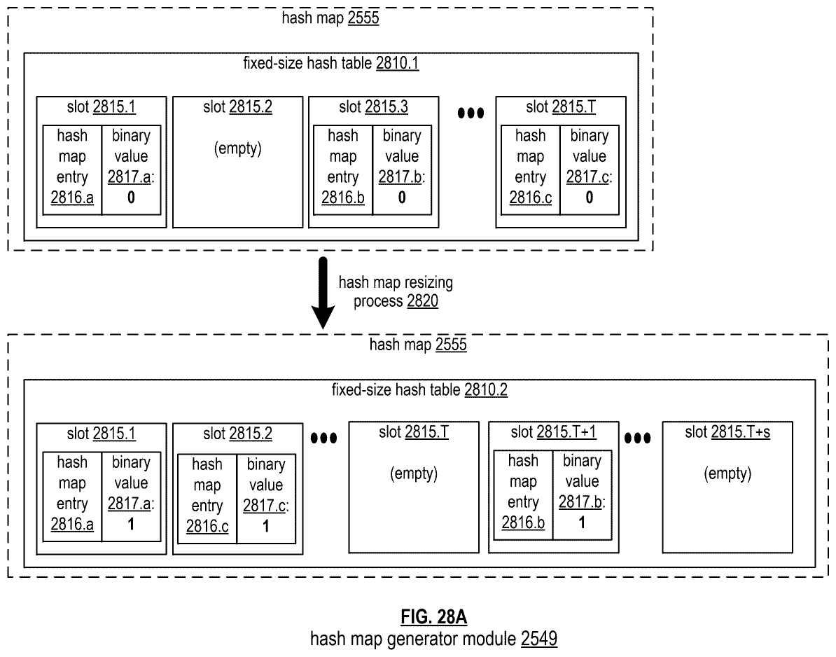

FIGS. 27A-27B present embodiments of a database system 10 that implement a hash map 2555 generated and accessed via execution of a join operator 2535 via a plurality of bucket structures 2710. Some or all features and/or functionality of FIG. 27A-27B can implement query execution module 2504 and/or hash map 2555 of FIG. 25C, any hash map and/or execution of join operators and/or corresponding join processes, and/or any embodiment of database system 10 described herein.

In some embodiments, hash join maps (e.g., hash maps 2555 generated and accessed when executing a corresponding join operator 2535) can be required to maintain a bucket of rows with equivalent hash keys for each key/value pair in the join map. In some cases, there may be a very large number of single element buckets in the case of a 1:1 or many:1 joins, and/or a single bucket may contain a very large number of rows. In some embodiments, it is also desirable to utilize huge page memory allocations for each bucket, and/or a separate memory pool with a custom allocator, for example, because a very large amount of memory may be used and/or a very large number of small allocations can be required. In some embodiments, of database system 10, a heap-allocated vector of fixed size huge-page chunks is utilized implement a deque-like data structure for join buckets. Such an implementation of hash maps 2555 can be inefficient, for example, based on it having both a large heap and huge memory overhead.

FIGS. 27A-27B present an embodiment of structuring of hash maps 2555 to render more efficient memory efficiency and/or lower overhead in generating and accessing hash maps 2555 in executing corresponding join operators (and/or other types of operators requiring generation of and access to corresponding hash maps).

As illustrated in FIG. 27A, a hash map 2555 can be populated and accessed in query execution (e.g., built from right row input and accessed to generate output based on then processing left row input as discussed previously). Some or all features and/or functionality of the hash map 2555 and/or corresponding execution of the join operator 2535 via query execution module 2504 of FIG. 27A can implement the hash map 2555 and/or corresponding execution of the join operator 2535 via query execution module 2504 of FIG. 27C and/or any embodiment of database system 10 and/or any embodiment of join execution/hash map implementation described herein.

As illustrated in FIG. 27A, the hash map 2555 can be implemented based on generating and storing a bucket structure 2710 for each key value 2644 (e.g., each right match value 2564) of a plurality of keys 2664.1-2664.M of the hash map 2555. Each bucket structure 2710 can indicate/store (e.g., across multiple locations accessible via access to the given bucket structure 2710) a value set 2662 that includes a corresponding set of values mapped to the corresponding key 2664 (e.g., the right output values 2563 mapped to the given key/given right match value 2564).

FIG. 27B illustrates an embodiment of a bucket structure 2710 for access to a corresponding value set 2622 via a plurality of value subsets 2623.1-2623.C of the value set 2622 stored across a plurality of chunks 2713.1-2713.C (e.g., stored via non-contiguous fragments of memory) accessible via access to the bucket structure 2710. Some or all features and/or functionality of the bucket structure 2710 and/or corresponding storage of value set 2622 of FIG. 27B can implement some or all bucket structures 2710 of FIG. 27A and/or can implement other hash maps/other types of key/value storage structures implemented via database system 10.

The plurality of value subsets 2623.1-2623.C can be mutually exclusive and/or collectively exhaustive with respect to the value set 2622. Note that some value subsets 2623 may store duplicates of a same value based on different ones of the set of right input rows having the given key and having this same value.

As illustrated in FIG. 27B, a given bucket structure 2710 can include a pointer 2712 denoting the memory location of a first chunk 2713.1 of the plurality of chunks (e.g., in accordance with an ordering, for example, of a corresponding circular, doubly linked list of corresponding memory fragments). The bucket structure can further include a size value 2711 set as the value C: the number of chunks 2713 for the bucket structure 2710. Different bucket structures 2710 can have different numbers of chunks (e.g., based on how many values are included in their respective value sets, where a first bucket structure 2710 for a first key mapped to more values in its value set 2622 has/points to a greater number of chunks than a second bucket structures 2710 for a second key mapped to less values in its value set 2622.

In some embodiments, bucket structure 2710 optionally stores only these two values (e.g., does not store any values of value set 2622 itself, and instead points to chunks in other memory locations storing different subsets of the value set 2622).

The values of value set 2622 can be stored across chunks 2713.1-2713.C, for example, in accordance with a circular, doubly linked list. In particular, each chunk can include a next chunk pointer 2715 pointing to the memory location of a next chunk in the ordering (e.g., implemented circularly, where the next chunk pointer 2715 for the last chunk 2713.C points to the first chunk 2713.1). Furthermore, each chunk can include a previous chunk pointer 2714 pointing to the memory location of a prior chunk in the ordering (e.g., implemented circularly, where the previous chunk pointer 2714 for the first chunk 2713.1 points to the last chunk 2713.C).

As a particular example, the bucket structure 2710 and each corresponding chunk 2713 can be structured via implementing some or all of the following logic:

$$bucket : [ size ( 8 B ) , firstChunk * ( 8 B ) ] \\ chunk : [ prevChunk * ( 8 B ) , n e x tChunk * ( 8 B ) , rowInfo\_t [ 20 ] ]$$

For example, the size value 2711 (e.g., size), pointer 2712 (e.g., firstChunk*), previous chunk pointer 2714 (e.g., prevChunk*) and/or next chunk pointer 2715 (e.g., nextChunk*) can be implemented via 8 Byte data values and/or other sized data values. The value subset 2523 (e.g., rowInfo_t[20]) can be implemented as an array having a predetermined max number of values (e.g., exactly 20 values per chunk, and/or up to 20 values per chunk, or any other predetermined number of values). The predetermined number of values can be implemented as a configured maximum number of values (e.g., configurable via user input, automatic selection via database system 10, or via another determination enabling changing of the predetermined number of values over time for different queries/different dataset/different timeframes/etc.

In some embodiments, because large joins can frequently have exactly one value per key/a small number of values per key for some or all of its keys, any bucket of size 1 optionally isn't implemented as a linked list element. For example, for such keys, only a single chunk 2713.1 is stored to include only the corresponding value subset 2623 (and not the previous chunk pointer 2714 or next chunk pointer 2715), which corresponds to all of the value set 2622 due to the value set 2622 being small (e.g., smaller than the predetermined maximum number of values), and optionally only one value. As a particular example, in the case where a key maps to exactly one value, a chunk of size of (rowlnfo_t) is stored rather than a linked list element. This can avoid both the doubly linked list overhead and/or the (configurable) 20× overallocation for bucket entries.

In some embodiments, this structure then requires two different allocations sizes, but will only make low overhead fixed size allocations, for example, where the custom allocator requires very little additional bookkeeping. The custom allocator can be scoped to a single operator instance, so it can be efficient to bulk free each huge page memory chunk when the map is cleared. The allocator can be implemented to be stateful and/or non-static, where each bucket can be required to be only modifiable by a bucket manager that contains a reference to the allocator, debugging info, and/or other state shared between all buckets.

In some embodiments, the bucket structures 2710 are specialized for hash joins and optionally support only a limited API (e.g., a corresponding API custom to the configured structuring of the bucket structures 2710). The limited API can include a set of functions which can be executed to render generation/population/modification/access to the bucket structures 2710 and their corresponding chunks 2713 (e.g., in conjunction with populating and/or accessing the corresponding hash map 2555 in executing a corresponding join operator 2535).

The set of functions of the API can include a size function e.g., “Size”. For example, size is recorded as a member of the bucket and/or is optionally implemented with O(1) complexity.

The set of functions of the API can alternatively or additionally include at least one access and/or iteration function. For example, a front function (e.g., “front( )”) is O(1) complexity as the bucket maintains a pointer to the first chunk; a back function (e.g., “back( )”) is O(1) complexity, for example, because the chunks are part of a circular list the previous chunk from the first chunk will be the last chunk. In some embodiments, random access is not supported, and/or is supported with O(N) efficiency, for example, because the linked list would have to be traversed. In some embodiments, advancing bidirectional iteration is possible where advancing is O(1) complexity. In some embodiments, only forward iteration is supported. In some embodiments, iterator must record its current element index and data pointer, then must advance its pointer to the next chunk when it reaches an element index corresponding to a chunk boundary.

The set of functions of the API can alternatively or additionally include an emplace back function (e.g., “emplace back”), enabling addition of a new chunk appended to the list (e.g., to account for adding new values for the corresponding key once the maximum threshold has been reached in the current backmost chunk as the hash map continues to be populated). For example, back( ) is O(1) complexity as described above, and emplacing the optionally value has no additional overhead. Other than when switching from a single-slot list to a linked chunk when moving from size==1 to size==2, no previous values need to be modified when adding a new value.

The set of functions of the API can alternatively or additionally include a combine function (e.g., “combine”), enabling appending one bucket a to another bucket b. This can be utilized for skipping any allocation overhead, for example based on the combined map reusing the chunks from the added bucket. This can be implemented with worst case O(N) complexity for appending a bucket of size N to a bucket of size M. For example, if bucket b's last value lies on a chunk boundary, the chunks must be linked and no values need to be moved. In some embodiments, if there is space available in b's last chunk, the values from a will all be shifted to fill the space. In some embodiments, the combine function can be implemented in in O(1) worst case complexity, for example, based on enabling destroying of the value ordering within the bucket. In such cases, any slots in b's tail chunk can be filled with values from a's tail chunk rather than shifting all values in a, rendering bounded above by the number of values allowed to be fit in a single chunk.

The set of functions of the API can alternatively or additionally include an erase function (e.g., “erase(iterator)”). For example, this can be implemented with O(1) complexity, where it partially destroys list ordering. Erasing the value at the provided iterator can include swap that value with back( ) and then potentially dropping the tail chunk. This reorders the values after the iterator, but otherwise does not break forward iteration because no values preceding the iterator are moved.

In some embodiments, alternatively or in addition to implementing the bucket structures 2710 in implementing join maps (e.g., hash map 2555), bucket structures 2710 can be implemented in secondary index building, for example, in building inverted index structures and/or other index structures stored for segments 2424 for access via query execution via index elements of an IO pipeline via some or all functionality described previously herein. For example, a same row-bucket data structuring, implemented via some or all features and/or functionality of bucket structure 2710, can be utilized to implement both hash maps 2555 utilized to execute join operations and index structures utilized to build/store index data of some or all segments 2424.

In some embodiments of building secondary index structures via bucket structures 2710, although the values-per-chunk size is configurable, the single-value bucket optimization in the case where the bucket stores only one value can be extended to more values to avoid the overhead of a full linked chunk. In some embodiments, more fixed-size allocators can be required, but are practical in allocating a span of N rowlnfo_t for a fixed set of values of N before falling back to the linked chunks. For example, consider the special case N={1, 2, 4, 8} value lists, where a direct allocation of rowlnfo_t[n] is used for the smallest n in N such thatn>=the current required size of the bucket (e.g., a bucket of 3 values would use exactly 4*sizeof(rowInfo_t) space, a bucket of 8 values would use exactly 8*sizeof(rowlnfo_t) space, and/or a bucket of 9 or more values would fall back to the linked list of chunk structure). Such implementation can add some cost to the allocations each time the fixed span grows and values must be copied to the new span, but further reduces memory overhead for small buckets where the cumulative overhead may be more significant.

FIG. 27C illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 27C, for example, based on participating in execution of a query being executed by the database system 10. Some or all of the method of FIG. 27C can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 27C based on implementing a corresponding plurality of processing core resources 48.1-48.W. Some or all of the steps of FIG. 27C can optionally be performed by any other one or more processing modules of the database system 10. Some or all of the steps of FIG. 27C can be performed to implement some or all of the functionality of the database system 10 as described in conjunction with FIGS. 27A-27B, for example, by implementing some or all of the functionality of query execution module 2504, hash map 2555, and/or bucket structure 2710. Some or all steps of FIG. 27C can be performed by database system 10 in accordance with other embodiments of the database system 10 and/or nodes 37 discussed herein. Some or all of the steps of FIG. 27C can be performed in conjunction with performing some or all steps of any other method described herein.

Step 2782 includes generating, in conjunction with executing a join operator of a query, a hash map that includes a plurality of keys each mapped to one of a plurality of bucket structures. In various examples, each bucket structure of the plurality of bucket structures is mapped to a corresponding key of the plurality of keys. In various examples, each bucket structure of the plurality of bucket structures includes a pointer to a first chunk of a set of chunks, where each chunk of the set of chunks includes a corresponding subset of row values of a full set of row values mapped to the corresponding key. In various examples, each bucket structure of the plurality of bucket structures includes a size value indicating a number of chunks included in the set of chunks.

Step 2784 includes accessing, in conjunction with executing the join operator of the query, the hash map to identify the full set of row values mapped to each of a set of keys of the plurality of keys. In various examples, a query resultant for the query is generated based on the full set of row values mapped to the each of the set of keys.

Performing step 2784 can include performing step 2786 and/or 2788. Step 2786 includes accessing a corresponding one of the plurality of bucket structures mapped to the each of the set of keys. Step 2788 includes retrieving each corresponding subset of row values of the full set of row values based on accessing the set of chunks via utilizing the pointer to the first chunk.

In various example, different ones of the set of chunks are stored via non-contiguous memory.

In various examples, the set of chunks pointed to by the pointer of each of a subset of bucket structures in the plurality of bucket structures includes a corresponding plurality of chunks. In various examples, the each chunk of the set of the set of chunks for the each of a subset of bucket structures further includes: a previous chunk pointer to a previous chunk of the set of chunks; and/or a next chunk pointer to a next chunk of the set of chunks.

In various examples, the corresponding plurality of chunks in the set of chunks pointed to by the pointer of each of a subset of bucket structures in the plurality of bucket structures is stored as a circular, doubly linked list.

In various examples, the subset of bucket structures is a first proper subset of the plurality of bucket structures. In various examples, the set of chunks pointed to by the pointer of each of a second proper subset of the plurality of bucket structures includes only the first chunk. In various examples, the first proper subset and the second proper subset are mutually exclusive and/or collectively exhaustive with respect to the plurality of bucket structures. In various examples, the first chunk of the set of the set of chunks for the each of the second proper subset of bucket structures is implemented without inclusion of the previous chunk pointer and the next chunk pointer.

In various examples, the first chunk for all bucket structures of the second proper subset are stored via less memory than the first chunk for any bucket structures of the first proper subset based on the first chunk of the set of the set of chunks for the each of the second proper subset of bucket structures being implemented without inclusion of the previous chunk pointer and the next chunk pointer.

In various examples, retrieving the each corresponding subset of row values of the full set of row values for ones of the set of keys mapped to one of the subset of bucket structures includes performing a forward progression through the set of chunks based on: utilizing the pointer to the first chunk to access the first chunk; retrieving a first subset of row values included in the first chunk; and/or after retrieving the corresponding subset of row values included in the each chunk, advancing to a next chunk of the set of chunks via the next chunk pointer based on the next chunk pointer pointing to another one of the set of chunks distinct from the first chunk.

In various examples, performing the forward progression includes advancing a number of times equal to one less than the size value to access a number of subsets of row values equal to the number of chunks.

In various examples, the set of chunks are configured to store up to a configured maximum number of row values per chunk. In various examples, every corresponding subset of row values of the full set of row values includes less than or equal to the configured maximum number of row values per chunk.

In various examples, the configured maximum number of row values per chunk is equal to twenty.

In various examples, each of a set of full chunks included in the set of chunks has exactly the configured maximum number of row values per chunk included in the corresponding subset of row values. In various examples, a number of full chunks included in the set of full chunks is equal to one of: the number of chunks included in the set of chunks, or exactly one less than the number of chunks included in the set of chunks.

In various examples, generating the hash map is based on populating the hash map based on processing a set of right input rows in conjunction with executing the join operator.

In various examples, processing each right input row of the set of right input rows is based on, when a key value for the each right input row is already mapped to a corresponding one of the plurality of bucket structures, accessing the corresponding one of the plurality of bucket structures mapped to the key value; accessing, based on utilizing the pointer to the first chunk, a last chunk of the set of chunks in an ordering of the set of chunks starting with the first chunk; when the last chunk includes less than a configured maximum number of row values per chunk in the corresponding subset of row values, adding a row value for the each right input row to the corresponding subset of row values; and, when the last chunk includes the configured maximum number of row values per chunk the corresponding subset of row values, creating a new chunk in the set of chunks, ordered after the last chunk in the ordering, and/or initializing the corresponding subset of row values of the new chunk to include the row value for the each right input row. In various examples, processing each right input row of the set of right input rows is based on, when the key value for the each right input row is already mapped to a corresponding one of the plurality of bucket structures, creating a new bucket structure of the plurality of bucket structures mapped to the key value for the each right input row based on: initializing the size value as one; and/or creating the first chunk of the set of chunks for the new bucket structure by initializing the corresponding subset of row values of the first chunk of the set of chunks for the new bucket structure to include the row value for the each right input row.

In various examples, accessing the hash map to identify the full set of row values mapped to each of a set of keys of the plurality of keys is based on processing a set of left input rows in conjunction with executing the join operator. In various examples, the set of keys correspond to all key values included in the set of left input rows.

In various examples, processing each left input row of the set of right input rows is based on, when a key value for the each left input row is mapped to a corresponding one of the plurality of bucket structures: accessing the corresponding one of the plurality of bucket structures mapped to the key value; retrieving each corresponding subset of row values of the full set of row values based on accessing the set of chunks via utilizing the pointer to the first chunk; and/or emitting an output set of rows based on, for each of the full set of row values, emitting a corresponding row of the output set of rows that includes the key value and the each of the full set of row values.

In various examples, the plurality of bucket structures are implemented in accordance with a custom application programming interface (API) configured for the plurality of bucket structures based on a set of functions that includes: a size function to access the size value; a front access function to access the first chunk; a back access function to access a last chunk in the set of chunks; an emplace back function to append a new element to the set of chunks as a new last chunk; a combine function that combines multiple bucket structures based on appending a first set of chunks for a first one of the multiple bucket structures to a second set of chunks for a second one of the multiple bucket structures; and/or an erase function that removes a chunk in the set of chunks. In various examples, generating the hash map is based on executing at least one of the set of functions to generate each of the plurality of bucket structures. In various examples, accessing the hash map is based on executing at least one of the set of functions to access at least one of the plurality of bucket structures.

In various examples, the plurality of bucket structures are implemented via a custom data structuring. In various examples, the method further includes generating an inverted index structure indexes for a plurality of rows of a segment stored by a database system based on generating a second plurality of bucket structures implemented via the custom data structuring. In various examples, each bucket structure of the second plurality of bucket structures is mapped to a corresponding index and includes, based on being implemented via the custom data structuring: the pointer to the first chunk of the set of chunks, wherein each chunk of the set of chunks includes the corresponding subset of row values of the full set of row values mapped to the corresponding index; and/or the size value indicating the number of chunks included in the set of chunks. In various examples, executing the query is further based on applying filtering conditions of the query based on accessing the inverted index structure to identify a filtered subset of the plurality of rows of the segment. In various examples, the query resultant is based on the filtered subset of the plurality of rows.

In various examples, a query operator execution flow for the query includes a plurality of hierarchical instances of a heap sort operator in conjunction with applying a hierarchical limit sort strategy. In various examples, executing the plurality of hierarchical instances of the heap sort operator in conjunction with executing the query is based on: identifying a first subset of a plurality of rows based on generating a plurality of sorted subsets from a plurality of unsorted subsets based on performing a first parallelized plurality of instances of the heap sort operator; and/or identifying a top-ordered set of rows as a second subset of the first subset based on generating a set of sorted subsets from a set of range-based subsets of the first subset of the plurality of rows based on performing a second parallelized plurality of instances of the heap sort operator. For example, the query operator execution flow is generated and/or executed in conjunction with implementing some or all features and/or functionality of FIGS. 29A-29D.

In various examples, the query is one of a set of queries. In various examples, execution of the set of queries is initiated via a plurality of parallelized processing core resources. In various examples, the method further includes, after initiating execution of set of queries and while the set of queries are concurrently being executed, performing a spill to disk process based on: spilling to disk, based on at least one of the plurality of parallelized processing core resources signaling spilling in response to determining a spill to disk condition is met, data of at least one operator the query; and/or determining when a spill to disk process end condition has been met based on tracking the ones of the plurality of parallelized processing core resources that determine the spill to disk condition is met and signal the spilling. In various examples, the spill to disk process completes based on the determining the spill to disk process end condition has been met. For example, the query executed and/or spilled to disk in conjunction with implementing some or all features and/or functionality of FIGS. 30A-30B.

In various embodiments, any one of more of the various examples listed above are implemented in conjunction with performing some or all steps of FIG. 27C. In various embodiments, any set of the various examples listed above can be implemented in tandem, for example, in conjunction with performing some or all steps of FIG. 27C, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 27C described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 27C, for example, in conjunction with further implementing any one or more of the various examples described above.

In various embodiments, the operational instructions, when executed by the at least one processor, cause the database system to generate, in conjunction with executing a join operator of a query, a hash map that includes a plurality of keys each mapped to one of a plurality of bucket structures. In various embodiments, each bucket structure of the plurality of bucket structures is mapped to a corresponding key of the plurality of keys and includes: a pointer to a first chunk of a set of chunks, wherein each chunk of the set of chunks includes a corresponding subset of row values of a full set of row values mapped to the corresponding key; and/or a size value indicating a number of chunks included in the set of chunks. In various embodiments, the operational instructions, when executed by the at least one processor, further cause the database system to access, in conjunction with executing the join operator of the query, the hash map to identify the full set of row values mapped to each of a set of keys of the plurality of keys based on: accessing a corresponding one of the plurality of bucket structures mapped to the each of the set of keys; and/or retrieving each corresponding subset of row values of the full set of row values based on accessing the set of chunks via utilizing the pointer to the first chunk. In various embodiments, a query resultant for the query is generated based on the full set of row values mapped to the each of the set of keys.

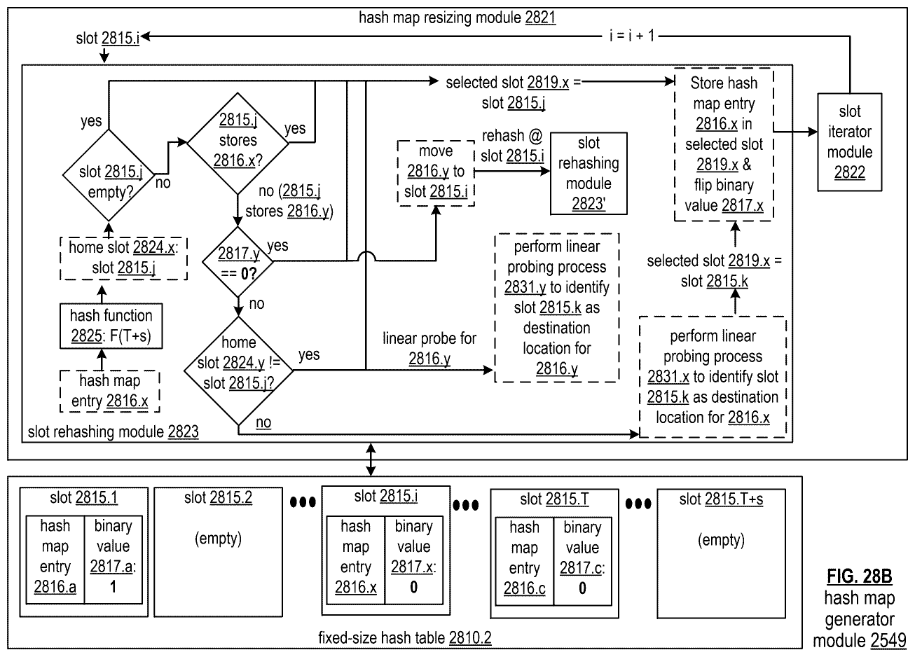

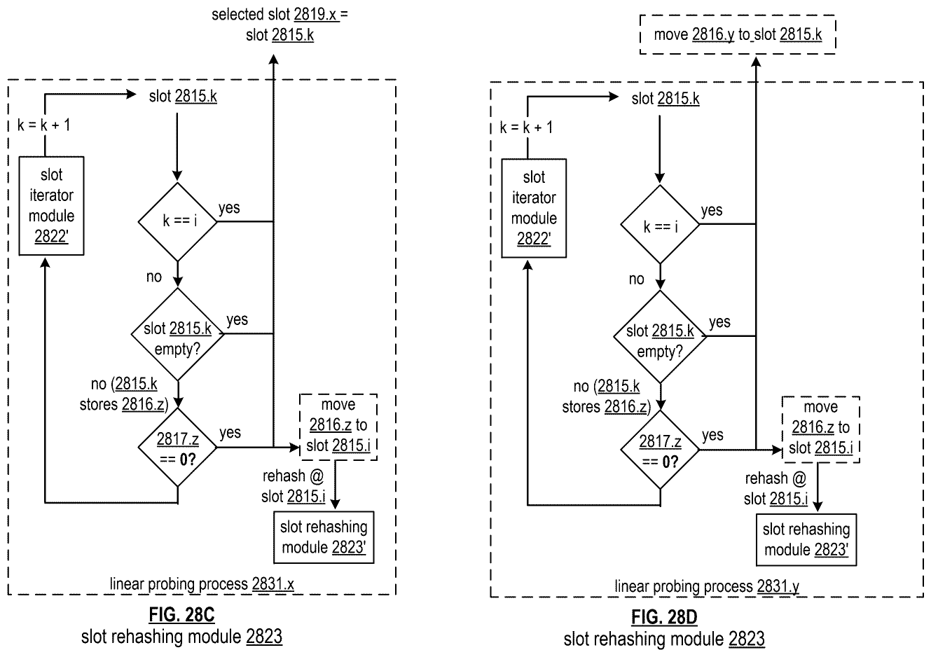

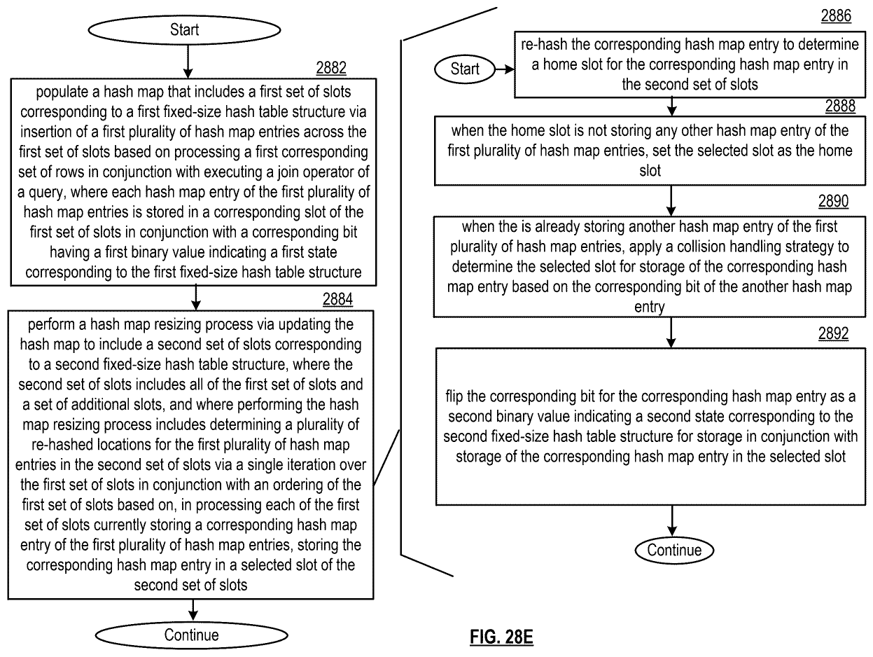

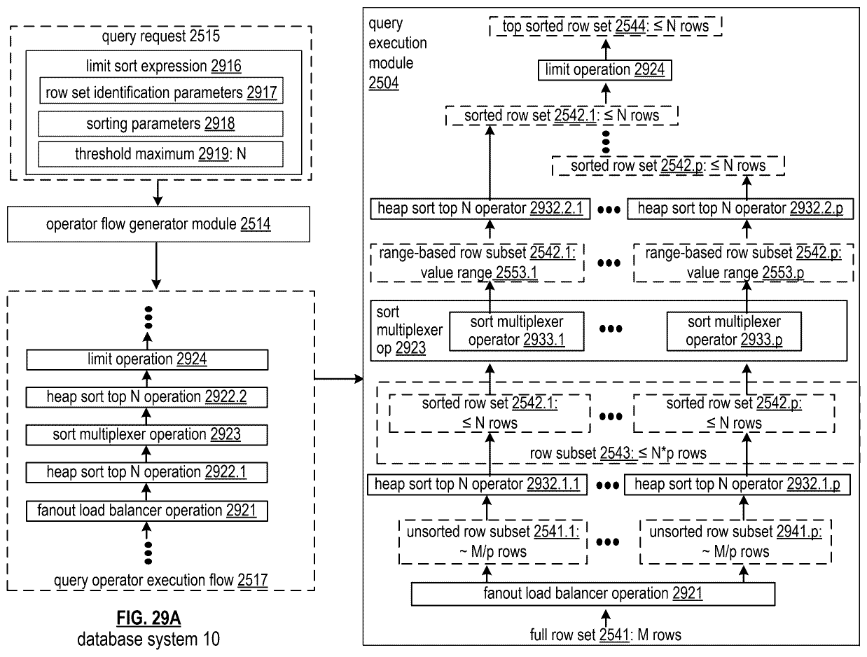

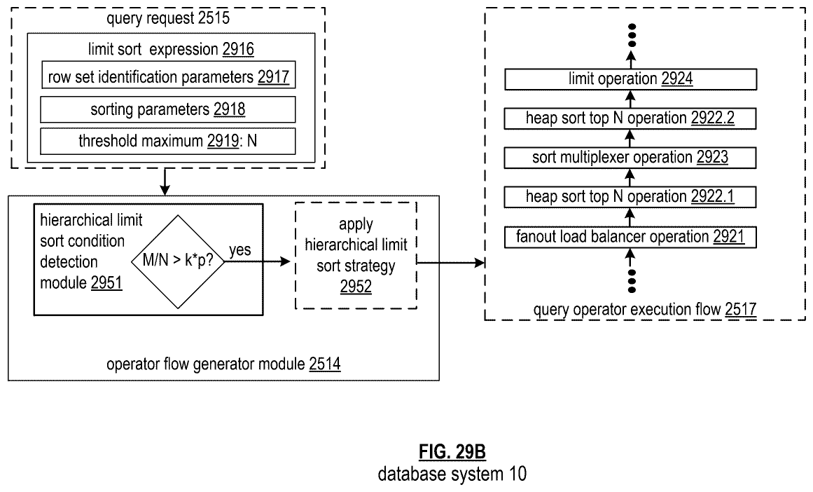

FIGS. 28A-28D illustrate embodiments of a database system 10 that implements a hash map generator module 2549 (e.g., in conjunction with executing a corresponding a join operator, aggregation operator, union distinct operator, other set operator, and/or other operator) that performs a hash map resizing process to resize hash map 2555, for example, as part of generating/populating the hash map 2555. Some or all features and/or functionality of FIGS. 28A-28D can implement any embodiment of hash map generator module 2549, hash map 2555, and/or execution of any join operator, aggregation operator, union distinct operator, other set operator, and/or other operator building a corresponding hash map 2555 as part of its execution. Some or all features and/or functionality of FIGS. 28A-28D can implement any embodiment of database system 10 described herein.

In some embodiments, the hash map 2555 is implemented via a hash table implementation back by fragmented huge page memory. The backing hash table for operations executed in conjunction with query executions described herein (e.g., equijoins, grouped aggregations, set operators, SQL operations, etc.) can easily become a very large memory sink. It can be ideal to handle as many large allocations as possible, for example with, Linux huge pages, and/or other memory implemented via fixed regions of contiguous memory. In some embodiments, the corresponding memory (e.g., the huge pages) can be further fragmented (e.g., to 128KiB), for example, enabling operators (e.g., SQL operators or other operators 2520 implemented via corresponding operator execution modules 3215) to use these fragments for some or all corresponding operations. This can constrain the hash table implementation to work with fixed size fragments of memory, for example, rather than a large array or vector of contiguous “slots”. For example, the corresponding hash map 2555 can be implemented via a mix of open addressing chaining for collision resolution. As used herein, the “home slot” in a table t for an element x can refer to the slot with an index equal to hash(x) mod N, where N corresponds to the size of the corresponding table t (e.g., number of memory fragments, equal to and/or an increasing function of a fixed number of slots of the table). Every occupied slot in table t can be implemented to maintain an intrusive, circular, doubly linked list of any other occupied slots with an equivalent home slot. If an inserted element collides with an element that's in its home slot, the inserted element can be added to any open slot with linear probing. If an inserted element x collides with an element y that's not in its home slot, then y be displaced to an open slot, and x will be added to its home slot.

One algorithm for resizing a hash table t of size N can include allocating new space for a new table t′ of size N′, for example, where N′=N+k and where k is some positive integer (e.g., k=N, where N′=2N). The algorithm for resizing can further include iterating through table t, inserting every element into new table t′, and discarding the prior table t. This can require significant memory (e.g., memory involved must be at least 3N in the case where N′=2N) because both the old and new table must remain in memory at the same time. For hash tables backing large join maps etc. that may require tens or potentially hundreds of GiBs of memory, the N+k allocation of new memory fragments on top of the existing N memory fragments of the current table could conceivably fail even if there is enough capacity for the final table of size N+k.

In some embodiments, such extra allocation overhead during table resizing and corresponding rehashing can be reduced based on reusing the original N memory fragments. This reuse of the original N memory fragments can be implemented based on leveraging configuration of the table implementing hash map 2555 having no constraints requiring the underlying memory be contiguous. FIGS. 28A-28D present embodiments of implementing such means of resizing a hash table (e.g., that implements hash map 2555) via reusing the original N memory fragments of the current table during the resizing.

FIG. 28A presents an embodiment of a hash map resizing process 2820 performed via hash map generator module 2549 to resize hash map 2555 from a first fixed-size hash table 2810.1 (e.g., table t), having a first size T based on having a set of T slots 2815.1-2815.T, to a second fixed-size hash table 2810.2 (e.g., table t′) having a second size T+s based on having a set of T+s slots 2815.1-2815.T+s. In particular, all of the T slots 2815.1-2815.T of table 2810.1 are reused and thus included in the hash table 2810.2, in addition to the s additional slots 2815.T+1-2815.T+s added to the table. Some or all features and/or functionality of the hash map generator module 2549 of FIG. 28A can implement any embodiment of hash map generator module 2549 and/or database system 10 described herein.

For example, the first number of slots T is equal to and/or is an increasing function of the number of memory fragments N implementing the first fixed-size hash table 2810, and/or the second number of slots T+s is equal to and/or is an increasing function of the number of memory fragments N′ implementing the second fixed-size hash table 2810, where s is equal to and/or an increasing function of the k additional memory fragments added to the table (e.g., s is equal to T).

As illustrated in FIG. 28A, each slot 2815 having a corresponding hash map entry 2816 (e.g., not “empty”) can have corresponding binary value 2817 mapped to the corresponding entry. These binary values 2817 can be utilized to enable the in-place resizing of the hash table via the reuse of the slots 2815.1-2815.T of the fixed-size hash table 2810.1 while ensuring that all entries 2816 of the prior table 2810.1 are rehashed appropriately in the updated table 2810.2. In particular, the binary values are utilized to implement proper handling of hash collisions occurring during rehashing of entries 2816 in conjunction with performing the resizing process. This can be a useful means of reducing memory cost in resizing while having little increase to memory and computational costs associated with resizing and maintaining the hash map 2555: the cost of this additional bookkeeping can be computationally trivial during normal hash table operations while only requiring additional bit of information per slot value, and/or additional logic required to handle collisions as a further function of binary values 2817 can be relatively inexpensive in implementing rehashing when resizing the table.

For example, the binary values 2817 can be considered “color” bits added to each slot element (e.g., each entry 2816), where the value of each bit indicates the “color” state of the corresponding table (e.g., the value 0 corresponds to black and the value 1 corresponds to red). Every element added to the table during normal operation will be assigned to the table's current color. When the table resizes, it can flip its current color bit. For example, a table t may look like {x(black), y(black)}, then when z is added and the table resizes as table t′, it will be {z(red), <empty slot>, y(red), x(red)}, for example, where y and x are in new locations due the rehashing (e.g., the hash function is a function of the number of slots of the table, for example, based on applying the modulo operation to the number of slots in the current table to dictate which index is the home slot for the corresponding entry, based on the slots having corresponding ordered indexes (e.g., 1−T, or optionally 0−T−1).

As illustrated in the example of FIG. 28A, the fixed-size hash table 2810.1 has a set of hash map entries 2816 that include a first hash map entry 2816.a in slot 2815.1, hash map entry 2815.b in slot 2815.3, and hash map entry 2816.c in slot 2815.T. All hash map entries in table 2810.1, prior to the hash map resizing process 2820, have binary values of 2817 set as 0 based on the value 0 corresponding to the table state of fixed-size hash table 2810.1 (e.g., based on the fixed-size hash table 2810.1 being designated as “black”). All of the set of hash map entries 2816 are maintained in the fixed-size hash table 2810.2 after the resizing process 2810 (e.g., where some or all entries are in new locations due to the corresponding rehashing) and have corresponding binary values 2817 all set as 1 based on the value 1 corresponding to the table state of fixed-size hash table 2810.2 (e.g., based on the fixed-size hash table 2810.1 being designated as “black”). The table state can set as opposite that of the prior table, where the hash map resizing process 2820 thus renders flipping of all binary values 2817 accordingly.

For example, in the hashing of fixed-size hash table 2810.1 (e.g., performed via applying mod T or otherwise being a function of T), hash map entry 2816.a hashes to the value one (or zero if zero-indexing is implemented), or hashes to a different home slot that was already occupied when hash map entry 2816.a was added via another entry having this home slot; hash map entry 2816.b hashes to the value three (or two if zero-indexing is implemented), or hashes to a different home slot that was already occupied when hash map entry 2816.b was added via another entry having this home slot; and/or hash map entry 2816.c hashes to the value T (or T−1 if zero-indexing is implemented), or hashes to a different home slot that was already occupied when hash map entry 2816.c was added via another entry having this home slot. One or more slots of fixed-size hash table 2810.1 may be unoccupied, such as at least slot 2815.2 in this example (e.g., none of the entries have this home slot, and were also not added to this slot in the case where their home slot was unavailable).

Continuing with this example, in the hashing of fixed-size hash table 2810.2 (e.g., performed via applying mod T+s or otherwise being a function of T+s), hash map entry 2816.a hashes to the value one (or zero if zero-indexing is implemented), or hashes to a different home slot that was already occupied when hash map entry 2816.a was rehashed via another entry having this home slot; hash map entry 2816.c hashes to the value two (or one if zero-indexing is implemented), or hashes to a different home slot that was already occupied when hash map entry 2816.c was rehashed via another entry having this home slot; and/or hash map entry 2816.b hashes to the value T+1 (or T if zero-indexing is implemented), or hashes to a different home slot that was already occupied when hash map entry 2816.c was added via another entry having this home slot. One or more slots of fixed-size hash table 2810.2 may be unoccupied, which can be different slots from those of fixed-size hash table 2810 that were unoccupied. In this example, at least slot 2815.T is unoccupied in fixed-size hash table 2810.2 after the resizing (e.g., none of the entries have this home slot, and were also not added to this slot in the case where their home slot was unavailable), and slot 2815.2 is no longer empty.

While not illustrated, after the resizing being complete, new elements can be added to the new hash table 2810.2. For example, some new entries are added to empty slots based on being their home slots or based on their home slot being occupied by another element having this same home slot. Other new elements may be added to slots already occupied based on these occupied slots being their home slots, for example, if not occupied by another entry in its home slot due to this other entry's home slot being occupied by an entry in its own home slot, where such other entries are optionally added to these empty slots to allow the such new elements to occupy their respective home slot.

The resizing process 2820 may be performed multiple additional times as necessary to accommodate the number of incoming new elements to be added. The table state can flip from 1 to 0, or vice versa, accordingly (e.g., from black designation to red designation, or vice versa, accordingly) with each respective resizing in this fashion.

While resizing and switching from black to red, special handling can be configured to enable proper handling any collisions between an element being reinserted and a black element that is waiting to be processed/reinserted. For example, every time reinsertion of an entry renders collision with a black value, its destination is controlled such that the map can be rehashed in a single, forward pass (e.g., starting from slot 2815.1 and ending with slot 2815.T, rehashing each respective entry accordingly if the slot is non-empty). For example, if rehashing of a given slot i renders collision with a black value in slot j in any case during placement, the value of slot j is moved to slot i, and the value in slot i is immediately rehashed again. This can guarantee that exactly one forward pass from [0, N) (e.g., from slot 2815.1 to 2815.T) is made to rehash a map with N original slots, for example, based on enforcing the requirement that a black value may never be moved to some slot j<i while rehashing slot i.

Such a single forward pass of performing the rehashing is illustrated in FIG. 28B, which presents an embodiment of a hash map generator module 2549 that implements a hash map resizing module 2821, for example, to perform hash map resizing process 2820 of FIG. 28A. Some or all features and/or functionality of the hash map generator module 2549 of FIG. 28B can implement the hash map generator module 2549 of FIG. 28A and/or any embodiment of hash map generator module 2549 and/or database system 10 described herein.

Hash map resizing module 2821 can implement a slot processing module that processes slots 2815.1-2815.T of table 2810.1 one at a time (e.g., after the additional slots 2815.T+1-2815.T+s are allocated/available for insertion of entries in conjunction with rehashing). Processing a given slot 2815.i can include (e.g., if this slot 2815.i has a corresponding entry 2815.x and/or if the corresponding entry is designated as black via binary value 2817 due to not having already been rehashed to slot 2815.i, where the slot 2815.i is optionally skipped if one of these cases is detected) determining location for the corresponding entry 2815.x in the updated table 2810.2. This can include first determining a new home slot 2824.x for the given entry 2816.x as some slot 2815.j based on performing the corresponding hash function F for the new table (e.g., where F is also a function of the number of slots T+s of the new table 2810.2, for example, via applying mod T+s rather than mod T to the value generated via a corresponding deterministic hash function, which is optionally otherwise the same for both tables). A selected slot 2819.x is determined for the given entry 2816.x, for example based on applying collision handling to the new home slot 2824.x as needed. The given entry 2816.x can be stored in the selected slot 2819.x and the corresponding binary value 2817.x for entry 2817.x can be flipped accordingly (e.g., marked as red in the case of resizing from a black table to a red table) to denote this element has already been rehashed to its new location, as opposed to other elements that may be encountered that have not yet been rehashed. This designation can be important in handling collisions, as encountering black vs. red entries in collisions are handled differently to enable the proper rehashing via the single pass through the table. This storing of map entry 2816.i in its selected slot 2819.x (e.g., moving to a new location or maintaining storage in its given location) and corresponding flipping of binary value 2817.x can render completion of processing slot 2815.i in the forward pass, where the process is repeated for slot 2815.i+1, for example, in accordance with iterating through the table via a slot iterator module 2822.

In some embodiments, all scenarios for collisions during rehashing of a given entry 2816.x in slot 2815.i have corresponding rules associated with how they are handled to render appropriate rehashing via this single pass based on leveraging the binary values 2817. The identification and handling of such scenarios is as follows (and is optionally implemented via a slot rehashing module 2823 in processing the given slot 2815.i, for example, via the corresponding flow implemented via slot rehashing module 2823 as illustrated in FIG. 28B.

Consider scenario 1: the new home slot 2824.x of 2816.x is unoccupied (e.g., slot 2815.j is empty). In handling this scenario, the selected slot 2819.x is set as slot 2815.j corresponding to the new home slot of 2816.x, where the entry 2816.x at 2815.i is moved to its new home slot and marked as red to designate it has been rehashed in accordance with the new table. Rehashing continues with slot 2815.i+1.

Consider scenario 2: the new home slot 2824.x of 2816.x is the same as the old home slot of 2816.x (e.g., slot 2815.j already stores 2816.x, where j is equal to i). In handling this scenario, the entry 2816.x at 2815.i remains in its current slot 2815.i, and is thus simply marked as red to designate it has been rehashed in accordance with the new table (e.g., the selected slot 2819.x is set as slot 2815.i corresponding to the current location of entry 2816.x, for example, based on home slot 2824.x being this slot 2815.i). Rehashing continues with slot 2815.i+1.

Consider scenario 3: the new home slot 2824.x stores an entry 2816.y, different from 2816.x and containing a black value (e.g., 2817.y is equal to 0). In handling this scenario, the values between 2815.i and 2815.j are swapped (e.g., selected slot 2819.x is slot 2815.j and entry 2816.x is moved to slot 2815.j, while entry 2816.y is moved to slot 2815.i, and slot 2815.i is rehashed again via reapplying slot rehashing module 2823 as slot rehashing module 2823′ within the slot rehashing module 2823 to rehash entry 2816.y and select the appropriate location for entry 2816.y accordingly, for example, via applying this same flow to entry 2816.y as 2816.x in rehashing slot 2815.i). This can be based on the fact that entry 2916.y has the black value, indicating that it hasn't yet been rehashed already via a prior iteration of slot rehashing module. Rehashing then continues with slot 2815.i+1.

Consider scenario 4: the new home slot 2824.x of entry 2816.x contains a red element that is in its home slot (e.g., slot 2815.j stores an entry 2816.y having home slot 2824.y that is slot 2815.j, and binary value 2817.y is equal to 1). This scenario can be handled similarly to a “normal” collision encountered via insertion of a new element to the table as discussed previously, for example, due to the entry 2816.y having already been rehashed as denoted by its red designation (e.g., via having been moved from a slot 2815 before 2815.i that was thus processed before slot 2815.i in accordance with the single, forward pass over the table. In handling this scenario, the slot rehashing module can linearly probe for a new slot for the entry 2816.x at slot 2815.i and add it to the entry 2816.y at 2815.i's chain (e.g., the corresponding linked list structure or other structuring pointing to/denoting all slots storing entries 2816 having this same home slot 2824.x). Rehashing then continues with slot 2815.i+1.

This handling of scenario 4 can include performing a linear probing process 2831.x to identify a corresponding slot 2815.k as the destination location for entry 2816.x, for example, as illustrated in FIG. 28C. This can include performing linear probing, which can include evaluating each slot 2815.k one at a time and advancing to the next slot 2815.k+1 (e.g., via applying a slot iterator module 2822′ within the slot rehashing module 2823 in implementing the linear probing process 2831.x to advance the index k of slots, for example, starting from slot 2815.i+1, and wrapping from slot 2815.T to slot 2815.1 if necessary) until the given slot 2815.k meets one of a set of conditions for storing entry 2816.x: being empty, being slot 2815.i and thus storing the entry 2816.x already, or storing a black element. When the given slot 2815.k meets one of these conditions, slot 2815.k selected as selected slot 2819.x, binary value 2817.x is flipped accordingly, and rehashing via rehashing module 2823 continues with slot 2815.i+1.

For example, while probing, if slot 2815.k is empty, entry 2816.x is moved to slot 2815k, is marked as red, and rehashing continues. If, while probing, entry 2816.x is encountered before an empty slot or a slot containing a black element (e.g., slot 2815.k is slot 2815.i; k is equal to i, for example, reached last in the probing process due to starting forward advancement from k=i+1), 2816.x is marked as red and rehashing continues (e.g., slot 2815.k selected as selected slot 2819.x and binary value 2817.x is flipped accordingly). If, while probing, a black element is encountered (e.g., slot 2815.k stores an entry 2816.z having binary value 2817.1 set as black, for example, due to not yet having been rehashed), the entries 2816.x and 2816.z are swapped (e.g., selected slot 2819.x is slot 2815.k and entry 2816.x is moved to slot 2815k, while entry 2816.z is moved to slot 2815.i, and slot 2815.i is rehashed again via reapplying slot rehashing module 2823 as slot rehashing module 2823′ within the slot rehashing module 2823 to rehash entry 2816.z and select the appropriate location for entry 2816.z accordingly, for example, via applying this same flow to entry 2816.z as 2816.x in rehashing slot 2815.i). Note that any slots 2815 containing red entries are ignored during probing as the respective entries were already rehashed—only values not yet rehashed are candidates for swapping, if encountered before encountering an empty slot or the given slot 2815.i itself.

Consider scenario 5: the new home slot 2824.x of entry 2816.x contains a red element that is not in its home slot (e.g., slot 2815.j stores an entry 2816.y having home slot 2824.y that is different from slot 2815.j, and binary value 2817.y is equal to 1). This scenario can be handled similarly to a “normal” collision encountered via insertion of a new element to the table as discussed previously, for example, due to the entry 2816.y having already been rehashed as denoted by its red designation (e.g., via having been moved from a slot 2815 before 2815.i that was thus processed before slot 2815.i in accordance with the single, forward pass over the table. In handling this scenario, the slot rehashing module can linearly probe for a new slot into which to move the entry 2816.y at slot 2815.j. Rehashing continues with slot 2815.i+1.

This handling of scenario 5 can include performing a linear probing process 2831.y to identify a corresponding slot 2815.k as the destination location for entry 2816.y, for example, as illustrated in FIG. 28D. This can include performing linear probing, which can include evaluating each slot 2815.k one at a time and advancing to the next slot 2815.k+1 (e.g., via applying a slot iterator module 2822′ within the slot rehashing module 2823 in implementing the linear probing process 2831.y to advance the index k of slots, for example, starting from slot 2815.j, and wrapping from slot 2815.T to slot 2815.1 if necessary) until the given slot 2815.k meets one of a set of conditions for storing entry 2816: being empty, being slot 2815.i, or storing a black element. When the given slot 2815.k meets one of these conditions, entry 2816.y is moved to slot 2815k, and rehashing via rehashing module 2823 continues with slot 2815.i+1. As binary value 2817.y is already designated as red as required in meeting condition 5, binary value 2817.y is thus not reflipped.

For example, while probing, if slot 2815k is empty, entry 2816.y is moved to slot 2815.k and rehashing continues. If, while probing, entry 2816.x is encountered before an empty slot or a slot containing a black element (e.g., slot 2815.k is slot 2815.i; k is equal to i), the entries 2816.x and 2816.y are swapped (e.g., 2816.y is moved to slot 2815.i, entry 2816.x is moved to slot 2815.j and is marked as red, and rehashing continues with slot 2815.i+1, for example, as entry 2816.y is already marked as red and does not require rehashing at slot 2815.i). If, while probing, a black element is encountered (e.g., slot 2815.k stores an entry 2816.z having binary value 2817.1 set as black, for example, due to not yet having been rehashed): the entry 2816.y at slot 2815.j is moved to slot 2815.k; the entry 2816.x at slot 2815.i is moved to slot 2815.j and marked as red; the entry 2816.z is moved to slot 2815.i and slot 2815.i is rehashed again (e.g., via reapplying slot rehashing module 2823 as slot rehashing module 2823′ within the slot rehashing module 2823 to rehash entry 2816.z and select the appropriate location for entry 2816.z accordingly, for example, via applying this same flow to entry 2816.z as 2816.x in rehashing slot 2815.i).

FIG. 28E illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 28E, for example, based on participating in execution of a query being executed by the database system 10. Some or all of the method of FIG. 28E can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 28E based on implementing a corresponding plurality of processing core resources 48.1-48.W. Some or all of the steps of FIG. 28E can optionally be performed by any other one or more processing modules of the database system 10. Some or all of the steps of FIG. 28E can be performed to implement some or all of the functionality of the database system 10 as described in conjunction with FIGS. 28A-28D, for example, by implementing some or all of the functionality of hash map resizing process 2820, hash map resizing module 2821, and/or hash map 2555. Some or all steps of FIG. 28E can be performed by database system 10 in accordance with other embodiments of the database system 10 and/or nodes 37 discussed herein. Some or all of the steps of FIG. 28E can be performed in conjunction with performing some or all steps of any other method described herein.

Step 2882 includes populating a hash map that includes a first set of slots corresponding to a first fixed-size hash table structure via insertion of a first plurality of hash map entries across the first set of slots based on processing a first corresponding set of rows in conjunction with executing a join operator of a query. In various examples, each hash map entry of the first plurality of hash map entries is stored in a corresponding slot of the first set of slots in conjunction with a corresponding bit having a first binary value indicating a first state corresponding to the first fixed-size hash table structure.

Step 2884 includes performing a hash map resizing process via updating the hash map to include a second set of slots corresponding to a second fixed-size hash table structure. In various examples, the second set of slots includes all of the first set of slots and a set of additional slots. In various examples, performing the hash map resizing process includes determining a plurality of re-hashed locations for the first plurality of hash map entries in the second set of slots via a single iteration over the first set of slots in conjunction with an ordering of the first set of slots. In various examples, determining the plurality of re-hashed locations for the first plurality of hash map entries in the second set of slots via the single iteration over the first set of slots in conjunction with the ordering of the first set of slots is based on, in processing each of the first set of slots currently storing a corresponding hash map entry of the first plurality of hash map entries, storing the corresponding hash map entry in a selected slot of the second set of slots.

Performing step 2884 can include performing some or all of steps 2886-2892. In various examples, in processing each of the first set of slots currently storing the corresponding hash map entry of the first plurality of hash map entries, storing the corresponding hash map entry in a selected slot of the second set of slots is based on performing some or all of steps 2886-2892 for the corresponding hash map entry of the each of the first set of slots.

Step 2886 includes re-hashing the corresponding hash map entry to determine a home slot for the corresponding hash map entry in the second set of slots. Step 2888 includes, when the home slot is not storing any other hash map entry of the first plurality of hash map entries, setting the selected slot as the home slot. Step 2890 includes, when thehome slot is already storing another hash map entry of the first plurality of hash map entries, applying a collision handling strategy to determine the selected slot for storage of the corresponding hash map entry based on the corresponding bit of the another hash map entry. Step 2892 includes flipping the corresponding bit for the corresponding hash map entry as a second binary value indicating a second state corresponding to the second fixed-size hash table structure for storage in conjunction with storage of the corresponding hash map entry in the selected slot.

In various examples, a query resultant is generated for the query based on join output generated via further execution of the join operator via accessing the hash map after performance of the hash map resizing process.

In various examples, the corresponding bit for all of the first plurality of hash map entries has the second binary value indicating the second state corresponding to the second fixed-size hash table structure after the single iteration over the first set of slots is complete based on flipping the corresponding bit for the corresponding hash map entry.

In various examples, the first set of slots are implemented via a plurality of non-contiguous memory fragments.

In various examples, a plurality of keys of the first plurality of hash map entries are utilized to determine ones of the first set of slots storing the first plurality of hash map entries. In various examples, the plurality of keys includes a first plurality of sets of colliding keys in accordance with first hash collisions of a first hash function corresponding to the first fixed-size hash table structure. In various examples, a corresponding set of hash map entries of the first plurality of hash map entries corresponding to each set of colliding keys in the first plurality of sets of colliding keys are stored via a set of different slots of the first set of slots, for example, that includes: a corresponding home slot for all of the each set of colliding keys in accordance with the first hash function, wherein the corresponding home slot stores only one hash map entry of the corresponding set of hash map entries; and/or a set of other slots that each stores a corresponding other hash map entry of the corresponding set of hash map entries. In various examples, all of the set of different slots are included in a same doubly linked list based on storing the corresponding set of hash map entries corresponding to the each set of colliding keys.

In various examples, the plurality of keys includes a plurality of second sets of colliding keys in accordance with second hash collisions of a second hash function corresponding to the second fixed-size hash table structure. In various examples, at least one second set of colliding keys of the plurality of second sets of colliding keys is different from any of the first plurality of sets of colliding keys based on the second hash function being different from the first hash function. In various examples, a corresponding second set of hash map entries of the first plurality of hash map entries corresponding to each second set of colliding keys in the plurality of second sets of colliding keys are stored via a set of second different slots of the second set of slots, for example, that includes: a second home slot for all of the each set of colliding keys in accordance with the second hash function, wherein the second home slot stores only one hash map entry of the corresponding second set of hash map entries; and/or a set of other slots that each stores a corresponding other hash map entry of the corresponding second set of hash map entries. In various examples, all of the set of second different slots are included in a second same doubly linked list based on storing the corresponding second set of hash map entries corresponding to the each second set of colliding keys.

In various examples, the first hash function is based on a first number of slots included in the first set of slots. In various examples, the second hash function is based on a second number of slots included in the second set of slots In various examples, the second number is strictly greater than the first number.

In various examples, the selected slot is set as the home slot when one of: the corresponding hash map entry is already stored in the home slot in conjunction with its storage via the first fixed-size hash table structure based on the home slot being included in the first set of slots; or the home slot is empty when the a current slot storing the corresponding hash map entry is processed in conjunction with performing the single iteration over the first set of slots. In various examples, storing the corresponding hash map entry via the selected slot includes moving the corresponding hash map entry from the current slot to the home slot. In various examples, the current slot becomes empty prior to processing a next one of the first set of slots based on moving the corresponding hash map entry from the current slot to the home slot.

In various examples, processing the each of the first set of slots is based on: identifying the selected slot for the corresponding hash map entry despite the selected slot already storing a different hash map entry based on the corresponding bit of the different hash map entry having the first binary value; and/or, based on the different hash map entry having the first binary value, swapping slot locations of the corresponding hash map entry and the another hash map entry, wherein processing each of the first set of slots further includes, after storing the different hash map entry in the each of the first set of slots via swapping the slot locations storing the different hash map entry in a second selected slot of the second set of slots. In various examples, the different hash map entry is the another hash map entry. In various examples, the different hash map entry is distinct from the another hash map entry.

In various examples, applying the collision handling strategy to determine the selected slot for storage of the corresponding hash map entry is based on, when the corresponding bit of the another hash map entry has the first binary value, setting selected slot as the home slot based on swapping slot locations of the corresponding hash map entry and the another hash map entry. In various examples, processing each of the first set of slots further includes, after storing the another hash map entry in the each of the first set of slots via swapping the slot locations, storing the another hash map entry in another selected slot of the second set of slots, for example, based on: re-hashing the another hash map entry to determine another home slot for the another hash map entry in the second set of slots; when the another home slot is not storing any other hash map entry of the first plurality of hash map entries, setting the selected slot as the home slot; when the another home slot is already storing a second other hash map entry of the first plurality of hash map entries, applying the collision handling strategy to determine the another selected slot for storage of the another hash map entry based on the corresponding bit of the second other hash map entry; and/or flipping the corresponding bit for the another hash map entry for storage in conjunction with storage of the another hash map entry in the another selected slot.

In various examples, applying the collision handling strategy to determine the selected slot for storage of the corresponding hash map entry is based on, when the corresponding bit of the another hash map entry has a second binary value different from the first binary value and the another hash map entry is stored in a corresponding home slot of the another hash map entry in the second set of data slots, the selected slot is determined via performing linear probing. In various examples, selected slot is included in a doubly linked list that includes the home slot.

In various examples, performing the linear probing includes iterating over the first set of slots in accordance with the ordering and identifying the selected slot as a first identified slot meeting one of a set corresponding selected slot criteria, for example, that includes: the selected slot being empty; the corresponding bit of a second other hash map entry stored in the selected slot having the first binary value; and/or the selected slot being the each of the first set of slots already storing the corresponding hash map entry.

In various examples, when the selected slot is identified based on the corresponding bit of the second other hash map entry stored in the selected slot having the first binary value, storing the corresponding hash map entry in the selected slot includes swapping slot locations of the corresponding hash map entry and the second other hash map entry. In various examples, processing each of the first set of slots further includes, after storing the second other hash map entry in the each of the first set of slots via swapping the slot locations, storing the second other hash map entry in another selected slot of the second set of slots based on: re-hashing the second other hash map entry to determine another home slot for the second other hash map entry in the second set of slots; when the another home slot is not storing any other hash map entry of the first plurality of hash map entries, setting the another selected slot as the home slot; when the another home slot is already storing a third other hash map entry of the first plurality of hash map entries, applying the collision handling strategy to determine the another selected slot for storage of the second other hash map entry based on the corresponding bit of the third other hash map entry; and/or flipping the corresponding bit for the second other hash map entry for storage in conjunction with storage of the another hash map entry in the another selected slot.

In various examples, applying the collision handling strategy to determine the selected slot for storage of the corresponding hash map entry is based on, when the corresponding bit of the another hash map entry has the second binary value and the another hash map entry is not stored in a corresponding home slot of the another hash map entry in the second set of data slots: setting the selected slot as the home slot; and/or identifying a second selected slot for the another hash map entry based on performing linear probing. In various examples, the second selected slot is included in a doubly linked list that includes the corresponding home slot.

In various examples, performing the linear probing includes iterating over the first set of slots in accordance with the ordering and identifying the second selected slot as a first identified slot meeting one of a set corresponding selected slot criteria, for example, that includes: the selected slot being empty; the corresponding bit of a second other hash map entry stored in the second selected slot having the first binary value; or the second selected slot being the each of the first set of slots already storing the corresponding hash map entry.

In various examples, when the second selected slot is identified based on the corresponding bit of the second other hash map entry stored in the second selected slot having the first binary value, storing the another hash map entry in the second selected slot includes storing the another hash map entry in the second selected slot based on moving the second other hash map entry to the each of the first set of slots. In various examples, processing each of the first set of slots further includes, after storing the second other hash map entry in the each of the first set of slots, storing the second other hash map entry in another selected slot of the second set of slots based on: re-hashing the second other hash map entry to determine another home slot for the second other hash map entry in the second set of slots; when the another home slot is not storing any other hash map entry of the first plurality of hash map entries, setting the another selected slot as the home slot; when the another home slot is already storing a third other hash map entry of the first plurality of hash map entries, applying the collision handling strategy to determine the another selected slot for storage of the second other hash map entry based on the corresponding bit of the third other hash map entry; and/or flipping the corresponding bit for the second other hash map entry for storage in conjunction with storage of the another hash map entry in the another selected slot.

In various examples, the method further includes, after performing the hash map resizing process, further populating the hash map that includes the second set of slots corresponding to the second fixed-size hash table structure via insertion of a second plurality of hash map entries across the second set of slots based on processing a second corresponding set of rows in conjunction with further executing the join operator of a query. In various examples, each hash map entry of the first plurality of hash map entries is stored in a corresponding slot of the second set of slots in conjunction with the corresponding bit having the second binary value indicating the second state corresponding to the second fixed-size hash table structure. In various examples, the method further includes performing a second hash map resizing process via updating the hash map to include a third set of slots corresponding to a third fixed-size hash table structure. In various examples, the third set of slots includes all of the second set of slots and a further set of additional slots. In various examples, performing the second hash map resizing process includes determining a second plurality of re-hashed locations for the first plurality of hash map entries and the second plurality of hash map entries in the second set of slots via a single iteration over the second set of slots in conjunction with an ordering of the second set of slots based on, in processing each of the second set of slots currently storing a corresponding hash map entry, storing the corresponding hash map entry in a selected slot of the third set of slots in conjunction with corresponding bit based on flipping the corresponding bit for the corresponding hash map entry back to the first binary value. In various examples, the query resultant is generated for the query based on join output generated via further execution of the join operator via accessing the hash map after performance of the second hash map resizing process. In various examples, the corresponding bit for all of the first plurality of hash map entries has the first binary value indicating the first state corresponding to the third fixed-size hash table structure after the single iteration over the first set of slots is complete based on flipping the corresponding bit for the corresponding hash map entry.

In various examples, generating the hash map is based on populating the hash map based on processing a set of right input rows in conjunction with executing the join operator. In various examples, the method further includes, after completing populating of the hash map via processing all of the set of right input rows, further executing the join operator based on accessing the hash map to process a set of left input rows to generate a set of output rows.

In various examples, a query operator execution flow for the query includes a plurality of hierarchical instances of a heap sort operator in conjunction with applying a hierarchical limit sort strategy. In various examples, executing the plurality of hierarchical instances of the heap sort operator in conjunction with executing the query is based on: identifying a first subset of a plurality of rows based on generating a plurality of sorted subsets from a plurality of unsorted subsets based on performing a first parallelized plurality of instances of the heap sort operator; and/or identifying a top-ordered set of rows as a second subset of the first subset based on generating a set of sorted subsets from a set of range-based subsets of the first subset of the plurality of rows based on performing a second parallelized plurality of instances of the heap sort operator. For example, the query operator execution flow is generated and/or executed in conjunction with implementing some or all features and/or functionality of FIGS. 29A-29D.

In various examples, the query is one of a set of queries. In various examples, execution of the set of queries is initiated via a plurality of parallelized processing core resources. In various examples, the method further includes, after initiating execution of set of queries and while the set of queries are concurrently being executed, performing a spill to disk process based on: spilling to disk, based on at least one of the plurality of parallelized processing core resources signaling spilling in response to determining a spill to disk condition is met, data of at least one operator the query; and/or determining when a spill to disk process end condition has been met based on tracking the ones of the plurality of parallelized processing core resources that determine the spill to disk condition is met and signal the spilling. In various examples, the spill to disk process completes based on the determining the spill to disk process end condition has been met. For example, the query executed and/or spilled to disk in conjunction with implementing some or all features and/or functionality of FIGS. 30A-30B.

In various embodiments, any one of more of the various examples listed above are implemented in conjunction with performing some or all steps of FIG. 28E. In various embodiments, any set of the various examples listed above can be implemented in tandem, for example, in conjunction with performing some or all steps of FIG. 28E, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 28E described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 28E, for example, in conjunction with further implementing any one or more of the various examples described above.

In various embodiments, the operational instructions, when executed by the at least one processor, cause the database system to: populate a hash map that includes a first set of slots corresponding to a first fixed-size hash table structure via insertion of a first plurality of hash map entries across the first set of slots based on processing a first corresponding set of rows in conjunction with executing a join operator of a query, where each hash map entry of the first plurality of hash map entries is stored in a corresponding slot of the first set of slots in conjunction with a corresponding bit having a first binary value indicating a first state corresponding to the first fixed-size hash table structure; and perform a hash map resizing process via updating the hash map to include a second set of slots corresponding to a second fixed-size hash table structure, where the second set of slots includes all of the first set of slots and a set of additional slots, and/or where performing the hash map resizing process includes determining a plurality of re-hashed locations for the first plurality of hash map entries in the second set of slots via a single iteration over the first set of slots in conjunction with an ordering of the first set of slots based on, in processing each of the first set of slots currently storing a corresponding hash map entry of the first plurality of hash map entries, storing the corresponding hash map entry in a selected slot of the second set of slots. In various embodiments, determining the plurality of re-hashed locations for the first plurality of hash map entries in the second set of slots via the single iteration over the first set of slots in conjunction with an ordering of the first set of slots is based on, in processing each of the first set of slots currently storing a corresponding hash map entry of the first plurality of hash map entries, storing the corresponding hash map entry in a selected slot of the second set of slots based on: re-hashing the corresponding hash map entry to determine a home slot for the corresponding hash map entry in the second set of slots; when the home slot is not storing any other hash map entry of the first plurality of hash map entries, setting the selected slot as the home slot; when the home slot is already storing another hash map entry of the first plurality of hash map entries, applying a collision handling strategy to determine the selected slot for storage of the corresponding hash map entry based on the corresponding bit of the another hash map entry; and/or flipping the corresponding bit for the corresponding hash map entry as a second binary value indicating a second state corresponding to the second fixed-size hash table structure for storage in conjunction with storage of the corresponding hash map entry in the selected slot. In various embodiments, a query resultant is generated for the query based on join output generated via further execution of the join operator via accessing the hash map after performance of the hash map resizing process.

FIGS. 29A-29C present embodiments of a database system 10 that executes a query operator execution flow that includes a plurality of hierarchical instances of a heap sort top N operation to execute a query having a query request 2515 indicating a limit sort expression 2916. Some or all features and/or functionality of FIGS. 29A-29C can implement any embodiment of database system 10 and/or query execution described herein.

In some embodiments, query requests 2515 (e.g., corresponding SQL queries for execution via database system 10) frequently involve execution of limit sort expressions 2916 (e.g., ORDER BY<cols> LIMIT N). In some embodiments, when N is significantly smaller than the size of the total result set to sort, there is likely a significantly more efficient approach to the limit than sorting the entire result set, and then selecting the first N values. In some embodiments, this case can be detected and handled via utilizing a heap of size N to maintain the top N values with a single operator instance. In some embodiments, such an operator is frequently forced to process all relevant rows on a single thread. In implementing such embodiments, all sorted data in the query execution module 2504 (e.g., corresponding vm) can be partitioned into p streams such that all data in stream p appears before all data in stream p+1 with the sorting conditions. Top N operators with a limited heap can appear parallelized after a sort multiplexer that generates this partitioning, and then a single, non-parallelized limit operator can apply the correct limit to each incoming stream. For example, query with an ORDER BY c1 LIMIT 100 limit sort expression 2916 could be executed via a query operator execution flow having a corresponding a sequence of operators such as:

Limit (1 operator)
|
heap sort top 100 (40 parallel operators)
|
sort multiplexer (40 parallel operators)

For example, in such embodiments, a corresponding query operator execution flow is implemented based on first implementing the sort multiplexer via 40 parallel operators, where output of the sort multiplexer then flows to a heap sort top 100 operator implemented via 40 parallel operators, and where output of the heap sort top 100 operator then flows to a limit operator implemented via one operator.

Consider an example case in implementing such embodiments with an input set of 150 rows, where a first partition 1 has 80 rows, a second partition 2 has 40 rows, and the other partitions have some distribution of the remaining 30. The limit operator will emit all rows from partition 1, then the first 20 rows from partition 2 to satisfy the top 100 condition. Nearly all of the practical sorting work done here occurs on partition 0, with some work required on partition 1 and any work done by the other heap sort operators is thus “wasted” effort. This inefficiency can become more significant for a very large input set, or for very poorly selected sort partition points. Additionally, the act of copying rows in the sort multiplexer to partition them can be more expensive than the limit sort itself. For a very large input set with M rows, M expensive row copies may be required ultimately to sort and/or process N final rows. FIGS. 29A-29C present embodiments of executing such queries, for example, with large M relative to N, to improve corresponding query efficiency.

In some embodiments, while partitioning data in the sort multiplexer for a very small limitN and a very large input size M over p sort partitions, the query execution module 2504 can be implemented to keep track of the number of rows emitted to each parent partition. If N or more rows total are emitted on partition 0, partitions [1,p) can immediately be discarded and their row copies skipped. While this configuration of executing such queries alone does not remove the requirement to row copy many rows to partition 0 or resolve the issue that all meaningful work occurs on a single thread for partition 0, such tracking and discarding of unnecessary partitions can be inexpensive to implement while removing some row copy overhead, thus improving query execution efficiency.

For example, assuming perfect, unskewed sort partitions, a naive heap sort block would require M row copies in the multiplexer, at least N row copies in the sorts depending on timing, and each heap sort would process M/p rows. With discarding partitions early on the multiplexer, this can drops to approximately M/p row copies (for M>>>N), M/p rows processed on a single heap sort thread, and N rows emitted by that heap sort thread.

In some embodiments, efficiency in handling such queries can be further improved via hierarchical heap sort top N operation instances, for example, in conjunction with applying a hierarchical limit sort strategy. For example, most row copies can be avoided based on calculating the top N result on a random partition of data before partitioning. This can be equivalent in principle to incomplete calculations utilized in performing aggregations and/or distinct operations in corresponding query execution via some embodiments of database system 10.

In some embodiments, implementing the hierarchical heap sort top N operation instances in executing a limit sort expression 2916 can be executed via a query operator execution flow having a corresponding a sequence of operators such as:

Limit (1 operator)
|
heap sort top N (p parallel operators)
|
sort multiplexer (p parallel operators)
|
heap sort top N (p parallel operators)
|
fanout load balancer with no row copies (p parallel operators)

For example, in such embodiments, a corresponding query operator execution flow is implemented as illustrated in FIG. 29A. For example, the query operator execution flow 2514 is generated based on processing a corresponding limit sort expression 2915 of a query request 2515 indicating row set identification parameters 2917, sorting parameters 2918, and/or a threshold maximum 2919, dictating the value N.

A fanout load balancer operation 2921 can process a full row set 2541 (e.g., identified based on row set identification parameters 2917, such as via one or more filtering predicates and/or row generation operators) of M rows via p parallel operators to emit p unsorted row subsets 2941.1-2941.p each containing approximately M/p rows. A first heap sort top N operation 2922.1 can be implemented via a first plurality of heap sort top N operators 2932.1.1-2932.1.p that each process a corresponding unsorted row subset 2941 to emit a corresponding sorted row set 2942 containing less than or equal to N rows, rendering the collective plurality of heapsort top N operators 2932.1.1-2932.1.p implementing the first heap sort top N operation 2922.1 collectively emitting a row subset 2543 containing less than or equal to N*p rows (e.g., each heap sort top N operation 2922 sorts its rows in accordance with sorting parameters 2918, such as from highest to lowest numeric value or other sorting means). A plurality of sort multiplexer operator instances 2933.1-2933.p can each emit a corresponding range-based row subset 2542 to include only values in a corresponding value range 2553 (e.g., equal ranges based on range of the full row set, configured ranges, etc., where value ranges 2553.1-2553.p are contiguous and collectively include a full value range of row set 2541) These range-based row subsets 2542.1-2542.p can be processed via a second heap sort top N operation 2922.2, implemented via a second plurality of heap sort top N operators 2932.2.1-2932.2.p, which can each process a corresponding range-based row subset 2542 to emit a corresponding sorted row set 2542 that includes less than or equal to N rows within the corresponding value range 2553. The limit operation can take the first N rows of these subsets, starting with the sorted row set 2542.1 and accumulating rows, in the already order, accessing additional sorted row sets 2542 if needed, until the N rows are obtained and emitted as the top sorted row set 2544 (or until all rows are emitted to optionally render less than N rows if M was less than N).

Thus, in applying a hierarchical limit sort strategy in such a fashion, the number of row copies processed via the sort multiplexer operation 2923 can be reduced from M to being at most p*N, which can improve query efficiency in cases where M is larger (e.g., much larger) than p*N. Additionally, additional p*N row copies parallelized on p by the not needed heap sorts below the multiplexer. Each thread with the not needed heap sort process M/p rows, which can improve query efficiency, for example, based on generated sort partition points being frequently very poor and the M/p per thread split guaranteed by the fanout rendering better efficiency.

In some embodiments, when M is more similar to N, this implementation of multiple hierarchical heap sort top N operations 2922 may not be worthwhile. For example, row copies without the pre-topN heap sorts is potentially M+roughly N, while row copies with the pre-topN heap sorts is pN+potentially pN+roughly N. Similarly, comparisons/sort operations done is on the scale of M without the not needed limit sorts, and M+pN with the not needed limit sorts.

FIG. 29B illustrates an embodiment of database system 10 where operator flow generator module 2514 can implement a hierarchical sort condition detection module 2951 to build the query operator execution flow 2517 in accordance with applying the hierarchical limit sort strategy 2952 to include the plurality of hierarchical heap sort top N operations 2922 as illustrated in FIG. 29A only when a corresponding hierarchical limit sort condition is met. For example, in order to apply the optimization in situations that are more favorable, operator flow generator module 2514 can determine whether to apply the hierarchical limit sort strategy 2952 to include the plurality of hierarchical heap sort top N operations 2922 as illustrated in FIG. 29A, where the hierarchical limit sort strategy 2952 is applied only when a corresponding hierarchical limit sort condition is met. Determining whether the hierarchical limit sort condition is met can be a function of the values of M (e.g., based on estimated input cardinality or otherwise estimated number of rows in full row set 2541), N (e.g., as indicated in the limit sort expression as the threshold maximum 2919), and/or p (e.g., the number of parallelized instances of the heap sort top N operator, for example, based on a number of parallelized resources such as number of nodes operating in parallel and/or number of processing core resources operating in parallel within one or more nodes). For example, a ratio of estimated input cardinality M and precise limit value N (e.g., the value M/N) and checking this checked against a constant multiple of p (e.g., p*k where p is the parallelization factor and where k is a positive number optionally equal to one, or greater than one). For example, if the ratio ends up being higher (e.g., the hierarchical limit sort condition is met), then the added not needed limit sort would reduce the number of row copies needed, and the hierarchical limit sort strategy 2952 can thus be applied.

FIG. 29C illustrates an embodiment of database system 10 where operator flow generator module 2514 can implement a multiplexer copy-free limit sort condition detection module 2953 to build, when a multiplexer copy-free limit sort condition is met, the query operator execution flow 2517 in accordance with applying a multiplexer copy-free limit sort strategy 2956 to include no sort multiplexer operation 2923, and thus induce no copies generated via sort multiplexer operators 2933 only. The multiplexer copy-free limit sort condition can be based on whether N is sufficiently small, such as smaller than a predetermined threshold limit 2955. For example, for a sufficiently small N, the sort multiplexer could be excluded entirely to remove an additional pN row copies. This would require that the higher limit sort is not parallelized and processes all p random topN streams into one output partition with the global top N result for that node. This logic could potentially also be used to handle re-sorting top N queries on the sql node (e.g., root node at the root level of a corresponding query execution plan 2504 executing the query). In some embodiments, the sql node is configured to process top N results from each child node by merging the sorted input on each partition, then applying a limit over the p sorted partitions. For a small enough N, the streams could be considered unsorted, row copies could be avoided, and a single heap sort top N operation 2922 could produce the global top N result across all nodes. If N is sufficiently small, this choice can be likely inconsequential, where reducing the initial M row copies is a much more important optimization.

FIG. 29D illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 29D, for example, based on participating in execution of a query being executed by the database system 10. Some or all of the method of FIG. 29D can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 29D based on implementing a corresponding plurality of processing core resources 48.1-48.W. Some or all of the steps of FIG. 29D can optionally be performed by any other one or more processing modules of the database system 10. Some or all of the steps of FIG. 29D can be performed to implement some or all of the functionality of the database system 10 as described in conjunction with FIGS. 29A-29C, for example, by implementing some or all of the functionality of operator flow generator module 2514, query operator execution flow 2517, heap sort top N operator 2932 and/or parallelized heap sort top N operators 2932, sort multiplexer operation 2932 and/or parallelized sort multiplexers 2933, limit operation 2924, hierarchical limit sort condition detection module 2951, and/or multiplexer copy-free limit sort condition detection module 2953. Some or all steps of FIG. 29C can be performed by database system 10 in accordance with other embodiments of the database system 10 and/or nodes 37 discussed herein. Some or all of the steps of FIG. 29C can be performed in conjunction with performing some or all steps of any other method described herein.

Step 2982 includes determining a query for execution that indicates identifying only a top-ordered set of rows of a sorted ordering of a plurality of rows, in accordance with an ordering scheme, that includes only up to a threshold maximum number of rows. Step 2984 includes determining a query operator execution flow for the query that includes a plurality of hierarchical instances of a heap sort operator in conjunction with applying a hierarchical limit sort strategy. Step 2986 includes executing the query operator execution flow in conjunction with executing the query.

Performing step 2986 can include performing step 2988 and/or 2990. Step 2998 includes identifying a first subset of the plurality of rows. Step 2990 includes identifying the top-ordered set of rows as a second subset of the first subset.

Performing step 2988 can include performing step 2992 and/or 2994. Step 2992 includes equally partitioning the plurality of rows into a plurality of unsorted subsets. Step 2994 includes generating a plurality of sorted subsets from the plurality of unsorted subsets based on performing, upon each of the plurality of unsorted subsets, the heap sort operator to emit a top-ordered first subset of rows in the each of the plurality of unsorted subsets in accordance with the ordering scheme that includes only up to the threshold maximum number of rows. In various examples, the first subset corresponds to a union of the plurality of sorted subsets.

Performing step 2990 can include performing step 2996, 2998, and/or 2999. Step 2996 includes generating a set of range-based subsets corresponding to a set of contiguous of value ranges in accordance with the ordering scheme based on partitioning rows in the first subset of rows across the set of range-based subsets based on corresponding values of the rows. Performing step 2998 includes generating a set of sorted subsets from the set of range-based subsets based on performing, upon each of the set of range-based subsets, the heap sort operator to emit a corresponding one of the set of sorted subsets as a top-ordered subset of rows in the each of the set of range-based subsets in accordance with the ordering scheme that includes only up to the threshold maximum number of rows. Step 2999 includes identifying the top-ordered set of rows based on accumulating rows from a top-ordered subset of the set of range-based subsets in accordance with the ordering scheme until the only up to the threshold maximum number of row is accumulated.

In various examples, a query resultant of the query is generated based on the top-ordered set of rows.

In various examples, partitioning the plurality of rows into a set of range-based subsets is based on including ones of the first subset of rows in a corresponding one of the set of range-based subsets based on generating copies of the ones of the first subset of rows. In various examples, the hierarchical limit sort strategy is applied based on determining to reduce a number of copies of rows generated in executing the query.

In various examples, equally partitioning the plurality of rows into the plurality of unsorted subsets requires no copying of any of the plurality of rows.

In various examples, accumulating rows from the top-ordered subset of the set of range-based subsets in accordance with the ordering scheme includes: accumulating all rows from all subsets but a last-ordered range-based subset in the top-ordered subset of the set of range-based subsets based on a first total number of rows across the all subsets but the last ordered range-based subset in the top-ordered subset of the set of range-based subsets including less than the threshold maximum number of rows; and/or further accumulating a top-ordered subset of rows in the last-ordered range-based subset in the top-ordered subset of the set of range-based subsets based on a number of rows included in the top-ordered subset of rows in the last-ordered range-based subset in the top-ordered subset of the set of range-based subsets being equal to a difference between the threshold maximum number of rows and the first total number of rows.

In various examples, partitioning the plurality of rows into the set of range-based subsets includes: tracking a number of rows emitted to each of a plurality of range-based subsets; and/or, once the threshold maximum number of rows are emitted to range-based subsets across a second top-ordered subset of the plurality of range-based subsets, discarding a remaining subset of the plurality of range-based subsets ordered after the second top-ordered subset of the plurality of range-based subsets. In various examples, the set of range-based subsets includes only the second top-ordered subset of the plurality of range-based subsets based on discarding of the remaining subset of the plurality of range-based subsets.

In various examples, the top-ordered subset of the set of range-based subsets is the second top-ordered subset of the plurality of range-based subsets. In various examples, the top-ordered subset of the set of range-based subsets is a proper subset of the second top-ordered subset of the plurality of range-based subsets.

In various examples, the second top-ordered subset of the plurality of range-based subsets includes only a single top-ordered subset of the plurality of range-based subsets based on the threshold maximum number of rows being emitted to the single top-ordered subset. In various examples, the top-ordered set of rows are accumulated from the single top-ordered subset of the plurality of range-based subsets in accordance with ordering of rows within the single top-ordered subset.

In various examples, the query operator execution flow includes a fanout load balancer operation. In various examples, the plurality of rows is equally partitioned into the plurality of unsorted subsets based on execution of the fanout load balancer operation via a first plurality of parallelized operators. In various examples, the query operator execution flow includes a first heap sort operation serially after the fan load balancer operator. In various examples, the plurality of sorted subsets is generated from the plurality of unsorted subsets based on execution of the first heap sort operation via a second plurality of parallelized operators. In various examples, the query operator execution flow includes a sort multiplexer operation serially after the first heap sort operation. In various examples, the set of range-based subsets is generated based on execution of the sort multiplexer operation via a third plurality of parallelized operators. In various examples, the query operator execution flow includes a second heap sort operation serially after the sort multiplexer operation. In various examples, the plurality of sorted subsets is generated based on execution of the first heap sort operation via a fourth plurality of parallelized operators. In various examples, the query operator execution flow includes a limit operation serially after the second heap sort operation. In various examples, the top-ordered set of rows is identified based on execution of the limit operation via a single operator.

In various examples, the first plurality of parallelized operators, the second plurality of parallelized operators, the third plurality of parallelized operators, and/or the fourth plurality of parallelized operators all include a same number of parallelized operators.

In various examples, determining the query operator execution flow is based on determining whether to apply the hierarchical limit sort strategy as a function of the threshold maximum number of rows, an estimated input cardinality value, and/or a parallelization factor. In various examples, the plurality of hierarchical instances of the heap sort operator are included in the query operator execution flow based on determining to apply the apply the hierarchical limit sort strategy.

In various examples, a number of rows included in the plurality of rows is based on the estimated input cardinality value. In various examples, a number of unsorted subsets included in the plurality of unsorted subsets is based on the parallelization factor. In various examples, a number of range-based subsets included in the set of range-based subsets is based on the parallelization factor.

In various examples, determining whether to apply the hierarchical limit sort strategy is based on comparing a ratio of the estimated input cardinality value to the threshold maximum number of rows to the parallelization factor. In various examples, determining to apply the hierarchical limit sort strategy is based on determining the ratio of the estimated input cardinality value to the threshold maximum number of rows exceeds the parallelization factor.

In various examples, the query operator execution flow for the query further includes a sort multiplexer operation to implement parallelization in identifying the top-ordered set of rows in conjunction with applying the hierarchical limit sort strategy. In various examples, the method further includes determining a second query for execution that indicates identifying only a second top-ordered set of rows of a second sorted ordering of a second plurality of rows, in accordance with the ordering scheme, that includes only up to a second threshold maximum number of rows; and/or determining a second query operator execution flow for the query that includes no sort multiplexer operation in conjunction with applying a multiplexer copy-free limit sort strategy.

In various examples, determining the second query operator execution flow is based on determining to apply the multiplexer copy-free limit sort strategy based on the second threshold maximum number of rows falling below a predetermined multiplexer copy-free limit threshold. In various examples, the hierarchical limit sort strategy is applied via the query operator execution flow based on the threshold maximum number of rows exceeding the predetermined multiplexer copy-free limit threshold.

In various examples, the top-ordered set of rows includes exactly the threshold maximum number of rows based on the plurality of rows including at least the threshold maximum number of rows. In various examples, the top-ordered set of rows includes a number of rows strictly less than the threshold maximum number of rows based on the plurality of rows including only the number of rows.

In various examples, the threshold maximum number of rows is set based on a configured value included in a query expression indicating the query for execution.

In various examples, the query for execution indicates identifying only the top-ordered set of rows of the sorted ordering of the plurality of rows based on indicating execution of a limit operation, for example, in accordance with SQL syntax and/or a SQL function call.

In various examples, the query is one of a set of queries. In various examples, execution of the set of queries is initiated via a plurality of parallelized processing core resources. In various examples, the method further includes, after initiating execution of set of queries and while the set of queries are concurrently being executed, performing a spill to disk process based on: spilling to disk, based on at least one of the plurality of parallelized processing core resources signaling spilling in response to determining a spill to disk condition is met, data of at least one operator the query; and/or determining when a spill to disk process end condition has been met based on tracking the ones of the plurality of parallelized processing core resources that determine the spill to disk condition is met and signal the spilling. In various examples, the spill to disk process completes based on the determining the spill to disk process end condition has been met. For example, the query executed and/or spilled to disk in conjunction with implementing some or all features and/or functionality of FIGS. 30A-30B.

In various embodiments, any one of more of the various examples listed above are implemented in conjunction with performing some or all steps of FIG. 29D. In various embodiments, any set of the various examples listed above can be implemented in tandem, for example, in conjunction with performing some or all steps of FIG. 29D, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 29D described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 29D, for example, in conjunction with further implementing any one or more of the various examples described above.

In various embodiments, the operational instructions, when executed by the at least one processor, cause the database system to: determine a query for execution that indicates identifying only a top-ordered set of rows of a sorted ordering of a plurality of rows, in accordance with an ordering scheme, that includes only up to a threshold maximum number of rows; determine a query operator execution flow for the query that includes a plurality of hierarchical instances of a heap sort operator in conjunction with applying a hierarchical limit sort strategy; and/or execute the query operator execution flow in conjunction with executing the query. In various embodiments, executing the query operator execution flow in conjunction with executing the query is based on identifying a first subset of the plurality of rows based on: equally partitioning the plurality of rows into a plurality of unsorted subsets; and/or generating a plurality of sorted subsets from the plurality of unsorted subsets based on performing, upon each of the plurality of unsorted subsets, the heap sort operator to emit a top-ordered first subset of rows in the each of the plurality of unsorted subsets in accordance with the ordering scheme that includes only up to the threshold maximum number of rows, wherein the first subset corresponds to a union of the plurality of sorted subsets. In various embodiments, In various embodiments, executing the query operator execution flow in conjunction with executing the query is further based on identifying the top-ordered set of rows as a second subset of the first subset based on: generating a set of range-based subsets corresponding to a set of contiguous of value ranges in accordance with the ordering scheme based on partitioning rows in the first subset of rows across the set of range-based subsets based on corresponding values of the rows; generating a set of sorted subsets from the set of range-based subsets based on performing, upon each of the set of range-based subsets, the heap sort operator to emit a corresponding one of the set of sorted subsets as a top-ordered subset of rows in the each of the set of range-based subsets in accordance with the ordering scheme that includes only up to the threshold maximum number of rows; and/or identifying the top-ordered set of rows based on accumulating rows from a top-ordered subset of the set of range-based subsets in accordance with the ordering scheme until the only up to the threshold maximum number of row is accumulated. In various embodiments, a query resultant of the query is generated based on the top-ordered set of rows.

FIG. 30A illustrates an embodiment of database system 10 where processing core resources 48 of a node 37 (e.g., vm cores, for example, implemented via query execution module 2504) are operable to track data spilling to disk triggered by other processing core resources 48 in conjunction with executing a corresponding query to determine whether and how much of their own data to spill at a given time, where data spilling is thus optionally performed in accordance with a collaborative, voting-based spill process across the processing core resources 48. Some or all features and/or functionality of the data spilling, corresponding query execution, and/or processing core resource 48 of FIG. 30A can implement any embodiment of data spilling, corresponding query execution, processing core resources 48, nodes 37, and/or database system 10 described herein.

In some embodiments, some or all features and/or functionality of spilling to disk, corresponding disk memory resources 3065, and/or handling out of memory conditions when query execution memory resources are determined to be low as described herein implements some or all features and/or functionality of spilling to disk corresponding disk memory resources, and/or handling out of memory conditions when query execution memory resources are determined to be low as disclosed by: U.S. Utility application Ser. No. 18/322,688, entitled “PROCESSING MULTI-COLUMN STREAMS DURING QUERY EXECUTION VIA A DATABASE SYSTEM”, filed May 24, 2023; and/or U.S. Utility application Ser. No. 18/326,305, entitled “HANDLING NULL VALUES IN PROCESSING JOIN OPERATIONS DURING QUERY EXECUTION”, filed May 31, 2023; which are hereby incorporated herein by reference in its entirety and made part of the present U.S. Utility Patent Application for all purposes.

In some embodiments of executing queries via database system 10, operators (e.g., operator execution modules 3215 implementing execution of corresponding operators 2520) require memory in order to make progress on their tasks. This can induce cases when operators are unable to proceed due to the system being out of memory. In cases like this, database system 10 can implement a spill to disk functionality which flushes data to disk (if required) and/or recovers memory in use by running queries (e.g., by extension operators that are part of those queries). There can be multiple priority levels that the system can spill at, each incrementally spilling more data, with the highest being dumping all operator data. This spilling can be costly in terms of performance because of the time it takes to both load off all the data and recover memory, and the time it takes to reacquire that memory and continue operator execution. FIG. 30A presents a mechanism for spilling data to disk that is configured to reduce the spill priority level required to resume operator execution, and consequently reduce the effect one operator has on another due to a lack of memory available.

In some embodiments, database system 10 operates as a multi-threaded system, where each vm core (e.g., parallelized thread where operator logic is executed via a corresponding node 37 and/or via query execution module 2504) handles their own spills. In order to achieve the goal of reducing required spill priority for recovering memory, the mechanism for spilling to disk can be adapted to implement a more collaborative approach where all vm cores can participate in spilling if a single core is unable to acquire more memory. Implementing this method of spilling to disk can enable recovery of more memory per spill priority, therefore reducing the cost of a single spill in general if a core ever requires more memory than available.

In some embodiments, such a spill to disk mechanism is implemented in accordance with adhering to a set of requirements. For example, this set of requirements can include: (1) spill should happen globally rather than locally per vm core in an effort to reduce the level and which data is spilled; and/or (2) all vm cores should agree on the minimum spill level to meet criteria to recover from an out of memory (OOM) scenario.

In some embodiments, spilling to disk can be dictated by query managers implemented via each vm core (e.g., each processing core resource 48). In the event that: (1) no operator instances can make any progress on the core (e.g., due to current memory status data 3016 indicating no progress can be made due to no memory being available to execute any of the operator instances); and/or that (2) at least one of the vm cores is out of memory (e.g., meets an OOM condition), for example, based on not being able to progress because the system has no more memory available to allocate to it, the query manager of the vm core can being to signal spill to all operators on its core (e.g., to all operator execution modules 3215). If after that, the system has not potentially recovered enough memory (e.g., has not recovered a threshold amount of memory, which can be dictated via a configurable parameter set via user input, determined automatically, accessed in memory, or otherwise determined, it can communicate to all other vm cores (e.g., via vm core messages) to signal their own spills.

In some embodiments, vm cores have multiple “vote trackers”, which can be implemented via an atomic count shared by all vm cores tracking how many cores have voted (e.g., vmCoreVOteTracker_t), which can allow for collaboration in the even of node-wide no progress to OOM kill a query to reduce memory usage. This can occur after multiple cycles of no progress and a consensus across the cores to kill a query.

FIG. 30A presents further improvements to this mechanism of spilling to disk, and potentially killing queries entirely, collaboratively across cores. As illustrated in FIG. 30A, a plurality of processing core resources 48.1-48.W of a given node 37 can each implement a query processing module 2435 (e.g., implementing some or all of the query manager for the corresponding vm) to execute one or more query operator execution flows 2433 for one or more queries. In this example, the processing core resources 48.1-48.W collectively participate in the node's execution of at least a first query A and a second query B (e.g., in conjunction with the node 37 participating in execution of these queries at a corresponding level of query execution plans 2405 for these queries, for example, in parallel with other nodes 37). Thus, each processing core resource 48 implements one or more operator execution modules 3215 to implement a corresponding operator execution flow 2433 for a corresponding query, where the operator execution modules 3215 are executed via processing, generating, and/or emitting corresponding operator data 3011, requiring query memory resources to be stored and accessed by the operator execution modules 3215.

The plurality of processing core resources 48.1-48.W can each further implement a plurality of operator execution modules a data spill signaling module 3015 (e.g., as part of implementing a corresponding query manager via a corresponding vm core), which can be configured to determine whether the corresponding processing core resource 48 spill some amount of its operator data 3011 for one or more queries to disk, and send spill signals 3018 accordingly (e.g., to corresponding operator execution modules 3215) to render the processing core resource flushing spilled data 3066 to disk memory resources 3065 operable to store the spilled data 3066.

The data spill signaling module 3015 of each processing core resource 48 can be configured to determine when/what type of spill signals 3018 be sent based on memory status data 3016 for the given processing core resource 48 and/or tracked spill status data 3017 maintained across all of the processing core resources 48.1-48.W (e.g., maintained via a corresponding spill manager of the node).

For example, vm core can have a vote tracker for each spilling priority in addition to a vote tracker for OOM killing queries. In particular, tracked spill status data 3017 can include a plurality of spill level statues 3031 for a plurality of spill levels 3021 (e.g., each implemented via a corresponding atomic integer indicating a current vote, where the integer value indicates the number of processing core resources having determined to apply the corresponding spill level 3021). A corresponding spill manager can be implemented to keep track of any on going spills on the node 37 (e.g., if there's a spill currently in progress, the amount of potential memory to be freed this spill round, the amount of memory already spilled this round, and/the actual atomic counters that the vm core vote trackers use).

A given data spill signaling module 3015 of a given processing core resource 48 can determine when/what type of spill signals 3018 be sent based on determining whether a given spill condition 3020.i for a given spill level 3021.i is met, based on tracked spill status data 3017 and the memory status data 3016. When the given spill condition 3020.i is met, spill signals 3018.i for the given spill level 3021.i (e.g., corresponding to the amount of data/instructions for spilling for that spill level 3021.i) can be sent to render corresponding flushing of spilled data 3066.i by the processing core resource in conjunction with the corresponding spill level 3021.i, and the spill level status 3031.i for spill level 3021.i can be updated, for example, to indicate the given processing core resource's “vote” for the spill level 3021.i (e.g., denoting they participated in spilling at this spill level, for example, where the spill level status 3031.i is an atomic integer for the spill level 3021.i that is incremented with each update, and where its current value thus denotes that it was voted for by a number of processing core resources equal to its current value).

Such spilling of data across processing core resource can be in conjunction with participating in a spill round, for example, starting from a lowest spill level 3031.1 and advancing as processing core resources determine (e.g., vote) to advance to the next level. Thus, a spill level 3021.i can be reached by one or more processing core resources in the spill round once all processing core resources have already applied the prior spill level 3021.i−1. The current spill level can be indicated by the spill level status 3031 (e.g., all spill level statuses 3031.1-3031.i−1 have values of W because all W processing core resources already updated these statues via incrementing the value once they entered the corresponding spill level, and one or more processing core resources are currently at spill level status 3031.i based on spill level status 3031.i having some value of its atomic integer less than W. The spill round can end once spilled data 3066 is able to be recovered and/or once a query is killed. A next spill round, if required, can start over from the first spill level 3021.

In some embodiments, a corresponding control flow dictating how processing core resources collectively participate in a spill round of spilling data to disk, for example, collaboratively in conjunction with accessing and updating tracked spill status data 3017. Each processing core resources determine whether a given spill condition 3020.i for a given spill level 3020.i is met and how data be spilled accordingly can be in accordance with a control flow, for example, implemented via some or all of the following logic:

As a first step of the control flow, a given vm core can determine to participate in spilling of a corresponding spill round when either a first condition or a second condition occurs. The first condition requires both of two sub-conditions: (1) the query manager of the given processing core resource 48 was unable to make any progress on any operator and (2) there is at least one query that is OOM. The second condition requires there is currently a spill round in progress (e.g., tracked spill status data 3017 indicates spill level status 3031 for at least one spill level denoting that it was applied by at least one processing core resource already in conjunction with having entered the spill round).

As a second step of the control flow, when the given vm core determines to participate in spilling of the corresponding spill round, voting can occur based on following a corresponding sub-flow.

A first step of this corresponding sub-flow can include finding the lowest spill priority (e.g., spill level) that has not been voted by all vm cores (e.g., spill level 3021.i based on spill level 3021.i−1 having been voted by all vm cores already).

A second step of this corresponding sub-flow can include, determining whether this core has voted for this spill level 3021.i: if the core has voted for this spill priority 3021.i already, then this core has nothing further to do at this time; if the core has not yet voted for this spill level 3021.i, then this core votes for the spill level 3021.i (e.g., increments its atomic integer value or otherwise update the spill level status 3031.i) and signals corresponding spills 3018.i on some or all of its queries (e.g., at least queries A and B), for example, in a descending order of priority across all queries regardless of query scheduling method.

A third step of this corresponding sub-flow can include, each time a spill signal is given to an operator instance on any vm core, that the spill manager of the node determines, in response to being notified of the amount of memory that can be potentially freed by that operator instance due to the spilling, whether the amount of memory that can be potentially freed and memory that's already been freed this spill round reaches a configured required amount of memory. If the amount of memory that can be potentially freed and memory that's already been freed this spill round reaches a configured required amount of memory, the spill manager can signal the end of the spill round. Otherwise, the spill round continues.

A fourth step of this corresponding sub-flow can include, if the spill round ends, an operator instance scheduler (e.g., the data spill signaling module 3015 that carries out the spill signaling to operator instances) being notified by the spill manager when updating potentially freed memory, and can stops any further spill signals due to the spill round ending.

A fourth step of this corresponding sub-flow can include, if the spill round continues, all operator instances can be signaled to spill.

A fifth step of this corresponding sub-flow can include determining if all spill priorities have been voted for and the spill round is still in progress. If all spill priorities have been voted for and the spill round is still in progress, the vm core can start an OOM kill timer, and can try to lower resource usage based on releasing bloom filters on all operators and/or signaling spills on the highest spill priority if not already done. If both of those are done already, the vm core can try to re-spill any pending blocks that operators might have re-allocated since freeing them during the spill before.

A sixth step of this corresponding sub-flow can include continuing performance of the fifth step until either: (1) enough memory is recovered, which will end the spill round, where vm cores will accordingly rescind all votes on the vote trackers; or (2) the oom kill timer runs out, at which point the lowest priority query will be killed and the vm core will vote to the oom killed queries vote tracker.

A seventh step of this corresponding sub-flow can include, once the last vm core kills the query (e.g., determined based on whether the vote tracker has votes from all vm cores) this last vm core signals the end of the spill round in the spill manager.

In some embodiments, this sub-flow is implemented based on the case when the processing core resource/corresponding node is out of huge page memory. In some embodiments, when the processing core resource/corresponding node is out of for being out of heap memory, this control flow is followed, except the voting starts from the highest (e.g., final) spill level 3021.

FIG. 30B illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 30B, for example, based on participating in execution of a query being executed by the database system 10. Some or all of the method of FIG. 30B can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 30B based on implementing a corresponding plurality of processing core resources 48.1-48.W. Some or all of the steps of FIG. 30B can optionally be performed by any other one or more processing modules of the database system 10. Some or all of the steps of FIG. 30B can be performed to implement some or all of the functionality of the database system 10 as described in conjunction with FIG. 30A, for example, by implementing some or all of the functionality of data spill managing module 3015, query processing module 2435, tracked spill status data 3017, and/or disk memory resources 3065. Some or all steps of FIG. 30B can be performed by database system 10 in accordance with other embodiments of the database system 10 and/or nodes 37 discussed herein. Some or all of the steps of FIG. 30B can be performed in conjunction with performing some or all steps of any other method described herein.

Step 3082 includes initiating execution of a set of queries via a plurality of parallelized processing core resources based on utilizing query execution memory resources to execute a plurality of operators of a corresponding query operator execution flow of each of the set of queries. Step 3084 includes, after initiating execution of set of queries and while the set of queries are concurrently being executed, performing a spill to disk process.

Performing step 3084 can include performing some or all of steps 3086-3092. Step 3086 includes determining, via at least one processing core resource of the plurality of parallelized processing core resources, a spill to disk condition is met based on progress of execution of at least one query. Step 3088 includes spilling to disk, based on the at least one of the plurality of parallelized processing core resources signaling spilling in response to determining the spill to disk condition is met, data of at least one operator of the plurality of operators of at least one of the set of queries. Step 3090 includes tracking ones of the plurality of parallelized processing core resources that determine the spill to disk condition is met and signal the spilling. Step 3092 includes determining when a spill to disk process end condition has been met based on tracking the ones of the plurality of parallelized processing core resources that determine the spill to disk condition is met and signal the spilling. In various examples, the spill to disk process completes based on the determining the spill to disk process end condition has been met.

In various examples, each of the at least one processing core resource in the plurality of parallelized processing core resources determines the spill to disk condition is met based on determining whether other ones of the plurality of parallelized processing core resources determine the spill to disk is met based on the tracking of the ones of the plurality of parallelized processing core resources that determine the spill to disk condition is met.

In various examples, each of the at least one processing core resource in the plurality of parallelized processing core resources determines the spill to disk is met based on determining no progress can be made on any of the plurality of operators of any of the set of queries and further determining there is at least one query of the set of queries meeting an out of memory condition. In various examples, each of the at least one processing core resource in the plurality of parallelized processing core resources determines the spill to disk is met based on determining the spill to disk process has begun based on at least one other one processing core resource in the plurality of parallelized processing core resources determining the spill to disk is met. In various examples, the spill to disk process is initiated based on a first processing core resource in the at least one processing core resource determining the spill to disk is met.

In various examples, a plurality of level-based spill to disks correspond to a plurality of spill levels corresponding to different amounts of data spilling. In various examples, the at least one of the plurality of parallelized processing core resources determining a spill to disk condition is met includes the at least one of the plurality of parallelized processing core resources determining at least one of the plurality of level-based spill to disks is met. In various examples, a number of operators having data spilled to disk is based on corresponding amounts of data spilling for the at least one of the plurality of level-based spill to disks determined to be met by the at least one of the plurality of parallelized processing core resources.

In various examples, performing the spill to disk process is based on applying incrementally increasing ones of the plurality of spill levels in accordance with an ordering of the plurality of spill levels by a corresponding amount of data spilled, starting with a lowest spill level of the plurality of spill levels corresponding to a smallest amount of data spilled.

In various examples, a next one of the plurality of spill levels is applied only after all of the plurality of parallelized processing core resources determining a prior one of the plurality of level-based spill to disks, corresponding to a prior one of the plurality of spill levels, is met.

In various examples, tracking ones of the plurality of parallelized processing core resources that determine the spill to disk condition is met includes tracking ones of the plurality of parallelized processing core resources that determine corresponding ones of the plurality of level-based spill to disks. In various examples, one of the plurality of parallelized processing core resources initiates advancing to the next one of the plurality of spill levels based on: the one of the plurality of parallelized processing core resources having already determined the prior one of the plurality of level-based spill to disks is met and signaling spilling of a number of operators corresponding to the prior one of the plurality of level-based spill to disks; and/or based on tracking ones of the plurality of parallelized processing core resources that determine corresponding ones of the plurality of level-based spill to disks, determining all other ones of the plurality of parallelized processing core resources also already determined the prior one of the plurality of level-based spill to disks is met and also signaling spilling of a corresponding number of operators corresponding to the prior one of the plurality of level-based spill to disks.

In various examples, performing the spill to disk process based on applying the incrementally increasing ones of the plurality of spill levels based on an out of huge page memory condition being met.

In various examples, a highest spill level of the plurality of spill levels corresponds to a spilling all data of all operators of the plurality of operators of the set of queries.

In various examples, the spill to disk process end condition is determined to be met prior to advancing to the highest spill level of the plurality of spill levels.

In various examples, performing a spill to disk process further includes, based on advancing to the highest spill level of the plurality of spill levels via the at least one processing core resource determining a highest level-based spill to disk corresponding to the highest spill level has been met, each at least one processing core resource: initiating an out of memory kill timer; releasing bloom filters on all of the plurality of operators of the set of queries; and/or re-spilling any pending blocks re-allocated by any of the plurality of operators after freeing of pending blocks via prior spilling in conjunction with prior advancing to a prior spill level.

In various examples, performing a spill to disk process further includes at least one of the plurality of parallelized processing core resources killing execution of a lowest priority query of the set of queries in response to having initiated the out of memory kill timer, and/or the out of memory kill timer elapsing.

In various examples, performing a spill to disk process is further based on tracking ones of set of queries killed by ones of the plurality of parallelized processing core resources. In various examples, determining the spill to disk process end condition has been met is based on determining all of the plurality of parallelized processing core resources killed their corresponding execution of the lowest priority query.

In various examples, tracking the ones of the plurality of parallelized processing core resources that determine the spill to disk condition is met and signal the spilling is based on maintaining an atomic integer accessible by all of the plurality of parallelized processing core resources. In various examples, the atomic integer is incremented in response to any of the plurality of parallelized processing core resources determining the spill to disk condition is met.

In various examples, determining the spill to disk process end condition has been met is based on, via tracking the ones of the plurality of parallelized processing core resources that determine the spill to disk condition is met and signal the spilling, determining an amount of memory freed via data of the at least one operator being spilled to disk meets a configured freed memory threshold amount.

In various examples, each of the at least one processing core resource signals the spilling based on signaling spilling of at least some of the plurality of operators for at least some of the set of queries being executed by the each of the at least one processing core resource.

In various examples, the plurality of parallelized processing core resources each independently execute the at least some of the plurality of operators for the at least some of the set of queries in accordance with parallelized execution of the at least some of the set of queries.

In various examples, the each of the at least one processing core resource signals spilling of the at least some of the plurality of operators for at least some of the set of queries in accordance with an ordering of signaling to the at least some of the plurality of operators corresponding to a descending order of query priority of the at least some of the set of queries.

In various examples, a query operator execution flow for a query of the set of queries includes a plurality of hierarchical instances of a heap sort operator in conjunction with applying a hierarchical limit sort strategy. In various examples, executing the plurality of hierarchical instances of the heap sort operator in conjunction with executing the query is based on: identifying a first subset of a plurality of rows based on generating a plurality of sorted subsets from a plurality of unsorted subsets based on performing a first parallelized plurality of instances of the heap sort operator; and/or identifying a top-ordered set of rows as a second subset of the first subset based on generating a set of sorted subsets from a set of range-based subsets of the first subset of the plurality of rows based on performing a second parallelized plurality of instances of the heap sort operator. For example, the query operator execution flow is generated and/or executed in conjunction with implementing some or all features and/or functionality of FIGS. 29A-29D.

In various embodiments, any one of more of the various examples listed above are implemented in conjunction with performing some or all steps of FIG. 30B. In various embodiments, any set of the various examples listed above can be implemented in tandem, for example, in conjunction with performing some or all steps of FIG. 30B, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 30B described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 30B, for example, in conjunction with further implementing any one or more of the various examples described above.

In various embodiments, the operational instructions, when executed by the at least one processor, cause the database system to: initiate execution of a set of queries via a plurality of parallelized processing core resources based on utilizing query execution memory resources to execute a plurality of operators of a corresponding query operator execution flow of each of the set of queries; and/or perform a spill to disk process, after initiating execution of set of queries and while the set of queries are concurrently being executed. In various example, performing the spill to disk process is based on determining via at least one processing core resource of the plurality of parallelized processing core resources, a spill to disk condition is met based on progress of execution of at least one query; spilling to disk, based on the at least one of the plurality of parallelized processing core resources signaling spilling in response to determining a spill to disk condition is met, data of at least one operator of the plurality of operators of at least one of the set of queries; tracking ones of the plurality of parallelized processing core resources that determine the spill to disk condition is met and signal the spilling; and/or determining when a spill to disk process end condition has been met based on tracking the ones of the plurality of parallelized processing core resources that determine the spill to disk condition is met and signal the spilling. In various embodiments, the spill to disk process completes based on the determining the spill to disk process end condition has been met.

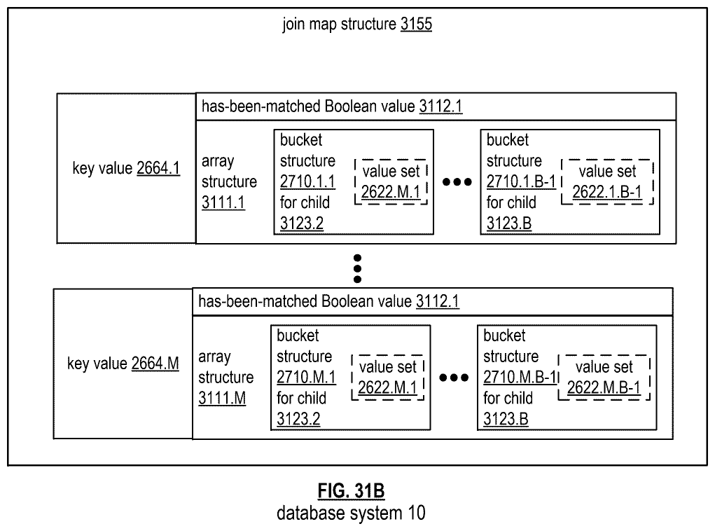

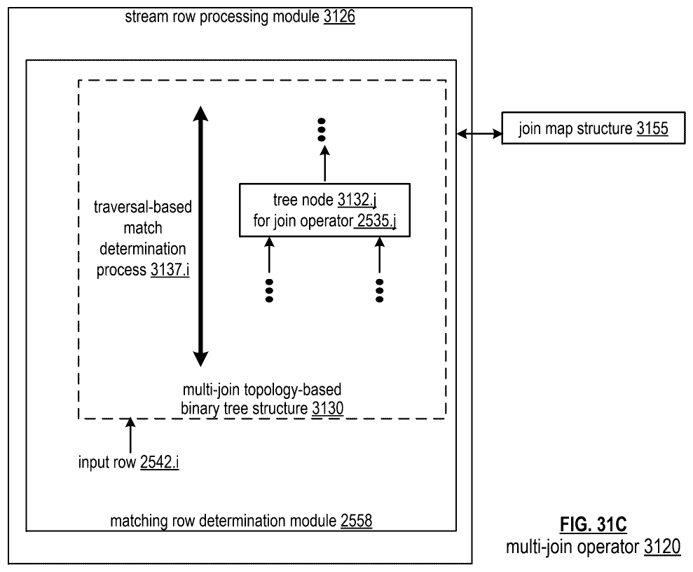

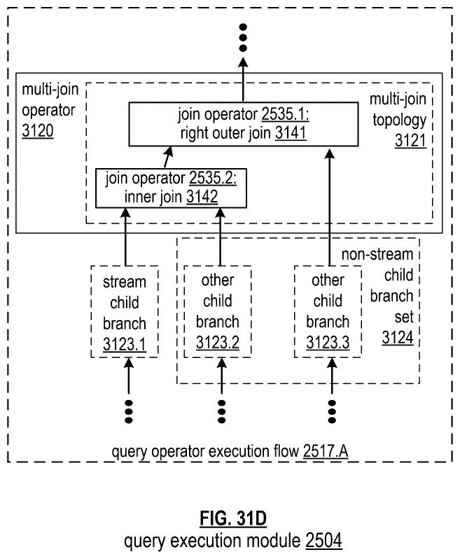

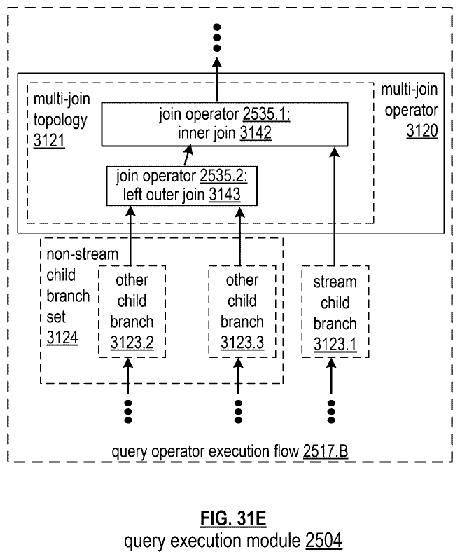

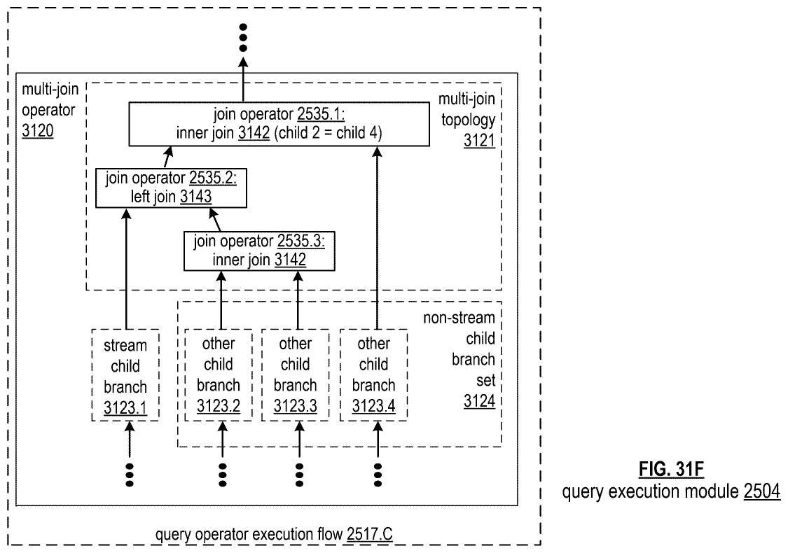

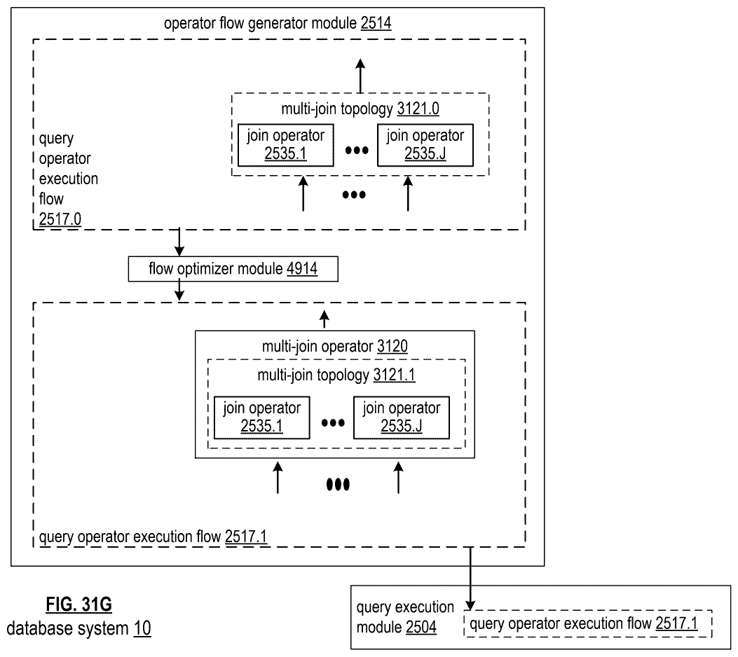

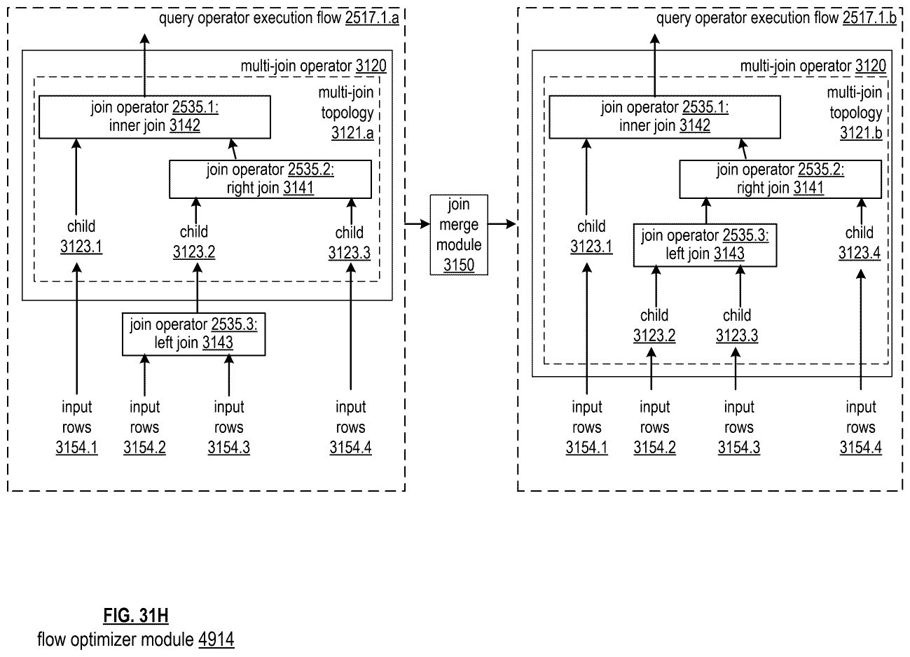

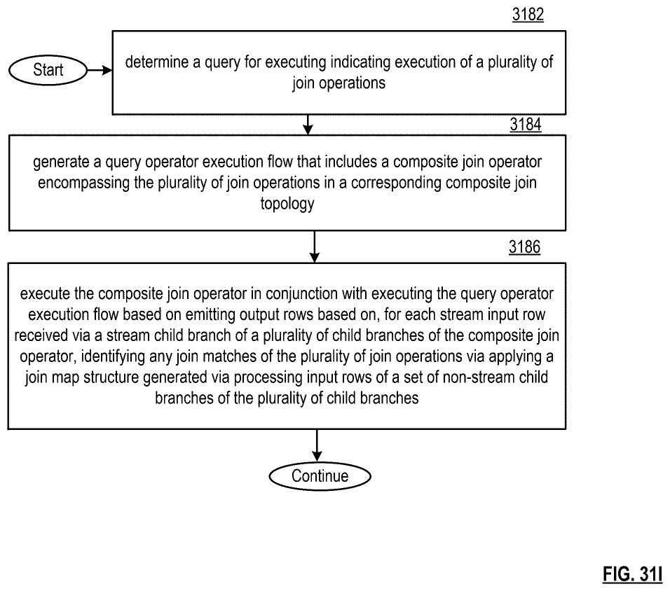

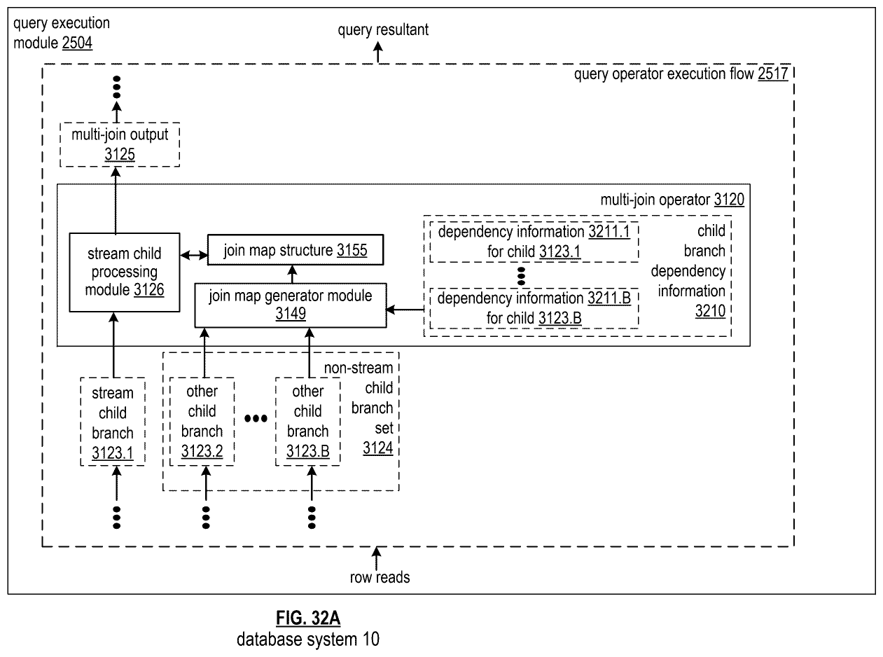

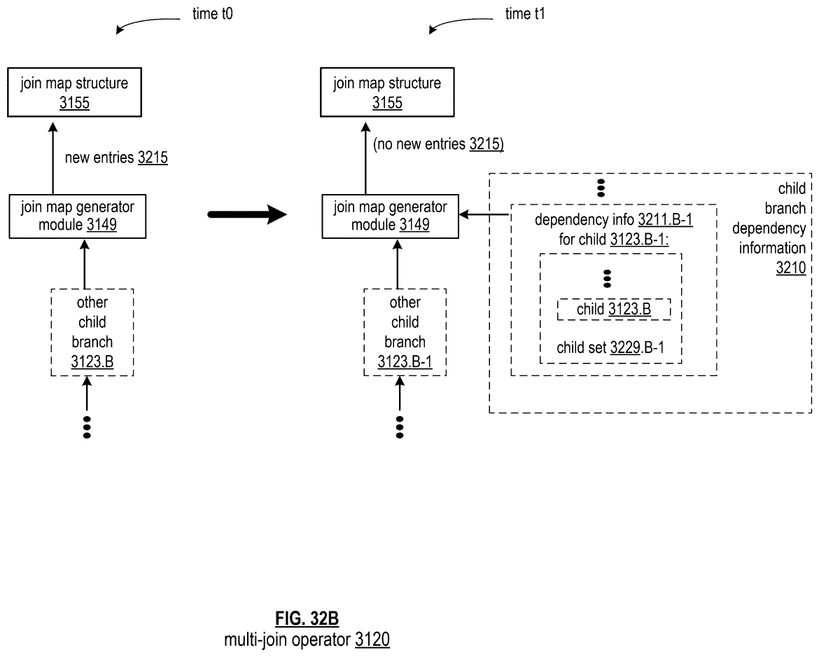

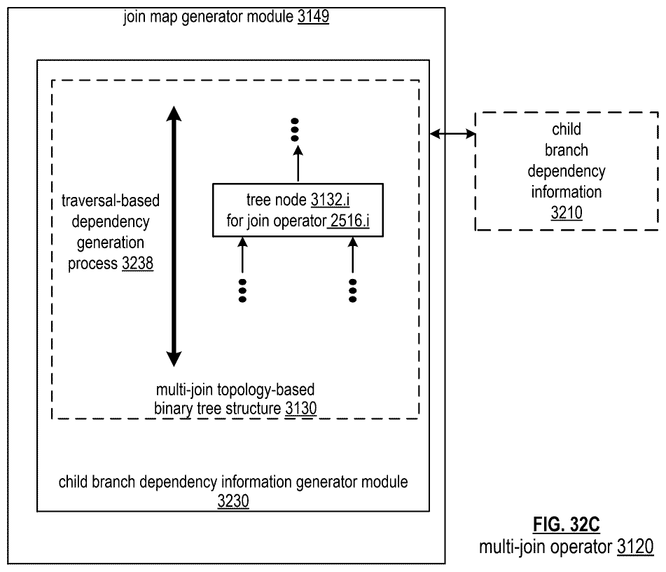

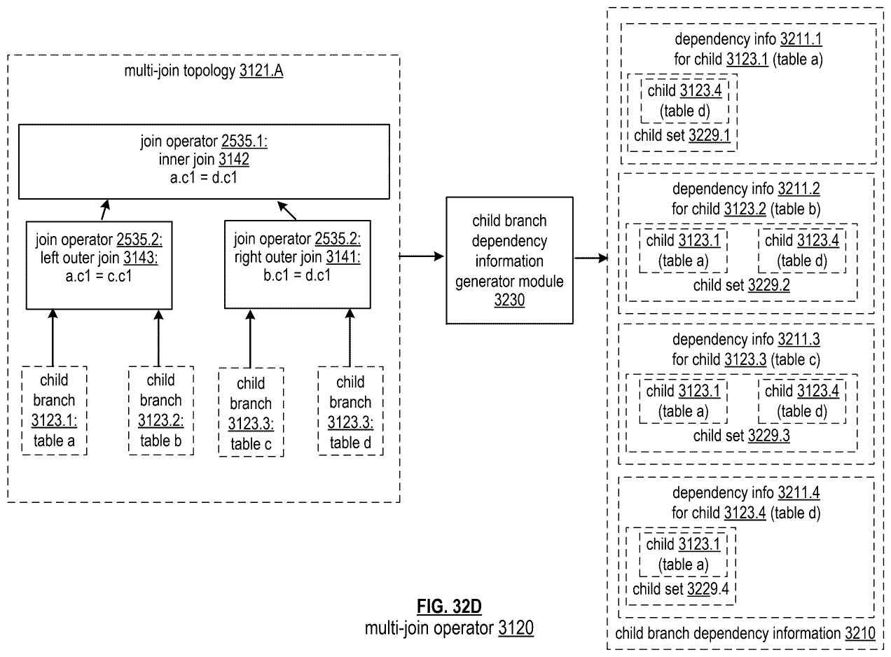

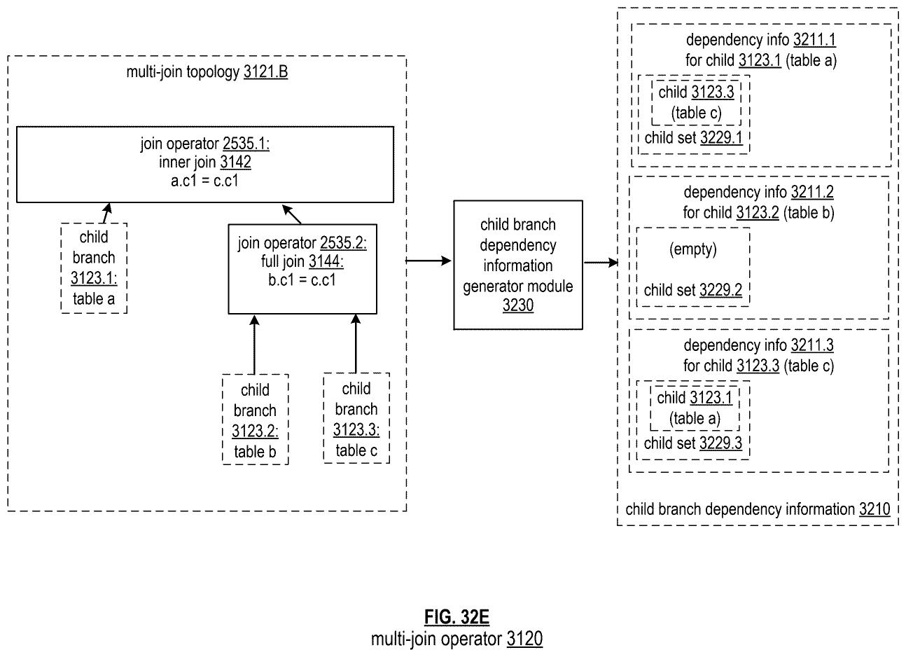

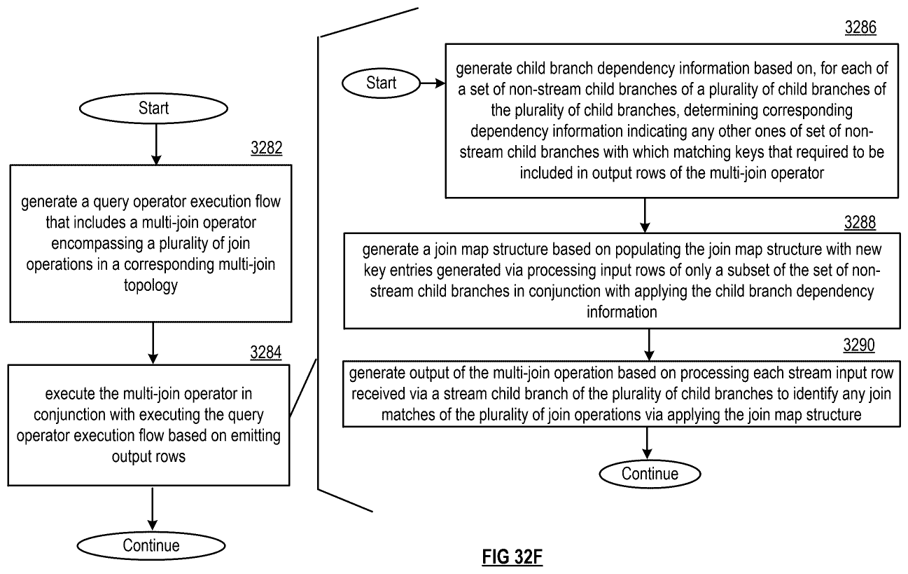

FIGS. 31A-32E illustrate embodiments of a database system 10 that executes a multi-join operator 3120 to implement a plurality of join operators 2535.1-2535.J in conjunction with implementing a corresponding plurality of join expressions 2516.1-2516.J (e.g., nested join expressions) of a corresponding query request 2515 via a multi-join topology. Some or all features and/or functionality of multi-join operator 3120 can implement any embodiment of execution of multiple join operations of a query. Some or all features and/or functionality of multi-join operator 3120 can implement any embodiment of multi-child operator 2629 described herein. Some or all features and/or functionality of executing join operations and/or corresponding queries of FIGS. 31A-31H can implement any embodiment of join operations, query execution, and/or database system 10 described herein.

In some embodiments of database system 10, equijoins between multiple tables can be merged into a single operator for execution via the query operator execution module 2504 (e.g., via a corresponding vm), for example, under the following conditions: (1) every join has transitively equal join columns in their equijoin conditions; (2) every binary join involved has the same type and that type is either inner, left outer, semi, or anti; (3) for the case of left outer and anti, the joins must also form a left deep tree; and (2) none of the joins have any additional predicates.

This merging of joins can greatly reduce the runtime cost of joins because materializing of intermediate join outputs can be skipped, and the output of all tables being joined can be materialized at once. However, the requirement that every binary join involved must have the same join type can blocked or partially blocked this optimization. In some embodiments, it can be is guaranteed that the leftmost child of a multijoin is streamed and a hash map is built for every child. In embodiments where only left deep joins are supported (e.g., in left outer logic), the limitation that join children cannot be rearranged and/or that indirection cannot be added can limit possibility of further memory reduction optimizations, for example, via rearranging children to stream the child with the highest cardinality. Such limitations can result in less efficient plans when a left join involves a very low cardinality child stuck in the streaming position and a very high cardinality child stuck in a hash map position.

FIGS. 31A-31H present embodiments where this functionality can be further expanded to allow merging of joins into a composite, multi-join operator 3120 that can implement an arbitrary topology 3121 of joins with arbitrary types (e.g., that still have the equivalent equijoin keys), where arrangement of the topology can be configured to allow the largest child (e.g., highest cardinality child) to be streamed. This can include representing each individual component join as node in a binary tree to manage corresponding output iteration state. For a composite multijoin with n children, a first child 0 (e.g., streamed child branch 3123.1) can be streamed through the join, and a hash map can be built for the join keys from children [1, n) (e.g., other child branches 3123.2-3123.B of a non-stream child branch set 3124, where B=n). Each node in a corresponding join tree can consider which, if any, of its children contain the streamed child, where execution of the corresponding multi-join operator 3120 can be free to stream any child and/or reorder the children in any way.

As illustrated in FIG. 31A, a query operator execution flow 2517 can be generated via an operator flow generator module 2514 to include a multi-join operator 3120 implementing a multi-join topology 3121 of J join operators 2535.1-2535.J based on a corresponding query request indicating J corresponding join expressions 2516.1-2516.J (e.g., of different types, but having a same equijoin condition, such as same value to match on). The multi-join operator can be based on processing a plurality of non-stream child branches 3123.2-3123.B of a non-stream child branch set 3124 via a join map generator module 3149 to generate a join map structure 3155 for access via a stream child processing module 3126 to process a stream child branch 3123.1 (e.g., highest cardinality child, which is optionally not the left-most branch in the topology, or is rearranged to a leftmost position in the topology) to generate multi-join output 3125, where a query resultant is based on the multi-join operator.

FIG. 31B illustrates an embodiment of join map structure 3155. Some or all features and/or functionality of the join map structure 3155 of FIG. 31B can implement the join map structure 3155 of FIG. 31A and/or any other embodiment of join map structure 3155 and/or hash map 2555 described herein.

In some embodiments, the join map structure 3155 can include join map values shared by children [1, n) structured as:

| { | |
|---|---|
| boolean | hasBeenMatched; |
| bucketArray[n-1] | childBuckets; |

}

For example, each bucket a in the bucketArray contains an unordered list of values in child a—1 that share the current map key.

As illustrated in FIG. 31B, each key value 2664 of a plurality of key values 2664.1-2664.M can be mapped to a corresponding array structure 3111 and a corresponding has-been-matched Boolean value 3112. The corresponding array structure can include a plurality of bucket structures 2710.1-2710.B−1 for the B−1 children 3123.2-3123.B in the non-stream child branch set 3124. Each bucket structure 2710 can include a value set 2622 of values mapped to the corresponding key value 2664, populated from values of rows included in the corresponding child branch 3123.

FIG. 31C illustrates an embodiment of stream row processing module 3125 that implements matching row determination module 2558 to emit rows via accessing join map structure 3155. Some or all features and/or functionality of stream row processing module 3125 of FIG. 31C can implement the stream row processing module 3125 of FIG. 31A and/or any embodiment of stream row processing module and/or processing of left input rows/other streamed child rows of a join operator described herein. Some or all features and/or functionality of and/or matching row determination module 2558 can implement matching row determination module 2558 of FIG. 25C and/or any embodiment of matching row determination module 2558 described herein.

Each input row 2542.i of the stream child branch 3123.1 can be processed via performing a traversal-based match determination process 3137 of a multi-join topology-based binary tree structure 3130 that includes a structuring of tree nodes 3132 for the join operators 2535 in accordance with the multi-join topology 3121. The traversal-based match determination process 3137.i can include determining matches for the input row 2542 in the join map structure 3155 based on the corresponding topology of joins, and their respective types, in conjunction with traversing through the tree structure 3130.

In some embodiments, traversal-based match determination process 3137 can include, for a matched inner and/or outer join, performing corresponding logic that include performing some or all of the following steps of a corresponding flow:

A first step can include calculating the hash key (e.g., key value 2664) of the current streaming row on child 0 (e.g., child branch 3123.1) and finding the matching value (e.g., matching key value 2664) in the join map.

A second step can include initializing all non-streaming leaf nodes of the composite join tree (e.g., tree structure 3130) with an iterator to an appropriate bucket from the bucket array for the matched value in the join map (e.g., based on which child branch this leaf-node corresponds to). If the streamed row did not match anything in the join map, each non-streaming leaf node can be initialized to an empty bucket; we still may emit a row for the stream child if the stream child is part of a chain of outer/anti joins that do not require a match.

A third step can include, for example, because it is known that there are no additional predicates for each binary join tree node 3132, that every row available from the lhs and rhs for each binary join tree node 3132 must match (e.g., excluding nulls, explained in further detail herein). For a matched inner/outer join and excluding nulls, performing traversal-based match determination process 3137 can include running a nested loop cartesian product of the rows available from each child, which can be performed based on implementing some or all of the following logic:
do {

```
  do {
    <make row available to parent>
  } (while rhsChild−>advanceState( ))
  rhsState−>reset( )
} (while lhsChild−>advanceState( ))
<no more emission state>
```

For an outer join with no matches on one side or a semi/anti join, corresponding steps can include simply advance through the appropriate single child instead. For example, for a left join where the right hand side (rhs) state is empty, performing traversal-based match determination process 3137 can be performed based on implementing some or all of the following logic:

```
rhsChild−>setEmitsNulls( )
  do {
    <make row available to parent>
  } (while lhsChild−>advanceState( ))
```

In some embodiments, certain conditions introduce additional complexities in implementing the traversal-based match determination process 3137. These conditions can include handling: join keys directly containing nulls; outer and/or anti joins that are not required to match the stream child to emit a row; outer and/or semi and/or anti joins that are required not to emit duplicate rows for certain emission states; and/or null join keys being generated by an outer join in the intermediate iteration state. Some or all of these conditions can be handled in conjunction with implementing a corresponding strategy, such as a null handling strategy or other corresponding type of strategy.

In some embodiments, in handling the case corresponding to join keys directly containing nulls, traversal-based match determination process 3137 can be implemented based on, if a join key directly contains a null, then none of the equijoin conditions will be true (e.g., NULL==NULL is not supported in composite joins, and/or in some embodiments, some plan optimizations for equijoins require that behavior even though it is not standard sql behavior). In some embodiments where this case is present for a corresponding join, for an inner join node, no rows are emitted. In some embodiments where this case is present for a corresponding join, for an outer or anti join, the child's emission state is irrelevant and is ignored, and the process includes iterating through the other child directly. In some embodiments where this case is present for a corresponding join, the only case where a null key is not equivalent to a single child containing no output rows is a full join.

Consider the following example query where the case of join keys directly containing nulls is handled:

SELECT * FROM (SELECT NULL AS c1, 5 as c2) a FULL JOIN (SELECT NULL AS c1, 5 as c2) b
ON a.c1 = b.c1 AND a.c2 = b.c2

Execution of this example query can include executing a corresponding multi-join operator 3120 to perform traversal-based match determination process 3137 that renders emitting, in conjunction with handling the case corresponding to join keys directly containing nulls:

{NULL, 5, NULL, NULL}
{NULL, NULL, NULL, 5}

In some embodiments of handling the case corresponding to join keys directly containing nulls, a full join with a null join key must iterate through all left rows while emitting nulls for the rhs, then iterate through all right rows while emitting nulls for the left hand side (lhs).

In some embodiments of executing multi-join operator 3120, the case corresponding to outer and/or anti joins that are not required to match the stream child to emit a row is handled via traversal-based match determination process 3137. Consider the following example composite join and expected result:

table A.c1 [ ]
table B.c1 [ ]
table C.c1 [1, 1]
——
SELECT * FROM A INNER JOIN B ON A.c1 = B.c1 RIGHT JOIN C ON A.c1 = C.c1
——
{NULL, NULL, 1},
{NULL, NULL, 1}

For example, this example case can be implemented via the example query operator execution flow 2517.A of FIG. 31D, where the multi-join topology includes a first join operator 2535.1 implementing a right outer join 3141, which joins upon other child branch 3123.3 and output of a second join operator 2535.2 implementing an inner join 3142, which joins upon stream child branch 3123.1 and other child branch 3123.2.

In some embodiments, in executing this example query in handling the case corresponding to outer and/or anti joins that are not required to match the stream child to emit a row is handled via traversal-based match determination process 3137, no rows will be emitted during the streaming of A because A is empty. Once the stream child is empty, performing traversal-based match determination process 3137 includes iterate through the join map and checking for valid emitted rows from each bucket that never matched the stream child. The statefulness of this can be handled by the hasBeenMatched Boolean stored as part of the join map value for each key. For example, the value can be stored per key rather than per child-row because there are no non-equijoin predicates involved. Once a key has been processed on the stream child, the has-been-matched Boolean value 3112 (e.g., the binary value of hasBeenMatched) for the corresponding key value 2664 will be flagged (e.g., set as 1).

In some embodiments of executing multi-join operator 3120, the case corresponding to outer and/or semi and/or anti joins that are required not to emit duplicate rows for certain emission states is handled via traversal-based match determination process 3137. For example, again consider the example query operator execution flow 2517.A of FIG. 31D.

In considering this example, suppose for some join key k that child branch 3123.2's join bucket is empty and child branch 3123.3's join bucket contains data. The inner join between the stream child and child branch 3123.2 will have 0 rows in its emission state, so the right outer join will emit each row from child branch 3123.3 with nulls for child branch 3123.2 and the stream child.

In some embodiments, these unmatched outer nulls can be evaluated before the stream child has finished streaming because there are no predicates outside of the equijoin keys. For example, if k appears in the stream child and an outer join has no matches on one side, then the outer join must also have no matches the next time k appears.

However, if k appears again later during streaming, then the outer join may be required to emit nothing. For example, consider the given the example query and expected result:

table A.c1 [1, 1]
table B.c1 [ ]
table C.c1 [1, 1, 1]
——
SELECT * FROM A INNER JOIN B ON A.c1 = B.c1 RIGHT JOIN C ON A.c1 = C.c1
——
{NULL, NULL, 1},
{NULL, NULL, 1},
{NULL, NULL, 1}

In some embodiments, if A is the stream child for the join/topology above, then key 1 will be processed twice. For example, it would be incorrect to emit all 3 rows from c each time the key arises.

Consider a similar join with the same base tables above:

SELECT * FROM A LEFT JOIN B ON A.c1 = B.c1 INNER JOIN C ON A.c1 = C.c1
——
{1, NULL, 1},
{1, NULL, 1},
{1, NULL, 1},
{1, NULL, 1},
{1, NULL, 1},
{1, NULL, 1}

For example, this example query can be executed via the example query operator execution flow 2517.B of FIG. 31E, where the multi-join topology includes a first join operator 2535.1 implementing an inner join 3142, which joins upon stream child branch 3123.1 and output of a second join operator 2535.2 implementing a left outer join 3143, which joins upon other child branch 3123.2 and other child branch 3123.3.

In this example, the left outer join must emit both of its unmatched rows every time 1 appears in the stream child. The statefulness for this logic can be handled by the has-been-matched Boolean value 3112 Boolean attached to each join key. For a given binary join node that must not emit duplicate rows from subtree a, it must ignore emission, for example, if and only if hasBeenMatched is true for the current key if its other subtree b contains the streamed child. For example, for a semi join that must only emit is left data once, it must consider its emission state empty if its rhs subtree contains the stream child and hasBeenMatched is set for the current hash key.

In some embodiments, the case corresponding to null join keys being generated by an outer join in the intermediate iteration state can be handled via traversal-based match determination process 3137. For example, consider the two queries and expected results below:

```
table A.c1 [1, 1]
table B.c1 [ ]
  table C.c1 [1]
  ——
  SELECT * FROM A LEFT JOIN B ON A.c1 = B.c1 RIGHT JOIN C ON B.c1 = C.c1
  ——
  {NULL, NULL, 1}
  ——
  SELECT * FROM A LEFT JOIN B ON A.c1 = B.c1 RIGHT JOIN C ON A.c1 = C.c1
  ——
  {1, NULL, 1},
  {1, NULL, 1}
```

For example, these joins have equivalent topologies and transitively equal join keys, but different results. The first join has no matches for C because B is listed as the equijoin key in the query text and B has been outer-nulled by the previous left join. This can break the general iteration assumption that every row present in any iteration state trivially matches and each binary join may simply run a cartesian product of lhs and rhs rows available. Each join node is then required to record the set of all children directly referenced in the equijoin predicate; this may be multiple different leaf nodes from each subtree if there are multiple components to the equijoin key (ex: ON a.c1=b.c1 AND c.c2=d.c2).

In some embodiments, outside of full joins, the presence of generated NULL for any individual child's join keys can be very constrained. For example, it is not sufficient to simply check whether a given child's join bucket is empty.

Consider the example query operator execution flow 2517.C of FIG. 31F, where the multi-join topology includes a first join operator 2535.1 implementing an inner join 3142 requiring child 2 (e.g., rows of 3123.2) equals child 4 (e.g., rows of 3123.4), which joins upon other child branch 3123.4 and output of a second join operator 2535.2 implementing a left outer join 3143, which joins upon stream child branch 3123.1 and output of a third join operator 2535.3 implementing an inner join 3142, which joins upon other child branch 3123.2 and child branch 3123.3.

In some cases, child branch 3123.2 may have data for a join key, but still be outer nulled by the leaf join above it if child branch 3123.3 has no data.

In some embodiments, ignoring certain full joins, an outer join that is forcing null emission on a given child branch (e.g., a given leaf) cannot change the state of that leaf during the iteration of its emission state. For example, a left join that is emitting nulls for its right subtree during the processing of a hash key cannot find a match in its rhs mid-iteration and begin emitting nonnull values for its rhs because none of the join components have non-equijoin predicates; either every row will match the rhs or no rows will match the rhs. Because of this, the traversal-based match determination process 3137 can be configured to only consider outer nulls on each child once while initializing the emission state of our tree, and then can store and reuse the result while advancing through emissions state. If any referenced child has nulls forced after initializing each subtree of a given join, the multi-join operator 3120 can be configured to treat its emission state in a same or similar fashion as in handing join keys containing nulls. Otherwise the join can be implemented to iterate a basic cartesian product and ignore the possibility of nulls.

In some embodiments, a full join can completely break these assumptions around nulls. For example, in the case where both children of a full join have data but some join key is null, the full join will emit all rows from both children and will switch which child has been forced to null in the middle of its iteration. In some embodiments, if a join key is directly null, this isn't particularly important because each component join would have null keys anyways and could not much. For example, if a full join exhibits this behavior as the result of one of its referenced children being forced null by another outer join, this results in a somewhat degenerate case for every join above this full join in the tree. It can be nontrivial to predict when and which full join children may be set to nulls during iteration. Each join above the full join that references any of these potentially nullable keys can be configured to poll its iteration states with a more standard nested loop join over the current states rather than assuming a cartesian product. For example, for any join above a full join, traversal-based match determination process 3137 can be configured to iterate through its state based on implementing some or all of the following logic:

```
do {
    advanceRhsUntilKeysMatch( )
    if(keysMatch)
      <make row available to parent>
    else if left outer / anti
      <make outer / anti row available to parent>
    rhs−>resetState( )
  } while (lhs−>advanceState( ))
```

In some embodiments, traversal-based match determination process 3137 can be further configured to handle right outer and/or anti joins based on implementing some or all of the following logic:

```
do {
  advanceLhsUntilKeysMatch( )
  if(!keys match for any lhs)
    <make right outer / anti join row available to parent>
  lhs−>resetState( )
} while (rhs−>advanceState( ))
```

FIG. 31G illustrates an embodiment of an operator flow generator module 2514 that implements a flow optimizer module to generate an updated query operator execution flow 2517.1 from an initial query operator execution flow 2517.0 to include a multi-join operator 3120 that includes a multi-join topology 3121.1 updated from a prior multi-join topology 3121.0 (e.g., that includes some or all join operators 2535.1-2535.J and/or that includes an initial version of multi-join operation 3120 Some or all embodiments of flow optimizer module 4914 of FIG. 31G can implement any embodiments of flow optimizer module 4914 described herein. The updated query operator execution flow 2517.1 can be executed by query execution module, and can implement the query operator execution flow 2517 of FIG. 31A and/or any embodiment of query operator execution flow 2517 and/or multi-join operator 3120 described herein.

FIG. 31H illustrates an embodiment of a flow optimizer module 4914 that implements a join merge module to generate an updated query operator execution flow 2517.b from a prior query operator execution flow 2517.a based on merging join operators 2535 of a multi-join topology 3121.a of a multi-join operator with join operators not yet included in the multi-join operator to render an updated multi-join operator 3120 implemented via an updated multi-join topology 3121.b. Some or all features and/or functionality of the flow optimizer module 4914 of FIG. 31H can implement the flow optimizer module 4914 of FIG. 31G and/or any embodiment of the flow optimizer module 4914 described herein.

In some embodiments, the flow optimizer module 4914 (e.g., implementing a corresponding optimizer) is implemented to form composite joins based on directly merging any applicable adjacent join operators. The composite multi-join join topology generated can be left as-is and is identical to the join topology of each individual binary join had before being merged into a composite join, for example, as illustrated in the example of FIG. 31H. In some embodiments, no additional optimizations are implemented to modify the join order within a composite join; the only additional step can include selecting the highest estimated row-volume child as the streamed child. In some embodiments, it is assumed that iteration of any equivalent topology is relatively inexpensive because: (1) there are no additional predicates, so outside of the degenerate case of full joins with complex outer nulls, there is no searching involved during any child iteration; and/or (2) there is no materialization of intermediate results, so a child lower in the tree with many matches does not require significant additional processing even if it the results are filtered later.

In some embodiments, composite multi-join operators 3120 are configured to enable support of non-equijoin predicates. This can be based on running a full nested loop scan for passing rows at every level of the join tree and/or recording the hasBeenMatched bool for each row of each join child rather than once for each map value that spans multiple child buckets. In some embodiments, if the additional predicates contain the streamed child, configuration of composite multi-joins to enable support of non-equijoin predicates can include delaying emission logic for the unmatched rows in outer joins etc., for example, until the streamed child is eof.

In some embodiments, composite multi-join operators 3120 are configured to enable deletion of keys from the map that don't satisfy pre-filtering conditions. This can reduce memory at the cost of some computation. In some embodiments, discarding the rows being ignored from the map is implemented based on data arriving in immutable blocks of rows/columns, where skipping adding a row to the join map for intermediate filtering can be worthwhile and saves some memory, but where the row data will still be kept in the block that arrived. Configuring composite multi-join operators 3120 to enable deletion of keys from the map that don't satisfy pre-filtering conditions can be based on copy incoming blocks to a minimal block so that the memory used by the discarded row can actually be released.

FIG. 31I illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 31I, for example, based on participating in execution of a query being executed by the database system 10. Some or all of the method of FIG. 31I can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 31I based on implementing a corresponding plurality of processing core resources 48.1-48.W. Some or all of the steps of FIG. 31I can optionally be performed by any other one or more processing modules of the database system 10. Some or all of the steps of FIG. 31I can be performed to implement some or all of the functionality of the database system 10 as described in conjunction with FIGS. 31A-31H, for example, by implementing some or all of the functionality of query operator execution flow 2517, multi-join operator 3120, stream child processing module 3126, join map generator module 3149, join map structure 3155, multi-join topology-based binary tree structure 3130, traversal-based match determination process 3137, flow optimizer module 4914, and/or join merge module 3150. Some or all steps of FIG. 31I can be performed by database system 10 in accordance with other embodiments of the database system 10 and/or nodes 37 discussed herein. Some or all of the steps of FIG. 31I can be performed in conjunction with performing some or all steps of any other method described herein.

Step 3182 includes determining a query for executing indicating execution of a plurality of join operations. Step 3184 includes generating a query operator execution flow that includes a composite join operator encompassing the plurality of join operations in a corresponding composite join topology. Step 3186 includes executing the composite join operator in conjunction with executing the query operator execution flow based on emitting output rows based on, for each stream input row received via a stream child branch of a plurality of child branches of the composite join operator, identifying any join matches of the plurality of join operations via applying a join map structure generated via processing input rows of a set of non-stream child branches of the plurality of child branches.

In various examples, a query resultant for the query is generated based on the output rows.

In various examples, at least two of the plurality of join operations correspond to different ones of a plurality of different join operation types. In various examples, the plurality of different join operation types includes: an inner join type; an outer join type; a left join type; a right join type; a semi join type; and/or an anti-join type.

In various examples, the query operator execution flow is generated to include the composite join operator encompassing the plurality of joins based on the plurality of joins all being equijoins having a same key.

In various examples, emitting the output rows is based on streaming stream input rows of the stream child branch as left output of the output rows.

In various examples, generating the query operator execution flow to include the composite join operator is based on: identifying one of the plurality of child branches expected to have a highest row cardinality; and/or selecting the one of the plurality of child branches as the stream child branch in the corresponding composite join topology based on the one of the plurality of child branches being expected to have the highest row cardinality.

In various examples, generating the query operator execution flow to include the composite join operator is based on generating an initial query operator execution flow that includes the plurality of join operations in a topology of adjacent join operations. In various examples, each of the plurality of join operations have two corresponding child branches in the topology of adjacent join operations. In various examples, a first one of the plurality of join operations is included in one of the two corresponding child branches of a second one of the plurality of join operations in the topology of adjacent join operators. In various examples, generating the query operator execution flow to include the composite join operator is further based on generating an updated query operator execution flow from the initial query operator execution flow in conjunction with applying an optimization process based on generating composite join operator via performing a merging process upon the plurality of join operations in the topology of adjacent join operations. In various examples, the corresponding composite join topology of the composite join operator is based on the topology of adjacent join operations of the initial query operator execution flow the corresponding composite join topology is an internal topology implemented by the composite join operator.

In various examples, generating the updated query operator execution flow is based on rearranging the topology of adjacent join operations based on moving one of the plurality of joins of the topology of adjacent join operations having a child branch expected to have a highest row cardinality to a new position in the corresponding composite join topology implemented by the composite join operator to set the child branch expected to have the highest row cardinality as the stream child branch in the corresponding composite join topology.

In various examples, executing the composite join operator in conjunction with executing the query operator execution flow is based on identifying the any join matches for the each stream input row is based on accessing the join map structure in conjunction with traversing a binary tree structure having a plurality of tree nodes corresponding to the plurality of join operations in accordance with the corresponding composite join topology based on each of the plurality of join operations having two child branches.

In various examples, traversing through the binary tree structure includes processing the each node of the plurality of tree nodes in accordance with applying a join operation type of a corresponding join operation of the plurality of join operations.

In various examples, the join map structure includes a plurality of array structures for a plurality of key values. In various examples, for each key value of the plurality of key values, a corresponding array structure of the plurality of array structures mapped to the each key value includes a corresponding array structuring that includes a set of child buckets corresponding to the set of non-stream child branches. In various examples, identifying the any join matches for the each stream input row is based on identifying a corresponding key value for the each stream input row. In various examples, identifying the any join matches for the each stream input row is further based on, when the corresponding key value is included in the plurality of key values: determining the corresponding array structure mapped to the corresponding key value; and/or initializing a set of leaf nodes of plurality of tree nodes of the binary tree structure with an iterator to a corresponding child bucket of the set of child buckets. In various examples, processing each of the set of leaf nodes in conjunction with traversing the binary tree structure is based on accessing corresponding values included in the corresponding child bucket to render corresponding node output in conjunction with the applying the join operation type of the each of the set of leaf nodes. In various examples, processing each of a set of non-leaf nodes of the plurality of tree nodes of the binary tree structure is based on processing corresponding child node output in conjunction with the applying the join operation type of the each of the set of non-leaf nodes.

In various examples, identifying the any join matches for the each stream input row is further based on, when the corresponding key value is not included in the plurality of key values, initializing a set of leaf nodes of plurality of tree nodes of the binary tree structure with an iterator to an empty corresponding child bucket.

In various examples, the join map structure further includes a has-been-matched Boolean value for each of the plurality of key values. In various examples, emitting the output rows is further based on flagging the has-been-matched Boolean value included in the join map structure for a corresponding key in the join map structure based on processing a corresponding stream input row having the corresponding key.

In various examples, a subset of the plurality of join operations have a corresponding join operation type corresponding to one of: an inner join type or an outer join type. In various examples, processing each of a subset of the plurality of tree nodes corresponding to the subset of the plurality of join operations is based on, when matches are identified in both of the two child branches, running a nested loop cartesian product of rows available from the two child branches of the each of the each of the subset of the plurality of join operations.

In various examples, a subset of the plurality of join operations have a corresponding join operation type corresponding to one of: an outer join type, a semi join type, or an anti-join type. In various examples, processing each of a subset of the plurality of tree nodes corresponding to the subset of the plurality of join operations is based on, when a match is not identified in a single child branch of the two child branches, advancing through the single child branch to process rows available from the single child branch of the each of the each of the subset of the plurality of join operations.

In various examples, a null join key is encountered by at least one of the plurality of tree nodes while traversing through the binary tree structure. In various examples, processing the at least one of the plurality of tree nodes includes handling the null join key in accordance with applying a null handling strategy.

In various examples, executing the composite join operator in conjunction with executing the query operator execution flow is further based on generating the join map structure in conjunction with processing a plurality of key values of a plurality of input rows included in the set of non-stream child branches. In various examples, the join map structure is generated to include, for each key value of the plurality of key values; a has-been-matched Boolean value; and/or a corresponding array structure mapped to the each key value that includes a corresponding array structuring that includes a set of child buckets corresponding to the set of non-stream child branches. In various examples, each child bucket of the set of non-stream child buckets includes values mapped to the each key value.

In various examples, the query operator execution flow further includes a plurality of hierarchical instances of a heap sort operator in conjunction with applying a hierarchical limit sort strategy. In various examples, executing the query operator execution flow in conjunction with executing the query is further based on: identifying a first subset of a plurality of rows based on generating a plurality of sorted subsets from a plurality of unsorted subsets based on performing a first parallelized plurality of instances of the heap sort operator; and identifying a top-ordered set of rows as a second subset of the first subset based on generating a set of sorted subsets from a set of range-based subsets of the first subset of the plurality of rows based on performing a second parallelized plurality of instances of the heap sort operator. For example, the query operator execution flow is generated and/or executed in conjunction with implementing some or all features and/or functionality of FIGS. 29A-29D.

In various examples, the query is one of a set of queries. In various examples, execution of the set of queries is initiated via a plurality of parallelized processing core resources. In various examples, the method further includes, after initiating execution of set of queries and while the set of queries are concurrently being executed, performing a spill to disk process based on: spilling to disk, based on at least one of the plurality of parallelized processing core resources signaling spilling in response to determining a spill to disk condition is met, data of at least one operator the query; and/or determining when a spill to disk process end condition has been met based on tracking the ones of the plurality of parallelized processing core resources that determine the spill to disk condition is met and signal the spilling, wherein the spill to disk process completes based on the determining the spill to disk process end condition has been met. For example, the query executed and/or spilled to disk in conjunction with implementing some or all features and/or functionality of FIGS. 30A-30B.

In various embodiments, any one of more of the various examples listed above are implemented in conjunction with performing some or all steps of FIG. 31I. In various embodiments, any set of the various examples listed above can be implemented in tandem, for example, in conjunction with performing some or all steps of FIG. 31I, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 31I described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 31I, for example, in conjunction with further implementing any one or more of the various examples described above.

In various embodiments, the operational instructions, when executed by the at least one processor, cause the database system to: determine a query for executing indicating execution of a plurality of join operations; generate a query operator execution flow that includes a composite join operator encompassing the plurality of join operations in a corresponding composite join topology; and/or execute the composite join operator in conjunction with executing the query operator execution flow based on emitting output rows based on, for each stream input row received via a stream child branch of a plurality of child branches of the composite join operator, identifying any join matches of the plurality of join operations via applying a join map structure generated via processing input rows of a set of non-stream child branches of the plurality of child branches. In various embodiments, a query resultant for the query is generated based on the output rows.

FIGS. 32A-32E present embodiments of database system 10 that implements execution of a multi-join operator 3120 based on utilizing child branch dependency information 3210 that includes a set of dependency information 3211.1-3211.B for the set of child branches 3123.1-3123.B. Some or all features and/or functionality of multi-join operator 3120 and/or execution of a corresponding query of FIGS. 32A-32E can implement any embodiment of multi-join operator 3120 of FIGS. 31A-31H and/or execution of join operations during query execution described herein.

As illustrated in FIG. 32A, multi-join operator 3120 can implement join map generator module 3149 based on processing child branch dependency information 3210 that includes a set of dependency information 3211.1-3211.B for the set of child branches 3123.1-3123.B. Some or all features and/or functionality of join map generator module 3149 of FIG. 32A can implement any embodiment of join map generator module 3149 and/or any hash map generator module described herein.

In some embodiments, the scheduler in the vm (e.g., implemented via query execution module 2504) makes no guarantees, where a best effort attempt is made to process the entirely of child n before processing child n−1 (e.g., in accordance with implementing right-to-left piecewise operator execution 2616 via implementing some or all features and/or functionality of FIGS. 26A-26J). This can be practical for ensuring the streamed child (0) does not accumulate memory while waiting for the join map to be populated.

For example, consider a simple multijoin composed of inner joins. In some embodiments, for each join child, a bloom filter can be generated (and/or potentially an explicit list of join keys), where the filters are pushed down the plan children to potentially filter rows at shuffles, io, and/or other applicable operators. These filters may often be disabled due to memory requirements and/or optimization heuristics, and may result in false positives because bloom filters are probabilistic. In some embodiments, an additional optimization can be implemented to directly ignore unmatched rows for multijoin children while building the hash map. For an inner equijoin between multiple tables, this can be very straightforward because every child must match every other child. If child a has processed an eof and every row has been inserted into the join map, then child b does not need to insert any rows into the hash map.

This can save memory based on skipping unnecessary emplace logic in the map, and can also improves map building performance because data for child b can use find to add values to buckets rather than the slightly more expensive emplace. In some embodiments, if multiple children are eof, then child b may also skip adding a value to its bucket in the map if a required child has no buckets in the map value. Ex: children a, c are eof fully processed into the join map. Child b finds k key in the map; the bucket for a contains values, but the bucket for c is empty. b can ignore this bucket and immediately discard the row because the row cannot satisfy the equijoin predicate. We may also choose to delete k from the join map entirely in this case, but that is not currently implemented.

This functionality can be extended for entirely empty children. For example, for this inner multi join, if child c sends exactly 0 rows to an operator instance, the operator can immediately send eof signals when c sends an eof without waiting to process any remaining children because no rows can satisfy the inner join. This 0-row early eof logic can also be configured in implementing nested loop joins and 2 child hash joins.

This prefiltering during map building and bloom filtering can also be applied to composite multi-joins depending on the join topology. For example, the database system is configured to calculate the set of children that must match any given child in the join map. This can be implemented by beginning with the set of referenced child keys attached to each composite join node, for example, as described in conjunction with handling the null join keys being generated by an outer join in the intermediate iteration state. For example, for a left join, each child on the rhs directly referenced on the join predicate can be required to match every child present on the lhs in order for the row to match and for the rhs to be emitted. This naive dependency graph can be built for each node in the join tree, and then transitive dependencies are calculated by depth first traversing the graph from each child.

In some embodiments, with this dependency information generated in the vm, it can be straightforward to determine whether a given child should add new keys to the join map. If any child in its dependencies is eof, then any keys not already in the map should be discarded. This graph can also be used to generate bloom filters/index join signaling for composite multi-joins. The bloom filter for a given child a can only be sent to children where a appears in their dependency list.

As illustrated in FIG. 32B, at a first time t0, join map generator module 3149 generates new entries 3125 to a join map structure in processing other child branch 3123.B. This can include identifying new key values 2664 in other child branch 3123.B not yet included in the join map structure 3155 and populating the join map structure to include new entries 3125 having these new key values, and further populating the join map structure to include values mapped to these new key values and existing key values already in the join map structure as they are encountered in other child branch 3123.B.

At a second time t1, join map generator module 3149 generates no new entries 3125 to join map structure in processing other child branch 3123.B−1 based on processing dependency information for child branch 3123.B−1 indicating dependency upon child branch 3123.B. In particular, based on the dependency information for child branch 3123.B−1 indicating dependency upon child branch 3123.B, the join map generator module 3149 can be implemented to add no new entries for any new key values 2664 encountered in processing the other child branch 3123.B−1. Instead, the only updating to the join map structure 3155 is populating value sets 2622 with additional values mapped to existing key values 2664 already included in the join map structure 2664, and ignoring any rows in child branch 3123.B−1 having new keys not yet included in the join map structure 3155 as they are irrelevant due to the dependency information.

As illustrated in FIG. 32C, multi-join operator 3120 can implement a child branch dependency information generator module operable to generate child branch dependency information 3210 via performing a traversal-based dependency generation process 3238 via traversal of multi-join topology-based binary tree structure 3130.

FIGS. 32D and 32E illustrate examples of implementing child branch dependency information 3210. Some or all features and/or functionality of multi-join topologies 3121, child branch dependency generator module 3230, and/or child branch dependency information 3210 of FIG. 32D and/or 32E can implement multi-join topologies 3121, child branch dependency generator module 3230, and/or child branch dependency information 3210 of FIG. 32C, and/or can implement any multi-join topologies 3121, child branch dependency generator module 3230, and/or child branch dependency information 3210, and/or corresponding execution of multi-join operator 3120 described herein.

FIG. 32D presents an example of generating child branch dependency information for a multi-join operator 3120 with an example multi-join topology 3121.A where a first join includes an inner join requiring a.c1 is equal to d.c1, joining upon a second join requiring a.c1 is equal to c.c1 and a third join requiring that b.c1 is equal to d.c1 (e.g., a, b, c, and d are tables 2710, and c1 is a column included in all of these tables).

In some embodiments, the direct dependencies from the join nodes (e.g., formatted as <child>: {other children that must match for <child> to be emitted/matched anywhere in the tree}) generated via performance of a first portion of traversal-based dependency generation process 3238 are:
a: {d}
c: {a}
b: {d}
d: {a}

In some embodiments, the dependencies generated via performance of a second portion of traversal-based dependency generation process 3238 (e.g., after traversing the transitive dependencies) are:
a: {d}
c: {a, d}
b: {a, d}
d: {a}

In some embodiments, this means of performing traversal-based dependency generation process 3238 is not totally sufficient to consider all outer join null scenario, and would, for example, force a mismatch for the example of FIG. 32E.

FIG. 32E presents an example of generating child branch dependency information for a multi-join operator 3120 with an example multi-join topology 3121.B where a first join includes an inner join requiring a.c1 is equal to c.c1, joining upon table a and a second join requiring b.c1 is equal to c.c1 (e.g., a, b, and c are tables 2710, and c1 is a column included in all of these tables).

In some embodiments, the dependencies generated via performance of traversal-based dependency generation process 3238 are:
a: {c}
b: { }
c: {a}

For example, these dependencies are generated even though no rows will be emitted if b does not match c. In some embodiments, this case can be guaranteed to always be detected elsewhere in optimization when propagate filters for join keys not being null. In this case, the filter c.c1 IS NOT NULL can be generated below the inner join, then push into the full join and convert it to a right join.

FIG. 32F illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 32F, for example, based on participating in execution of a query being executed by the database system 10. Some or all of the method of FIG. 32F can be performed by nodes executing a query in conjunction with a query execution, for example, via one or more nodes 37 implemented as nodes of a query execution module 2504 implementing a query execution plan 2405. In some embodiments, a node 37 can implement some or all of FIG. 32F based on implementing a corresponding plurality of processing core resources 48.1-48.W. Some or all of the steps of FIG. 32F can optionally be performed by any other one or more processing modules of the database system 10. Some or all of the steps of FIG. 32F can be performed to implement some or all of the functionality of the database system 10 as described in conjunction with FIGS. 32A-32E, for example, by implementing some or all of the functionality of multi-join operator 3120, join map generator module 3149, child branch dependency information 3210, multi-join topology-based binary tree structure 3130, and/or traversal-based dependency generation process 3238. Some or all steps of FIG. 32F can be performed by database system 10 in accordance with other embodiments of the database system 10 and/or nodes 37 discussed herein. Some or all of the steps of FIG. 32F can be performed in conjunction with performing some or all steps of any other method described herein.

Step 3282 includes generating a query operator execution flow that includes a multi-join operator encompassing a plurality of join operations in a corresponding multi-join topology. Step 3284 includes executing the multi-join operator in conjunction with executing the query operator execution flow based on emitting output rows.

Performing step 3284 can include performing some or all of steps 3286, 3288, and/or 3290. Step 3286 includes generating child branch dependency information based on, for each of a set of non-stream child branches of a plurality of child branches of the plurality of child branches, determining corresponding dependency information indicating any other ones of set of non-stream child branches with which matching keys that required to be included in output rows of the multi join operator. Step 3288 includes generating a join map structure based on populating the join map structure with new key entries generated via processing input rows of only a subset of the set of non-stream child branches in conjunction with applying the child branch dependency information. Step 3290 includes generating output of the multi-join operation based on processing each stream input row received via a stream child branch of the plurality of child branches to identify any join matches of the plurality of join operations via applying the join map structure.

In various examples, a query resultant for the query is generated based on the output of the multi-join operation.

In various examples, one of the set of non-stream child branches is not included in the subset of the set of non-stream child branches based on: the corresponding dependency information for the one of the set of non-stream child branches indicating matching is required with a second subset of non-stream child branches in the set of non-stream child branches; and/or all of the second subset of non-stream child branches being included in the subset of the set of non-stream child branches.

In various examples, the child branch dependency information for a first non-stream child branch of the set of non-stream child branches indicates matching is required with a second subset of non-stream child branches in the set of non-stream child branches. In various examples, generating the join map structure is based on: prior to processing of any input rows in the first non-stream child branch, completing processing of all input rows in all of the second subset of non-stream child branches. In various examples, generating the join map structure is further based on, after completing processing of the all input rows in all of the second subset of non-stream child branches, identifying the first non-stream child branch for exclusion from the subset of the set of non-stream child branches based on the corresponding dependency information indicating the matching is required with the second subset of non-stream child branches and based on the processing of all input rows in all of the second subset of non-stream child branches being completed, and/or completing processing of all input rows in the first non-stream child branch. In various examples, no new key entries are generated for any of the all input rows in the first non-stream child branch based on the first non-stream child branch being excluded from the subset of the set of non-stream child branches.

In various examples, the child branch dependency information is generated based on: a corresponding join operation type of each of the plurality of join operations; and/or an arrangement of the plurality of join operations in the corresponding multi-join topology.

In various examples, the multi-join operator is implemented as a composite join operator based on: at least a first one of the plurality of join operations having a first corresponding join operation type of a plurality of different join operation types; and/or at least a second one of the plurality of join operations having a second corresponding join operation type of the plurality of different join operation types,

In various examples, the first corresponding join operation type and the second corresponding join operation type corresponds to different ones of the plurality of different join operation types. In various examples, the plurality of different join operation types includes: two of: an inner join type; an outer join type; a left join type; a right join type; a semi join type; and/or an anti-join type.

In various examples, adding a new key entry to the join map structure is based on determining a corresponding key value included in a corresponding input row of a corresponding non-stream child branch of the subset of the set of non-stream child branches is not already included in any existing key entries of the join map structure, and wherein generating the join map structure is further based on updating existing entries of the join map structure generated via processing input rows of all of the set of non-stream child branches. In various examples, at least one existing key entry is updated based on processing at least one corresponding input row included in one of the set of non-stream child branches included in a set difference of the set of non-stream child branches and the subset of the set of non-stream child branches.

In various examples, a first key entry for a first key value is added to the join map structure based on mapping a first value of a first input row of a first non-stream child branch of the subset of the set of non-stream child branches to the first key value based on the first input row having the first key value. In various examples, the first key entry is updated in the join map structure based on further mapping a second value of a second input row of a second non-stream child branch of the set of non-stream child branches to the first key value based on the second input row having the first key value.

In various examples, the join map structure is generated to include, for each key value of a plurality of key values, a corresponding array structure mapped to the each key value that includes a corresponding array structuring that includes a set of child buckets corresponding to the set of non-stream child branches. In various examples, each child bucket of the set of non-stream child buckets includes values mapped to the each key value based on being included in input rows of a corresponding non-stream child branch of the set of non-stream child branches having the each key value.

In various examples, the corresponding dependency information for a first non-stream child branch of the set of non-stream child branches indicates matching is required with a second non-stream child branch in the set of non-stream child branches. In various examples, generating the join map structure is based on: prior to processing of any input rows in the first non-stream child branch, completing processing of all input rows in the second non-stream child branch; and/or after completing processing of the all input rows in the second non-stream child branch, processing input rows in the first non-stream child branch. In various examples, a first row of the input rows in the first non-stream child branch includes a first key value already included in the join map structure and having an empty child bucket for the second non-stream child branch based on none of the input rows in the second non-stream child branch having the first key value. In various examples, a first corresponding child bucket for the first non-stream child branch is not populated with a corresponding value of the first row despite the first row having the first key value based on the first key value having the empty child bucket for the second non-stream child branch and further based on the corresponding dependency information for the first non-stream child branch indicating the matching is required with the second non-stream child branch. In various examples, no new key entries are generated for any of the all input rows in the first non-stream child branch based on the first non-stream child branch being identified for inclusion in the subset of the set of non-stream child branches.

In various examples, no new key entries are generated for any of the all input rows in the first non-stream child branch based on the first non-stream child branch being excluded from the subset of the set of non-stream child branches in response to: the corresponding dependency information for the first non-stream child branch indicating the matching is required with the second non-stream child branch; and/or the processing of all input rows in the second non-stream child branch being completed prior to any processing of any input rows of the first non-stream child branch.

In various examples, the corresponding dependency information for a first non-stream child branch of the set of non-stream child branches indicates matching is required with a second non-stream child branch in the set of non-stream child branches. In various examples, generating the join map structure is based on: prior to processing of any input rows in the first non-stream child branch, completing processing of all input rows in the second non-stream child branch. In various examples, generating the join map structure is further based on: after completing processing of the all input rows in the second non-stream child branch and prior to processing input rows of the first non-stream child branch: identifying a set of entries in the join map structure based on each having an empty child buckets for the second non-stream child branch mapped to a corresponding key value of the plurality of key values; and/or deleting the set of entries from the join map structure based on each having the empty child buckets for the second non-stream child branch.

In various examples, the corresponding dependency information for a first non-stream child branches of the set of non-stream child branches indicates matching is required with a second non-stream child branch in the set of non-stream child branches. In various examples, generating the join map structure is based on: prior to processing of any input rows in the first non-stream child branch, completing processing of the second non-stream child branch via processing no rows based on the second non-stream child branch including no corresponding input rows; and/or foregoing processing of any input rows of the first non-stream child branch based on the second non-stream child branch including no corresponding input rows and/or further based on the corresponding dependency information for the first non-stream child branches indicating matching is required with the second non-stream child branch.

In various examples, generating the join map structure is further based on emitting empty output that includes no output rows via executing a first corresponding join operation of the plurality of join operations having the first non-stream child branch and the second non-stream child branch as input branches in the corresponding multi-join topology. In various examples, the empty output of the first corresponding join operation is input to a second corresponding join operation of the plurality of join operations in the corresponding multi-join topology.

In various examples, generating the child branch dependency information is based on traversing a binary tree structure that includes a plurality of nodes corresponding to the plurality of join operations in accordance with the corresponding multi-join topology.

In various examples, generating the child branch dependency information is further based on applying a null handling strategy.

In various examples, emitting the output rows is based on streaming stream input rows of the stream child branch as left output of the output rows.

In various examples, the query operator execution flow further includes a plurality of hierarchical instances of a heap sort operator in conjunction with applying a hierarchical limit sort strategy. In various examples, executing the query operator execution flow in conjunction with executing the query is further based on: identifying a first subset of a plurality of rows based on generating a plurality of sorted subsets from a plurality of unsorted subsets based on performing a first parallelized plurality of instances of the heap sort operator; and/or identifying a top-ordered set of rows as a second subset of the first subset based on generating a set of sorted subsets from a set of range-based subsets of the first subset of the plurality of rows based on performing a second parallelized plurality of instances of the heap sort operator. For example, the query operator execution flow is generated and/or executed in conjunction with implementing some or all features and/or functionality of FIGS. 29A-29D.

In various examples, the query is one of a set of queries. In various examples, execution of the set of queries is initiated via a plurality of parallelized processing core resources, and wherein the method further includes, after initiating execution of set of queries and while the set of queries are concurrently being executed, performing a spill to disk process based on: spilling to disk, based on at least one of the plurality of parallelized processing core resources signaling spilling in response to determining a spill to disk condition is met, data of at least one operator the query; and/or determining when a spill to disk process end condition has been met based on tracking the ones of the plurality of parallelized processing core resources that determine the spill to disk condition is met and signal the spilling, wherein the spill to disk process completes based on the determining the spill to disk process end condition has been met. For example, the query executed and/or spilled to disk in conjunction with implementing some or all features and/or functionality of FIGS. 30A-30B.

In various embodiments, any one of more of the various examples listed above are implemented in conjunction with performing some or all steps of FIG. 31I. In various embodiments, any set of the various examples listed above can be implemented in tandem, for example, in conjunction with performing some or all steps of FIG. 31I, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 31I described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 31I, for example, in conjunction with further implementing any one or more of the various examples described above.

In various embodiments, the operational instructions, when executed by the at least one processor, cause the database system to: generate a query operator execution flow that includes a multi-join operator encompassing a plurality of join operations in a corresponding multi-join topology; and/or execute the multi-join operator in conjunction with executing the query operator execution flow based on emitting output rows. In various embodiments, execute the multi-join operator in conjunction with executing the query operator execution flow based on emitting output rows is based on generating child branch dependency information based on, for each of a set of non-stream child branches of a plurality of child branches of the plurality of child branches, determining corresponding dependency information indicating any other ones of set of non-stream child branches with which matching keys that required to be included in output rows of the multi-join operator; generating a join map structure based on populating the join map structure with new key entries generated via processing input rows of only a subset of the set of non-stream child branches in conjunction with applying the child branch dependency information; and/or generating output of the multi-join operation based on processing each stream input row received via a stream child branch of the plurality of child branches to identify any join matches of the plurality of join operations via applying the join map structure. In various embodiments, a query resultant for the query is generated based on the output of the multi-join operation.

As used herein, an “AND operator” can correspond to any operator implementing logical conjunction. As used herein, an “OR operator” can correspond to any operator implementing logical disjunction.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining -A matches -B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c” “b” and “c” and/or “a” “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e., machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A query and response sub-system of a database system comprises:
a plurality of computing device clusters, wherein a computing device cluster of the plurality of computing device clusters includes a plurality of computing devices, wherein a computing device of the plurality of computing devices includes a plurality of computing nodes, wherein a computing node of the plurality of computing nodes includes a plurality of processing core resources, wherein a set of processing core resources of the pluralities of processing core resources is operable to:
receive a query regarding a dataset, wherein the dataset includes a plurality of rows of columnar data, wherein the columnar data includes a plurality of columns of data, wherein the query includes a plurality of query operations organized in a tree structure, wherein the tree structure includes a plurality of sections, wherein a section of the plurality of sections includes a set of branches having a common connection point, wherein a first branch of the set of branches includes a first set of query operations of the plurality of query operations, a second branch of the set of branches includes a second set of query operations of the plurality of query operations, and the common connection point includes a third set of query operations;
for the section:
set a first execution indicator to a pause mode value, wherein the first execution indicator is associated with the first branch;
set a second execution indicator to an execution mode value, wherein the second execution indicator is associated with the second branch;
execute the second set of query operations to produce a second partial query resultant;
when the second branch substantially completes execution of the second set of query operations, send an end of file signal to the third set of query operations; and
in response to the end of file signal:
change the first execution indicator to the execution mode value; and
execute the first set of query operations to produce a first partial query resultant.

2. The query and response sub-system of claim 1, wherein the set of processing core resources is further operable to:
send the first partial query resultant and the second partial query resultant to the third set of query operations to produce a third partial query resultant.

3. The query and response sub-system of claim 1, wherein the set of processing core resources is further operable to:
for a second section of the plurality of sections that includes a second set of branches having a second common connection point that includes a sixth set of query operations:
set a third execution indicator to the pause mode value, wherein the third execution indicator is associated with a first branch of the second set of branches, wherein the first branch of the second set of branches includes a fourth set of query operations;
set a fourth execution indicator to the execution mode value, wherein the fourth execution indicator is associated with a second branch of the second set of branches, wherein the second branch of the second set of branches includes a fifth set of query operations;
execute the fifth set of query operations to produce a fifth partial query resultant; and
when the second branch substantially completes execution of the fifth set of query operations, send a second end of file signal to the fourth set of query operations;
in response to the second end of file signal:
change the third execution indicator to the execution mode value; and
execute the fourth set of query operations to produce a fourth partial query resultant.

4. The query and response sub-system of claim 3, wherein the set of processing core resources is further operable to:
send the fourth partial query resultant and the fifth partial query resultant to the sixth set of query operations to produce a sixth partial query resultant.

5. The query and response sub-system of claim 1, wherein the first set of query operations includes one or more first query operations, the second set of query operations includes one or more second query operations, and the third set of query operations includes one or more third query operations.

6. The query and response sub-system of claim 1, wherein the first set of query operations is streaming data regarding the dataset from a set of long term storage memory devices.

7. The query and response sub-system of claim 1, wherein the second set of query operations is materializing data regarding the dataset into a short term memory device associated with the set of processing core resources from a set of long term storage memory devices associated with the database system.

8. A computer-readable memory comprises:
a first memory section that stores operation instructions that, when executed by a set of processing core resources of pluralities of processing core resources of a query and response sub-system of a database system, causes the set of processing core resources to:
receive a query regarding a dataset, wherein the dataset includes a plurality of rows of columnar data, wherein the columnar data includes a plurality of columns of data, wherein the query includes a plurality of query operations organized in a tree structure, wherein the tree structure includes a plurality of sections, wherein a section of the plurality of sections includes a set of branches having a common connection point, wherein a first branch of the set of branches includes a first set of query operations of the plurality of query operations, a second branch of the set of branches includes a second set of query operations of the plurality of query operations, and the common connection point includes a third set of query operations;
a second memory section that stores operation instructions that, when executed by the set of processing core resources, causes the set of processing core resources to:
for the section:
set a first execution indicator to a pause mode value, wherein the first execution indicator is associated with the first branch;
set a second execution indicator to an execution mode value, wherein the second execution indicator is associated with the second branch;
execute the second set of query operations to produce a second partial query resultant;
when the second branch substantially completes execution of the second set of query operations, send an end of file signal to the third set of query operations;
in response to the end of file signal:
change the first execution indicator to the execution mode value; and
execute the first set of query operations to produce a first partial query resultant.

9. The computer-readable memory of claim 8, wherein the second memory section further stores operational instructions that, when executed by the set of processing core resources, causes the set of processing core resources to:
send the first partial query resultant and the second partial query resultant to the third set of query operations to produce a third partial query resultant.

10. The computer-readable memory of claim 8, wherein the second memory section further stores operational instructions that, when executed by the set of processing core resources, causes the set of processing core resources to:
for a second section of the plurality of sections that includes a second set of branches having a second common connection point that includes a sixth set of query operations:
set a third execution indicator to the pause mode value, wherein the third execution indicator is associated with a first branch of the second set of branches, wherein the first branch of the second set of branches includes a fourth set of query operations;
set a fourth execution indicator to the execution mode value, wherein the fourth execution indicator is associated with a second branch of the second set of branches, wherein the second branch of the second set of branches includes a fifth set of query operations;
execute the fifth set of query operations to produce a fifth partial query resultant;
when the second branch substantially completes execution of the fifth set of query operations, send a second end of file signal to the fourth set of query operations; and
in response to the second end of file signal:
change the third execution indicator to the execution mode value; and
execute the fourth set of query operations to produce a fourth partial query resultant.

11. The computer-readable memory of claim 10, wherein the second memory section further stores operational instructions that, when executed by the set of processing core resources, causes the set of processing core resources to:
send the fourth partial query resultant and the fifth partial query resultant to the sixth set of query operations to produce a sixth partial query resultant.

12. The computer-readable memory of claim 8, wherein the first set of query operations includes one or more first query operations, the second set of query operations includes one or more second query operations, and the third set of query operations includes one or more third query operations.

13. The computer-readable memory of claim 8, wherein the first set of query operations is streaming data regarding the dataset from a set of long term storage memory devices associated with the database system.

14. The computer-readable memory of claim 8, wherein the second set of query operations is materializing data regarding the dataset into a set of short term memory devices associated with the processing core resources from a set of long term storage memory devices associated with the database system.
